(19) United States
(12) Patent Application Publication
(10) Pub. No.: US 2026/0203763 A1
(43) Pub. Date: Jul. 16, 2026

(54) METHODS, SYSTEMS, ARTICLES OF MANUFACTURE AND APPARATUS TO CONTROL TRANSACTIONAL DATA

(71) Applicant: Intel Corporation, Santa Clara, CA (US)

(72) Inventor: Robert Vaughn, Portland, OR (US)

(73) Assignee: Intel Corporation, Santa Clara, CA (US)

(21) Appl. No.: 19/561,066

(22) Filed: Mar. 9, 2026

Related U.S. Application Data
(63) Continuation of application No. 18/153,931, filed on Jan. 12, 2023.
Application No. 18/153,931 is a continuation-in-part of application No. 17/517,238, filed on Nov. 2, 2021, now abandoned.
(60) Provisional application No. 63/108,734, filed on Nov. 2, 2020.
(60) Provisional application No. 63/298,855, filed on Jan. 12, 2022.
(60) Provisional application No. 63/298,871, filed on Jan. 12, 2022.
(60) Provisional application No. 63/299,949, filed on Jan. 15, 2022.
(60) Provisional application No. 63/299,969, filed on Jan. 15, 2022.
(60) Provisional application No. 63/299,947, filed on Jan. 15, 2022.
(60) Provisional application No. 63/300,011, filed on Jan. 16, 2022.
(60) Provisional application No. 63/300,012, filed on Jan. 16, 2022.
(60) Provisional application No. 63/300,014, filed on Jan. 16, 2022.
(60) Provisional application No. 63/300,015, filed on Jan. 16, 2022.
(60) Provisional application No. 63/300,016, filed on Jan. 16, 2022.
(60) Provisional application No. 63/300,017, filed on Jan. 16, 2022.
(60) Provisional application No. 63/332,653, filed on Apr. 19, 2022.

(51) Int. Cl. G06Q 20/40; G06Q 20/38

(52) U.S. Cl. CPC G06Q 20/4016; G06Q 20/3829; G06Q 2220/00

(57) ABSTRACT

Methods, apparatus, systems, and articles of manufacture are disclosed to control transactional data. An example apparatus disclosed herein includes memory, machine readable instructions, and processor circuitry to at least one of instantiate or execute the machine readable instructions to populate encrypted input data into a first portion of a data structure, populate an encryption key into a second portion of the data structure, cause the first portion of the data structure to be signed with (a) credentials corresponding to an owner of the encrypted data and (b) credentials corresponding to a transaction host, and store the data structure in a ledger.

### RELATED APPLICATIONS

This patent arises from a continuation of U.S. patent application Ser. No. 18/153,931 which was filed on Jan. 12, 2023. U.S. patent application Ser. No. 18/153,931 arises from a continuation-in-part of U.S. patent application Ser. No. 17/517,238 which was filed on Nov. 2, 2021, which claims the benefit of U.S. Provisional Patent Application No. 63/108,734, which was filed on Nov. 2, 2020. This patent also claims the benefit of U.S. Provisional Patent Application No. 63/298,855, which was filed on Jan. 12, 2022. This patent also claims the benefit of U.S. Provisional Patent Application No. 63/332,653, which was filed on Apr. 19, 2022. This patent also claims the benefit of U.S. Provisional Patent Application No. 63/298,871, which was filed on Jan. 12, 2022. This patent also claims the benefit of U.S. Provisional Patent Application No. 63/299,949, which was filed on Jan. 15, 2022. This patent also claims the benefit of U.S. Provisional Patent Application No. 63/299,969, which was filed on Jan. 15, 2022. This patent also claims the benefit of U.S. Provisional Patent Application No. 63/299,947, which was filed on Jan. 15, 2022. This patent also claims the benefit of U.S. Provisional Patent Application No. 63/300,011, which was filed on Jan. 16, 2022. This patent also claims the benefit of U.S. Provisional Patent Application No. 63/300,012, which was filed on Jan. 16, 2022. This patent also claims the benefit of U.S. Provisional Patent Application No. 63/300,014, which was filed on Jan. 16, 2022. This patent also claims the benefit of U.S. Provisional Patent Application No. 63/300,015, which was filed on Jan. 16, 2022. This patent also claims the benefit of U.S. Provisional Patent Application No. 63/300,016, which was filed on Jan. 16, 2022. This patent also claims the benefit of U.S. Provisional Patent Application No. 63/300,017, which was filed on Jan. 16, 2022. U.S. patent application Ser. No. 18/153,931, U.S. patent application Ser. No. 17/517,238, U.S. Provisional Patent Application No. 63/108,734, U.S. Provisional Patent Application No. 63/298,855, U.S. Provisional Patent Application No. 63/332,653, U.S. Provisional Patent Application No. 63/298,871, U.S. Provisional Patent Application No. 63/299,949, U.S. Provisional Patent Application No. 63/299,969, U.S. Provisional Patent Application No. 63/299,947, U.S. Provisional Patent Application No. 63/300,011, U.S. Provisional Patent Application No. 63/300,012, U.S. Provisional Patent Application No. 63/300,014, U.S. Provisional Patent Application No. 63/300,015, U.S. Provisional Patent Application No. 63/300,016, and U.S. Provisional Patent Application No. 63/300,017 are hereby incorporated herein by reference in its entirety. Priority to U.S. Patent Application No. U.S. patent application Ser. No. 18/153,931, U.S. patent application Ser. No. 17/517,238, U.S. Provisional Patent Application No. 63/108,734, U.S. Provisional Patent Application No. 63/298,855, U.S. Provisional Patent Application No. 63/332,653, U.S. Provisional Patent Application No. 63/298,871, U.S. Provisional Patent Application No. 63/299,949, U.S. Provisional Patent Application No. 63/299,969, U.S. Provisional Patent Application No. 63/299,947, U.S. Provisional Patent Application No. 63/300,011, U.S. Provisional Patent Application No. 63/300,012, U.S. Provisional Patent Application No. 63/300,014, U.S. Provisional Patent Application No. 63/300,015, U.S. Provisional Patent Application No. 63/300,016, and U.S. Provisional Patent Application No. 63/300,017 are hereby claimed.

### FIELD OF THE DISCLOSURE

This disclosure relates generally to information management and, more particularly, to methods, systems, articles of manufacture and apparatus to control transactional data.

### BACKGROUND

In recent years, blockchain has garnered interest in managing data verification tasks. In some cases, blockchain techniques allow for the detection of data modification, such as instances of potential fraud with transactions. As such, some applications of blockchain provide assurances that tampering has not occurred.

### BRIEF DESCRIPTION OF THE DRAWINGS

FIG. 1 is a schematic illustration of an example network environment to control transactional data constructed in a manner consistent with this disclosure.

FIG. 2 is a schematic illustration of the example transaction container circuitry of FIG. 1.

FIGS. 3A and 5 are architectural views of a system corresponding to the example network environment of FIG. 1 to control transactional data and facilitate ChainCasting.

FIGS. 3B, 4, 6, 7, 10-12, 14, 15, 20, 21H, D1, D2, E1 through E10, E12 through E16, F1 through F10, F12, G2, I1, I2, J1 through J8, K1 through K3, L1, M1 through M3, N1 through N4, O1 and O2 are flowcharts representative of example machine readable instructions and/or example operations that may be executed by example processor circuitry to implement the transaction container circuitry of FIGS. 1 and 2.

FIG. 8 is an example ledger constructed in a manner consistent with this disclosure.

FIG. 9 is example pseudo code executed by the example TC circuitry of FIGS. 1 and 2.

FIGS. 13A and 13B are tables including example transaction type descriptions.

FIGS. 16A, 16B, 17A, 17B, 18 and 19 are tables that describe example objects.

FIGS. 21A through 21G and 21I, and E19, and F19 through F25 are example transaction lists.

FIGS. E20 through E25 is a table having the same column headings as disclosed in FIG. E19 in which the table of FIGS. E20 through E25 illustrate example mock transactions.

FIGS. 22A through 22E are screen images of tools instantiated by examples disclosed herein to facilitate transactions.

FIGS. 23A through 23D are example code to facilitate transactions with an application programming interface.

FIGS. 23E through 23G illustrate example APIs.

FIGS. E11 and F11 are tables illustrating example ad revenue processes.

FIGS. E17, E18, F17 and F18 illustrate example multiplexed ledger technology (MIT) array techniques.

FIG. H1 is an example list of data labels, values and corresponding hashes.

FIG. H2 is an example list of hashes.

FIG. H3 is an example separation of a hash channel from the service channel.

FIG. 40 is a block diagram of an example processing platform including processor circuitry structured to execute the example machine readable instructions and/or the example operations of the aforementioned flowcharts to implement the transaction container circuitry of FIGS. 1 and 2.

FIG. 50 is a block diagram of an example implementation of the processor circuitry of FIG. 40.

FIG. 60 is a block diagram of another example implementation of the processor circuitry of FIG. 40.

FIG. 70 is a block diagram of an example software distribution platform (e.g., one or more servers) to distribute software (e.g., software corresponding to the example machine readable instructions of the aforementioned flowcharts to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Current public blockchain techniques do not enable and/or otherwise allow owners or originators of their data to maintain control of such data. Institutions and/or vendors that receive user data do not provide for reliable and/or otherwise verifiable techniques to allow user data to be moved and/or otherwise removed from the vendor's reach while maintaining provable data integrity and access controls. Instead, current techniques that attempt to suggest user-control of their data require a degree of trust that cannot be verified. Vendors, such as financial institutions and/or social media companies, employ architectures that store data separately from contextual dependencies such as identity and access control capabilities. Conventional information systems are architected in a manner where the hosting institution (e.g., bank, 3PL provider, social media platform, eCommerce service, search engine, manufacturing company, etc.) controls their applications, services, data and user identity. The hosting institution has complete control over the application, data, and user identity. In effect, the hosting institution is the basis of data trust and integrity for all of the data and identity information that is entrusted to it.

When data, identity and trust are bound to a hosting institution then those attributes are, in effect, siloed (e.g., a walled garden). Because data, identity and trust are siloed, the sharing of data, especially trusted data, is complex, risky and costly. Because the Internet evolved as a collective of siloed platforms, industry solutions are developed to enable collaboration and commerce to take place across data silos. The need for such solutions generates computational waste, bandwidth waste, financial cost and inefficiencies related to multi-party data sharing.

At least one problem with conventional approaches is that trust cannot be established that confirms the data is free from manipulation (e.g., unless the data is self-hosted or has a direct (e.g., point to point) relationship with another party. Beyond such localized control of data, there is no helpful ability to determine the safety, integrity or reliability of data across these supply chains or collaboration solutions. Furthermore, integrating new suppliers into a supply chain (e.g., or other industries such as energy, finance, healthcare, government, etc.) via conventional collaboration solutions is clumsy at best and impossible in some cases.

When two or more businesses need to share data, they often take an informal approach like sending emails or posting data to web pages. Often, the data that businesses need to share is complex and requires a database or a Software-as-a-Service (SaaS) solution. If any of this data needs to be provably free from manipulation or involves many companies, management of the data sharing process becomes burdensome and complicated. Database platforms and SaaS providers are not able to provide proof to multiple parties that the data they store is free from manipulation. It is not possible for a company to simply put data “in the cloud” and have it be trusted by another party. A practical solution does not exist to store multi-party trusted data in the cloud without a third party attesting to the integrity of the data.

Examples disclosed herein enable user control of their data, thereby removing blind trust that is typically required from vendors. Stated differently, examples disclosed herein decouple data from one provider of services (e.g., a first bank) and re-couple data to a different provider of services (e.g., a second bank). As described in further detail below, examples disclosed herein enable improved control of transactional data by facilitating a transaction container to encapsulate contextual dependencies (e.g., metadata, meta-functions, etc.) into a data construct (e.g., data structure) that may be ported and/or otherwise transmitted to application servers and/or transaction systems. In other words, the transaction containers eliminate the requirement that a single vendor maintain control over user data.

Examples disclosed herein are sometimes referred to as “owner-centric computing” in which owners of the data control their transactional data. Contrary to owner-centric computing, conventional institution-centric computing is a trust model in which the control, trust, data and identity is rooted in and/or otherwise bound to an organization (e.g., a service, a company, etc.). While such organizations have their own techniques to prove the integrity of the data, users do not have such abilities. For instance, while a bank can confirm whether their own data has not been manipulated, the user/customer must rely on the bank's statements or assurances of this analysis, but the user/customer has no independent manner of such verification. Even if the user/customer suspects that the organization has mis-treated their data, there are no methods by which conventional techniques allow that user to port their data to a competing organization.

As described in further detail below, examples disclosed herein facilitate the ability for a creator of a transaction to retain control of associated data, but can assign rights to it. Examples disclosed herein also organize transactions into a chain of transactions, in which chains may include sub-chains. Examples disclosed herein enable transaction/data portability and the ability to prove validity via any permissioned party. Examples disclosed herein enable any number of transactions to form a ledger, which itself may be proven valid, immutable and/or whole.

As described herein, examples permit the creator of data to maintain control over that data, thereby assuring privacy is preserved. Examples disclosed herein establish access rights for the user in a manner that is not dependent on or connected to a separate controlling authority. Examples disclosed herein permit other parties to verify data integrity to make it uncontestable.

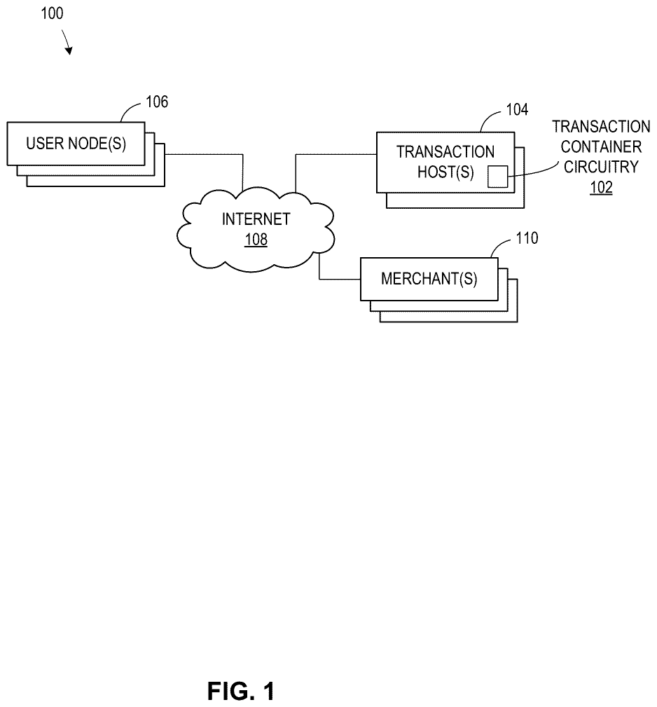

FIG. 1 is a schematic illustration of an example network environment 100 to control transactional data. In the illustrated example of FIG. 1, the environment 100 includes transaction container circuitry 102 within any number of transaction hosts 104. The example transaction hosts 104 are communicatively connected to a network 108, which is communicatively connected to any number of user nodes 106 and any number of merchants 110.

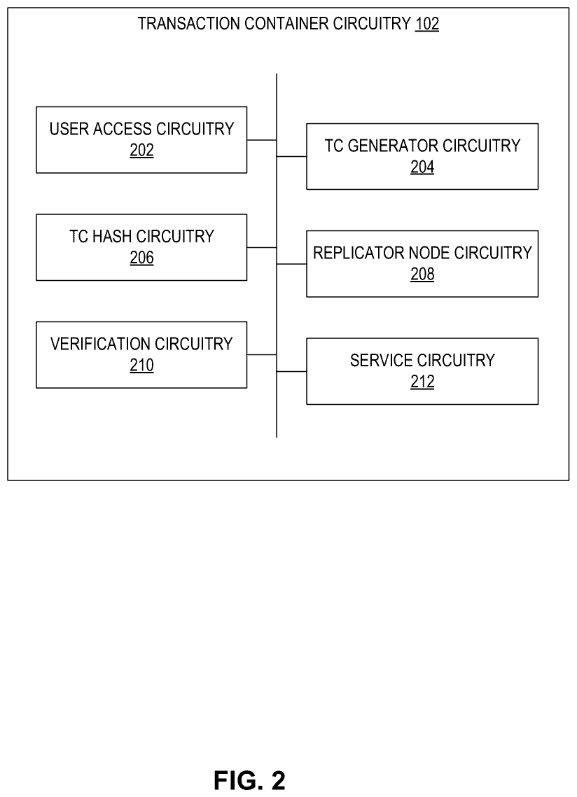

FIG. 2 is a schematic illustration of the example transaction container circuitry 102 of FIG. 1. In the illustrated example of FIG. 2, the transaction container circuitry 102 includes example user access circuitry 202, example transaction container (TC) generator circuitry 204, example TC hash circuitry 206, example replicator node circuitry 208, example verification circuitry 210, and example services circuitry 212.

In operation, examples disclosed herein manage user access, such as data intake and control of services for data already ingested by the example system 100. As described in further detail below, after data intake any number of different services may be instantiated to facilitate transactional data control in a manner that promotes data integrity and user control of their data. The example user access circuitry 202 determines whether access requests need to be serviced and, if so, a user interface is provided to an authenticated user. The example TC generator circuitry 204 generates a transaction container (TC) to package objects, including a data object containing user data (e.g., text, images, etc.), and the example TC hash circuitry 206 hashes the generated TC and stores the same to a ledger, as described in further detail below. In some examples, the user data is immediately encrypted (e.g., via AES) before storing the data object in the TC. Additionally, all TCs are hash bound to their prior temporally occurring TC. Unlike traditional blockchain techniques, which requires a requisite quantity of transactions before storing a block to a ledger, examples disclosed herein immediately store a transaction corresponding to the TC to the ledger. As such, examples disclosed herein implement secure ledger generation without interim latency while waiting for a threshold quantity of transactions, which improves data safety/integrity. In other words, there is reduced latency associated with a need to have a block fill up with transactions and then process the same through a time-consuming consensus algorithm.

Furthermore, to improve data integrity, both the user and a governor of the transaction host (e.g., a transaction host 104 of FIG. 1) sign the TC. The user provides their public key in the TC, thus both the governor and the user sign the TC prior to it being committed to the ledger. Concerns that the ledger integrity is compromised, which is described in further detail below, is mitigated by soliciting certified replicator nodes (CRNs) to participate in proving the immutable chain of custody. CRNs may include other ones of the example transaction hosts 104 of FIG. 1, in which each transaction host 104 may operate as an independent entity that participates in control of transactional data when a user decides that the particular transaction host 104 (e.g., CRN) is allowed to do so.

To form an immutable chain of custody, the example TC hash circuitry 206 forms a collection of transactions (e.g., a block) that is part of the ledger stored on a first transaction host 104, such as the transaction host that is currently servicing the user's data. As described in further detail below, ledgers are not public, but TCs are portable and fully encapsulated data elements (e.g., as JSON files). This unique data structure permits convenient control by the user over any participating entity. The TCs may include objects, public keys, etc. Additionally, encryption keys may be stored as a chainribbon object, which is the only portion of the TC that may be deleted and/or otherwise “killed”. When a TC is killed, the example TC circuitry 102 spawns techniques to determine a reason the TC is killed to comply with, for instance, GDPR regulations.

The example TC hash circuitry 206 retrieves a quantity of transactions from the ledger, in which the particular transactions/entries are specified with a chain identifier (ChainID) to make sure comparisons involve the same ones of the quantity of transactions. For instance, the example replicator node circuitry 208 transmits and/or receives a batch quantity of transactions from one or more other certified replicator nodes (CRNs) on a periodic, scheduled, aperiodic and/or manual basis. The one or more other CRNs are typically independently owned/operated. As such, efforts to compromise one or more transactions within a block would be readily detected unless the malicious actor had control over two or more independent CRNs. For transaction systems (e.g., CRNs) that exhibit a threshold number of inconsistencies, the example replicator node circuitry 208 labels them as untrustworthy and discontinues further participation thereto.

Entries of the blocks that may be shared between the transaction host 104 and one or more other transaction hosts (e.g., participating CRNs) include multi-tenant entries, unlike traditional blockchain techniques. While traditional blockchains include entries corresponding to homogonous transactions (e.g., a series of banking transactions), examples disclosed herein improve data integrity by creating blocks of heterogeneous entries that do not share a common interest and/or a common source. For instance, a first transaction may be associated with a financial transaction, which is hash-bound to a temporally subsequent transaction associated with a store inventory list. This lack of source commonality helps reduce the possibility of a single malicious actor or several conspirators manipulating two or more block entries that they may have access to and/or an association with.

Examples that follow build upon the generated transaction containers to facilitate, in part, user-centric services, tokenization services, portability services, hash services, contract services, licensing services, open authentication services, confidentiality services, cloning services and metaverse services, to name a few.

### Blockchain Transaction Containers

Blockchain, also known as distributed ledger systems, refer to information systems that facilitate transactions across a network, storage of transactional and supporting (meta) data, cryptographic functions to bind records serially for immutability, cryptocurrency and consensus methods for distributed and decentralized network nonrepudiation. Blockchain and cryptocurrency have garnered intense interest from both society and industry. At least one objective of blockchain was to drive significant efficiencies across many facets of a digital ecosystem (e.g., finance, social media, e-commerce, global supply chains, healthcare, etc.). At least one other objective was for blockchain to allow the building of a system where cryptographically bound trust could remove the need for middlemen and intermediaries. Datacentric monopolies and monopolistic industries like social media, online shopping and finance could be replaced with a technology model that would allow for transactions (regardless of whether one is purchasing a product from an online website or posting to social media) could take place directly between two parties without intermediaries.

Stated differently, some objectives of blockchain would 1) enable a user to get rid of one's bank and allow the user to conduct business directly with other people and companies, 2) enable the user to get rid of their merchant (e.g., Amazon®) account and allow a user to purchase directly from vendors and even manufacturers, and 3) enable a user to get rid of their social media (e.g., Facebook®) account and let the user share social posts with whomever he or she wanted. As discussed in further detail below, such social media accounts force their users to relinquish control of uploaded photos without clear verification that they will be taken down when a demand occurs.

At least two problems related to trust occur within business, commerce, finance, social media, etc. The first is with the basic model of trust between a company and its customers. The second is in the trust of the data between one company and another company. Generally speaking, an original objective of blockchain was to not trust a centralized organization. This notion is predicated on the belief that 1) a centralized organization cannot be trusted, and, 2) a centralized organization is not really necessary for the operation of a complex system (e.g., a business). To the first point, examples disclosed herein increase the trust model of an organization and the relationship with customers by making the organization “decouplable” from its data. In some examples, this is realized in a manner similar to a blockchain function that allows for an election or vote of sorts to take place by the customers of an organization. The result of the vote could force the current company (sometimes referred to herein as a custodian or a governor) to relinquish control of the data to a new company (e.g., custodian). Alternatively, customers may simply move or bridge their data to another transaction system.

As described in further detail below, examples to allow users to maintain control of their data and/or otherwise separate complete control of data from a particular custodian, ChainCasting is used. For instance, if a social media custodian (e.g., Facebook) misbehaved, and Facebook used the ChainCasting method described in this invention, its customers could vote the custodian to lose control of the underlying data (e.g., baby pictures, contacts, clicks, etc.). This function of decoupling an underlying data set from operational control is sometimes referred to herein as operational decoupling.

Current distributed ledger systems have failed to solve the problems that they were originally designed for and enterprises or consumers are slow to adopt these conventional techniques. Some problems with existing ledger systems can be broadly categorized as: 1) Blockchain systems largely rely upon the processing of blocks of transactions. A requirement that a block contain greater than one transaction forces a wait in the system as other transactions arrive. This “wait” introduces significant latency in transaction validation, which exposes those transactions to risk while waiting for commitment to a ledger (e.g., while in a non-hashed or cleartext format). 2) Blockchain systems lack reliable truth until a dominant fork presents itself (e.g., 6-10 blocks for Bitcoin, 12 or more blocks for Ethereum), which further introduces latency in transaction validation. 3) Governance models of blockchain systems are described as distributed and decentralization when they are actually monopolistic or obfuscated by unknown actors. 4) Blockchain systems, due to various forms of forking, will present disparate versions of truth. An example to consider is Fork A contains a transaction for the sale of a house while Fork B does not. Truth is relative. 5) Smart Contracts, touted as a benefit of blockchain systems such as Ethereum and EOS, are architected in a manner that lack scalability (every node has to run each contract upon trigger) as well as input data fundamentally breaking the closed loop nature of the system because of the reliance upon oracles (people or systems identified as being authoritative). 6) Reliance upon consensus models to provide truth and trust. The nature of transaction ingress (wallets, third-party apps, etc.) fails because blockchains are not closed systems. This problem fundamentally talks to the challenge of integrating blockchain into a proper solution or application stack. 7) Rich data is discouraged in transactions due to the compensation model maximizing compensation for reduced data per transaction (packing transactions into blocks). 8) Coins (e.g. cryptocurrency tokens) acting as both utility and security (like investment) make for difficult if not impossible transaction cost modelling. 8) Pseudo-anonymity in permission-less blockchains prevents privacy. Existing public blockchain systems are pseudo-anonymous. One reason is to allow for transaction inputs/outputs to be used to determine the current balance of an ID. Unfortunately, this method results in transparency of transaction volume, amount, etc. for that ID. Ownership of that ID may not be apparent or available, but a lot of information may still be derived. In other, more anonymous systems that leverage obfuscation with ring signatures and “mixing” data (e.g., Monero) is hidden, for the most part, but those systems do not adhere to legislative requirements and are therefore not viable for business. 9) Immutability in blockchain fails to adhere to privacy controls such as GDPR. 10) Permissioned blockchains (closed party blockchains) for enterprises require identification of a central authority but lack broad adoption thereby limiting “crowd truth.”

As described above, and in further detail below, ChainCasting is an example ledger system disclosed herein that is centrally executed with distributed accountability supporting authoritative data decoupling and elective appointment of operational governance. An example unit of information within the system is the “extensible transaction container” or “transaction container” (TC). As used herein, a “transaction” represents a record that contains information describing, in part, the sender, the recipient, an amount of native cryptocurrency to transfer, fees charged by a second or third party or administrator. As used herein, “container” refers to the cryptographic data that binds each transaction serially, cryptographic data that binds each user's own records serially, ledger support functions, application support functions and message data. “Message data” provides for a flexible storage field that can accept a variety of data types and data structures. Those data structures with the message data could be as simple as a text string or integer but may also hold very complex data structures such as application templates, programming code, structured data like JSON formatted data or even operating system level virtualization containers such as is commonly known as a Docker container.

In some examples, the system (e.g., the example network environment 100 and/or the example TC circuitry 102) facilitates a transactional capability that would allow one user to send a message or to transfer an amount of native cryptocurrency or combination thereof to another user and be recorded in the ledger. A user could be a person, a machine such as an Internet of Things (IoT) device or an online service provider. The user who originates the transaction would have the ability to retain control of the transaction through the subsequent use of specialized transactions types. Control would be performed by the user having functions and methods commonly known in the industry as Access Control Lists (ACL) where the user could allocate or remove rights to other users by ID and be recorded in the ledger. An ID may be expressed as a onetime number (like a random number) or through the use of a disclosed ID. An ID may be alpha-numeric (like a long string) or as a “human friendly” alpha-numeric string that would be easier for humans to use and remember. The example system 100 will have characteristics similar to industry terminology such as Software as a Service (SaaS) and Platform as a Service (PaaS) and would be expressed in the ledger. With the ChainCasting SaaS model, users could create applications that could further be described as chain app templates that are stored on the ledger using a format similar to JSON but unique to ChainCasting. Users wishing to access those application templates (the applications may be known as “chain apps”) would be able to search for them on the ledger, select them for use, and have the ChainCasting system render the application so as to allow the user to interact with, as an example, HTML controls, to enter data with that data then being written to the ledger. An analogy would be a HTML form, but served and stored on a blockchain rather than a database. A chain application (chain app) ID would allow for data records created by the chain app to be aggregated for access and viewing by those who have rights. In the PaaS model, a user could create an online application that is hosted elsewhere (like GoDaddy®) with an application stack and architecture of the user's choosing. The application would leverage an authentication model (e.g., OAuth). However, although similar in functionality of extending rights from one platform to another for, what the industry described as Single Sign on, the example ChainCasting OAuth-like system would use one or more techniques that would allow for functionality with the ChainCasting blockchain system and be recorded in the ledger. The result of the ChainCasting PaaS model would be an application layer that is controlled by one user (e.g., chain app developer) with the data records or transactions controlled by the users who submitted data through the first user's PaaS application. The second user who submitted the transaction (e.g., submitting data in a form with a chain app) would retain full control as was described previously with the SaaS model. Users who create chain apps would have the ability to require a fee for usage of the chain app created by the user. The creator of a chain app would never have rights to control the aforementioned transactions. In this context, control refers to the ability to delegate read rights.

In some examples disclosed herein, controls may enable a user to delete a key such that the message is effectively “killed.” However, even if a message is killed and is no longer accessible to anyone, the associated data would remain. That associated data includes sender ID (which may be randomized), recipient ID (which may be randomized), public keys (which may be permanent or onetime), fees sent or received, fees charged for administrative purposes, cryptographic data used to bind records serially and other non-message data contained in the transaction. Transactions and associated data, excluding killed message data, will persist regardless of account status. In some examples, the system 100 provides voting capabilities to allow users to vote on who should have operational control of the network. In some examples, the system 100 provides voting capabilities to allow users to vote on the quality of, for example, the quality of apps, the quality of field naming practices or other aspects of chain apps.

New blockchain devices, apparatuses, systems and methods for enabling services on a blockchain are discussed herein. For the sake of clarity and readability, several definitions are provided below.

As used herein, a “chain” represents a separate and distinct blockchain that interoperates with other ChainCasting chains for, for example, tracking balances and for performance/scaling reasons. In some examples a chain is referred to herein as a sender_chain_ID or a chain ID.

As used herein, a “block” represents a record of data that is cryptographically signed and bound to a prior transaction.

As used herein, a “sender” represents a person or other entity that is creating a transaction.

As used herein, a “recipient” represents a person or other entity that receives a message, information or an amount of value (e.g., money, fiat) from a transaction.

As used herein, a “transaction” represents a single entry in a ledger that (1) redirects funds (e.g., coin, money, fiat currency, etc.) to a recipient or contains a message, and (2) becomes a record of data included in the transaction.

As used herein, a “governor” represents a centrally controlled process or entity that executes and validates transactions. In some examples, Interchain Transaction Signature Array (ITSA) is implemented without a central governor process. In some examples, the governor represents the controlling authority.

As used herein, a “LRN” represents a long random number.

As used herein, a “PID” represents a LRN that represents an identifier (ID) that is kept secret from everyone/everything except the governor and owner of the ID.

As used herein, a “SID” represents a secondary ID, which is an LRN that is unique for every transaction.

As used herein, an “ID” represents an identifier and sometimes used interchangeably with PID or SID to refer to an identifying number.

As used herein, “T” represents a unit of cryptocurrency.

As used herein, “PKP” represents a primary key pair.

As used herein, “SKP” represents a secondary key pair.

As used herein, “Pkp” represents a public key.

As used herein, “Pvt” represents a private key.

As used herein, “ACL” represents an access control list.

As used herein, “AES” represents Advanced Encryption Standard.

As used herein, “SaaS” represents Software as a Service. In some examples, SaaS reflects a user interaction mode where there are reduced (e.g., minimal) processing and storage requirements on a client-side. The system, in a centralized manner, retains keys, IDs, passwords, etc.

As used herein, “PaaS” represents Platform as a Service. In some examples, PaaS reflects a user interaction mode where there exists a requirement for processing and storage on a client-side. In such examples, the client system retains keys, IDs, passwords, etc. Additionally, the client system (e.g., a user node 106 and/or transaction container circuitry 102 implemented thereon) participates in assembling transaction parts and then passing those parts (e.g., through TCPIP) to a routing node or otherwise transmitting to a governor (e.g., a governor process).

As used herein, “masking database” represents a lookup table that is owned and/or otherwise accessible by the governor to enable matching between PIDs and SIDs.

As used herein, “signing” or “signed” or “to sign” represents a process of using what is generally referred to as public-key cryptography to generate a digital signature.

As used herein, “decouplable” represents servicing of one or more transactions by a separate application service provider in a manner such that another party (e.g., a social media company, a bank, etc.) can accept the data as complete and valid (e.g., authoritative). If such transactions are copied from ChainCasting, then such transaction sets can be proven to be decoupled to avoid double spending for accounting purposes.

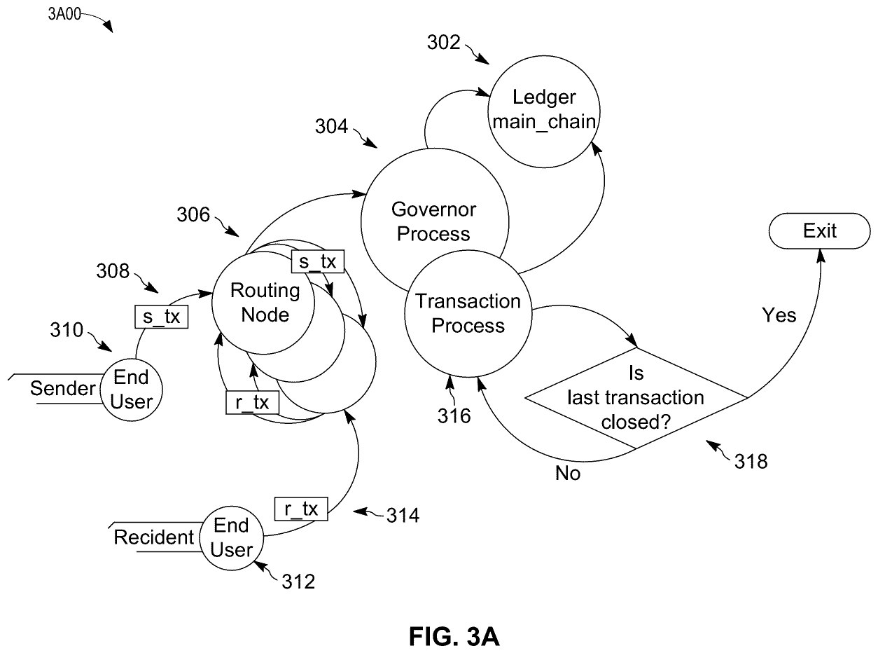

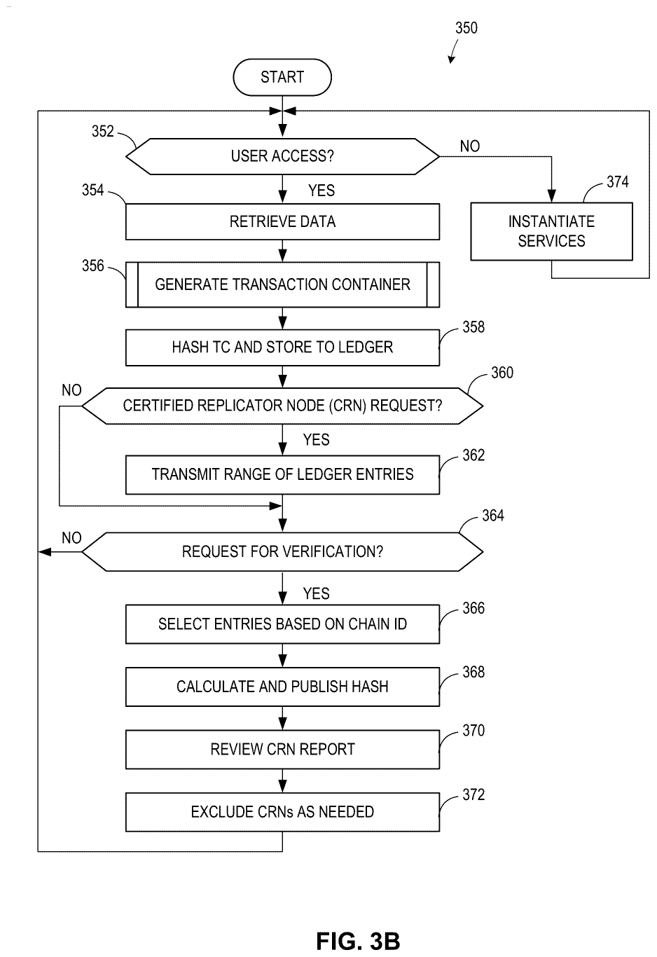

FIG. 3A is an alternate architectural view of a system 300 corresponding to the example network environment 100 of FIG. 1 to control transactional data and facilitate ChainCasting. In some examples, the system 300 is implemented by the example transaction container circuitry 102 of FIGS. 1 and 2. In the illustrated example of FIG. 3A, the system 300 includes a ledger 302, which may be implemented as any number of generally recognized data storage systems such as relational database, NoSQL, etc. The example ledger 302 may be replicated across a multitude of nodes or upon a single node only. The example system 300 includes an example software program 304 that is typically described herein as a governor process or centralized process or transaction execution system or transaction process or similar wording. The governor process 304 may be the registration process for a new user or may be the final step in accepting inputs from end users. The governor process 304 may include any number of processes such as is required for administration of the system. Inputs may be viewed as parts of a transaction such as sender ID, recipient ID, amount, message. Those inputs may arrive synchronously or asynchronously. A connecting key, which is a one-time use random number, may be used by end users to provide an association across transaction parts to allow the governor process 302 to properly reconstruct asynchronously received transaction parts. Example routing nodes 306 may be used to accept user inputs from remote locations or for load balancing or load sharing. In some cases, the routing nodes may be used to reinforce consensus by being a “check” on overall system performance. Performance may be viewed in the manner of rate of processing like transaction speed or performance may be viewed as trust and accountability. In some cases, the routing node could, without sharing personally identifiable information, share some information on transactions to provide for public visibility into ledger performance.

In the illustrated example of FIG. 3A, a sender 308 is the user, but in some examples the sender 308 could be a machine like an IoT device that is originating the transaction process and may have a “sender transaction” be represented as “s_tx”. In some examples, an end user 310, could be a human or machine (e.g., an IoT device), could be in a generic sense the sender or recipient or viewer who interacts with the system. An example end user 312 could be a recipient 314 in a transaction. The recipient 314 is the user, in some cases could be a human or a machine like an IoT device that is identified as the recipient of the transaction process and may be represented as “r_tx”. An example transaction process 316 may be viewed as interchangeably as the governor process, but in some cases will be a sub-process of the larger governor process. In some examples, multiple sub processes or child processes may exist in relation to an example transaction process 318 to determine if a given user (e.g., or IoT device) has closed their transaction set or if the transaction currently being processed is closing the transaction set or if the sender is otherwise attempting to modify the status of their transaction set.

In some examples, transactions occur in either the SaaS model (like logging into a website) or client based (like creating one's own sender object) or with a third-party that has been given access to PIDs and keys. Transactions are formed from objects. Objects are collections of similarly grouped information such as sender data, recipient data, etc. In its simplest form a transaction is constructed with the example sender 310 and the example recipient 312 each providing some information (like amount and SIDs) to send or receive, respectively, each other. The sender 310 and the recipient 312 each sign their respective information to prove that they are approving this transaction. The example governor 304 then signs the entire transaction to complete it. In some cases, the recipient does not need to sign the transaction. Public keys (SID_pkp) for the recipient and sender are unique for each transaction. Although, in some implementations key pairs may not be unique. This is configurable. Public keys for the governor are the same for each transaction. Public keys will be stored within the transaction. In some examples, the governor 304 retires keys and uses multiple keys, but no hard requirement is likely to exist.

An Interchain Transaction Signature Array (ITSA) may be required for both the sender and the recipient. The ITSA provides information to point to the sender's prior transaction and the recipient's prior transaction. The ITSA is used to determine the balance of the sender and to allow the recipient to determine a balance afterwards. The ITSA provides for proof of wholeness of a set of transactions. The ITSA is included as part of the sender object and recipient object and finally the governor has an object that combines both sender and recipient objects.

As described above, FIG. 2 is a block diagram of the example transaction container circuitry 102 to do facilitate secure data transactions. The example transaction container circuitry 102 of FIG. 2 may be instantiated (e.g., creating an instance of, bring into being for any length of time, materialize, implement, etc.) by processor circuitry such as a central processing unit executing instructions. Additionally or alternatively, the transaction container circuitry 102 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

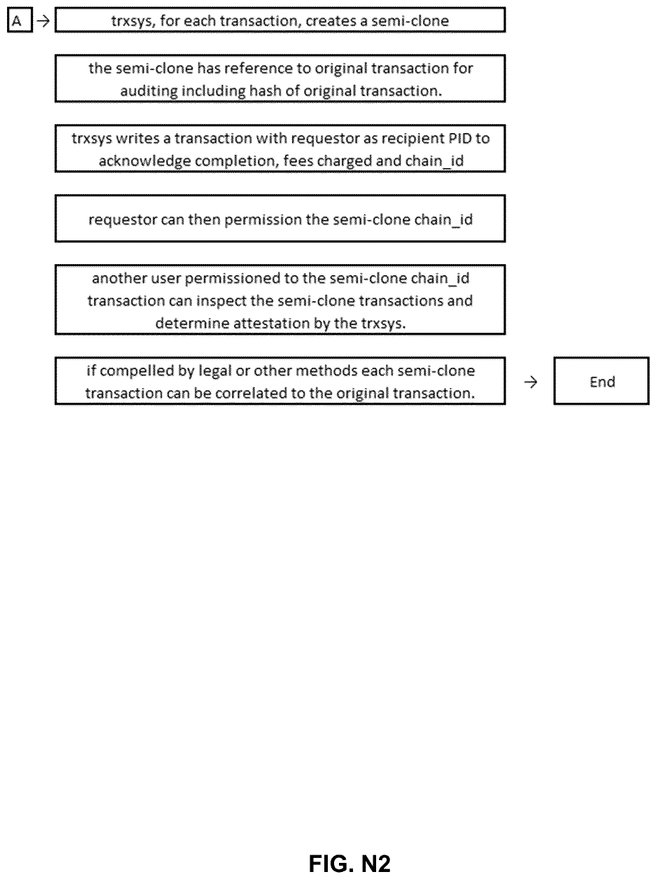

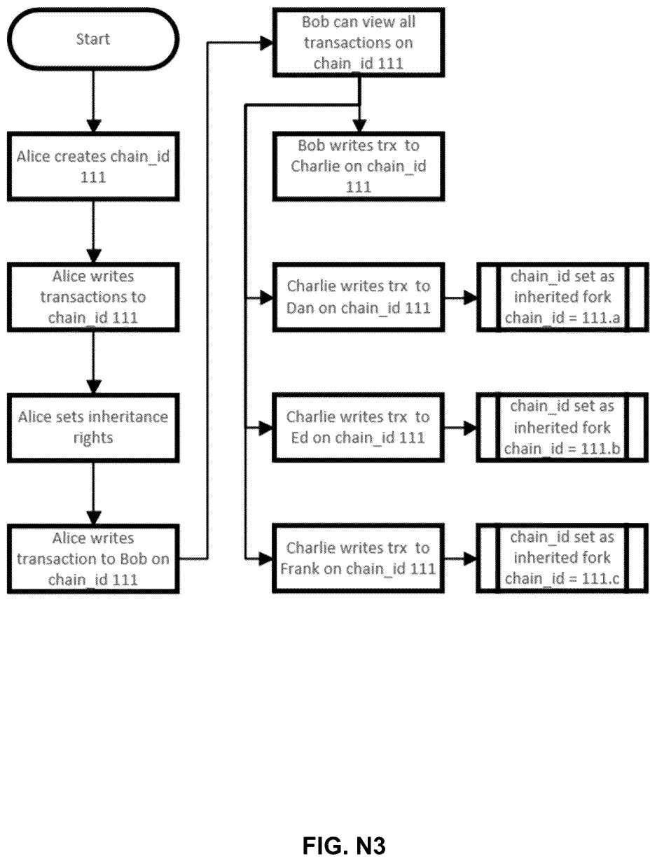

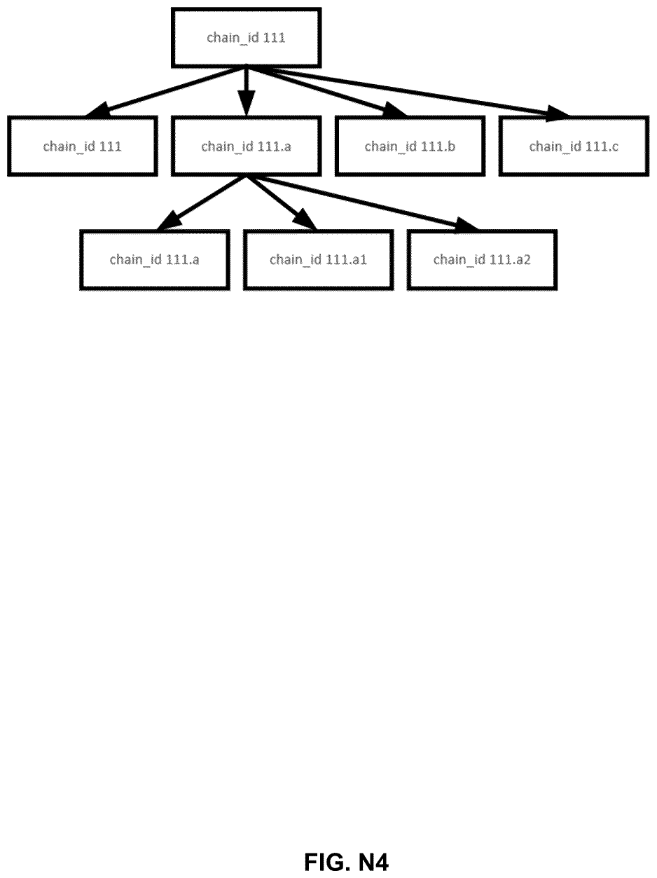

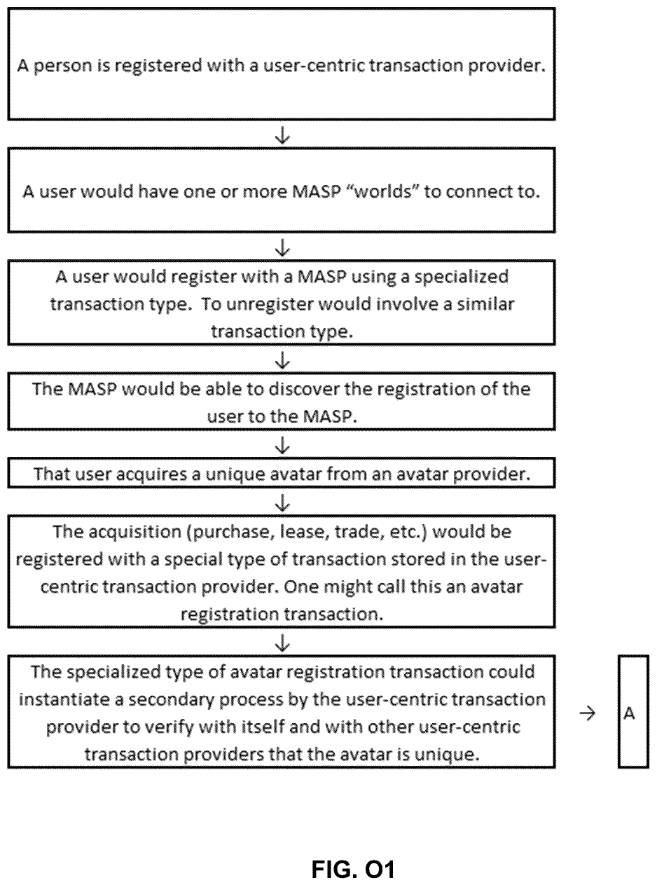

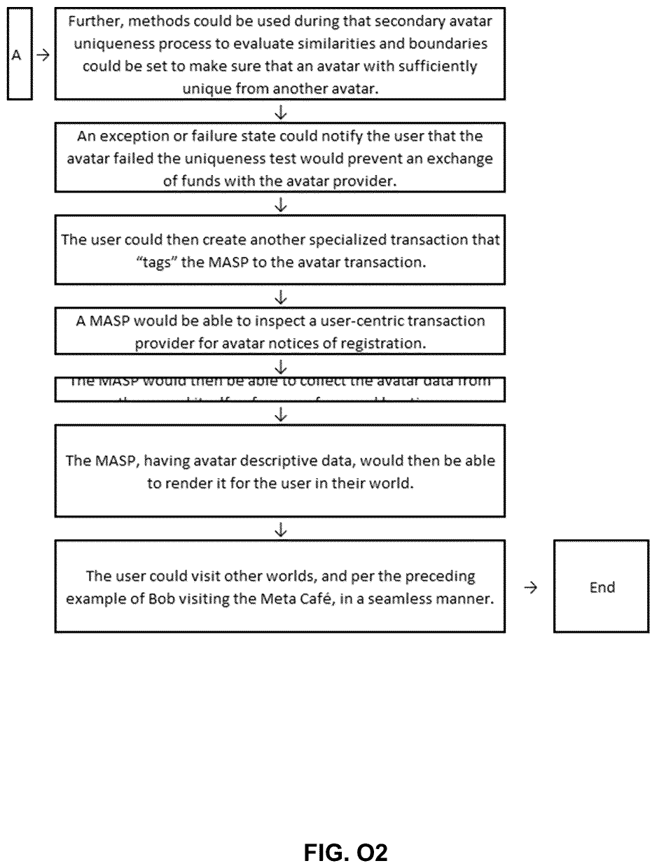

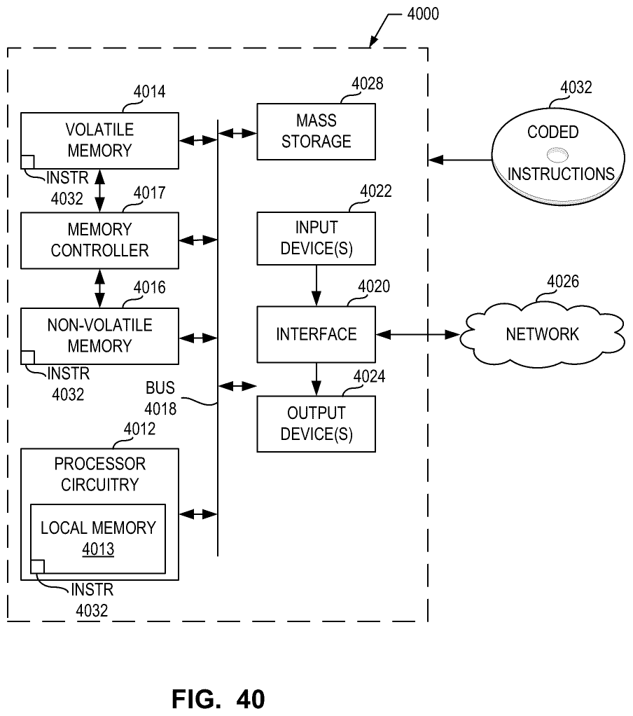

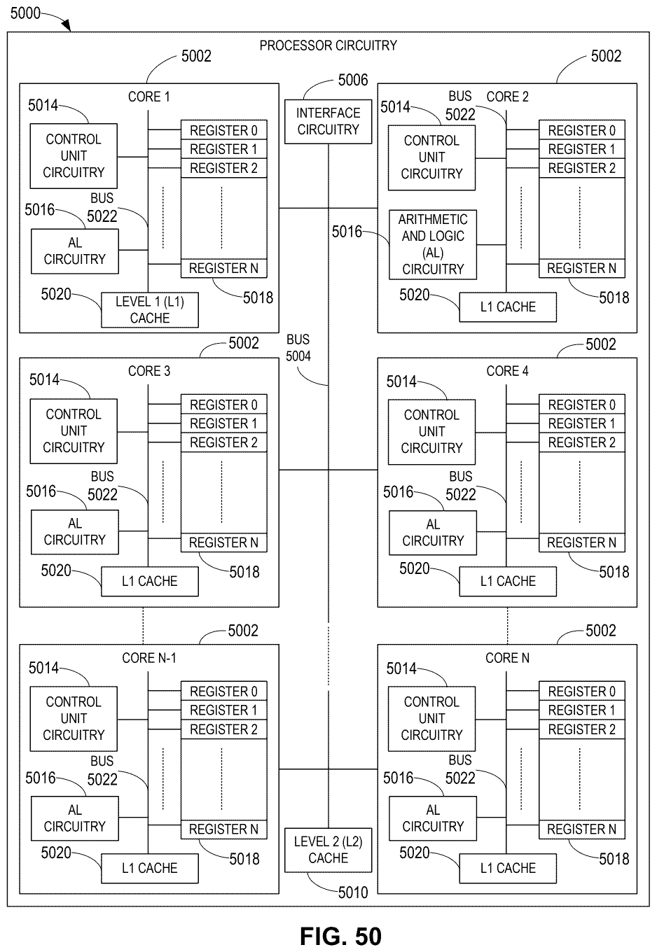

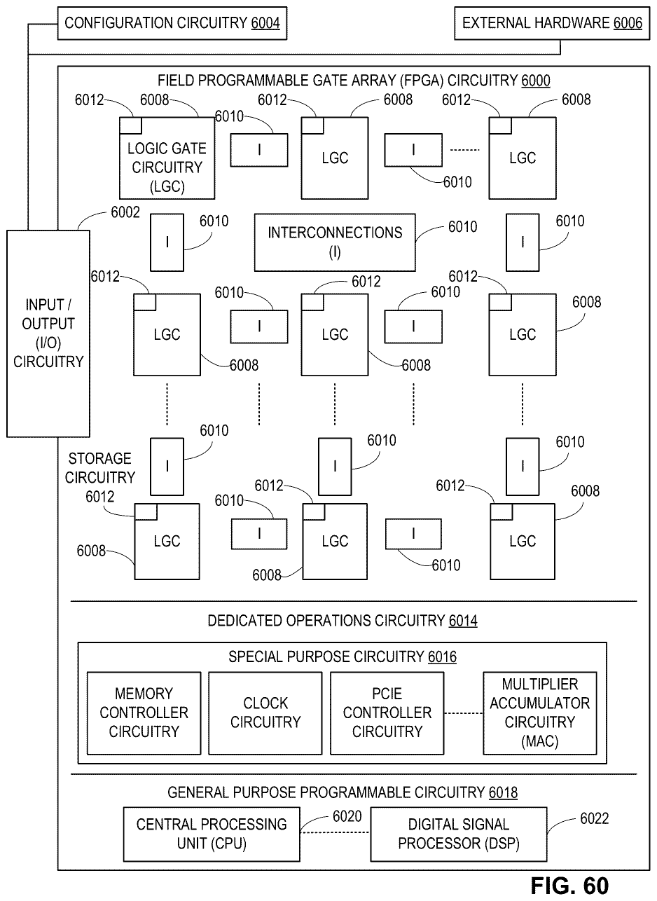

In some examples, the transaction container (TC) circuitry 102 includes means for user access, means for TC generation, means for TC hashing, means for node replication, means for verification and means for service. For example, the aforementioned means may be implemented by, respectively, user access circuitry 202, TC generator circuitry 204, TC hash circuitry 206, replicator circuitry 208, verification circuitry 210 and service circuitry 212. In some examples, the aforementioned circuitry may be instantiated by processor circuitry such as the example processor circuitry 4012 of FIG. 40. For instance, the aforementioned circuitry may be instantiated by the example microprocessor 500 of FIG. 50 executing machine executable instructions such as those implemented by blocks of the aforementioned flowcharts. In some examples, the aforementioned circuitry may be instantiated by hardware logic circuitry, which may be implemented by an ASIC, XPU, or the FPGA circuitry 600 of FIG. 60 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the TC circuitry 102 of FIG. 1 is illustrated in FIG. 2, one or more of the elements, processes, and/or devices illustrated in FIGS. 1 and/or 2 may be combined, divided, re-arranged, omitted, eliminated, and/or implemented in any other way. Further, the example user access circuitry 202, the example TC generator circuitry 204, the example TC hash circuitry 206, the example replicator circuitry 208, the example verification circuitry 210, the example service circuitry 212, and/or, more generally, the example TC circuitry 102 of FIG. 1, may be implemented by hardware alone or by hardware in combination with software and/or firmware. Thus, for example, any of the example user access circuitry 202, the example TC generator circuitry 204, the example TC hash circuitry 206, the example replicator circuitry 208, the example verification circuitry 210, the example service circuitry 212, and/or, more generally, the example TC circuitry 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example TC circuitry 102 of FIG. 1 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the TC circuitry 102 of FIGS. 1 and 2, are shown in FIGS. 3B, 4, 6, 7, 10-12, 14, 15, 20, 21H, D1, D2, E1 through E10, E12 through E16, F1 through F10, F12 through F16, G2, I1, I2, J1 through J8, K1 through K3, L1, M1 through M3, N1 through N4, O1 and O2. The machine readable instructions may be one or more executable programs or portion(s) of an executable program for execution by processor circuitry, such as the processor circuitry 4012 shown in the example processor platform 4000 discussed below in connection with FIG. 40 and/or the example processor circuitry discussed below in connection with FIGS. 50 and/or 60. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts, many other methods of implementing the example TC circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3B, 4, 6, 7, 10-12, 14, 15, 20, 21H, D1, D2, E1 through E10, E12 through E16, F1 through F10, F12 through F16, G2, I1, I2, J1 through J8, K1 through K3, L1, M1 through M3, N1 through N4, O1 and O2 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3B is a flowchart representative of example machine readable instructions and/or example operations 350 that may be executed and/or instantiated by processor circuitry to add transactional data to a ledger. The machine readable instructions and/or the operations 350 of FIG. 3B begin at block 352, at which the user access circuitry 202 determines whether access requests need to be serviced and, if so, a user interface is provided to an authenticated user to retrieve data (block 354). The example TC generator circuitry 204 generates a transaction container (TC) (block 356), as described in further detail below. The example TC hash circuitry 206 hashes the generated TC and stores it to a ledger (block 358).

The example replicator node circuitry 208 determines if a certified replicator node (CRN) made a request (block 360) and, if so a range of ledger entries is transmitted to the requesting CRN (block 362). The example verification circuitry 210 determines whether a request for verification occurs (block 364) and, if so, selects particular entries based on a chain identifier (block 366). The example verification circuitry 210 calculates and publishes a corresponding hash (block 368), reviews a CRN report (block 270), and excludes particular CRNs in the event of suspected malfeasance (block 372). In some examples, when the user access circuitry 202 does not have any current access requests (block 352), then the example service circuitry 212 processes one or more TC services disclosed herein (block 374).

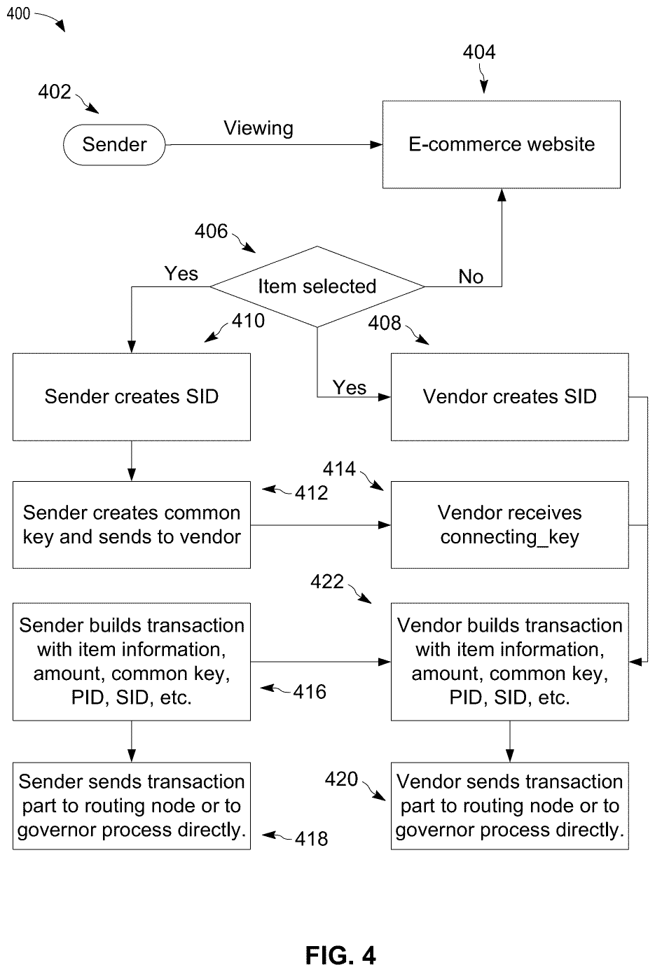

FIG. 4 is an example process 400 to control transactional data during eCommerce activity. In the illustrated example of FIG. 4, a sender 402 wishes to create a transaction. An example recipient 404 wishes to receive a transaction. The example of FIG. 4 illustrates a circumstance where an online user wishes to purchase a t-shirt from an online retailer. The illustrated example of FIG. 4 generally shows the example 402 sender on the left side process with the example recipient 404 or vendor on the right side of the process 400.

In the illustrated example of FIG. 4, the sender 402 is the buyer and the recipient 404 is the online vendor. The example buyer navigates to a vendor website, finds an example t-shirt 406 of interest, and clicks an order button. The example TC generator circuitry 204 creates, for the example vendor, as recipient, an SID (block 408) (could be centrally created by example transaction container circuitry 102 corresponding to a governor process or on the client side). In some examples, the TC generator circuitry 204 corresponding to the vendor may or may not share SID with respective TC generator circuitry 204 corresponding to the buyer (block 412). In some examples, vendor information includes some metadata such as an order number(s), etc. that are included in the message field and is not required information for the chaincasting transaction.

The example TC circuitry 102 facilitates an ability for the buyer to create a SID (block 410) (again centrally or client side). A connecting key (also known as connecting_key) is created (block 412) by the buyer (e.g., as a LRN). The example connecting key provides an association between data from sender and recipient so the governor can deal with transaction parts asynchronously. The buyer (e.g., as facilitated by the example TC circuitry 102) sends (block 412) connecting key to the vendor (e.g., to example TC circuitry 102 corresponding to the vendor) (block 414). In some examples the exchange could be reversed or even provided by a third party. The buyer sends (blocks 416, 418) PID, SID, connecting key, payment info, key info, etc. to governor (or a routing node). In some examples, the information exchanged may or may not contain those data parts described in the prior or proceeding description. The details described in this example are to establish context and are not meant to imply a singular method of said process implementation. The vendor sends (block 420) PID, SID, connecting key, payment info, key info, etc. to governor, where it will be signed. This could be kept as receipt and appended to the message.

### Transaction Construction

During the formation of a transaction, the example TC hash circuitry 206 signs data provided by the sender using, in some examples, a sender PKP (primary key pair). In some examples, a PKP public key will not be included in the transaction because it is traceable. In some examples, data provided by the sender can also be signed (e.g., via the example TC hash circuitry 206) by a onetime SKP (secondary key pair). If used, a SKP public key will be included in the transaction. Data provided by the recipient may be signed by the recipient unless a SID is reused. In some cases, the recipient is not required to sign a transaction.

All data will be signed by the governor. Where transactions are asynchronous, common data (like amount and connecting_key) will be signed by both the sender and recipient. Where transactions are asynchronous, a specification for connecting keys (connecting_key) is provided. A connecting key will be mutually agreed upon by both parties. The connecting key is a LRN and is never reused. It does not provide any identifying information. The purpose of connecting keys is to allow the governor or routing agent to determine the relationship or association between transaction sets or packages received asynchronously from the sender and recipient. The connecting key reduces the burden on the “edge” for synchronization of sender and recipient transactions sets.

The connecting key also reduces how much information has to be exchanged by each party. Additionally, the connecting key reduces the amount of trust in the transaction. Meaning, neither party has to own constructing the entire transaction. The connecting key reduces the chances of a transaction going to the wrong party. In some cases, the sender may provide a complete set of data where the recipient provides required data to the sender. And in other cases, the inverse may occur with the recipient collecting all necessary information. As one possible specification for data objects. A transaction will include several data sets or objects that will typically be delineated with curly brackets “{ }” or otherwise described in JSON or similar structure . . .

Objects will be assembled, signed and packaged into a transaction. However, in some examples the parts of a transaction, the sender part and the recipient part, may arrive asynchronously to the same or different routing nodes. A connecting key, included in each transaction part is included in the recipient and sender transaction parts.

As depicted in FIG. 3A, the example routing node 306 (if used) or governor will assemble, validate, and sign before writing to the ledger. No receipt is issued as the ledger will be updated in near real-time and the transaction itself will therefore serve as a receipt. A transaction, as mentioned above, represents a collection of objects. While those objects may exist with different names, the basic functionality of the system requires each of these objects. Of course, somewhat different cryptographic methods could be used and additional objects may be included. In some cases, functionality can be reduced with the removal of objects or some of the methods included in the objects.

### Types of Transactions

Examples disclosed herein include different types of online transactions. Example ChainCasting (the system) disclosed herein can be used to keep user data private using two methods that would involve integration of ChainCasting into browsers (or “browser-ish” apps). Following are two types of online interactions.

Presented as the first type of online transaction where the web site does not know who the user is. The user would not log in. Data shared with the web site would be configurable by the user. Configurable options could include a limit to screen preferences, a limit to shopping cart data access, a limit current session page tracking, etc. The user would use Chaincasting SIDs to maintain session state across single or multiple visits. A unique ChainCasting chain can be used as a data store for a specific user.

A second example type of online transaction is where the web site does know who the user is. The user would not log in but provide identity information. Data shared with the web site would be configurable by the user. Similar to above, configurable options could include a limit to screen preferences, a limit to shopping cart, a limit current session page tracking, etc. The user would use Chaincasting SIDs to maintain session state across single or multiple visits. A unique ChainCasting chain or chain ID can be used as a data store for a specific user.

With ChainCasting, the user, either explicitly or relying upon the ChainCasting system would have knowledge and control of their Internet usage data. For a web site to provide a rich experience, data is needed. As such, the web site requires a manner of receiving such data without cookies and other stateful session methods that it can inspect and use in rendering a quality user experience.

For the first type of online transaction where the web site does not know who the user is. This option is elaborated upon below. This example should be considered as one possible implementation that leverages the invention. In this example, it is assumed that a ChainCasting agent (e.g., TC circuitry 102) has been integrated into a browser. User goes to a web site. One might suppose for illustrative purposes that it is a small online commerce site that sells clothing for men and women. Using rather conventional technology the browser opens a port (like port 443) on the web site. The client downloads a web page. Typically, a client would login and a session would be established that is tracked by a client cookie. However, examples disclosed herein do not require such tracking with cookies.

Instead, the client is authenticated to the ChainCasting network. The client browser via plugin (etc.) requests from the ChainCasting client (either local or cloud based) a SID. The SID becomes a reference to a local object (state object) that can be written and read from. The SID is kept private from the web site. The ChainCasting system is able to analyze the web address (e.g., domain) and determine if the user had been to this site before and has prior state or configuration information. For the sake of this example, it is assumed that the user has seen/visited this site on a prior occasion.

The ChainCasting system provides (i.e. Get or Post) approved configuration information such as screen format, screen color, preference for Men's clothing of size Medium to the web site. The web site, knowing preference, etc. constructs a user experience (e.g., candidate men's clothes rather than children's shoes). The user clicks through the site and the pages visited are stored in the local (could be cloud) state object. The user clicks on a jacket to purchase. This data is recorded into local state. After the user clicks on check-out, a second request is submitted to the web site to request an SID. The local client creates unique (one time) ID and sends connecting_key to the web client, which creates sender transaction with SID sender, connecting_key, etc. and sends to ChainCasting network. Web site creates a recipient transaction with SID recipient, connecting_key, etc. and sends to ChainCasting network. ChainCasting network (via Routing Nodes or direct to the governor) will receive the sender and recipient transaction requests asynchronously.

The ChainCasting governor will use the common connecting_key to identify the sender and recipient transaction requests. The governor will process the request. Both sender and recipient can inspect the transaction using their knowledge of SID (sender or recipient) and connecting_key. The sender does not produce a recipient. Both sender and recipient can identify prior transactional data using other methods described herein, such as Interchain Transaction Signature Arrays. As such, in the first type of online transaction where the web site does not know who the user is, one might observe incorrectly that the above is simply local state management shifted to a cloud data repository. That observation would be incorrect because the web site would not have ultimate control over the session and associated meta data. Unlike traditional BC techniques, examples disclosed herein (1) keep the user information private, and (2) create continuity of transactions from client state, to shopping cart, to check-out, to transaction processing.

### Cryptographic Signing

Given the above information, it would become possible for a person who is familiar with blockchain programming to create a working system with the described features. The following will provide some context on some of the particulars such as signing and encryption (which are all normal industry methods). Objects should be viewed as collections of related name/value pairs.

The sender and recipient objects will be signed (respectively) by the sender, the recipient object will be signed by the recipient and the governor object and all other objects swill be signed by the governor. Objects may have different names with those names being described for the sake of establishing context. Each object signed by their respective keys that were created for this single transaction. Finally, the system would, in a somewhat simplified manner, collect all objects, hash, and then sign. Included would be a hash of the prior record. This last step would be to create a chain of transaction blocks. The system would embrace rigorous transactional transparency to reinforce trust. Transactional transparency is enabled by allowing the user to inspect every transaction that they are either a sender or recipient. It is important to establish that transparency is bounded to a user. There is no intent for public inspection of the entire blockchain as that would disclose information about other users when there is no established need to do so. One might consider an example of if customer A's bank records and transactions are provably authentic then customer A does not need to inspect bank customer B or C to establish such a fact as customer A's balance and status.

The system could use routing nodes that would act as both a check (to validate behavior of the governor by providing transaction transparency) and to provide routing capabilities. The system would not use consensus methods at all. There is no Proof of Work or Proof of Stake, as those are unnecessary. Instead, trust of the example system is reinforced through (1) visibility of chained transactions, (2) historical public record, and (3) threat of governor replacement by voting.

### Auditing

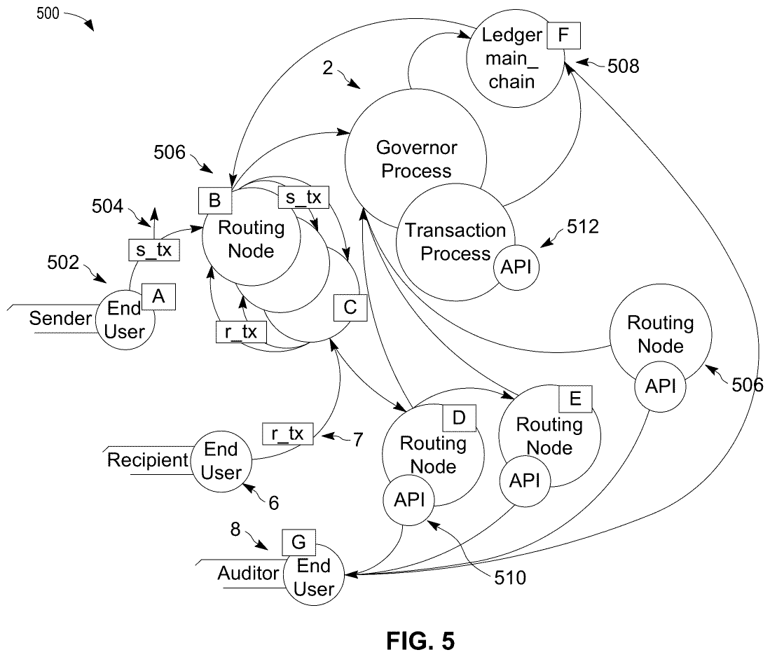

Returning to the illustrated example of FIG. 3A, auditing concepts will be discussed to show a process of establishing truth and trust in the system without formal consensus methods. The following example process outline numbers refer to steps and not the numbered elements of FIG. 3A. However, the process is further described in FIG. 5. The below process 500 may give appearances of being a consensus method as is used in conventional blockchain systems. However, the process described below is more similar to a (1) a load balancing process with (2) methods for transactional transparency and nonrepudiation.

User 502 creates a transaction 504 and submits to a routing node 506. The routing node 506 is discovered through a published list of nodes. The sender signs the transaction. The routing node 506 signs the transaction. A routing node is a permissioned entity and is, therefore, different from a conventional blockchain node where each blockchain node receives a copy of the entire ledger.

All or some nodes may receive some or all transactions. Routing Node 506 “B” receives the transaction. Routing Node 506 “B” may replicate or send a copy of transaction from “A” to routing node “C”. Routing Node “C” may send a copy of transaction “A” to “D”, “D” sends to “E”. Not every node needs a copy of every incoming transaction. Not every node will need a copy of the ledger 508.

Nodes will be able to ask each other if they have “seen” a transaction. This will validate that transactions have not been discarded, ignored or otherwise manipulated. Nodes will be able to keep copies of ledgers. Routing nodes and Auditors 506 (users who perform this function) will be able to validate the authenticity of ledgers. This is to reinforce trust through transparency. However, in some implementations routing nodes will not be able to determine balances. This is for security reasons.

APIs (Application Programming Interfaces) (510 and 512) may be made available to users to send transactions through. In some cases, the routing node and auditor node can be the same computer system or node while in other implementations routing nodes and or auditor nodes may not be used at all.

### Administrative Features

If ever a problem is identified with a transaction then all the routing nodes will be notified for transparency (e.g., to accomplish dispute resolution). An automated process will take place to resolve the problem which is assumed to be from a corrupted or malicious transaction. The governor will determine resolution path. The governor cannot overwrite a transaction but can reverse a transaction with a subsequent transaction.

If a dispute exists between two parties over a transaction or set of transactions then a mediation process to be determined by the governor will take place. If the governor is found to be “misbehaving”, then an election (described below related to “Operational Governance”) can take place for a new governor. A governor is the persons or company that have operational control of the system.

The system provides air drop resistance. An air drop is where another cryptocurrency or business promotes themselves, typically a new cryptocurrency offering, by sending unsolicited “coins” to most if not all users of a blockchain system. ChainCasting is air drop resistant because (1) users have the ability to never publicly show their chain and (2) the “advertiser” can never identify unique users or accounts thereby making it impractical to “send” X quantity of counts to each user. Finally, the ledger is never made publicly available in its entirety.

Ledger close function with Transaction Systems. When the topic of data portability is discussed in the industry it typically revolves around the ability of a user being able to access, download and move data to another service. There are many examples. One can download transaction history from a bank or even a blockchain system like Ethereum. In some cases, a service provider (e.g., bank or blockchain) can provide cryptographic signatures such that the data retains a certain degree of truth. Unfortunately, when data exits in one system it is seldom accepted as authoritative for the receiving institution. This is a result of trust being based on the truth of the provider organization and not a public basis of truth. The difference is subtle but a significant “showstopper” for data portability. Additionally, even if data is assured through a third party (such as an escrow provider), there exists no public truth about the status of the providing organization. In other words, and again regardless of using conventional database or blockchain, there needs to be a publicly verified “closing” of the transaction capability of the user's account. Stated differently, and continuing with the prior banking example, it is not possible for one's bank account balance and transaction history to be authoritatively moved from one bank to another. This will never be possible until the requirement of publicly verifiable truth becomes available. Blockchain attempts to do this but fails also.

While blockchain provides for that publicly verifiable truth, blockchain fails on transaction portability (e.g., from one blockchain system to another) because blockchain systems do not provide the ability to simply close a transaction set. This invention provides the method to close a blockchain transaction set. It is a rather simple method but since it is not available in current blockchains it must not be that obvious. Accordingly, examples disclosed herein enable authoritative non-duplicative data decoupling and portability. Specifically, example techniques to flag a transaction in such a manner as to allow for portability to other systems (blockchain or not) without the risk of double spends or transaction reversals/manipulations. Users of a transaction based system (like the blockchain described herein) will have the ability to select different service providers while maintaining continuity of data, balances and transactions. Wholeness of data sets (e.g. collection of related transaction containers) can also be established across multiple independently owned transaction systems.

### Decoupling

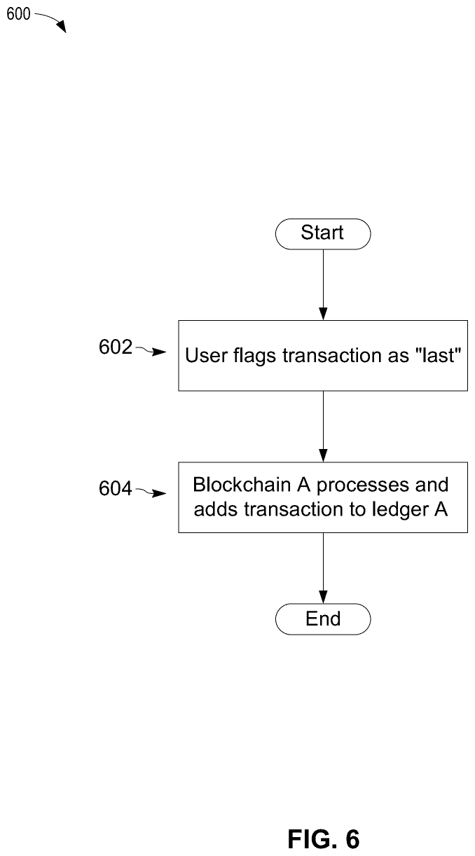

Presented in FIG. 3A at 318 and FIG. 6 at 602 and 604 is an example process 600 for decoupling that can mark or flag a transaction in such a manner that the user can authoritatively decouple their data, balances and transaction set such that another institution will accept the data as whole. Although described in the context of the ChainCasting system, examples disclosed herein can be generalized to other blockchain systems. Examples disclosed herein are scoped to blockchain systems because conventional database systems lack the immutable characteristics of blockchain. It is important to clarify that the transaction set or collection of transactions for a particular user will not, in effect, be deleted from a ledger. The intent is to allow the user to authoritatively copy to another blockchain provider or to leave ledger records “in place” and allow for a new application service provider to use said data records in an authoritative manner.

Typically, a transaction set may be the entire set of transactions performed by the user as either sender or recipient. However, in some examples a summary or condensed transaction could be provided by the system to authoritatively provide for a balance of the user's account. Balances would typically be represented as a native cryptocurrency but could, in some examples, be represented as dollars or other currency.

Presented in FIG. 6, to close a set of transactions or to, in effect, close a ledger account, the user acting within a transaction of a blockchain based ledger system the user (via the example TC circuitry 102), when creating a transaction, would create a transaction 602 of type “last transaction.” Of course, the wording can vary or can be a simple integer value as shown below. The system, during transaction construction would check in FIG. 3A at 318 whether the user has closed their transaction set. Other blockchains, when presented with a transaction that is flagged as a “first” transaction could then check that ID against the prior blockchain for authoritative historical transaction information. This would presuppose that blockchains leverage similar methods. Those that did not would simply not be trusted. As a clarifying point, a ledger close does not close an entire ledger, rather is closes a specific user's collection of transaction on a ledger. And, to further clarify, a transaction system may have multiple ledger and transaction system may interoperate with other transaction systems.

In some examples, a transaction flagged in such a manner as to represent closing of the transaction set would be searchable or otherwise publicly available so as to allow un-permissioned parties to find such a record. In other examples, the owner of the transaction set could extract, copy or otherwise make available a list of transactions or a summary thereof, in a form or format that would be authoritative and immutable from retroactive change on balances and to/from addresses.

In the illustrated example of FIG. 6., the example TC circuitry 102 allows the user to flag a transaction as “last” (block 602). The example transaction has a Transaction Type set to “last transaction”. The transaction is written (by the example TC circuitry 102) to the ledger (block 604).

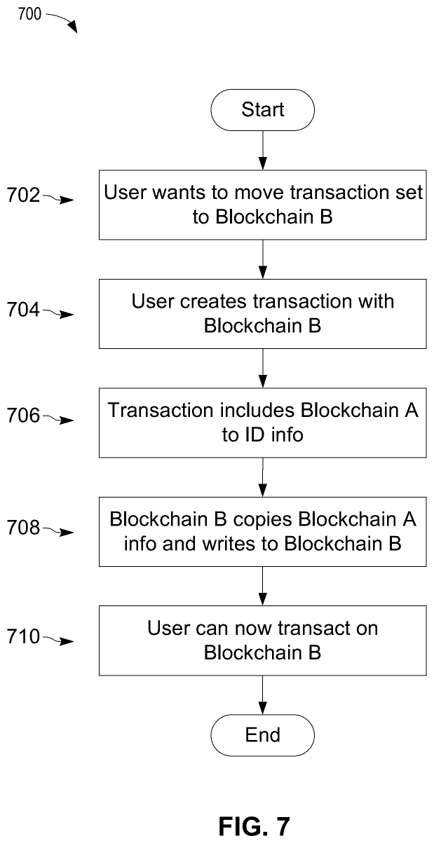

In the illustrated example of FIG. 7, an example process 700 instructs the TC circuitry 102 to permits the user to authoritatively move data from Blockchain A (origin) to Blockchain B (destination). Additionally, this effectively freezes the balance (e.g., of coins or other value) that might exist in Blockchain A and opens up that balance in Blockchain B. If the user ever tried to spend the balance in Blockchain A then this would not be possible be the “last transaction” flag in the users transaction set would result in a failed transaction. Of note, is that this example describes coins (e.g. tokens) when the transactions could easily be describing bank records, sales orders, etc. Regardless, the user could never “pretend” that the “last” transaction flag was never set because it would be part of an immutable ledger. This also helps to mitigate forking in blockchain because parallel “truths” would not be able to exist since continuity of “account” would span multiple disparate “blockchains”.

Upon closing transaction set FIG. 6 (e.g., blocks 602 and 604), the illustrated example of FIG. 7 illustrates that the user intends to authoritatively enable access of the transaction set from Blockchain “A” to Blockchain “B” (block 702). The example TC circuitry 102 permits the user to create a transaction in Blockchain “B” (block 704). Included in the transaction is the identifier for Blockchain “A” and any other necessary information to allow Blockchain “B” identify the transaction set for this particular user's transaction set.

In the illustrated example of FIG. 7, the TC circuitry 102 facilitates the ability for Blockchain “B” to be written as a transaction into Blockchain “B” with a reference to Blockchain “A” (block 708) to provide for continuity of transactions and balances. The example TC circuitry then facilitates user transactions on Blockchain “B” (block 710). As such, the example process 700 of FIG. 7 illustrates a continuity of transactional data and balances to be maintained without risk of double spending or other malicious behavior related to transaction manipulation.

### Revoking Keys

A challenge faced by blockchain systems is with deletion or removal of unwanted data. The larger topic is integrating privacy protections (such as GDPR) into a blockchain system. Blockchains generally have the defining characteristic of being immutable. Therefore, it becomes very difficult or impossible to modify previously written records. This invention addresses this larger problem within blockchain technology.

Within a blockchain system there are four commonly recognized ways to modify previously written data to an immutable ledger.

Method #1: Encrypt the contents of the record and provide a reference to an “off-chain” location (e.g., a database on a web site) where a symmetric key would be located. That symmetric key could be deleted from the web site there by rendering the data inaccessible. The disadvantage is that a significant amount of trust needs to be placed in either a single repository or in a multitude of unrelated disparate sites to store keys.

Method #2: Fork the database at the point where the record in question is and re-hash all of the subsequent records. The disadvantages are (1) systems that re-forking is too costly in compute and time with systems that use POW (Proof of Work) consensus, (2) trust is lost in a system that allows for practical rewriting of data. In some cases, a system may be described that would allow for skipped records or intra-block skips, but these also fail the test of trust and are not a practical solution.

Method #3: Architect the ledger in such a manner as to allow records to be rewritten. The disadvantage is that trust is lost in a system that allows for practical rewriting of data.

Method #4: Only accept data where all parties involved agree that the data is immutable. The disadvantage is that correcting a record as in editing or removing/cancelling may be or become a legislative requirement. Overall, not a practical solution.

Examples disclosed herein allow for authorized parties (sender, recipient, or governor) to remove and replace cryptographic keys on message data within a blockchain transaction with traceability that such actions did occur. Additionally, examples disclosed herein provide for a blockchain that has data that is “adjacent” rather than typical descriptions of data being either on-chain or off-chain.

Examples disclosed herein provide for 1) techniques to remove the ability for a user of a blockchain system to read data in clear text or in an otherwise unencrypted state or to follow a link to an external source. 2) Techniques to communicate, notify or otherwise allow users of a blockchain system that a key was intentionally revoked and is not an error within the system. 3) Techniques to re-enable a previously deleted key. 4) Techniques to extend key removal/replace authority to multiple parties using different keys. 5) Techniques to provide for adjacent-chain data in a ledger.

Examples disclosed herein focus on the techniques that enable key revocation of a message in a ledger record that meet the following requirements: 1) A record is a transaction in a ledger and may contain data or information as content stored within the record. That information will be described generally as the “message.” 2) The record is a collection of fields and may be presented as name/value pairs. The message name pair may be described as {message: “message data”} and may be represented in multiple encodings such as Base64, Hex, Binary, ASCII, etc. 3) The message may present itself as the content itself (like a web page or paragraph or list of items) or the message may be a link to another online source (like a web server or API). 4) Remove the ability for a user of the system to read the data in clear text or in an otherwise unencrypted state or to follow a link to an external source. 5) It is considered out of scope for examples disclosed in this section to entirely remove the possibility that message data that has at one time been viewed publicly while unencrypted (i.e. existed clear in the public domain) can be viewed by an alternate source or through an historical or archived copy or artifact.

A ledger is typically described as having various field to make up a record or a transaction. Commonly, records and transactions are used interchangeably within a blockchain ledger. Examples disclosed herein continue with that practice. The record will have inputs and outputs (sender and receivers in ChainCasting) that describe who it is that originated the transaction and to whom is the recipient of funds or of a message. In some cases, the transaction contains a message that is sent to a particular person or simply to the system as sort of posting. Regardless, all blockchain systems have in common the ability to post information in the form of a transaction. In some cases, it is intended that the message contained with the transaction be readable in an unencrypted form by other users of the system. And, in some cases, per legislative ruling or other reasons, that message (a part of a transaction) which was previously available in clear text or otherwise unencrypted, needs to have its “read” ability revoked. Examples disclosed herein provide for a data field, that is not part of the immutable record, to be stored “on the chain” and to provide for transactions that can comment on or even re-enable a revoked key. We call this type of field to be chain-adjacent. In some cases, we may call this a chain ribbon or chain ribbon object. “Ribbon” is intended as a metaphor to describe that the adjacent keys run alongside the ledger. In examples disclosed herein, the information is included on-chain because it is more likely that data stored in such a manner will be considered more authoritative and will be accessed more often in contrast to web sites or services that have made copies of the data.

On-chain, as described above, is intended to mean that the data is stored alongside the transaction “block” such that a user can reliably and with confidence access, query, report or otherwise display the object that contains the adjacent key that is used to unlock or decrypt the message field.

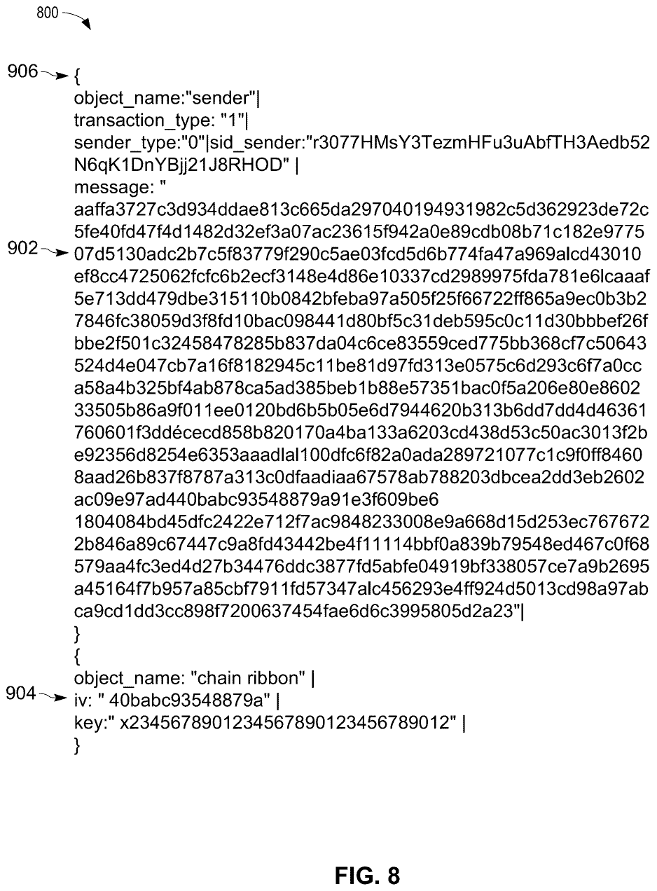

In some examples, ChainCasting, has been described as fork resistant. This is a key advantage for ChainCasting as other blockchains suffer from forking where it may prove impractical to adhere to privacy practices. Consider a message in a transaction stating some information (e.g., a news report). FIG. 8 illustrates an example ledger 800 generated by examples disclosed herein. Within the example ledger 800 the system may store that message in an encrypted format (e.g., a JSON-style format). The illustrated example ledger 800 of FIG. 8 is an example presented for illustrative and conceptual purposes, and the actual implementation will vary.

For illustrative purposes, the example ledger 800 of FIG. 8 includes a block of encrypted text (see 902) as message: “aaffa3727c3d934dd . . . ”. The example ledger 800 of FIG. 8 also includes another code block (see 904) with the name “chain_ribbon” as an object name. That block has an “iv” and a “key” object. The block “iv” is for “initialization vector” as is commonly used in AES (Advanced Encryption Standard). Those names and the specific encryption algorithm are not as relevant as the concept that the message is encrypted using a symmetric encryption method. The example chain ribbon 904 is chain-adjacent. As such, the chain ribbon 904 is writeable and inspectable by anyone with access to the ledger. Because that code block is not part of the immutable record it can be changed. So far, the only capability added is to allow a controlling authority to delete the key. In some examples multiple parties would need the ability to revoke and replace keys. The system (e.g., blockchain node software) would expect that a proof of some sort would exist by the person who deleted the key or the system would simply replace the key. So, it would not be possible for a bad actor delete keys without detection.

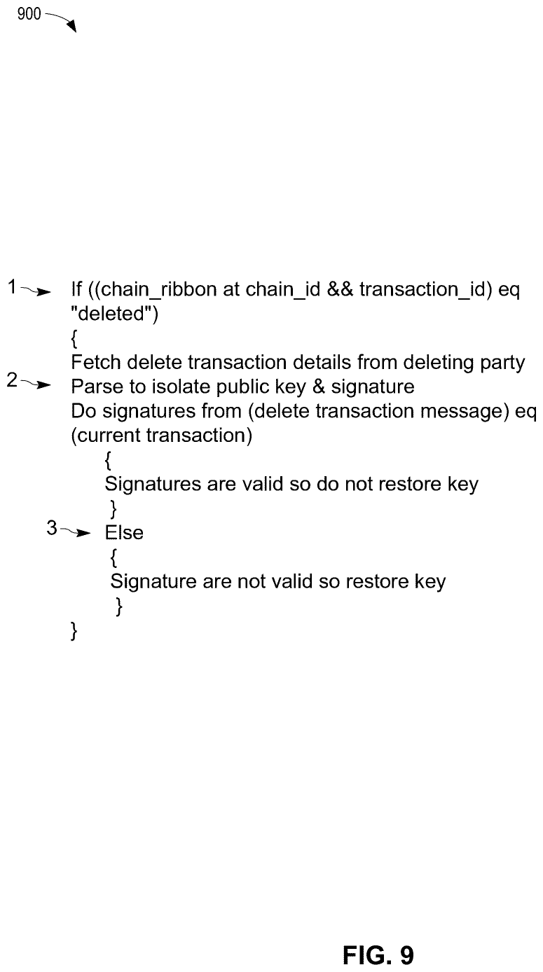

FIG. 9 is example pseudo code 900 executed by the example TC circuitry 102 to validate whether a key was allowed to be deleted. In circumstances where an adjacent key was deleted (e.g., by accident or incorrect information), then the key could be restored from an off-chain or otherwise different data store such as a backup.

In some examples, the same key (asymmetric key pair) could be shared to multiple parties so as to provide proof that the person who deleted the record was authorized to do so.

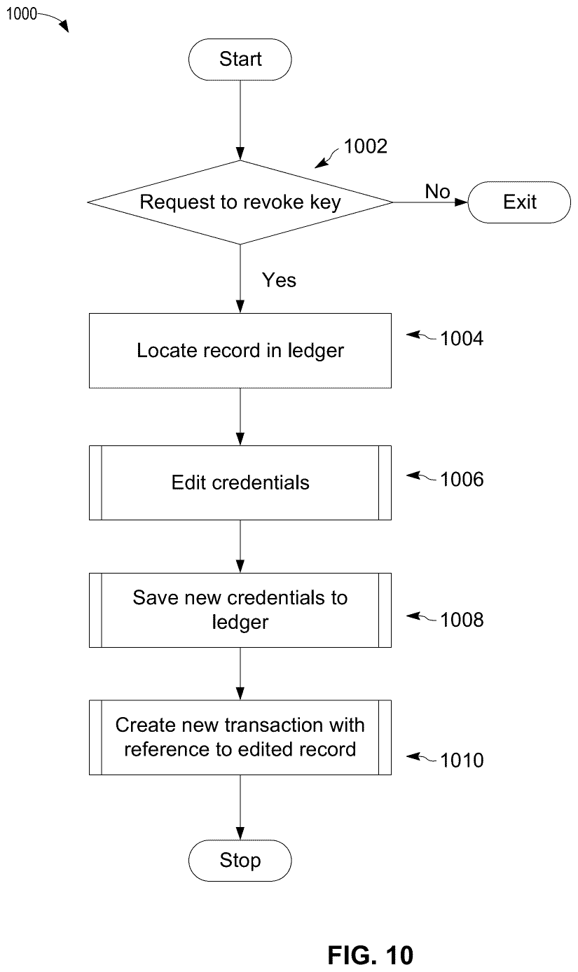

In practice, the system may function as is described in an example process 1000 of FIG. 10. At block 1002 the governor process is running (e.g., on the example TC circuitry 102) and evaluating a transaction for consideration to write to the ledger. The transaction is a request to revoke a key (block 1002). At block 1004 the record or transaction is located in the ledger. The ledger may exist as a record set of objects in a database, a JSON store or other data storage structure. At block 1006 the system executed by the governor or control process will edit the record or object containing the adjacent or chain ribbon key. This object is editable and is the only editable object in the transaction record. The record is edited to delete the specified adjacent key. At block 1008 the record or object is saved in the updated or modified form. At block 1010 the system will write a transaction of a special type that denotes that an adjacent key was deleted. Additional meta data may be included in the message and may include a reason (or not) depending upon configuration and policies. As such, examples disclosed herein facilitate revoking keys for messages, and facilitates modification or deletion of keys that are adjacent to the ledger so as to allow for enforcement of system policies.

### Transaction Processing

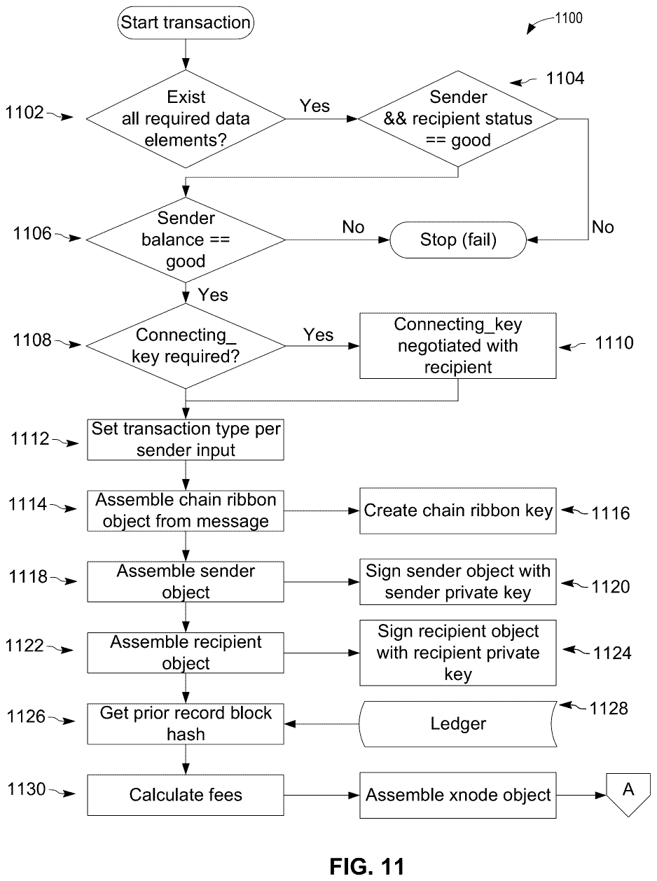

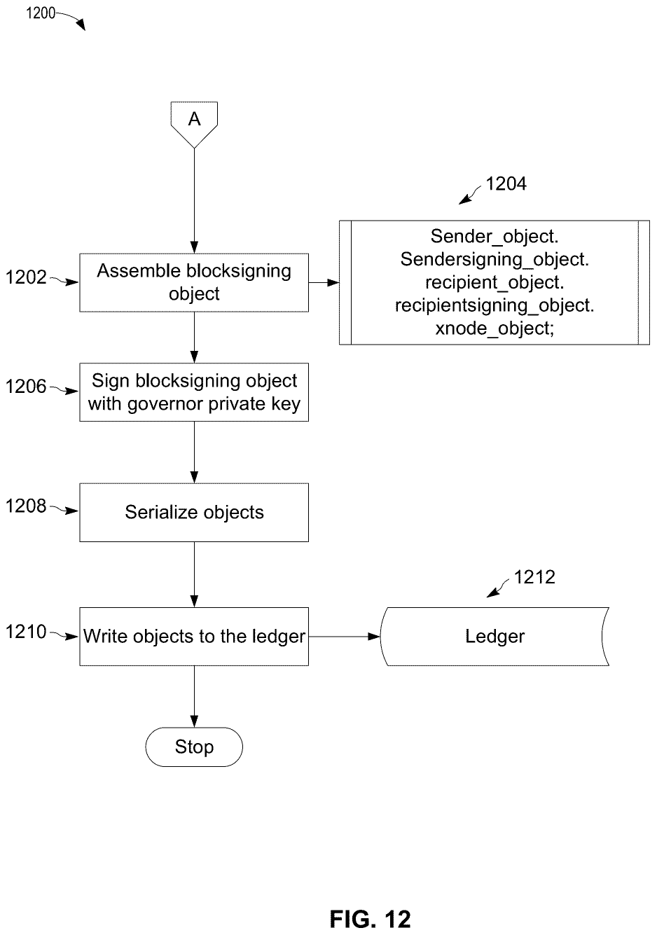

Presented are the transaction process steps. While the illustrated example of FIG. 4 above describes an example process 400 to construct a transaction in a scenario, and FIG. 3A and FIG. 5 illustrate a high-level architecture view, FIG. 11 and FIG. 12 depicts the process of assembling objects into a transaction and writing to the ledger.

In the illustrated example of FIG. 11, the example process 1100 starts with a transaction request (e.g., from a user, a governor, etc.). In some examples the user access circuitry 202 facilitates this process. The example TC circuitry 102 (and/or structure contained therein) facilitates validation that all data elements are provided and in a correct format (block 1102), that the sender and recipient have an account or user status that allows the transaction to proceed (block 1104), confirm that the sender has sufficient balance for the transaction (block 1106) and determine if a connecting_key is required (block 1108) and if so then to create it (block 1110).

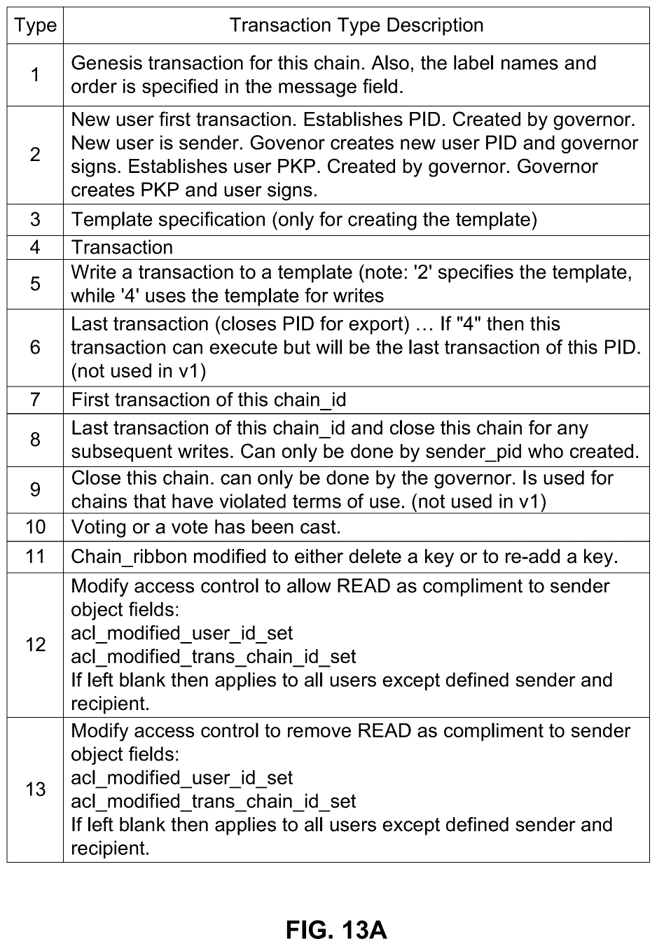

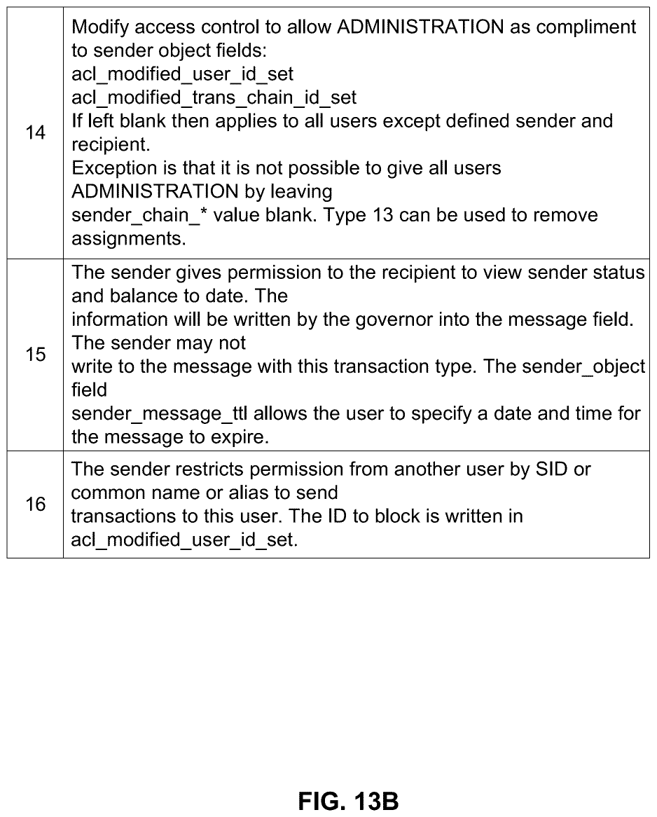

The example TC generator circuitry 204 sets a type of transaction (block 1112). A variety of transaction types are provided for in FIGS. 13A and 13B. The sender specifies the transaction while the governor determines if the sender has sufficient rights for the transaction.

In the illustrated example of FIG. 11, the TC generator circuitry 204 assembles a chain ribbon (block 1114). The message field, provided by the sender, in most cases, will be encrypted using a randomly generated passphrase. The encrypted message will replace the unencrypted message. The passphrase, known commonly as the key, and the initialization vector, known commonly as IV, will be stored together with the chainribbon_object in clear text (block 1116). These, per prior discussion, will be stored in an adjacent manner to the transaction itself. If the chainribbon key is removed or otherwise disabled then the message within the transaction is then disabled or made otherwise unreadable.

The example TC generator circuitry 204 assembles the sender object containing information such as the sender PID, SID, random ID, and administrative fields (block 1118). Assembled herein and throughout is intended to mean that individual fields of data are stored in a delimited string to form an object. Therefore, an object is simply a collection of related information. At block 1120 the object is signed by taking a hash of the object and then calculating or otherwise performing a mathematical function to produce what is commonly known as a digital signature or simply a signature.

The example TC generator circuitry 204 assembles the recipient object containing information such as the recipient PID, SID, random ID, and administrative fields will be assembled (block 1122), and the example TC hash circuitry 206 signs the recipient object (block 1124). The example TC hash circuitry 206 gathers (block 1126) the “block hash” of the prior or most recent ledger record (block 1128). The prior block hash then becomes part of the current transaction thereby cryptographically binding, as a result of signatures, transactions serially to each other.

The example TC generator circuitry 204 calculates fees charged by the system (block 1130). Fees are typically calculated based on the size of the message. The example TC generator circuitry 204 assembles the fees, a prior record hash, a sequential ID, a timestamp, and a PID of the governor and other administrative information, which is described in further detail in the illustrated example of FIG. 12 (see blocks 1202 and 1204). The example TC hash circuitry 206 signs the block signing object with the governor's private key (block 1206). In all cases of signing the corresponding public key is included in the transaction while the private key is never included. An exception, of course, is the chainribbon object. The example TC generator circuitry 204 serializes or otherwise prepares the objects for writing to the ledger (block 1208). The example TC generator circuitry 204 writes the transaction as a collection of objects (block 1210) to the ledger (block 1212).

### Chain Apps and Chain Templates

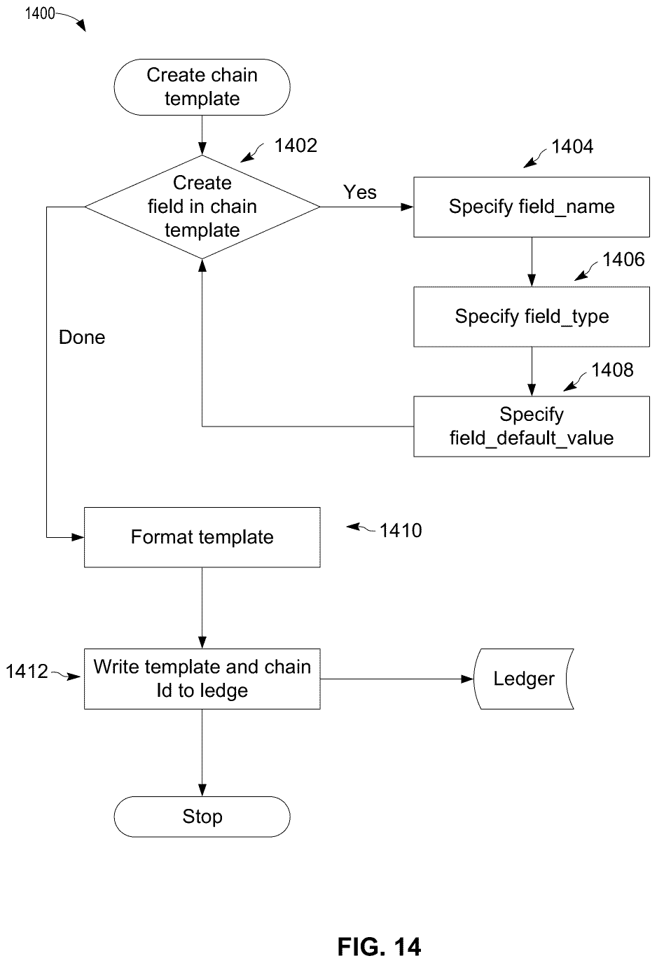

Presented is a model for chain templates in support of user application enabled through transaction containers in one or more transaction systems that will be described as “chain apps” for clarity. A chain template provides a specification for a chain app that is stored on the blockchain otherwise known as the ledger. FIG. 14 illustrates an example process 1400 to create chain templates. In the illustrated example of FIG. 14, the example TC circuitry 102 determines that a chain template creation has been requested (block 1402) and, if so, specifies a field_name (block 1404), specifies a field_type (block 1406), and specifies field_default_values (block 1408). Once the chain app is completed (block 1402), the example TC circuitry 102 formats the template design as a template object (block 1410) and writes the template and chainID to the ledger (block 1412).

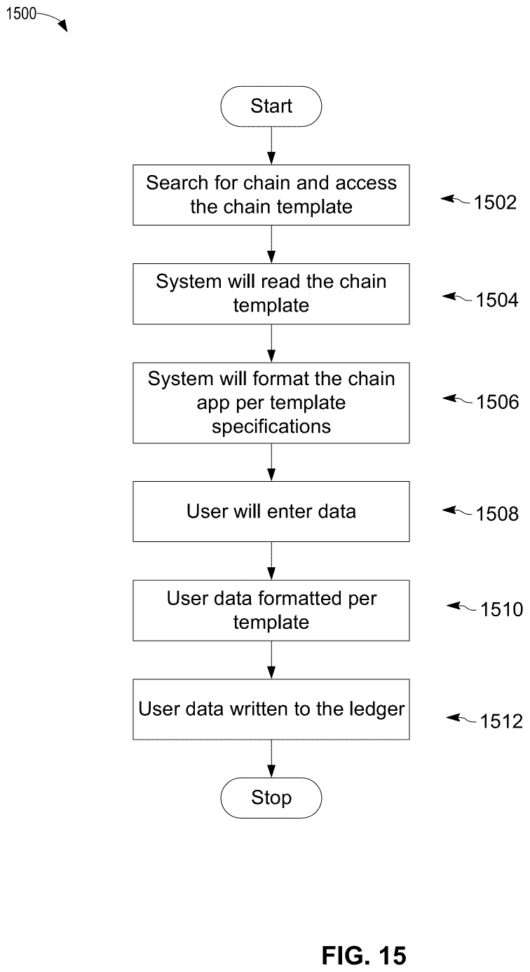

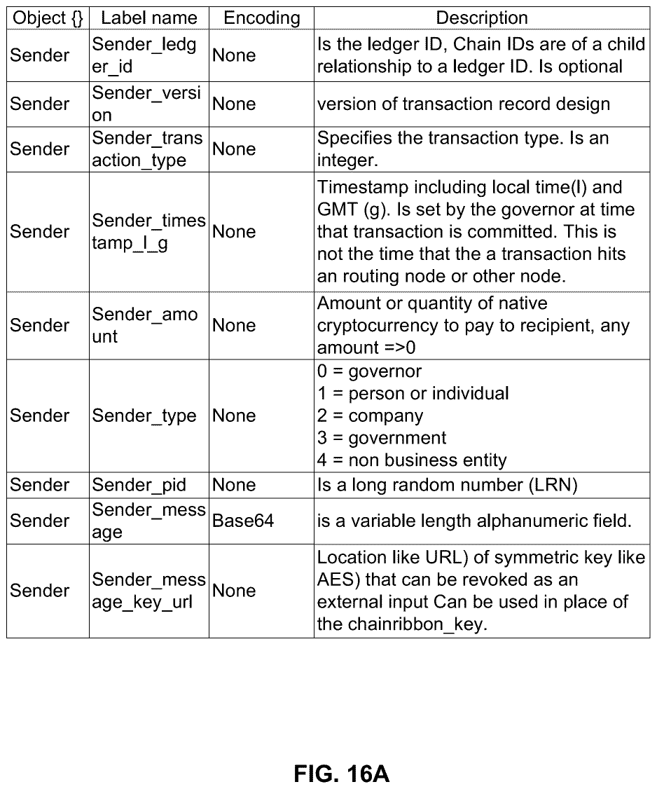

As shown in the illustrated example process 1500 of FIG. 15, to use a chain app, the example TC circuitry 102 facilitates an ability for the user to search for a chain and access a chain template through a query or read process from the ledger (block 1502). The system that is serving or otherwise processing the chain template will use the template to render an application interface for the user (block 1504). The user will be presented with an application (e.g., via the capabilities of the example TC circuitry 102) that may contains commonly known functions such as web forms, text fields, combo boxes and more advanced controls for the user to interact with (block 1506). The controls may access or query supporting data, such as values of a list box, from ledger transactions thereby providing for chain templates that can inherit other chain templates or chain templates that can inherit chain app data.

The user may interact with the chain app in a manner such as is commonly known as a graphical interface or presentation layer and the user may enter data (block 1508). The user may then, upon entering data into forms may save the data as a transaction written to the ledger by the system after first formatting the data per the specifications of the template (block 1510). The transaction will be tagged as a transaction of type “chain app” with reference to the chain app ID. The transaction will be processed by the system and written to the ledger (block 1512).

As shown in the illustrated example of FIG. 15, the model for chain templates in support of chain apps the system is able to specify an application structure and store data to the ledger in a manner specified by the chain template. In other examples, the chain template could be specified off chain or otherwise not in a transaction in the ledger. In other cases, an application could be encapsulated within an application container such as is known commonly as a Docker container.

### Transaction Container

Disclosed herein are examples for an “extensible transaction container” to enable Transaction as a Service. Regardless of the use cases employed by examples disclosed herein, the blockchain system is structured around a notion that one might call “extensible transaction container” where a transaction is the fundamental or most basic functional unit of a system, in which the transaction contains meta data to encapsulate additional functionality such as (but not limited to) rights (ACL), voting, ITSA, etc. Therefore, transactions disclosed herein have flexibility to perform multiple roles so as to minimize the need for secondary storage and logic systems. Hence, Transaction as a Service is enabled by increasing the capability of each individual transaction with minimal reliance upon secondary or tertiary administrative systems. To this point, a transaction has been described in general terms while the processing of said transactions are discussed in much greater detail. Given that, the following description details example components of the transaction. Of course, other wording or ordering of functions could be used as the following is simply one example implementation of the techniques set forth within this description.

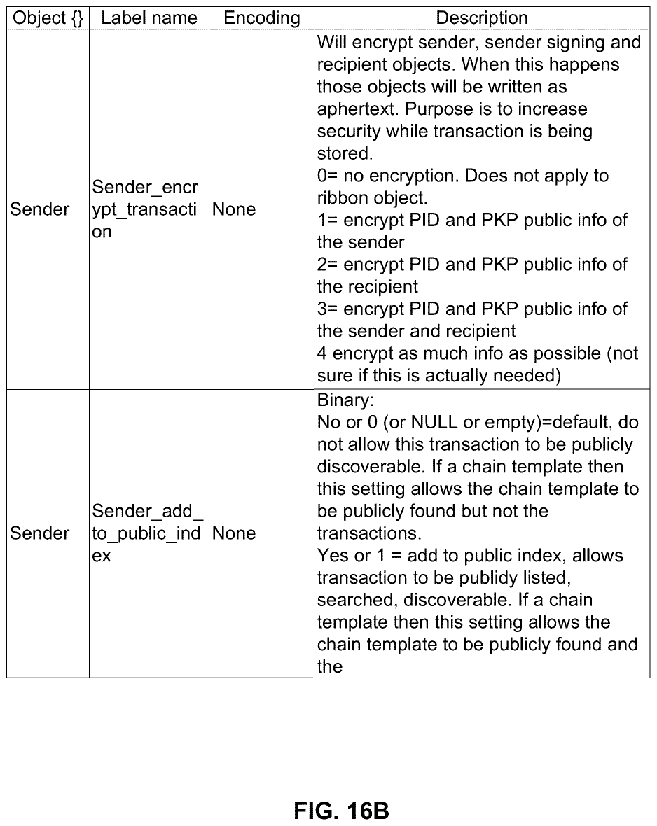

FIGS. 16A, 16B, 17A, 17B, 18 and 19 are tables that illustrate example objects, their associated fields and corresponding descriptions related to transaction containers. Other object or field names could be used without limitation. Those objects and fields described should be viewed as a subset or minimal set of required objects and fields. Discussed below are additional fields not included in those tables that represent an implementation that further increases privacy.

Examples disclosed herein will include any number of objects. Example object names, for the sake of description and context include: sender, sendersigning, recipient, recipientsigning, xnode, blocksigning and chainribbon. In some examples of FIGS. 16A, 16B, 17A, 17B, 18 and 19 do not illustrate secondary IDs and/or secondary keys and, as such, examples disclosed herein would require the user to disclose their PID and Primary public key. In some examples, access controls (ACL) are implemented to determine who could view full transaction details such as PID and PKP primary public key. Viewing is controlled via ACL transactions. Viewing may be considered a type of query that users can perform against the ledger. However, in some implementations an additional set of fields will be included to allow for a onetime secondary key pair (PKP secondary) and a secondary ID (SID) to be used entirely in place of the PKP primary key and PID.

In that second example, implementation with secondary key and secondary ID the primary key and ID would not be included in the transaction. In those examples, the ITSA would provide for serial connectivity between any particular user's transactions. Non-repudiation of signing by that particular user is possible because the governor would sign along with the user retaining copies of any secondary keys. Finally, the transaction would be signed by the primary key and included in the transaction without the associated primary public key being included in the transaction.

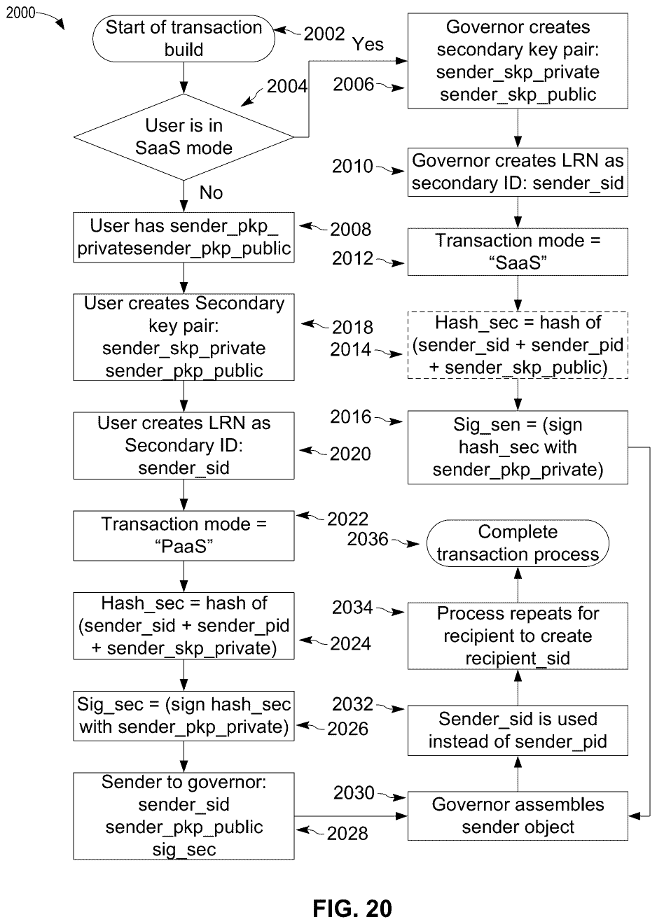

FIG. 20 is a flowchart representative of example machine readable instructions and/or operations that may be executed by example processor circuitry to implement secondary keys and IDs to further protect user privacy by introducing one-time use keys and IDs. In the illustrated example of FIG. 20, at block 2002 the TC circuitry 102 initiates the example process 2000 in response to, for example, a request to assemble a sender object (see block 1118 of FIG. 11). Initiation of the example process 2000 of FIG. 20 illustrates creating a sender secondary key pair and sender secondary ID. While not included in the illustrated example of FIG. 20, the same process would take place with the recipient secondary key pair and recipient secondary ID. The example TC circuitry 102 determines or the user discloses whether the user “mode” is PaaS or SaaS (block 2004). The primary difference between the two branches, starting at block 2006 and block 2008, is whether the processing is performed, respectively, by the user (as a client-side process in connection with the TC circuitry 102 therein) or by the governor on behalf of the user (also in connection with respective TC circuitry 102). Example sequences in the two branches of FIG. 20, respectively, being blocks 2006 and 2010 through 2016, and blocks 2018 through 2028. Given the similarities of those branches, further discussion of the illustrated example of FIG. 20 will focus on example blocks 2018 through 2028 and recognizing that the same process is performed at blocks 2006 and 2010 through 2016.

At example block 2008, the illustrated example process 2000 of FIG. 20 shows that the user has their primary key pair. One may consider that the primary key pair is client-side. At example block 2018, the user generates a unique key pair as a secondary key pair with a private and public key. At example block 2020, the user generates a unique LRN as the secondary id number. The purpose of this secondary id is to provide a unique identifier for the sender of the transaction. At example block 2022, the transaction mode is set as “PaaS”. This task will document in the transaction, as field sender_mode, that the user, as opposed to the governor, generated the secondary key pair and secondary ID. At example block 2024, a hash, referred to herein as hash_sec, is generated (e.g., by the example TC hash circuitry 206) from the string including hash_sec=(hash of sender_sid+sender_pid+sender_skp_public). This may use SHA256 or similar. The result is a hash. At example block 2026 hash_sec is signed (e.g., via the example TC hash circuitry 206) by the user's primary key pair. This provides for a cryptographic binding of the user's PID, SID, primary key pair and secondary key pair. At example block 2028, the example TC generator circuitry 204 sends the data for sender_sid, sender_pkp_public and sig_sec to the governor. Of course, other data is also sent to the governor such as the message, the recipient information, etc. None of the data elements sent from the sender or recipient are kept private from either the routing nodes or the governor. The user, who is the sender in this scenario, being in PaaS mode, will also provide credentials to a routing node or the governor such as to uniquely identify the specific user. The intent, as a reminder, is to keep data private when it is included in a transaction and later shared with a third party.

The example TC generator circuitry 204 (e.g., the governor) assembles the transaction (block 2030), and the sender_SID is used instead of the sender_PID (block 2032). At example block 2034, the same process repeats for the recipient to create recipient secondary keys and ID. Further, within a transaction leveraging secondary keys and IDs, the sender info will be unique. The questions arise: 1) How does the sender prove that this transaction was authorized? And, 2) How can someone else attain proof that a particular user did authorize or is otherwise responsible for the transaction?

To point 1) above; the sender will always have access, by default, to their own transactions. But that is just a simple issue of rights for a query. However, the user does have access to their primary key pair. For any given transaction, the user can use her primary key pair public key to validate the sig_sec of the hash_sec. Recalling, that the hash_sec is a hash of the (sender_sid+sender_pid+sender_skp_public). Therefore, the user can prove that they did in fact use her undisclosed primary key pair to sign. Further, the governor asserts, through signing the entire transaction, that valid primary key pairs were used to sign the one-time secondary key pairs. Additionally, the user who is the sender may also retain copies of the secondary key pair private key pair to, as an extra level of proof, re-sign the hash_sec.

To point 2) above; there are actually two different types of proof. A) Was this a valid transfer of cryptocurrency? B) Did the expected user authorize the transfer? This question may arise in circumstances where, outside of the system, a deal is made for a transaction with a person from one country yet the sender is actually from another country. Or, as another example, an agreement is made between two people for the purchase of a controlled substance but the actual purchase is made by a third person. For proof of circumstance “A”, the governor ultimately validates that a transaction is authorized. The governor includes a disclosed primary key pair public key to allow a third party to use that public key to validate that the entire transaction is valid. For proof of circumstance “B”, the user can provide rights to the user genesis record via ACL modified transaction to the third party. The user genesis record is the first record of a new user and may contain information such as name, address, country, age, etc. Additionally, a transaction type may be specific to disclose that genesis information to a third party.

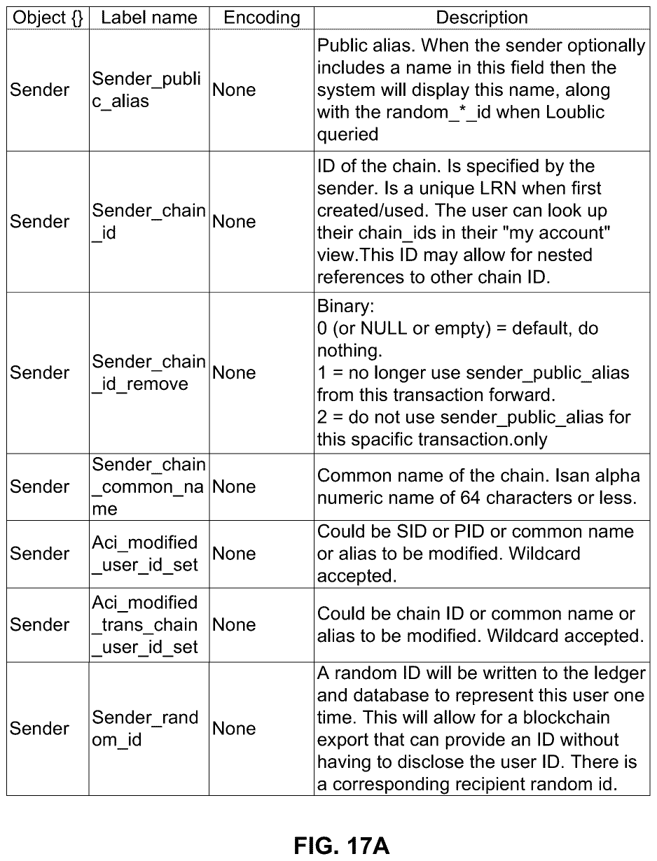

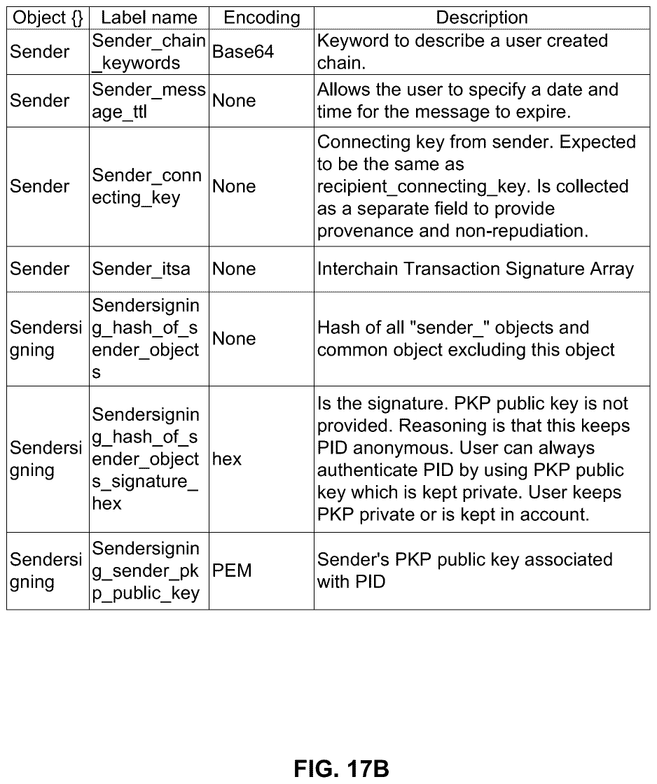

As described above, FIGS. 16A, 16B, 17A, 17B, 18 and 19 are tables that describe example objects, their associated fields and descriptions used in a minimal implementation of the system. In particular, example sender and sender signing objects are shown in FIGS. 16A, 16B, 17A and 17B. The sender object is the largest, by quantity of fields and count of bytes, and serves as a collection of information about the sender. Descriptions of example objects are provided below:

The example sender_ledger_id is a field in the sender object. It is the ledger ID. Chain IDs are of a child relationship to a ledger ID. Is an optional field with a default of main_chain. A ledger may be viewed as one contiguous data store. The purpose of this field is to allow for multiple independent ledgers to interoperate.

The example sender_version is a field in the sender object. It is the version of transaction record design or layout.

The example sender_transaction_type is a field in the sender object. It specifies the transaction type and is an integer. See FIGS. 13A and 13B.

The example sender_timestamp_l_g is a field in the sender object. It is the timestamp including localtime (l) and GMT (g). Is set by the governor at time that transaction is committed. This is not the time that transaction hits an routing node or other nodes because the “relied upon” timestamp is when the transaction actually is recorded in the ledger.

The example sender_amount is a field in the sender object. It is the amount or quantity of native cryptocurrency to pay to recipient, any amount=>0.

The example sender_type is a field in the sender object. Values are O=governor, 1=person or individual, 2=company, 3=government, and 4=nonbusiness entity. Other types may be added. The purpose is to allow a person to act on the behalf of an organization.

The example sender_pid is a field in the sender object. It is It is a long random number (LRN) that is assigned to the user. It changes infrequently and acts as a key to associate SIDs with PIDs.

The example sender_message is a field in the sender object. It is a variable length alphanumeric field. This is where the user will write a message. This is also where chain app templates are stored, chain app data is written and any other data artifact, container, virtual machine, jupyter notebook or other information will be contained that the user intends to record.

The example sender_message_key url is a field in the sender object. It is a location (like URL) of a symmetric key (like AES) that can be revoked as an external input. Can be used along with the chainribbon_key to allow the user or a third party to also have message kill capability or even to be used as an external reference for other purposes such as secondary checksum.

The example sender_encrypt_transaction is a field in the sender object. It allows the user extra options in determining if data within the transaction should be encrypted for extra safety while the data (the transaction) is at rest. When this option is enabled those objects will be written as ciphertext. Purpose is to increase security while transaction is being stored. Options are O=no encryption. Does not apply to ribbon object., 1=encrypt PID and PKP public info of the sender, 2=encrypt PID and PKP public info of the recipient., 3=encrypt PID and PKP public info of the sender and recipient., 4=encrypt as much info as possible (not sure if this is actually needed)”

The example sender_add_to_public_index is a field in the sender object. It is binary: Options are No or O (or NULL or empty)=default, do not allow this transaction to be publicly discoverable. If a chain template then this setting allows the chain template to be publicly found but not the transactions. Yes or 1=add to public index, allows transaction to be publicly listed, searched, discoverable. If a chain template then this setting allows the chain template to be publicly found and the transactions.

The example sender_public_alias is a field in the sender object. It is a public alias. When the sender optionally includes a name in this field then the system will display this name, along with the random_*_id when public queried.

The example sender_chain_id is a field in the sender object. It is the ID of the chain. Is specified by the sender. Is a unique LRN when first created/used. The user can look up their chain_ids in their “my account” view. This ID may allow for nested references to other chain ID to build richer chain app capabilities.

The example sender_chain_id remove is a field in the sender object. It is an integer with options: 0 (or NULL or empty)=default, do nothing. 1=no longer use sender_public_alias from this transaction forward. 2=do not use sender_public_alias for this specific transaction only.

The example sender_chain_common name is a field in the sender object. It is a common name or alias of the chain. Is an alpha numeric name of 64 characters or less. The Chain ID as a LRN is not human friendly. This option provides for human friendly names of Chain Apps.

The example acl_modified_user_id_set is a field in the sender object. This enables a list of user IDs to be modified. It could be SID or PID or common name or alias to be modified. Wildcards may be accepted. It may contain more than one value.

The example acl_modified_trans_chain_id_set is a field m the sender object. This enables a list of user Chain Apps to be modified. It could be chain ID or common name or alias to be modified. Wildcard accepted. It may contain more than one value.

The example sender_random_id is a field in the sender object. It is a random ID will be written to the ledger and database to represent this user one time. This will allow for a blockchain export that can provide an ID without having to disclose the user ID. There is a corresponding recipient_random_id

The example sender_chain_keywords is a field in the sender object. It provides for a list of keywords to describe a user created chain app.

The example sender_message_ttl is a field in the sender object. It allows the user to specify a date and time for the message to expire. This field extends to allows the user to provide an end of life for chain apps, elections, etc. The chainribbon will be removed when this value is met.

The example sender_connecting_key is a field in the sender object. It is a connecting key from sender. Expected to be the same as recipient_connecting_key. Is collected as a separate field to provide provenance and non-repudiation. Fundamentally, this field allows for asynchronous arrival of sender and recipient transaction parts. Those parts may be queued up in some implementations by a secondary process or may be written as a transaction in other implementations.

The example sender_itsa is a field in the sender object. It is the Interchain Transaction Signature Array. In some implementations a “Time to Execute” or TTE, field may be specified. In such a case, the date and time specified as a TTE will delay execution, that is the transfer of native cryptocurrency, until the specific date and time has arrived. In some implementations a “Time to Execute Message” or TTM, field may be specified. In such a case, the date and time specified as a TTM will delay publishing of the chainribbon_key, that is the message will not be readability, until the specific date and time has arrived.

The example sendersigning_hash_of_sender_objects is a field in the sendersigning object. It is a hash of all “sender_*” objects.

The example sendersigning_hash_of_sender_objects_signature_hex is a field in the sendersigning object. It is the signature of the sender object hash. A user can always authenticate PID by using the PKP public key which is kept private. User keeps PKP private or is kept in account. In some implementations a secondary key pair will be used to sign. That will allow for a secondary public key to be used to enable the recipient or third party to validate the signature.

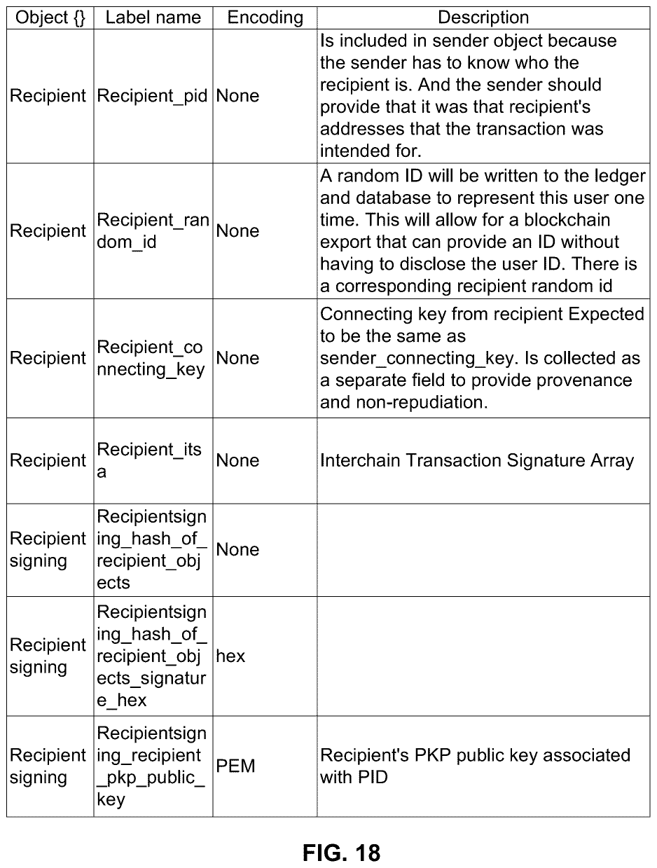

The example sendersigning sender_pkp_public_key is a field in the sendersigning object. It is Sender's PKP public key associated with PID. The recipient and recipientsigning objects are depicted in FIG. 18. The recipient object serves as a collection of information about the recipient.

The example recipient_pid Is included in sender object because the sender has to know who the recipient is. And the sender should prove that it was that recipient's addresses that the transaction was intended for.

The example recipient_random_id is random ID that will be written to the ledger and database to represent this user one time. This will allow for a blockchain export that can provide an ID without having to disclose the user ID. There is a corresponding recipient_random_id.

The example recipient_connecting_key is a connecting key from recipient that is expected to be the same as sender_connecting_key. Is collected as a separate field to provide provenance and non-repudiation.

The example recipient_itsa reflects an Interchain Transaction Signature Array.

The example recipientsigning_recipient_pkp_public_key reflects a recipient's PKP public key.

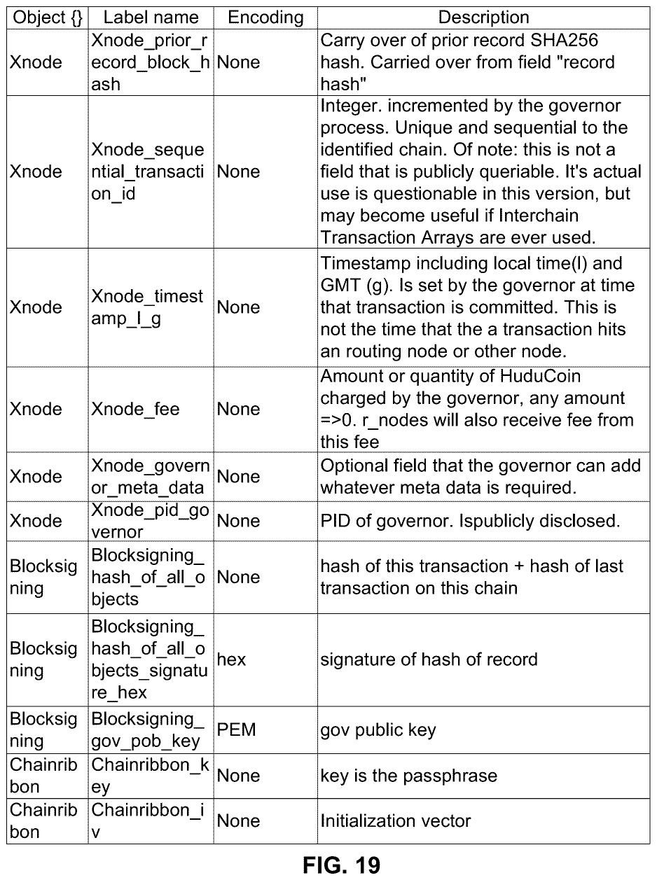

The example xnode, blocksigning and chainribbon objects are depicted in FIG. 19. xnode_prior_record_block_hash carry over of prior record SHA256 hash. Carried over from field “record_hash”.

The example xnode_sequential_transaction_id integer is incremented by the governor process. Unique and sequential to the identified chain. Of note: this is not a field that is publicly searchable.

In some implementations a sequential ID for each chain will be specified to provide a serial connection between each transaction of a distinct chain. The governor will sign thereby proving that for a collection of transaction for a specific chain that all transactions are accounted for. This field may be known as xnode_sequential_chain_id.

xnode_timestamp_l_gTimestamp including localtime (l) and GMT (g). Is set by the governor at time that transaction is committed. This is not the time that the transaction hits a routing node or other node.

The example xnode_fee reflects an amount or quantity of HuduCoin charged by the governor, any amount=>0. r_nodes will also receive fee from this fee.

The example xnode_governor_meta_data is an optional field that the governor can add whatever meta data is required. That meta data may include traceability information such as sender IP address, OS version, and other data that may be useful in “fingerprinting” the sender or recipient. That data will generally be available only to the governor for security and operational purposes.

The example xnode_pid_governor reflects a PID of governor. Is publicly disclosed.

The example blocksigning_hash_of_all_objects reflects a hash of this transaction+hash of last transaction on this chain

### Voting

Presented is a voting method within a blockchain system. There are many circumstances where a vote can be used to arrive at a consensus. Some examples include; a vote can be used to approve changes to a blockchain system, to modify governance rules, to provide a mechanism where popularity or quality of a chain template or other chain app descriptive elements can be affirmed or rejected, or (in some implementations) to even change the governing body of the system. To that end, example voting capabilities are disclosed herein.

Voting is to be considered different from surveys. Surveys can exist as Chain Apps with ACL mechanisms for management. Voting with the system will force a different set of rules with processing queries and voting transactions. In some implementations, additional fields in the transaction may be used to either specify or allow for additional fees to be charged by or to the transactor, the election creator or both.

In all cases, transactions flagged as “vote” or “voting” will be publicly searchable to provide for transparency. A transaction type is specified to define that an election has been created or that a vote has been specified. The duration of the election is specified by other transaction types. A transaction type of vote will enable the transaction to be publicly read or queried.

In some implementations a field may be provided for the transaction specification to state the type of election such as “election for governor”, “election for feature approval”, “chain template is lacking in description”, etc. In some implementations the phrasing of the topic or nominee of the election does not follow strict conventions. In those less structured cases, the creator of the election may nominate herself in a simple manner such as, “I, Jane Joe, do hereby run for governor.”

Please note the prior mention of “chain template is lacking in description”. This is critical in that it forces chain app creators to use clear variable names. By having a capability that allows the community to critique variable names in a chain app template then the community can force good (easy to read and sensible) variable names. Good variable names increase the portability of data records. In contrast, it is known that some companies have been known to make data portability difficult by obfuscating variable names. While this function could be performed off chain or as simple chain app survey having voting performed on chain app variable names and chain app templates provide for increased transparency and an official recognition of chain app quality.

During the creation of the transaction for an election, where Transaction Type=Vote, then a new sender_chain_id (“chain ID”) will also be created. The chain ID, along with the election being publicly accessible will allow for both others to add in candidates.

A chain serial ID, similar the sequential ID across every transaction may be provided for in some implementations to provide for proof of vote tally completeness. Clear and open definition of variable names is required to allow for users of the system to move or port their data (their transactions) to other platforms. If clear and open definition of variable names are not provided for by the chain app creator then data portability will be difficult. In some implementations a transaction type of “rating” may be provided to allow an integer of example (1 to 5) to allow a user of a chain app to share their opinion of a chain app and to promote adherence to principles of clear and open definition of variable names. In some implementations the rating capability may be extended to include general user satisfactions with a chain app.

### Transaction Types

Examples for access control contained within a ledger are disclosed herein. FIGS. 13A and 13B depict tables with a column for an integer and a corresponding table for a description of the capability enabled with that integer within a “transaction type” setting. The right to execute for any particular transaction type is the sender unless otherwise specified.

Example transaction type 0 is the first transaction in the entire system. Only utilized by the governor.

Example transaction type 1 represents the first transaction to establish or create a user. Only utilized by the governor.

Example transaction type 2 defines that a chain app template will be written into a transaction message.

Example transaction type 3 is a standard transaction that is not reliant upon a chain template.

Example transaction type 4 represents data that is written to the message in a format specified by a chain app template.

Example transaction type 5 allows a user to close transaction set. No subsequent transactions can be performed under this PID.

Example transaction type 6 establishes a chain ID. The difference between types 2 and 5 is that a chain app template is not specified.

Example transaction type 7 closes a chain ID and

prevents new transactions using this chain ID. Allowed by the chain creator.

Example transaction type 8 is not specified in the table.

Example transaction type 9 closes a chain ID and prevents new transactions using this chain ID by the governor for a violation of terms of use.

Example transaction type 10 establishes a new chain ID for an election and is used to register votes.

Example transaction type 11 identifies that a chain ribbon has been modified to either delete a key or to re-add a key. A reason may be added to the message. Rights for this are allocated to the governor and the original sender of a transaction. The transaction to modify is specified as transaction sequential ID stated as recipient and optional reasoning included in message.

In consideration of example transaction types 12, 13 and 14 acl_modified_user_id_set and acl_modified_trans_chain_id_set are introduced as fields in the sender_object of a transaction. A user may not alter their own rights as applied to their own transactions such that the user would remove a read right for themselves. acl_modified_user_id_set—Identifies a user or group of users. Could be a user's SID or PID or common name or alias to be modified. Multiple IDs allowed using a delimiter such as a comma. Wildcard accepted. acl_modified_trans_chain_id_set—identifies a transaction, set of transactions or a chain of transactions. Could be chain ID or common name or alias to be modified. Multiple IDs allowed using a delimiter such as a comma. Wildcard accepted. Only the creator of the referenced transaction ID or chain ID can modify access control. The exception is where rights have been delegated with transaction Type 14.

Example transaction type 12 identifies that access control is being modified to ALLOW READ rights. The acl_modified_user_id_set and acl_modified_trans_chain_id_set will be recorded in this transaction which will modify identify rights for all prior and future transactions as specified until and if revoked by a subsequent ACL modification transaction.

Example transaction type 13 identifies that access control is being modified to REMOVE READ rights. The acl_modified_user_id_set and acl_modified_trans_chain_id_set will be recorded in this transaction which will modify identify rights for all prior and future transactions as specified until and if revoked by a subsequent ACL modification transaction.

Example transaction type 14 identifies that access control is being delegated to another user (delegate) such that the identified user can execute transaction types 12 and 13 upon the first user's (delegator) transactions and chains. The acl_modified_user_id_set and acl_modified_trans_chain_id_set will be recorded in this transaction which will modify identify rights for all prior and future transactions as specified until and if revoked by a subsequent ACL modification transaction. The delegatee can not modify access control of the delegator.

Examples disclosed herein facilitate the granting of READ rights. As an example of an ACL modification where user A intends to grant user B READ rights to an existing transaction then user A would create a new transaction of type “12” and then enter User BID (could be SID or PID or common name or alias) into acl_modified_user_id_set. User A would also enter the transaction sequential ID of the transaction intended to have rights modified into the acl_modified_trans_chain_id_set and optionally the ledger ID as may be named as sender_ledger_id. The ledger ID refers to the blockchain itself. Multiple Chain IDs can exist within one ledger ID.

Examples disclosed herein facilitate the removing of READ rights. As an example of an ACL modification where user A intends to revoke user B READ rights to an existing transaction then user A would create a new transaction of type “12” and then enter User B ID (could be SID or PID or common name or alias) into acl_modified_user_id_set. User A would also enter the transaction sequential ID of the transaction intended to have rights modified into the acl_modified_trans_chain_id_set and optionally the ledger ID as may be named as sender_ledger_id. The ledger ID refers to the blockchain itself.

The preceding two examples of granting READ rights and revoking READ rights could similarly be implemented upon a multitude of transactions or a chain ID or by using wildcard characters to describe the range of affected transactions. And, keeping in mind that such changes in ACL assignment are retroactive and persist into the future until such time as those right are revoked by a subsequent transaction to modify the “as is” assignment status.

Examples disclosed herein support any number of practical use examples where ChainCasting is used for session management. As an example of practical use where a user (User A) interacts with a web site to maintain session state, consider that a session state refers to a data collection or data store that records items that a user has selected in a shopping cart. For instance, User A goes to Website B. Both parties are using examples described herein and collectively referred to as ChainCasting. Upon User A arriving at Website B, User A has a long random number generated as a connecting key and in some implementations where asynchronous and incomplete transactions are written to the ledger, a long random number generated as a secondary ID (SID). That connecting key is shared with Website B. Website B then creates a temporary data store using the connecting key as an identifier. In some implementations the temporary data store is located on the website and in other cases temporary data store is located on the user platform while in other cases the temporary data store can be located on a third-party platform. User A clicks through different items. At each click, is configurable for what actually gets recorded, the selected page is recorded in the temporary data store. User A selects an item in the website catalog to purchase. Keeping mind, that this example only explorers one thread or path of activity, User A then exits the website.

Per configuration and implementation, the temporary data store with connecting key and other identifying information is formed into a transaction part. Keeping in mind that the connecting key allows for asynchronous submission of transaction parts to a routing node or the governor transaction process, the transactions parts are cached or otherwise stored in a manner such that a complete transaction has not been written. In some implementations, however, an incomplete transaction could be written by, for example Website B and subsequently User A could write a transaction based on the connecting key to provide a complete transaction. A complete transaction, in this case, refers to a transaction that has all sender and all recipient required data elements.

Regardless, the existence of the connecting key would allow for recollection and continuity of session data. In this example, User A left the website before completing a purchase. An item had only been selected from the catalog. Continuing with the example scenario, User A returns to the website. Given that the parties are using ChainCasting and not traditional cookies or other conventional session management techniques, the method by which session continuity is enabled is with the user, in some implementations, sharing the prior connecting key (or other identifier) to continue the session but with a new connecting key since a connecting key has to be unique and given that the prior common ley had already been written into a transaction. In other implementations, User A may only provide a narrow range of data such as the item number intending to purchase. User A may do this to restrict the amount of information available to the website. User A may then proceed with a session and use transactions, in the manner of ChainCasting, to exchange information and complete the sale with a transaction being written with sufficient data to facilitate renumeration, shipping, etc.

Per the prior example scenario, there is minimal information that the website will have access to. Of course, session information can leak through other mechanisms such as OS fingerprinting, etc. Examples disclosed herein intend to reasonably protect session information. More importantly, examples disclosed herein enable control and monetization of user session data. To that end, another example scenario would allow for User A to assign READ rights to a collection of transactions to a third-party. That third-party, perhaps an advertising firm, would be allowed to inspect those “temporary data store” that are actually permanently written to the ledger. The third party could query the ChainCasting system for those records and analyze to determine, for example, the best type of advertisements (such as banner ads) to display to User A. Agreements and methods to provide value or value in kind for third-party access to session information is outside of the scope of examples disclosed herein, but are enabled nonetheless.

In consideration of third-party reading transactions, the system will provide techniques of querying or searching transactions from the ledger that are assigned READ rights to all. Transaction type 15 is presented as a technique to validate a user status and balance. In some cases, it may prove useful to allow a third-party to determine if a user is registered with the system ChainCasting. One technique to validate that the user is a registered user of the system with the current status being displayed is for the user being queried to provide any prior SID. One may consider, that the third-party, if having sufficient READ rights could issue a query to the system asking if the user is registered, the user status and if the user has sufficient balance. However, this example would possibly leak unintended information on the user to the third party. Instead, examples disclosed herein provide for a transaction type 15 where the sender can give permission to the recipient to view sender status and balance to date. The information will be written by the governor into the message field. The sender may not write to the message with this transaction type. The sender_object field sender_message_ttl allows the user to specify a date and time for the message to expire. Therefore, examples herein are available through Transaction type 15 to allow a third-party to query a particular user's status and balance. In some examples and configurations this transaction type may be broken into multiple transaction types with one transaction type to allow a third-party to check user status, another transaction type to allow a third-party to check user balance as well as other type for various purpose such checking quantity of transactions, etc.

Example transaction type 16 provides techniques for a user to block the receipt (to be a recipient) of transactions from an identified user. The user to be blocked is identified by SID or common name or alias to send transactions to this user. The block persists until such time as the same transaction type is issued again or until the ttl expires.

Example transaction type 17 is a transaction that describes funding of the user account based on credit card purchase of cryptocurrency. The message field can be used to describe either the credit card meta data or reason for funding.

Example transaction type 18 is used to authoritatively associate a domain name with the email address existing in the user account.

Example transaction type 19 allows for a sender public alias to be defined.

Example transaction type 20 allows for a user to bookmark a chain app. This is particularly useful for chain apps that are not publicly discoverable.

### Interchain Transaction Signature Array

Presented is an Interchain Transaction Signature Array (ITSA). Throughout examples disclosed herein a concept has been discussed referred to as Interchain Transaction Signature Array (ITSA). An Interchain Transaction Signature Array is a set of data that is included in ledger-based transactions that allows the creator of the transaction or the validator of a transaction to step or point to the prior transaction in a series of transactions with the benefit of both the sender IDs of transaction and the recipient IDs are completely anonymous for purposes of balance tabulation and proof of wholeness or continuity of transaction sets per user. Additionally, this method makes a ledger fork resistant. An Interchain Transaction Signature Array, regardless of how IDs are obfuscated, will allow for authoritative reconstruction of the prior transactions for a given ID. Forking exhibits some challenges in Distributed Ledger Technology (DLT). Simply put, 1) forks create disparate versions of the truth and 2) existing methods of balance determination leak information. Examples disclosed herein make forking impractical if not completely impossible because of how balances are determined.

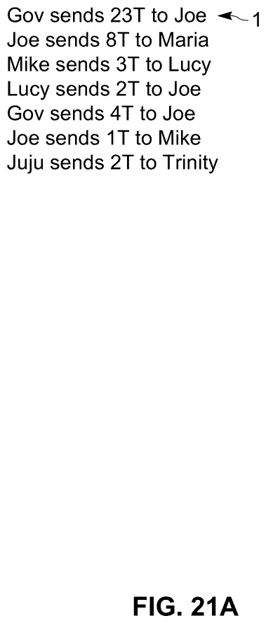

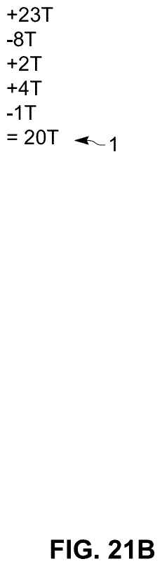

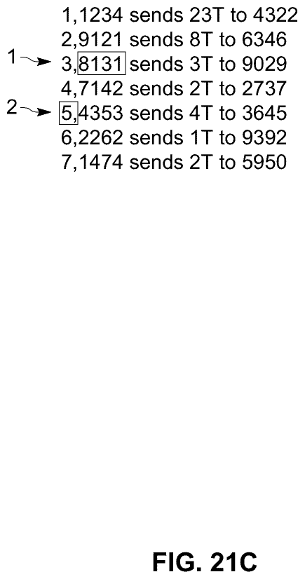

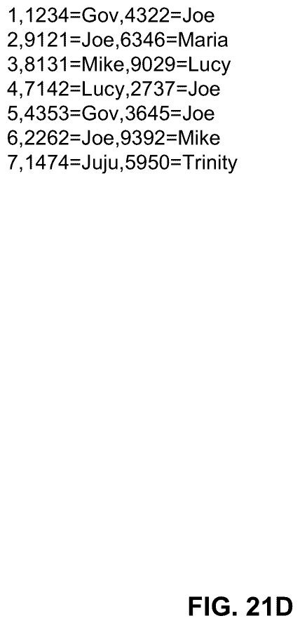

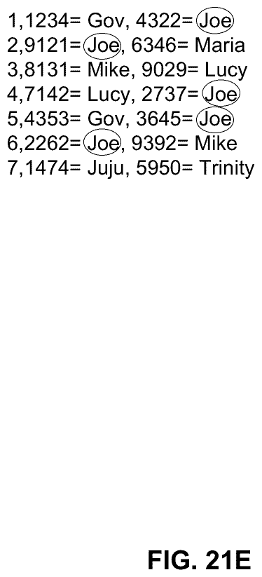

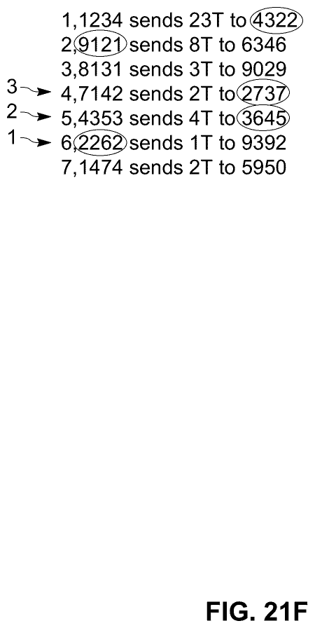

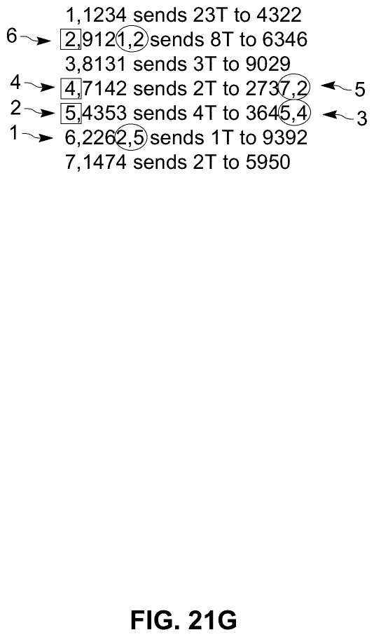

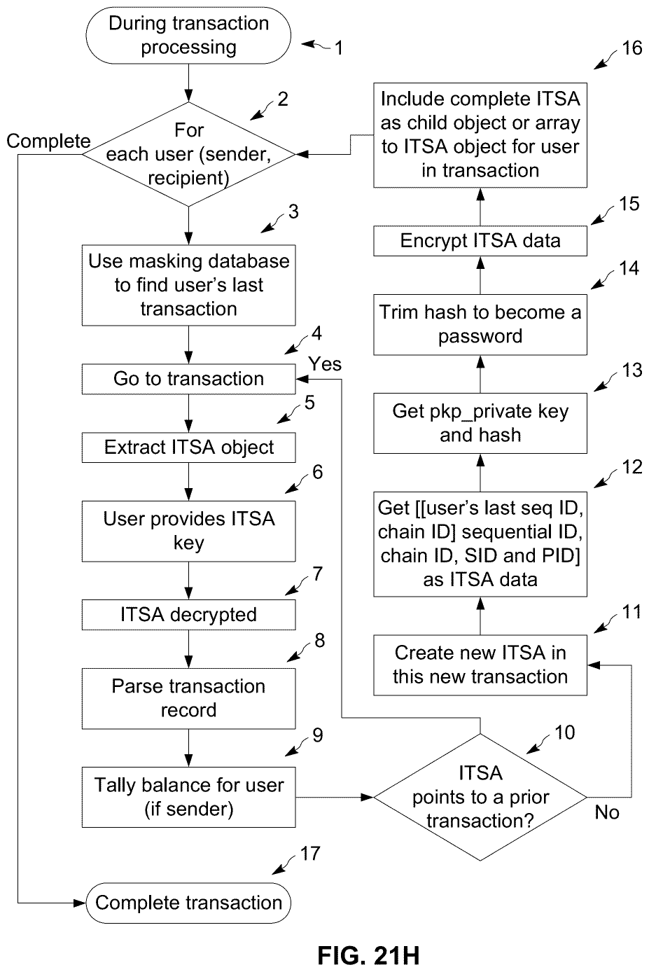

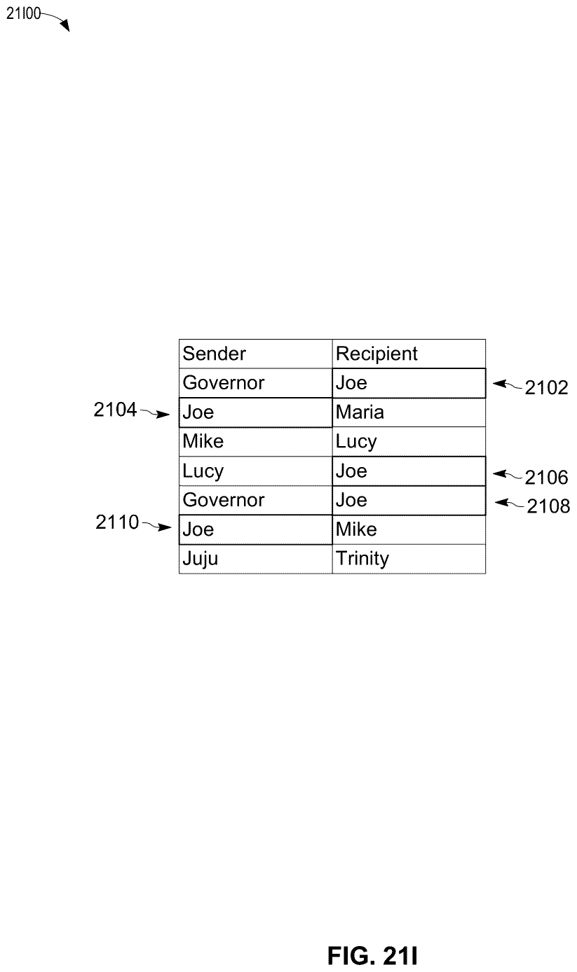

FIG. 21 depicts a very simple table 2100 of transactions from a “sender” to a “recipient”. This table is intended to establish some context or conceptualization of the Interchain Transaction Signature Array (ITSA). Here, we can see at 2102 the Governor made a transaction with Joe. One may consider that a transaction involves some exchange, from sender to recipient, of native cryptocurrency and or a message. At 2104 Joe has “sent” a transaction to Maria. At 2106 Joe was the recipient. At 2108 and 2110 are described similar exchanges. Depending upon the amounts sent, Joe's balance will either increase, stay the same or decrease.

Determining a particular user's balance without leaking information about the user's prior transactions has proven difficult in conventional blockchain systems given that a balance is tabulated by tallying up credits and debits to a user's account across a multitude of transactions. But, for one to navigate from one transaction to another requires information that connects those transactions together, hence the leak of information with ledgers that are in part or whole publicly or semi-publicly inspectable, viewable or otherwise downloadable.

The ITSA intends to solve the problem of balance determination without leaking information beyond a user's own transaction set. Of course, as mentioned previously a special transaction type (Type 15) allows for balance determination to be performed in a centrally executed manner by the governor. But, perhaps most important of all, is that the ITSA provides a technique of serially connecting all of a particular user's transactions (both as sender and recipient) together so as to be able to decouple their transactions in an authoritative, with nonrepudiation and in an immutable manner. This feature may also be described as “authoritative wholeness” of a set of transactions.

The ITSA is an object in the transaction. It is primarily composed of three child objects or arrays with those being the sender ITSA, the recipient ITSA and a combined one for the governor. The governor will need an ITSA with both sender and recipient information because, in the absence of an optional masking database, this array would contain information to allow the governor to reconstruct transactions by user serially. And, keeping in mind that each ITSA is encrypted with information that may not be available to the governor. Hence the governor is in need of a combined (sender info+recipient info) ITSA.

Regarding the aforementioned “masking database”. Some blockchain systems may use an off-chain system to manage the mapping of random IDs to known IDs. The ITSA removes a requirement for a masking database and allows for true anonymity and wholeness of record sets to be proven authoritatively.

The ITSA may include meta data to allow for the collection of traceability information such as sender IP address, OS version, and other data that may be useful in “fingerprinting” the sender or recipient. That data will generally be available only to the governor for security and operational purposes.

While the ITSA is described above as provide a whole set of records for a given user, additional ITSAs can be used for other whole record sets. For example, we expect that an ITSA could be constructed such that all records for a given chain app ID could be linked via ITSA and prove wholeness of all records of that chain app ID. This would allow one to prove that a set of transactions for a chain app ID is inclusive of every transaction. A benefit might be described in the form of a scenario where all votes collected by a voting chain app could be proven to be whole.

### ITSA Specification

Specification for Interchain Transaction. 1) Sufficient data will always be provided to point the sender's current transaction to the sender's last transaction. 2) Sufficient data will always be provided to point the recipient's current transaction to the recipient's last transaction. Alternatively, an ITSA could be created that points to each transaction of a chain app ID.

The purpose of the Interchain Transaction Signature Array (ITSA) is to allow a governor or user process to determine the balance of the sender and or to reconstruct a user's transaction set. The Interchain Transaction Signature Array is used to determine the balance of the recipient afterwards (like when the recipient is then the sender.) The Interchain Transaction Signature Array is critical to allow for user data decoupling. A hidden or backend system such as a masking database is not required if the governor is able to use an ITSA.

Within the overall ITSA object, separate ITSAs are included in every transaction; one for sender, one for recipient and a combined one for the governor. As stated, the ITSA will contain information to trace back to the prior transaction of the sender and the recipient independently. ITSA are encrypted and only the sender, recipient and governor can decrypt their respective ITSA.

The ITSA will, in effect, direct the observer to go to a specific prior transaction where this current sender (or recipient) either last did a send or a receive. And, by going from one record to another, even though each transaction uses different ID numbers, a list (and balance) of prior transactions can be authoritatively reconstructed from on-chain information while maintaining complete anonymity of sender and recipient IDs.

Depicted in FIG. 21A is a simplified list of transaction. And let's say we have a new transaction where Joe 1 wants to send 5T, with “T” representing a unit of native cryptocurrency, to Claire. We need to figure out if Joe has at least 5T in his balance. In a conventional manner A process would go through the list and tally up the credits and debits for Joe to arrive at FIG. 21B balance 1.

A balance tabulation, given in the presented scenario, determines that Joe does have enough T to send 5T to Claire. So far, this is analogous to how Bitcoin works. In ChainCasting, randomization of user IDs and encryption is used to hide information. We will now replace names with secret codes. A secret code is never used twice so we need a list of how those secret numbers map to each other. We add a sequential number to the list to facilitate mapping of a distinct user's prior transactions. Our list of transactions might look like FIG. 21C. With 1 referring to a secret code used to replace the user name or ID. With 2 being a simple (like an integer) sequential ID for each record. Now it is impossible to determine a balance for Joe if one were to inspect the ledger in its native format. But we may have a masking database that is external to the ledger, populated and, managed by the governor. The masking database, if used, is a simple lookup table. The masking database might have entries as are described in FIG. 21D. With the lookup table (masking database) the governor can figure out who sent how much to whom. Continuing with the example of creating a transaction for Joe wanting to send 5T to Claire, we first need to find all transactions that Joe was in. In the masking database FIG. 21E we can find all references (denoted by being circled) to Joe. Sufficient information is available to tally up Joe's current balance. There is only one problem. Only the governor has access to the masking database. Therefore, it is impossible for Joe, or any other user, to decouple an authoritative and serially complete list of transaction. Conversely, if everyone had access to the masking database then there would be no anonymity. The question is then posed; how can someone look up their own balance or provide proof to someone else that their balance is X or to provide an authoritative list of their transactions? Keeping this in mind, how might the system be useful to Joe. Joe may have a list of his transactions. He could provide those transactions as proof of his balance. But this introduces another problem. The list of transactions that Joe has are not authoritatively chained (serially bound) together. So, let's add another data element to tie everything together. Joe's sends and receives are again circled in FIG. 21F. The challenge is in how connecting record “6” as I send to record “5” as 2 receive to record “4” as 3 receive, and so on in the same manner through the list of transactions? The governor can simply use the masking database if it exists in this particular implementation or configuration, so this capability is primarily for the user. Again, Joe has a bunch of transactions. How does he calculate his balance or even build a list of his transactions yet alone an authoritative list of transactions (for purposes of decoupling)? And to make it a little more challenging let's say that the governor should also have the ability to construct a list of transactions for the user without relying on the masking database?

Therefore, we add an additional field that helps to connect all of Joe's records. In table FIG. 21G we added the record number of the prior record alongside the masked ID (i.e. SID). The number we added, circled in 1, 3 and 5, points to the prior record for the sender, and a similar markup for the recipient. An explanation is that 1 “5” as sender refers to 2 sequential ID “5”. 3 as “4” refers to 4 as sequential ID “4”, and so on through 5 and 6. Keep in mind FIG. 21A that shows the user name before the user name is obfuscated with a onetime random number. As a reminder, in this scenario, we are using an ITSA (the number that connects each transaction for a specific user together serially) to determine Joe's balance. Joe, in this scenario, is the sender. Of course, in some cases Joe may be the recipient. As is the case in 3 and 5. The point being that in each transaction there will be an ITSA for the sender and an ITSA for the recipient. And, the governor will sign both along with having that information in the third ITSA (the governor's ITSA).

Notice that records in the scenario, FIG. 21A through FIG. 21G, does not have a similarly marked reference to a prior record because, in this example, this would be the very first record that Joe shows up in as either sender or receiver. Of course, the other users would be similarly marked up. But there is another challenge. We do not want to include clear text (i.e. unencrypted) references between each of Joe's records in the transaction ledger. This is acceptable to do in the masking DB where only the governor has access but not in a manner that provides visibility to others. Therefore, we encrypt the information that is important to constructing Joe's list of record pointers.

Some additional details. During a transaction the user (sender) could use an asymmetric key (like AES) to encrypt the ITSA. This could solve the problem for the sender but what about the recipient and the governor? If we look at transactions FIG. 21G and we know that Joe is the recipient at record sequential IDs #1, #4 and #5. And, if the sender had encrypted the ITSA then Joe would not be able to pull authoritative information from those transactions. We could have the recipient provide a key (AES password) also, but that may create too much complexity. The recipient will have to provide a secondary SID which does require some minimal processing on the part of the recipient. Since the recipient has to create a SID the recipient can also create an AES key as a practical solution.

As depicted in FIG. 21H at 1 the process is taking place during the processing of a transaction. It may prove beneficial to reference, FIG. 11 at 5 depicts sender object assembly, FIG. 11 at 6 depicts recipient object assembly, FIG. 12 at 9 depicts block signing object assembly to better establish where FIG. 21H steps in to process the ITSA for the sender and recipient. Continuing with FIG. 21H at 2 a loop in initiated to step through the creation of the ITSA for the sender and the recipient individually. At 3 the masking database is used by the governor to identify the respective user's last transaction as either sender or recipient. If a masking database is not used then a brute force process is used where the user's ITSA password is used to attempt each subsequent record until a valid solution for an ITSA is found. From there the process continues at 5. At 6 or an earlier step the user provides a password. In some implementations the governor may have this information in other cases the user will provide the password. The description at 13 and 14 states that the password is derived from the user's private key. However, that is just an example implementation. The salient point is that a password exists that is known, at least, to the user. At 7 the ITSA is decrypted. At 8 the decrypted ITSA is parsed to extract information such as Sequential ID of last transaction that this user was a sender or recipient in. At 9 that next transaction is parsed and balance information is tallied as either a credit or debit depending upon whether the user is a sender or recipient in that transaction. If that ITSA at 10 points to another prior transaction for this user then that record will be similarly fetched and processed. If at 10 no other records for this user are identified then at 11 a new ITSA record will be created for this current in process transaction. At 12 the governor process gathers relevant information for the ITSA including [[user's last seq ID, chain ID] sequential ID, chain ID, SID and PID] as ITSA data. At 13 and 14 the password is assembled or reused. At 15 the ITSA data, what we call an array, is encrypted. The ITSA for the user is included in the appropriate object as either sender or recipient. The governor will then take the unencrypted ITSA data of the sender and the recipient. That data will be placed in another child object and encrypted by the governor using a third password that is not disclosed to the sender, recipient or anyone else.

Let's review. At this point we are saying that with a given transaction the sender creates an encrypted string containing the transaction [sender's last seq ID, chain ID], sequential ID, chain ID, SID and PID. The sender will know their own AES key. We will address creating the key in a moment.

The recipient does the same thing. The recipient creates an encrypted string containing the transaction [recipient's last seq ID, chain ID] sequential ID, chain ID, SID and PID. The recipient will know her own AES key. And, the governor does basically the same thing. The governor creates an encrypted string containing the transaction such that; sender [sender's last seq ID, chain ID] sequential ID, chain ID, SID and recipient [recipient's last seq ID, chain ID] sequential ID, chain ID, SID. The governor will know their own AES key.

Another way of expressing this is: ITSA=[ITSA_sender]+[ITSA_recipient]+[ITSA_governor]

And, reminding that the ITSA could be constructed around a chain app ID along with sender and recipient information. Creating the AES password may be accomplished by examples disclosed herein as one of potentially many methods of creating the passwords, such as a password for each object in the ITSA, for the ITSA. It does not seem practical to have the user create an original password with every transaction. We also want the user to be able to reliably remember, recall or automatically access the password. One possible solution is to run a hash against the user's primary private key or a hash of the PID. Both are secret and never been openly disclosed. To create a password for the ITSA for the sender, the system would use SHA256 (or similar) and optionally, per requirement of a given cipher, trim to X characters. This allows the user to not need to remember a secondary password. Of course, if the user's private key is leaked then the system is compromised. Regardless, if user PID (or whatever hashed base) then a new PID could simply be created. The system would have knowledge of the older PID and new PID. This would have to be implemented in the system in the manner of record continuity but that could rely upon known methods.

Given that it has been described that the system will derive the ITSA password from a secret PID or secret PKP private key, examples disclosed herein then handle a recipient's ID. For any transaction to take place the sender must have a SID or common name (like an alias) produced and shared by the recipient. In some implementations that governor will retain user PKP private key and PID. During the processing of a transaction where the governor process has access to the PKP private key then the governor can produce an ITSA key in the same manner.

In cases where the sender or recipient have control of their PKP private key and PID such that they are not stored by the governor but by the user, then a process running under the control of the user could create ITSA keys in the same manner. In some cases, a user may provide a SID to another user with an expectation that the sender will generate a multitude of transactions with that SID. In these cases, the SID of the sender, being the other party, will be unique but a unique SID is not available for the recipient field. In such cases, the governor will force the generation of a new SID that is unique. Therefore, a SID may be somewhat re-used as a “send to” type of address. Unfortunately, this opens up the risk of a user receiving unwanted (i.e. spam) transactions. Transaction type 16 can be used to block a specific user from sending unwanted transactions.

Example Interchain Transaction Signature Array disclosed herein provides for (1) coin/money balance determination, and (2) authoritative record of transactions and fork resistance. A masking database can be used for performance reasons but is not required. The ITSA works on both centrally and fully distributed ledger systems.

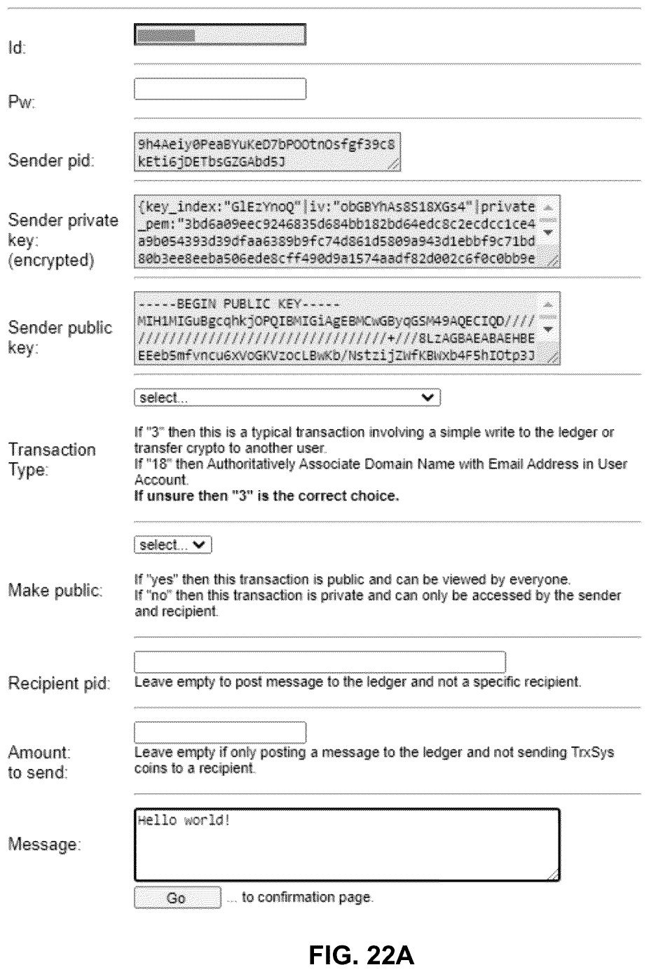

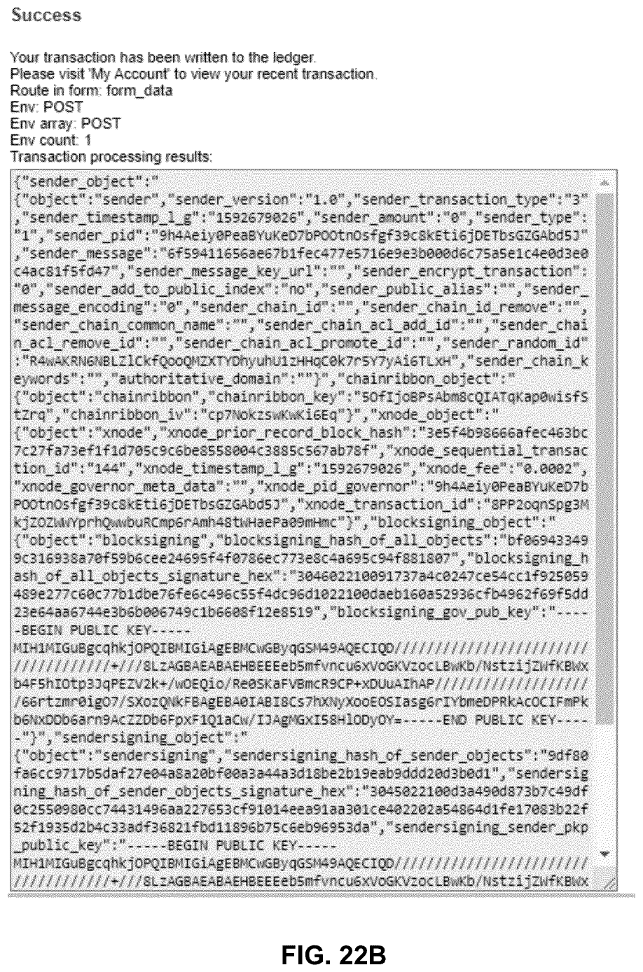

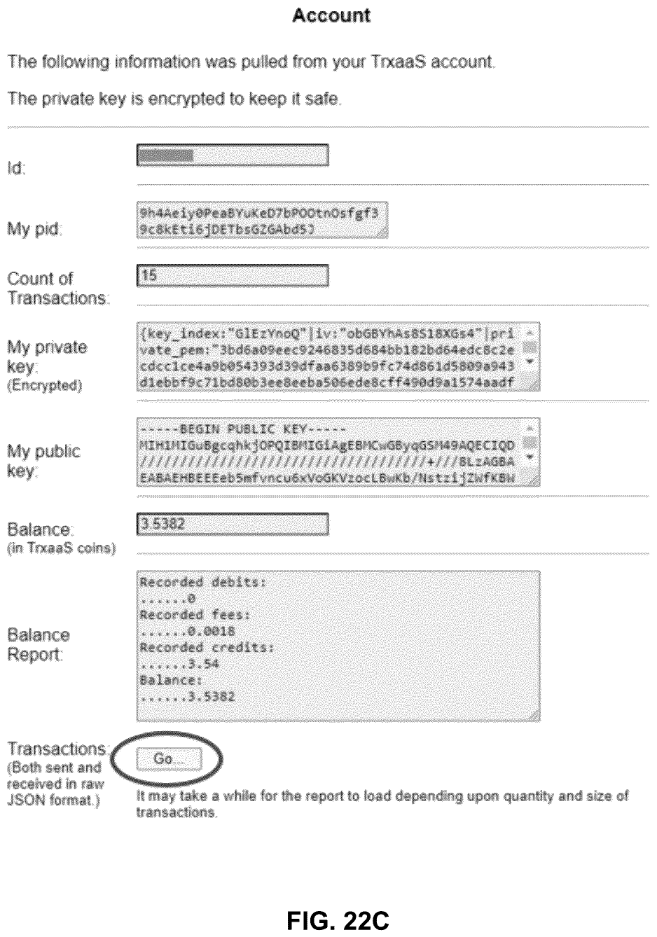

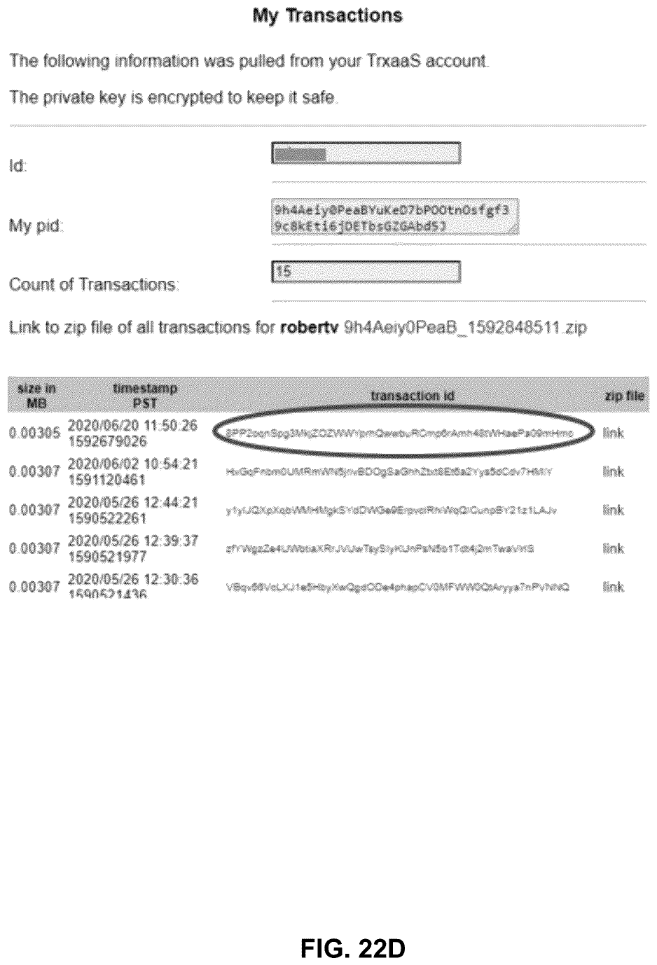

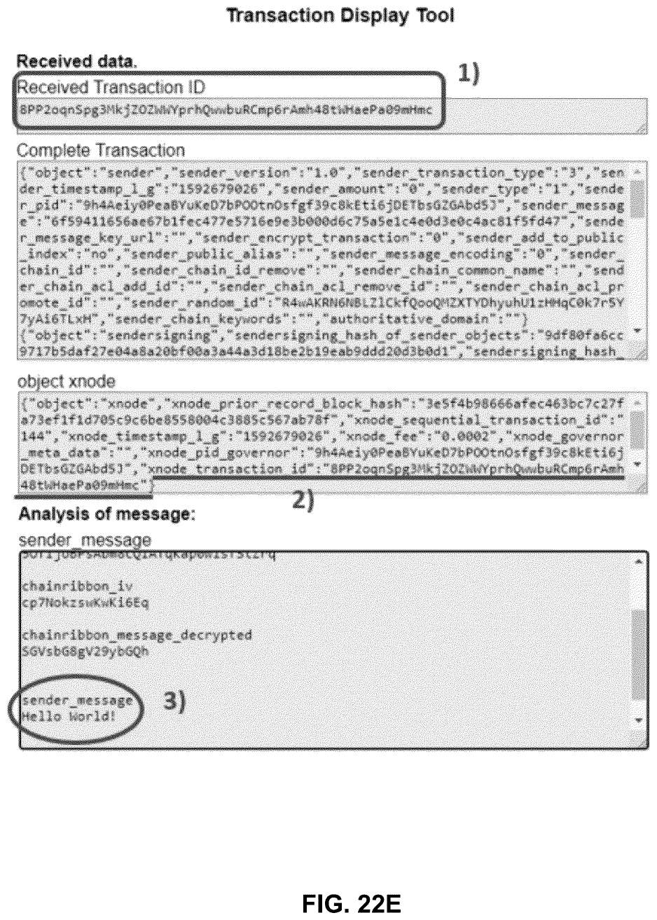

FIG. 22A is a screen image capture of the description of the fields involved that create a transaction from a Transaction form.

FIG. 22B is a screen image capture of the acceptance all the defaults and the entry of a message of “Hello world!”. The “Transaction Type” defaults to “3: Basic Transaction”.

FIG. 22C is a screen image capture of the acceptance of “Go” on the Transaction form which is followed by a displayed “Success” message. There is no need to copy this information as it is permanently stored in the trx_sys ledger.

FIG. 22D is a screen image capture of the “My Transactions” page which lists the transaction id's that have been sent or received for that particular account.

FIG. 22E is a screen image capture of the “Transaction Display Tool” page which lists the transaction id's that have been sent or received.

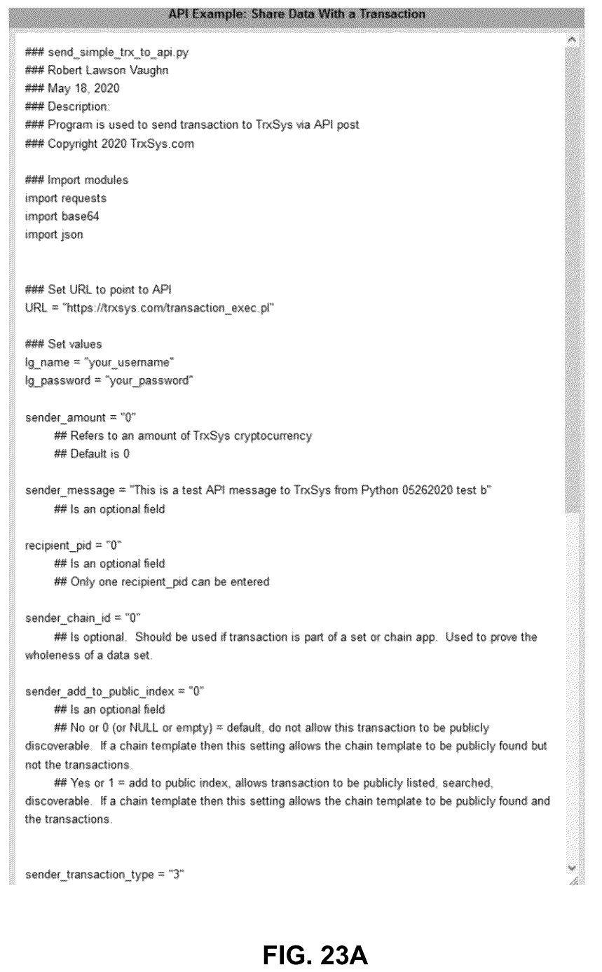

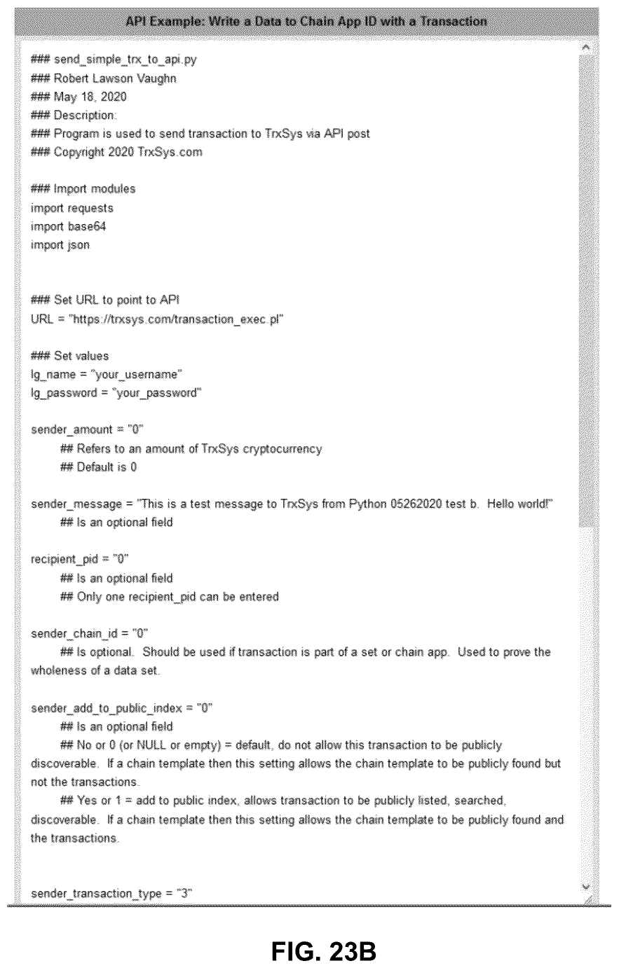

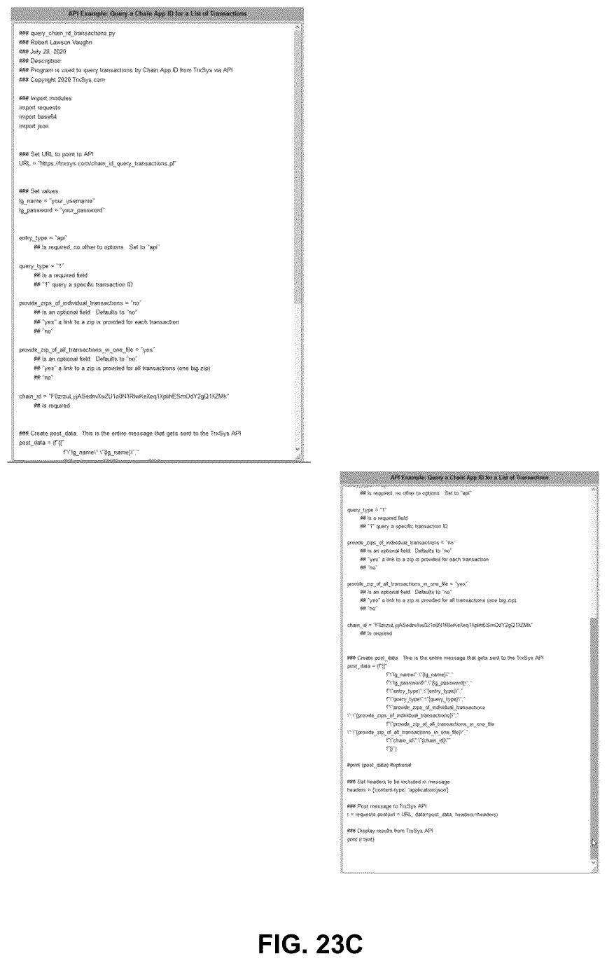

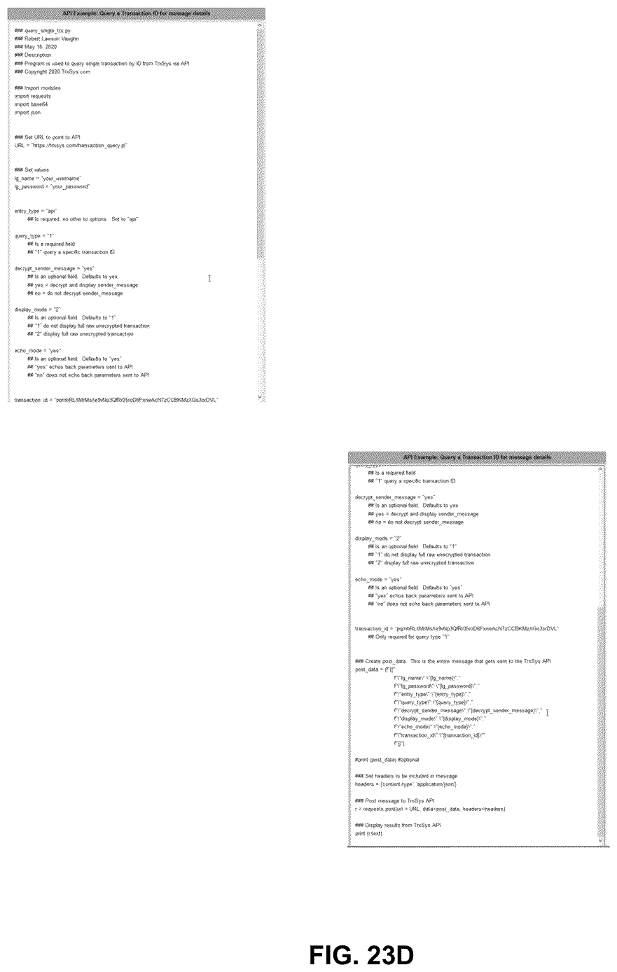

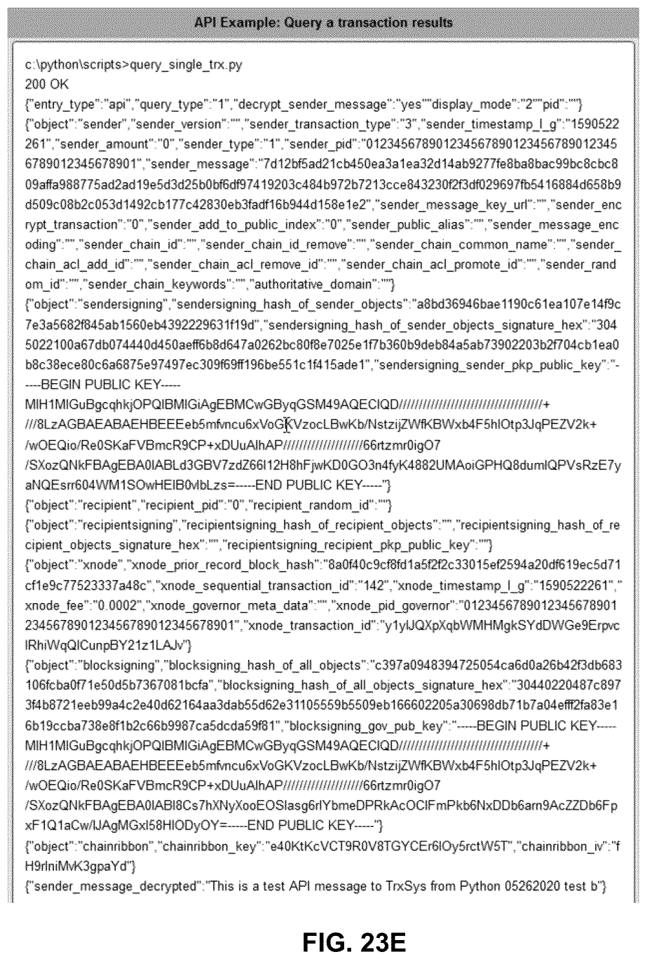

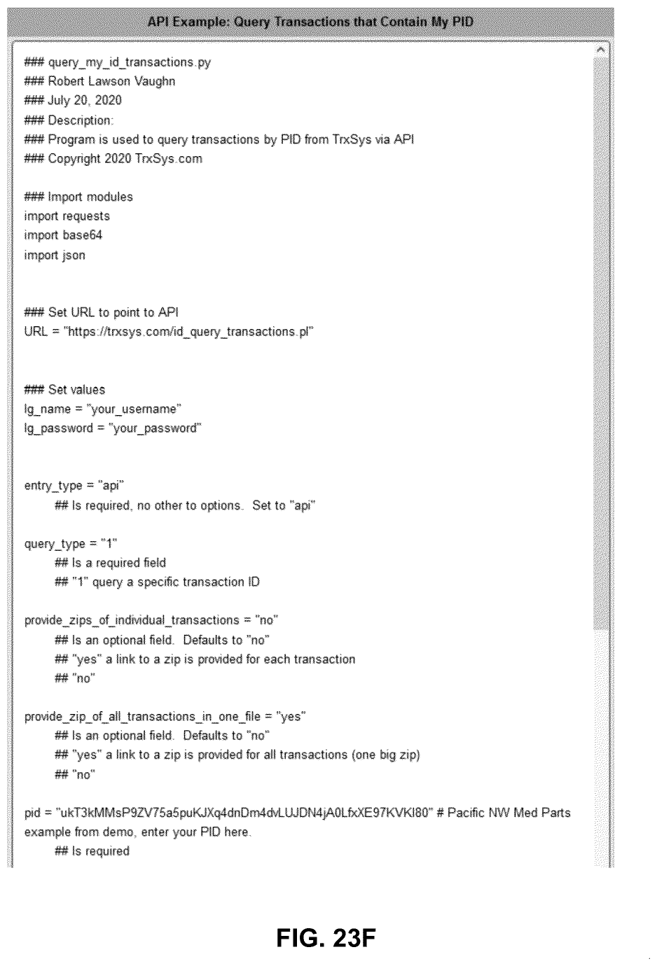

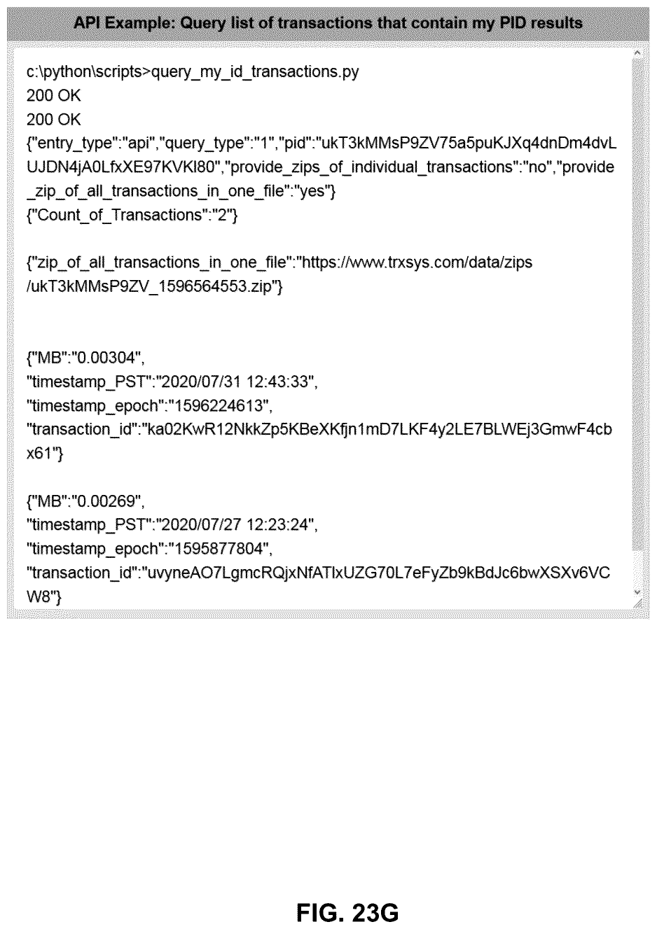

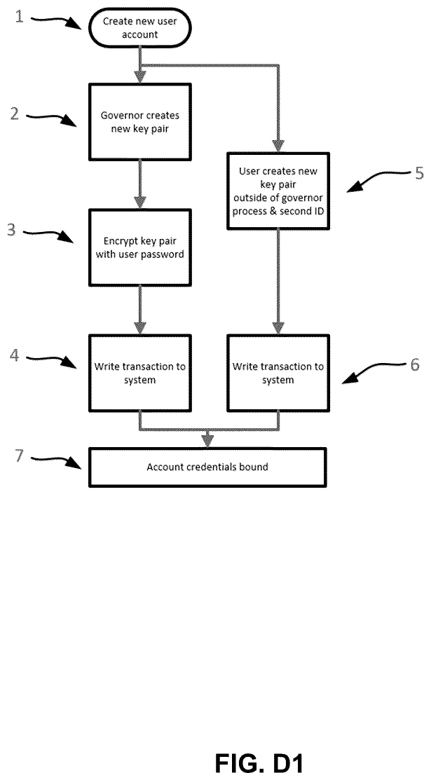

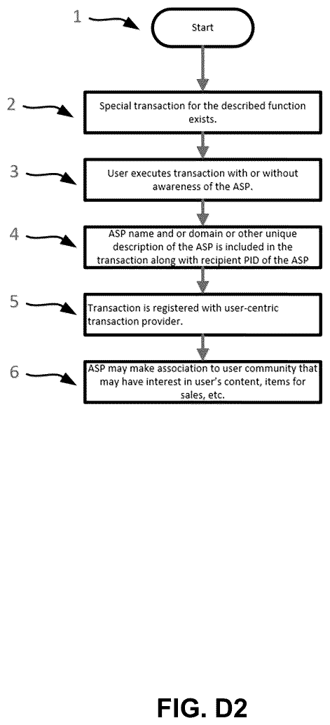

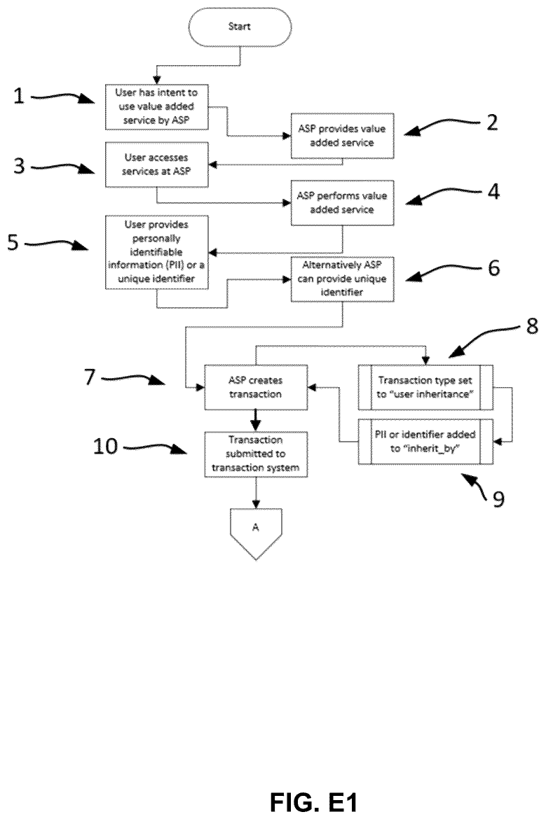

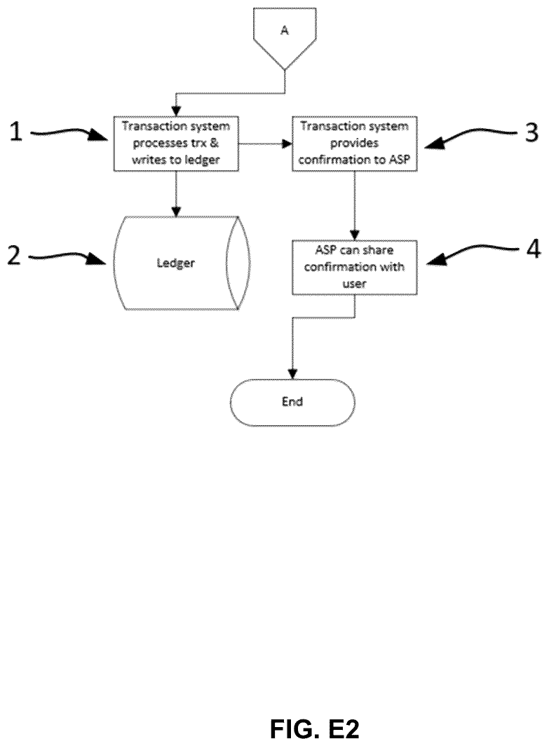

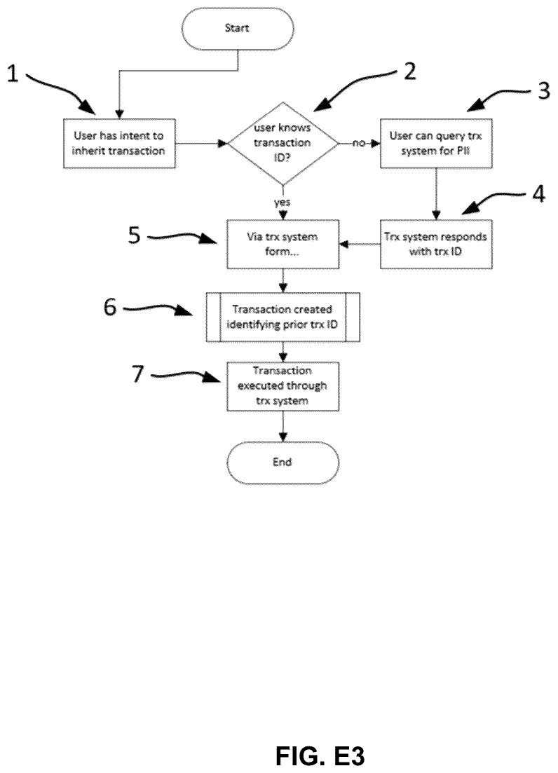

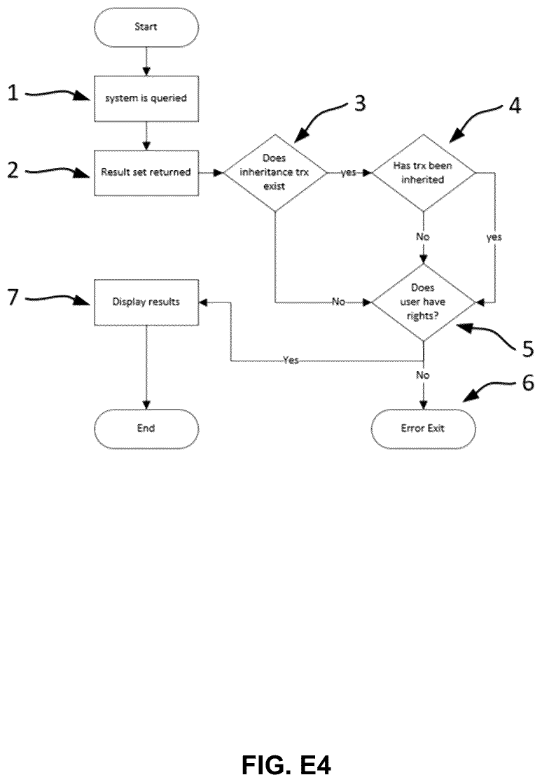

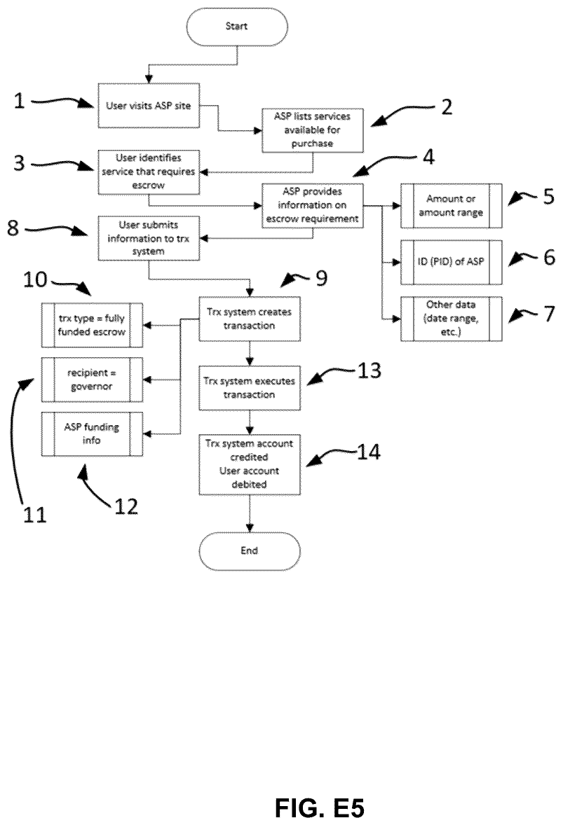

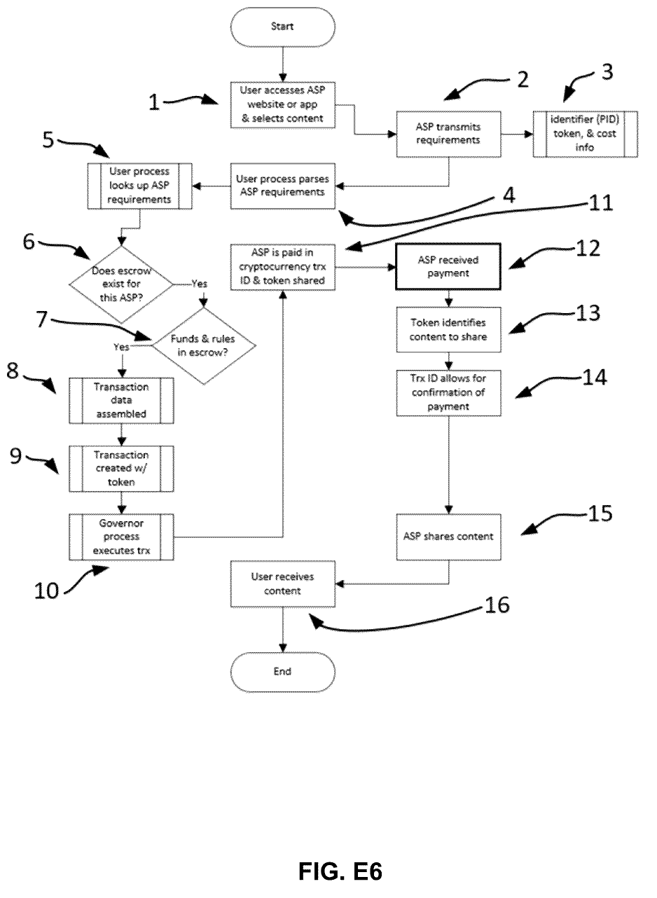

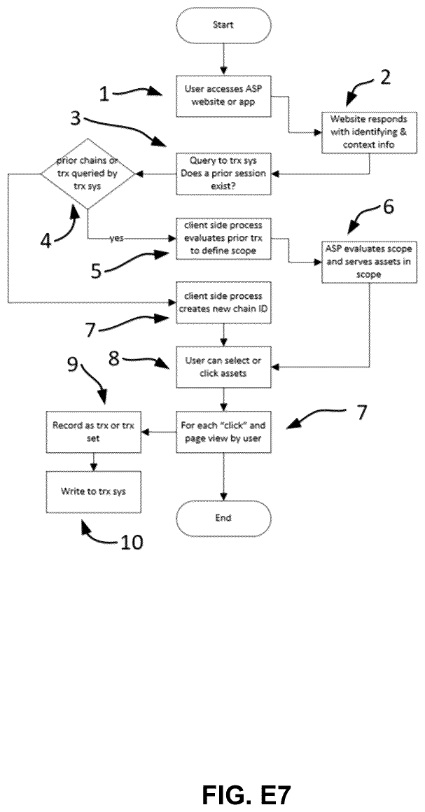

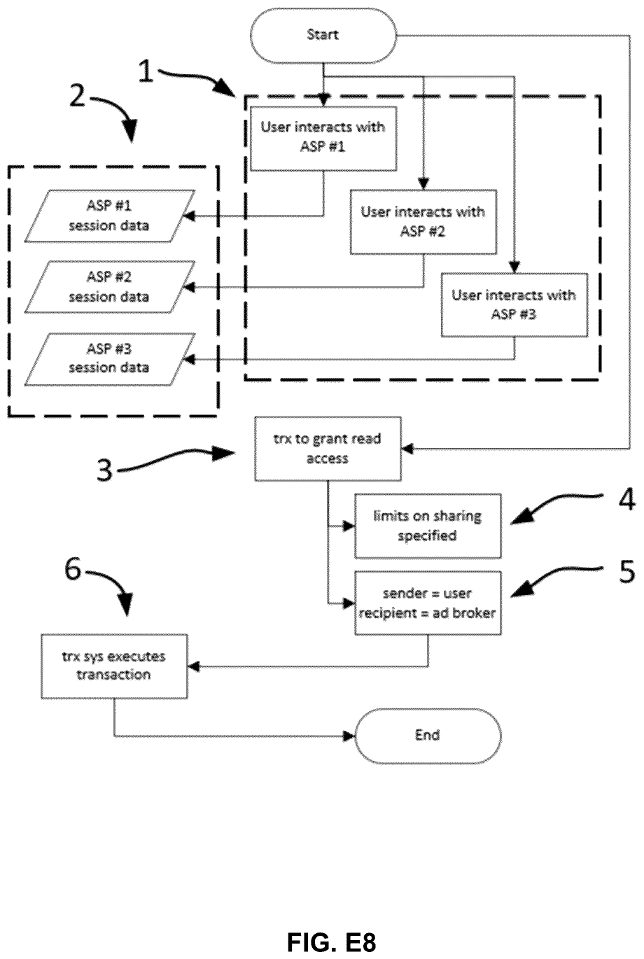

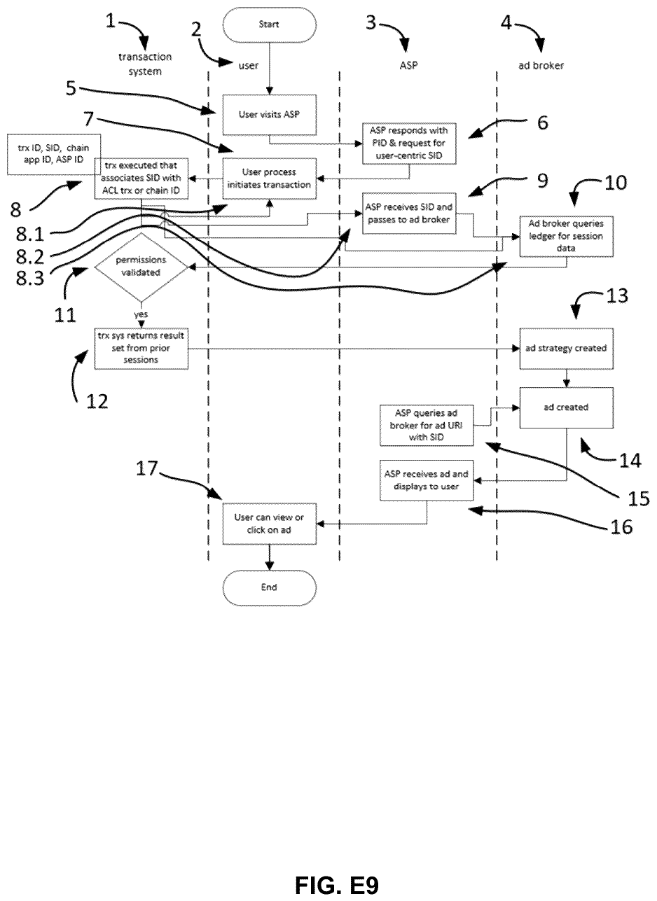

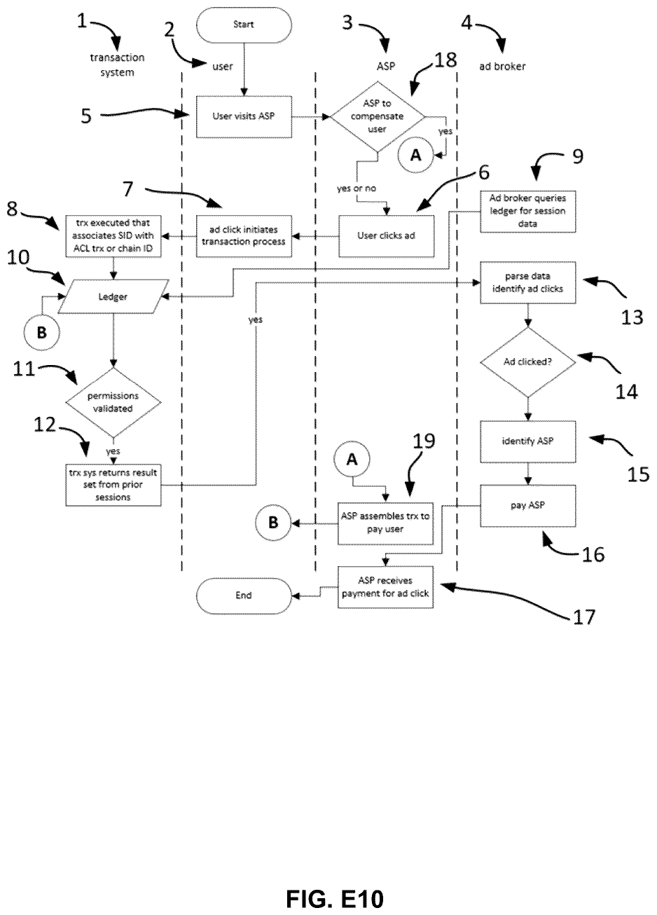

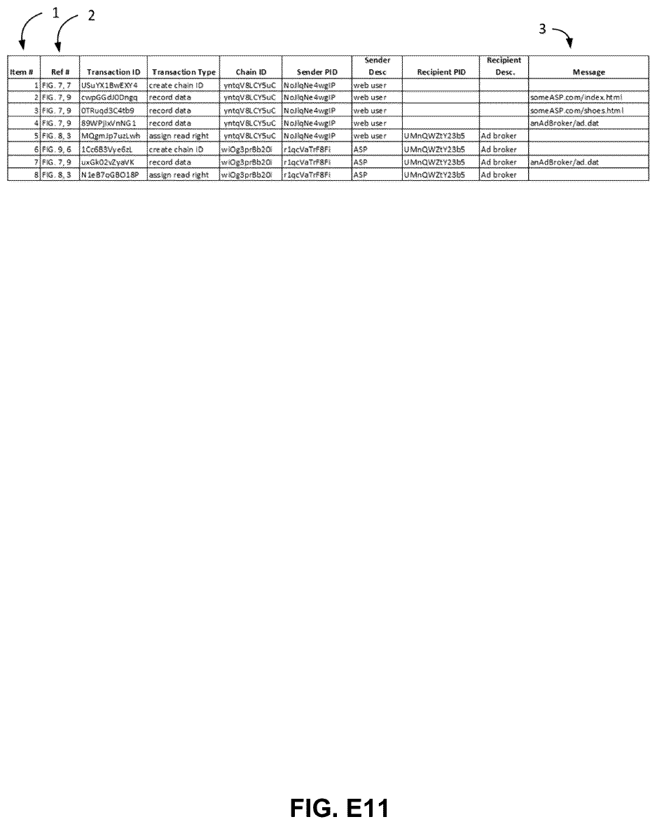

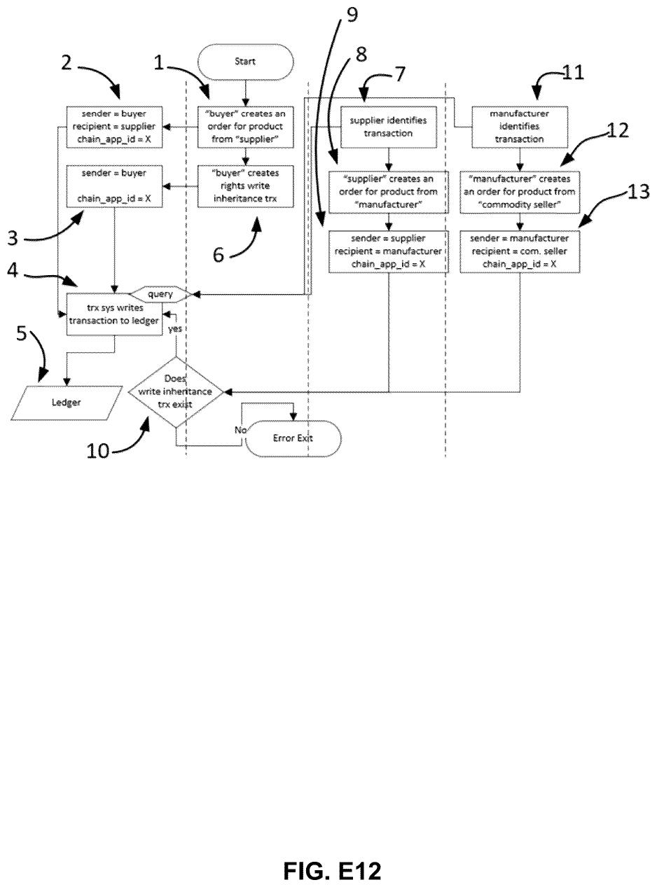

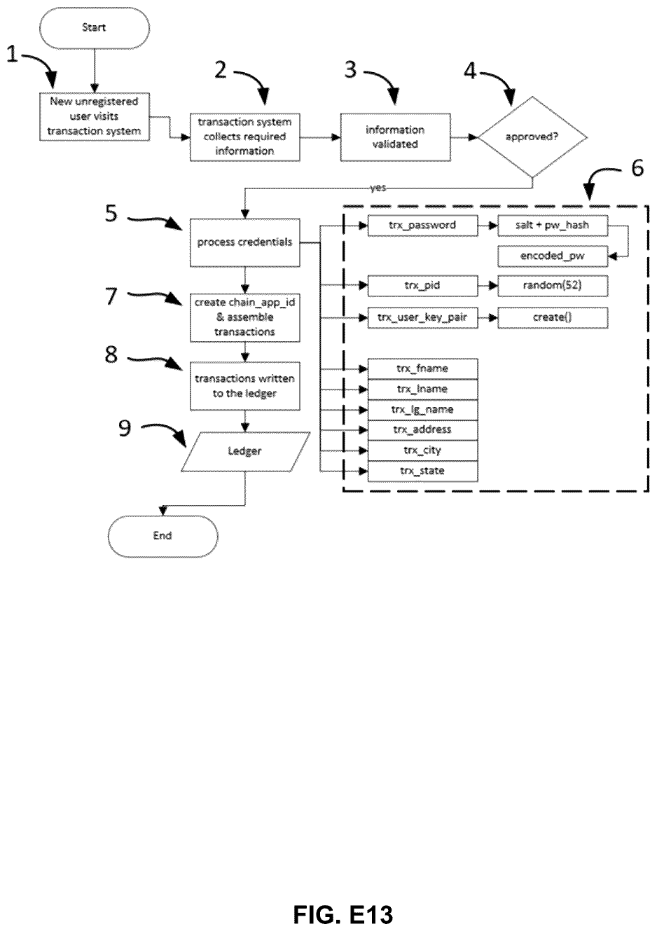

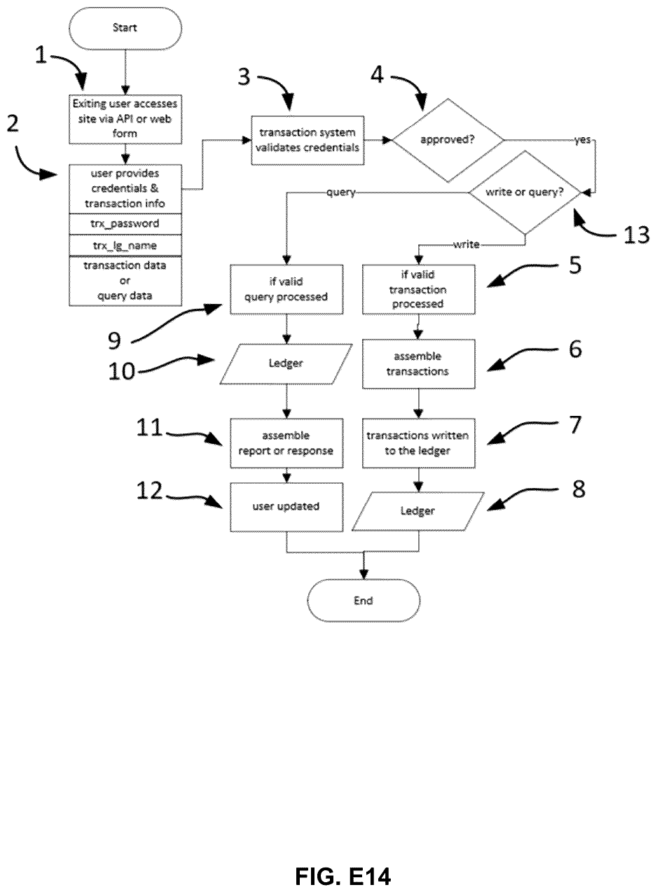

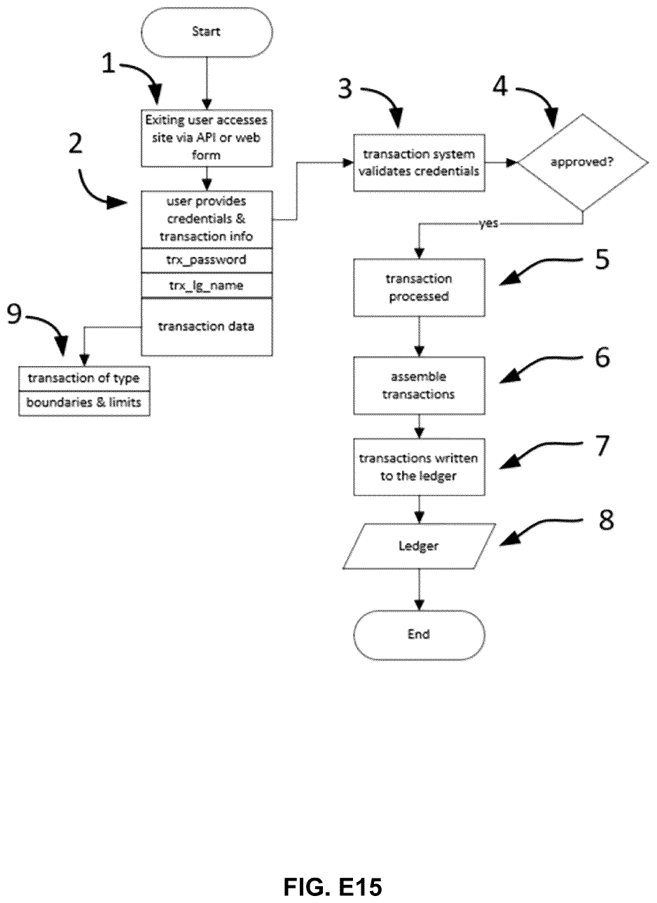

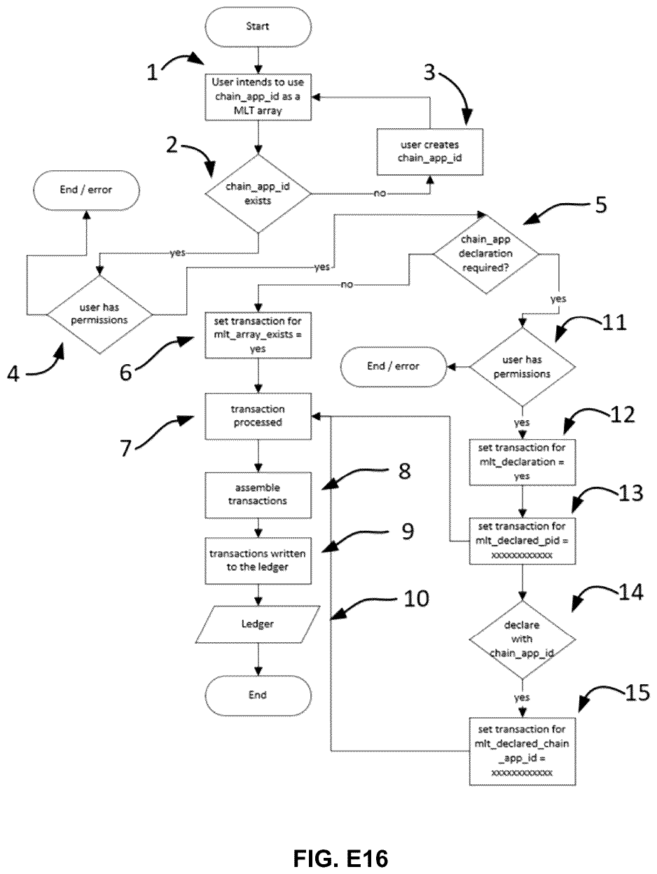

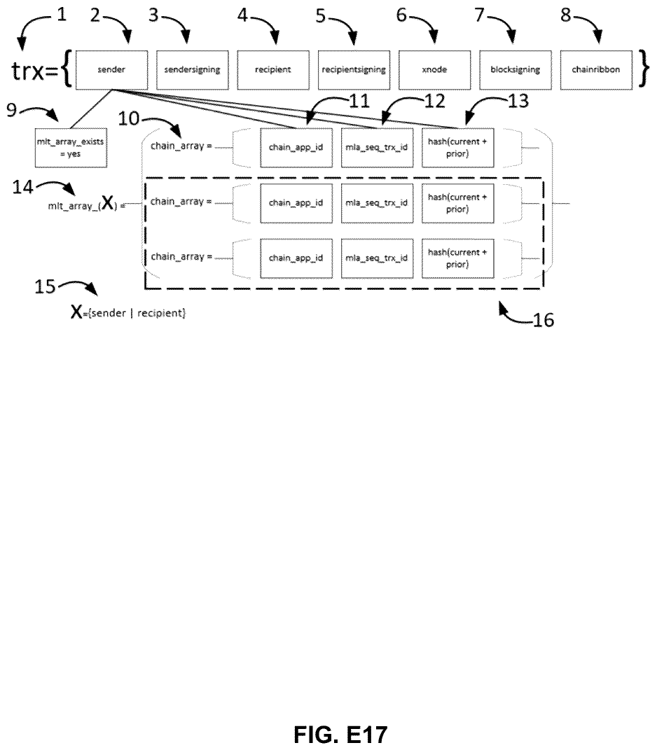

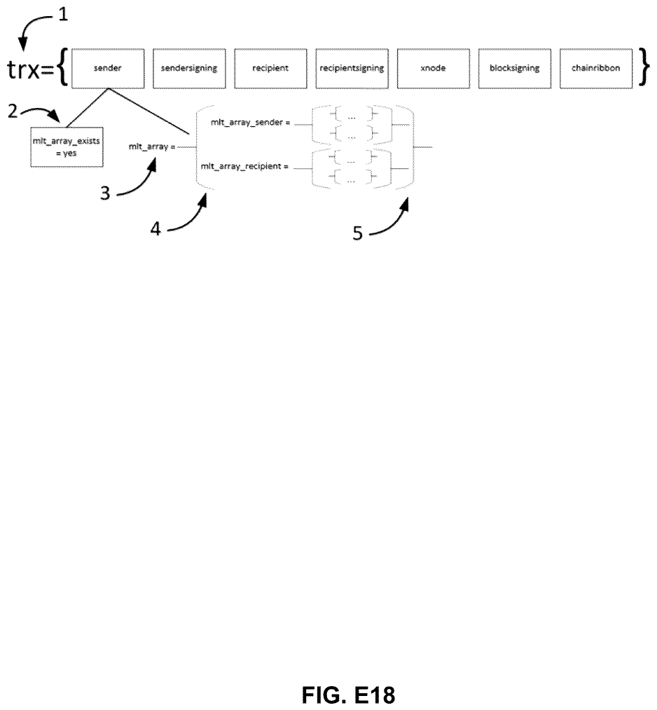

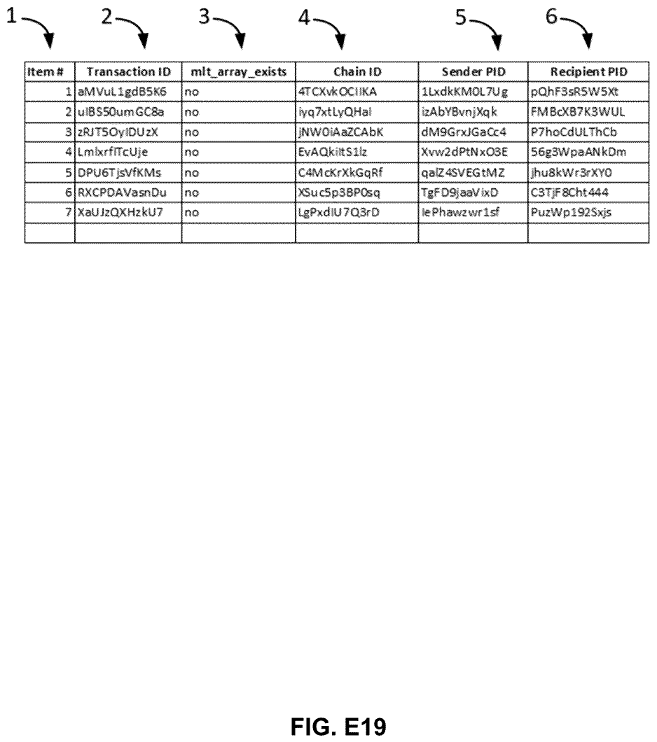

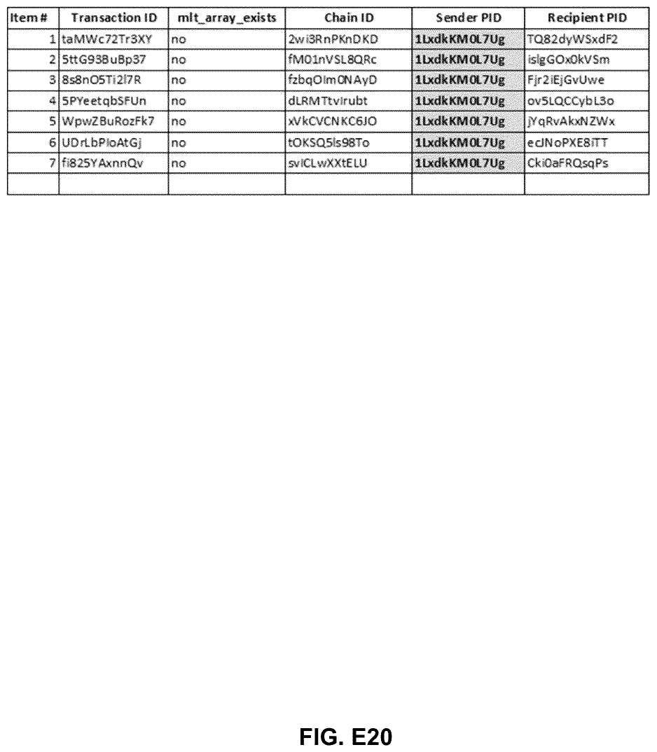

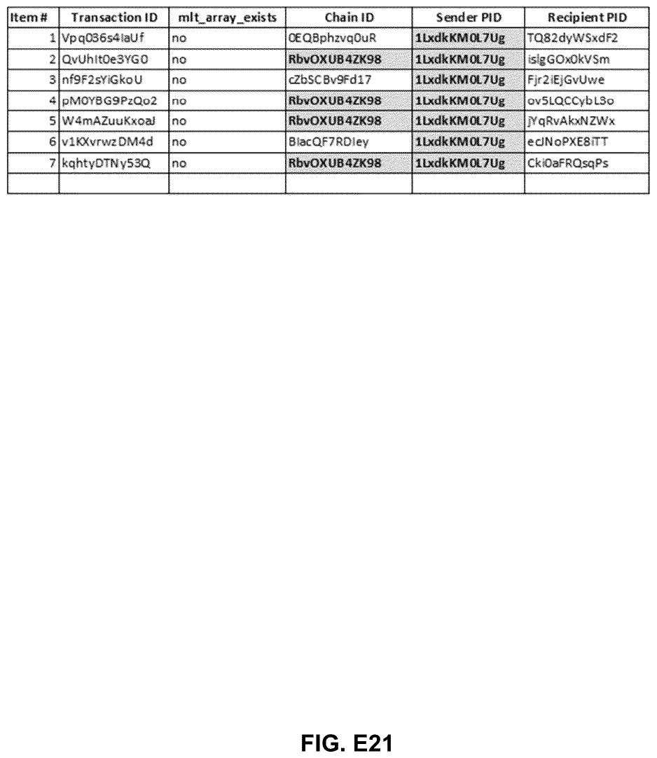

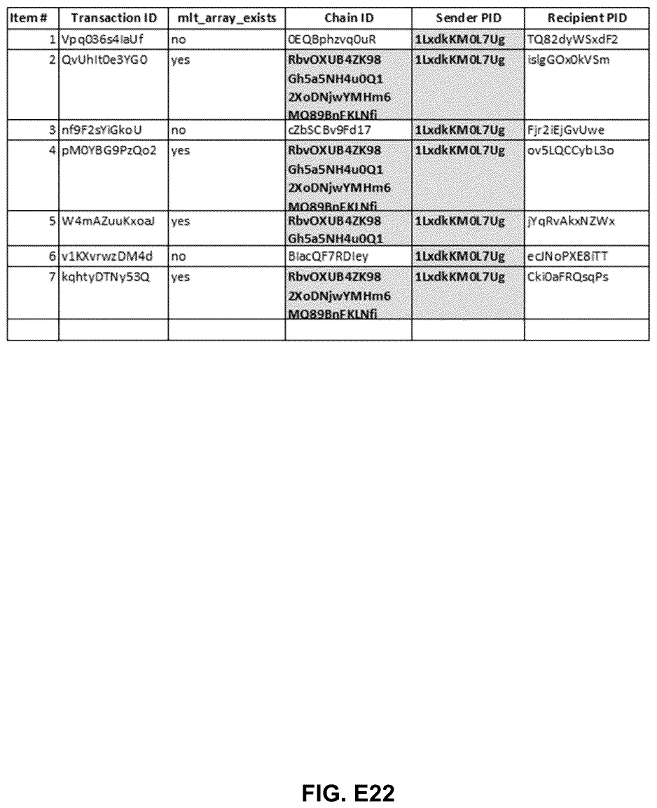

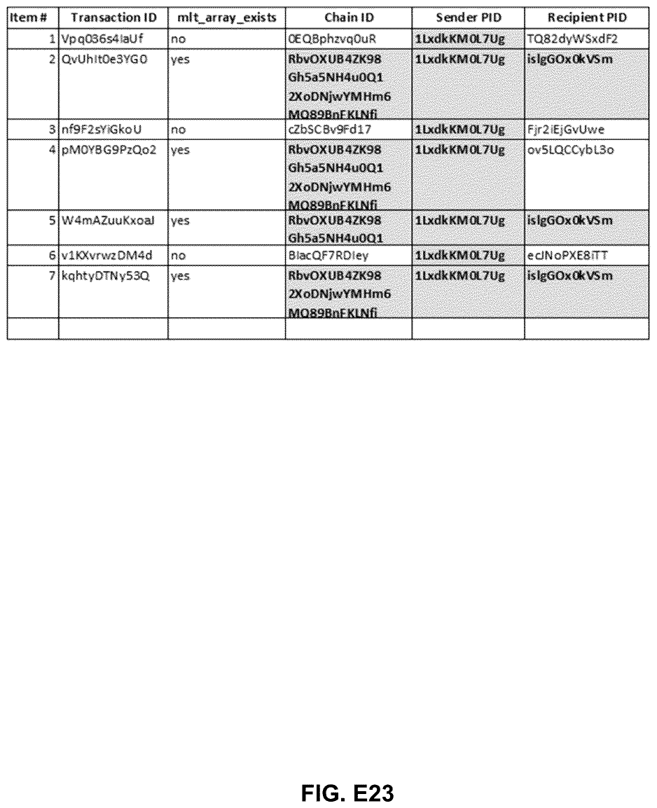

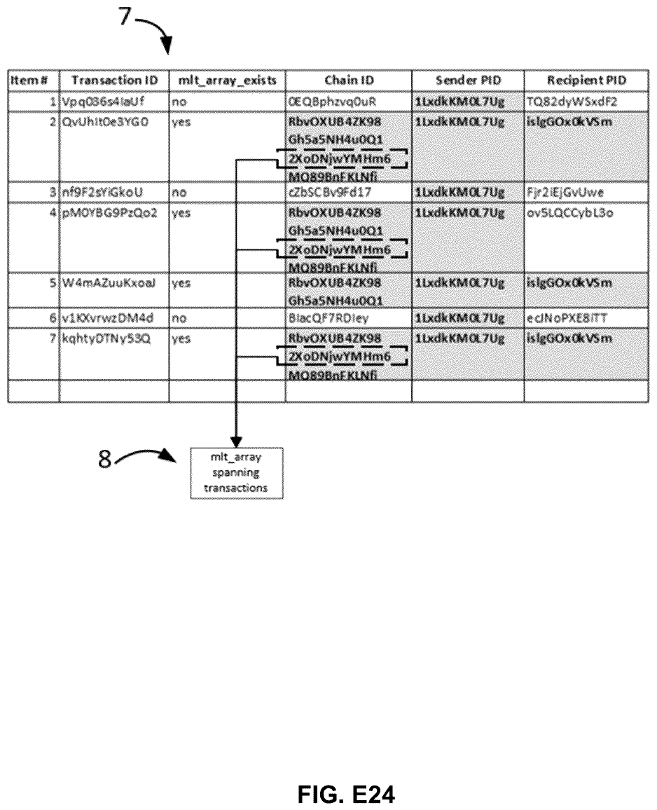

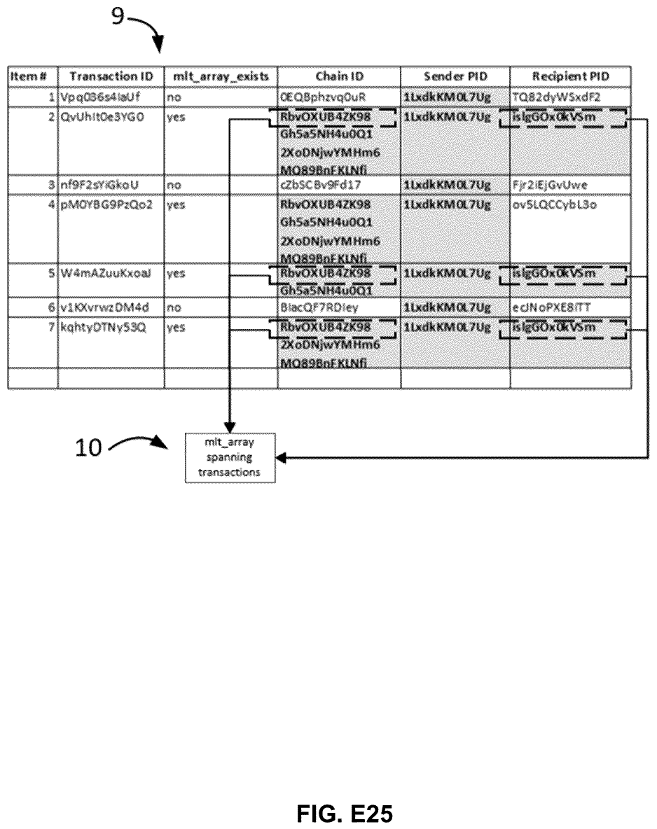

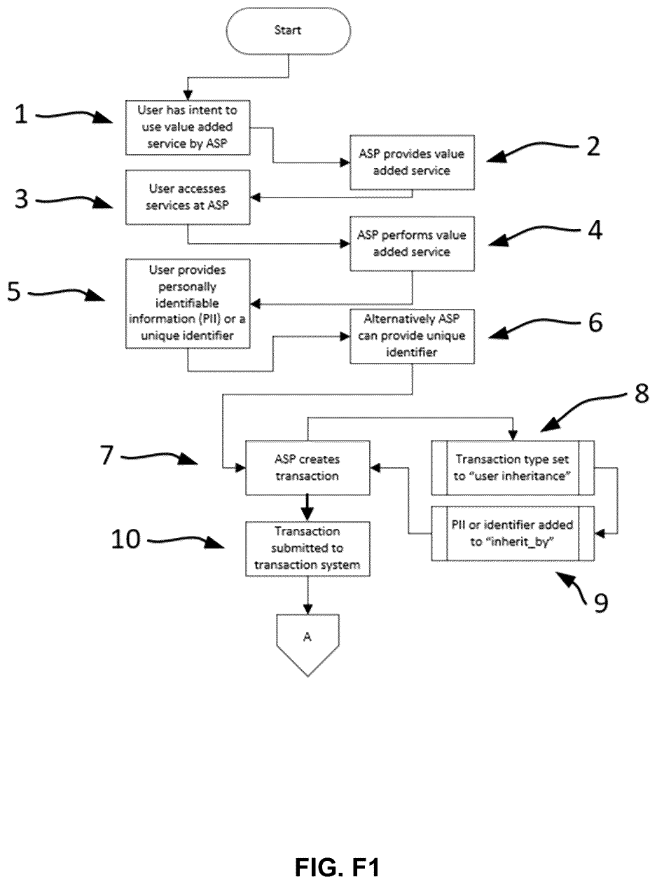

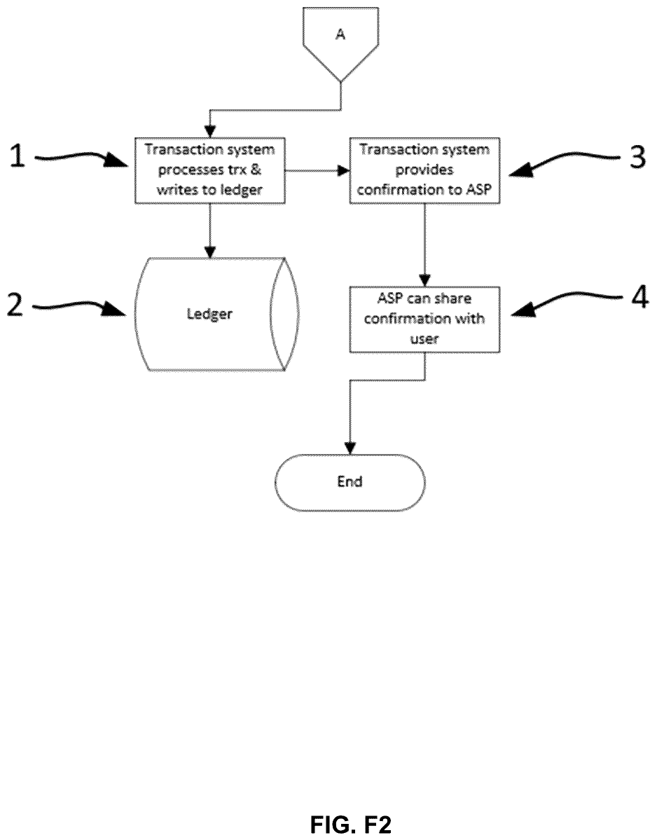

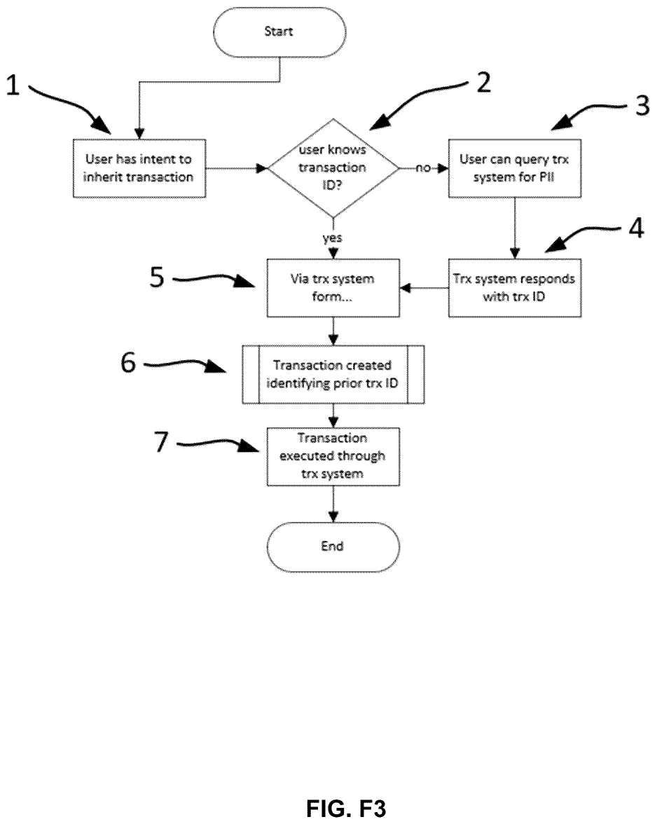

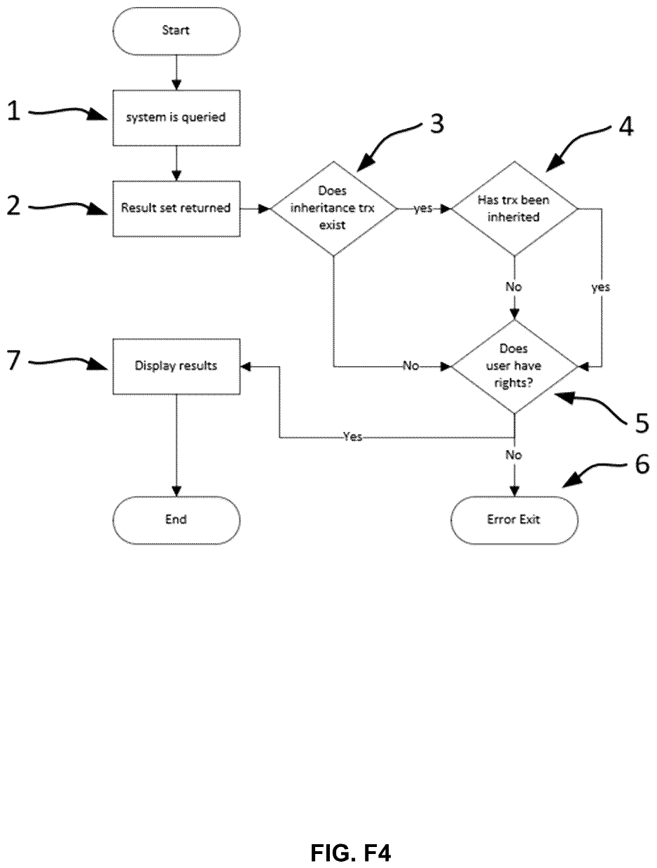

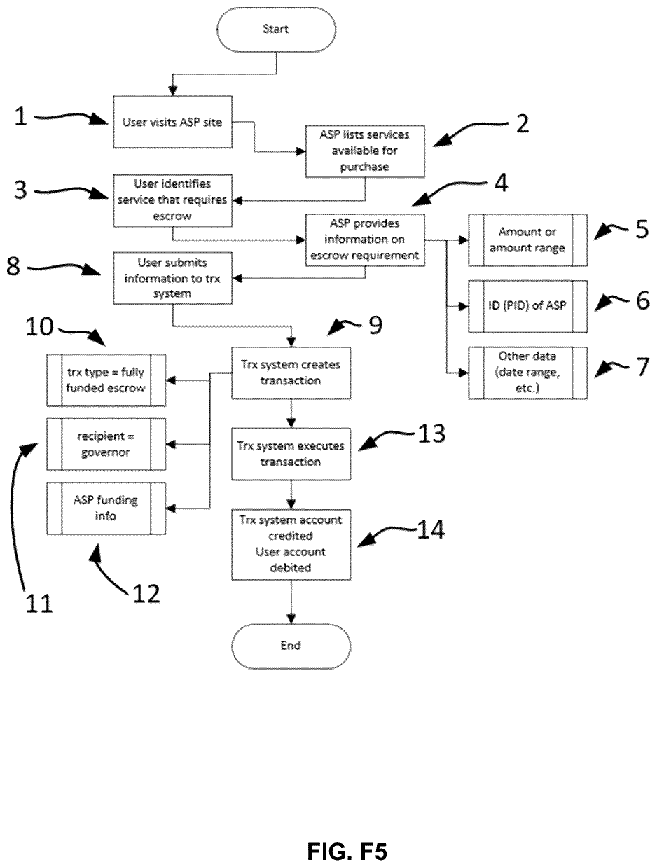

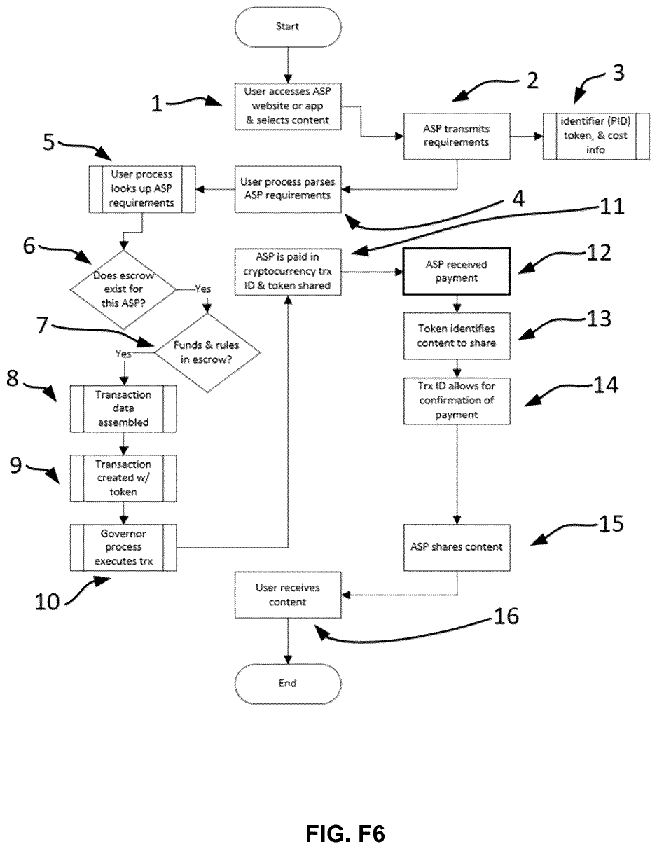

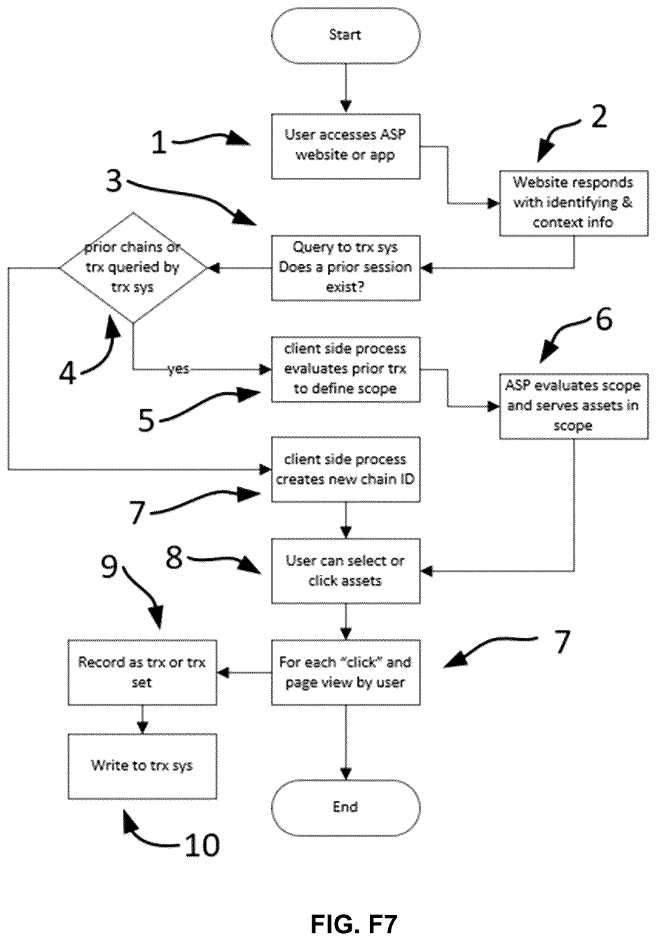

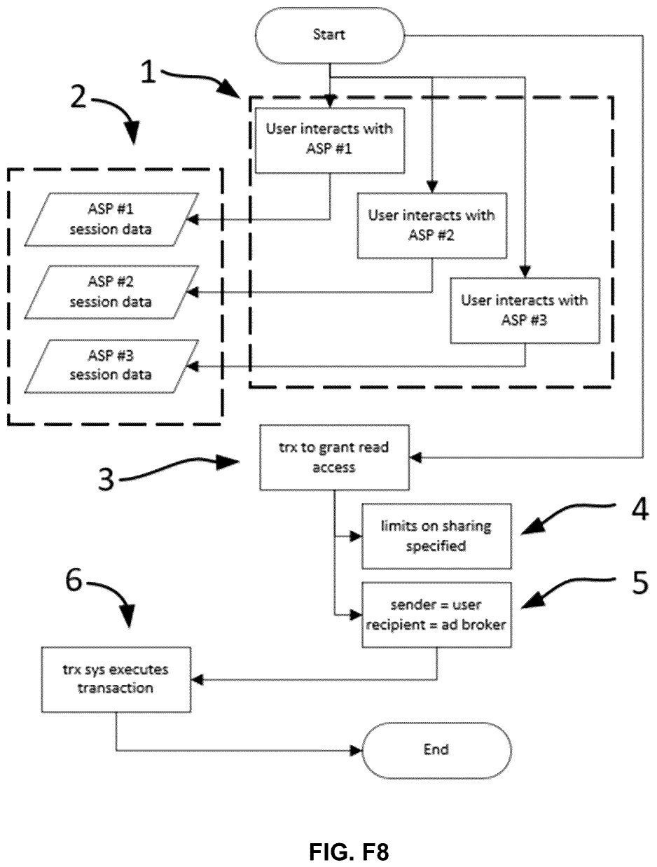

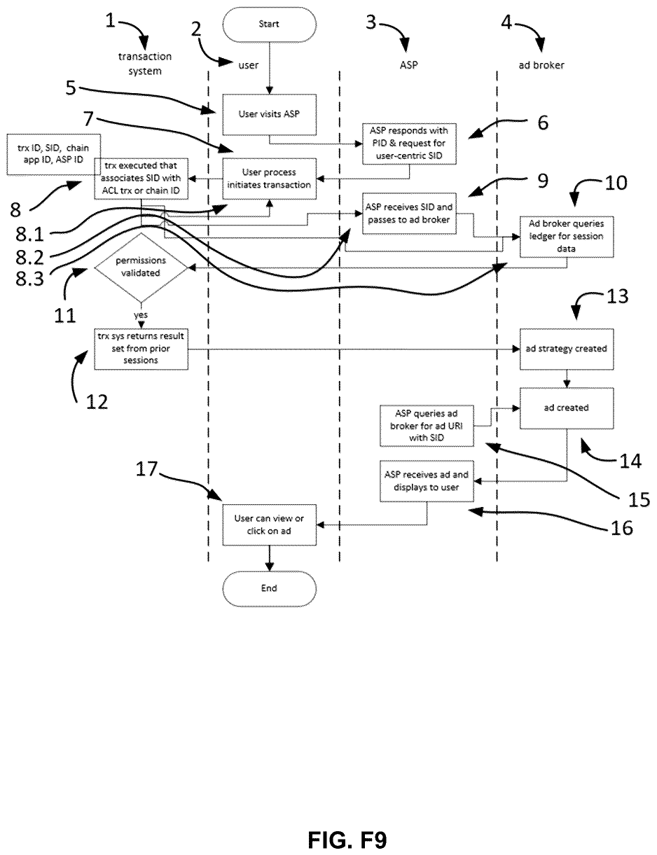

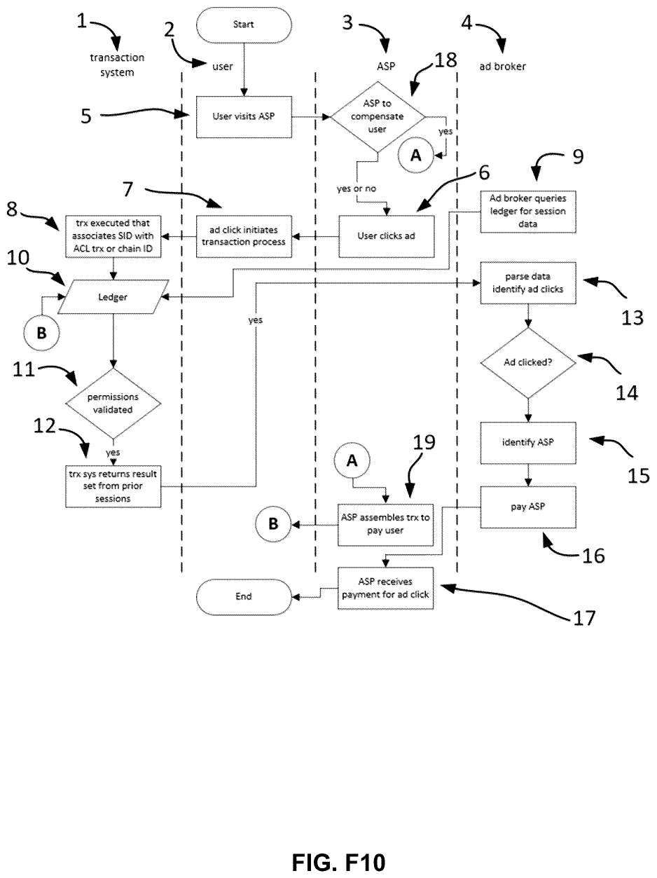

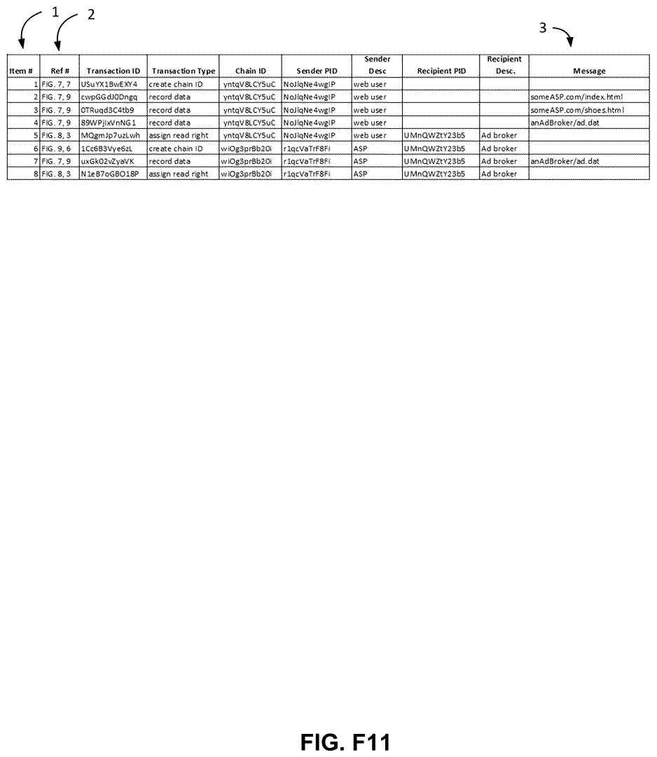

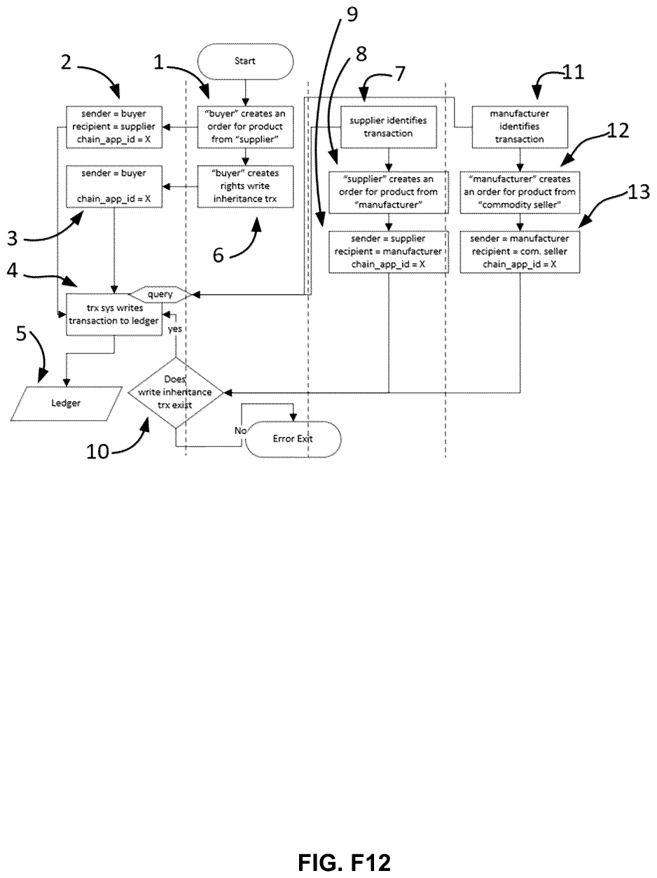

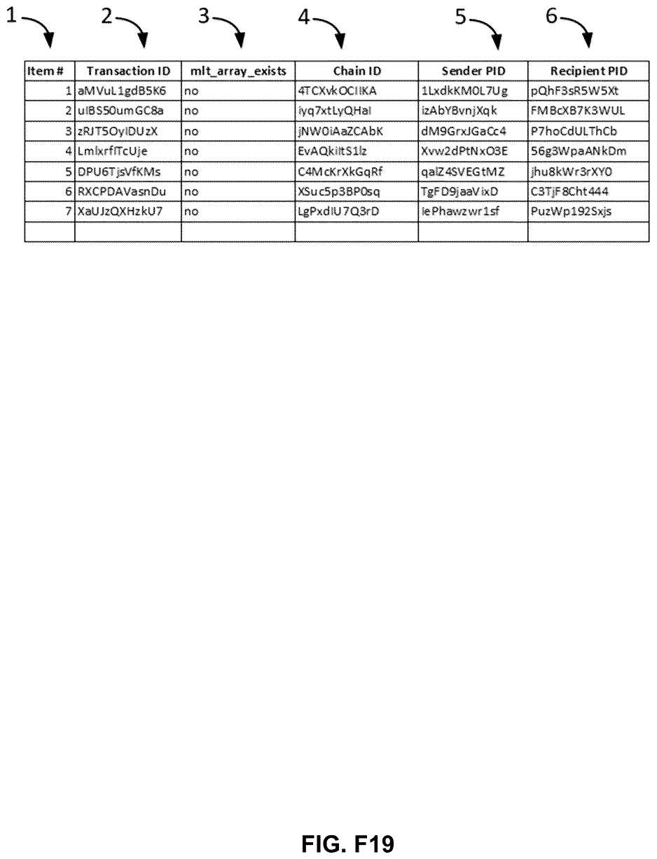

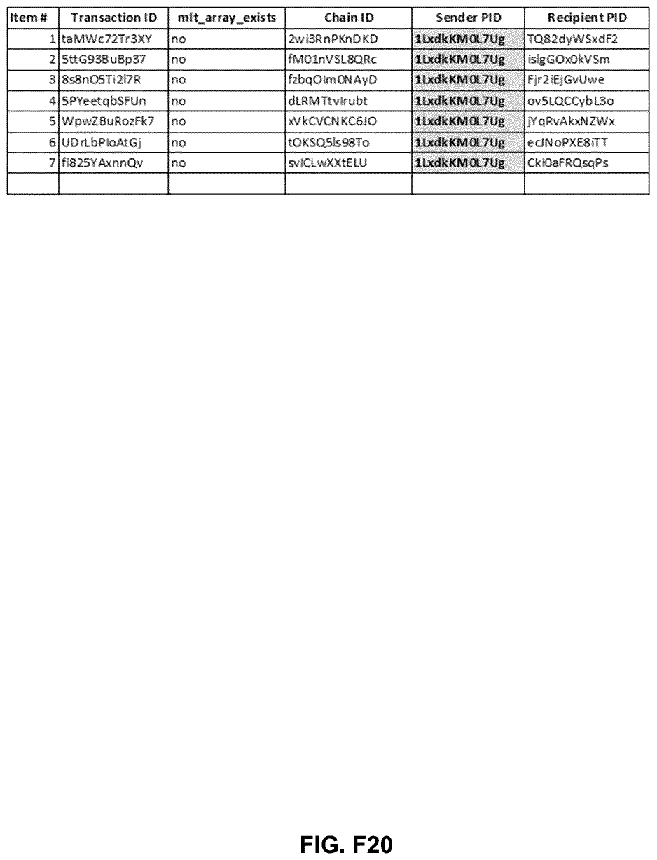

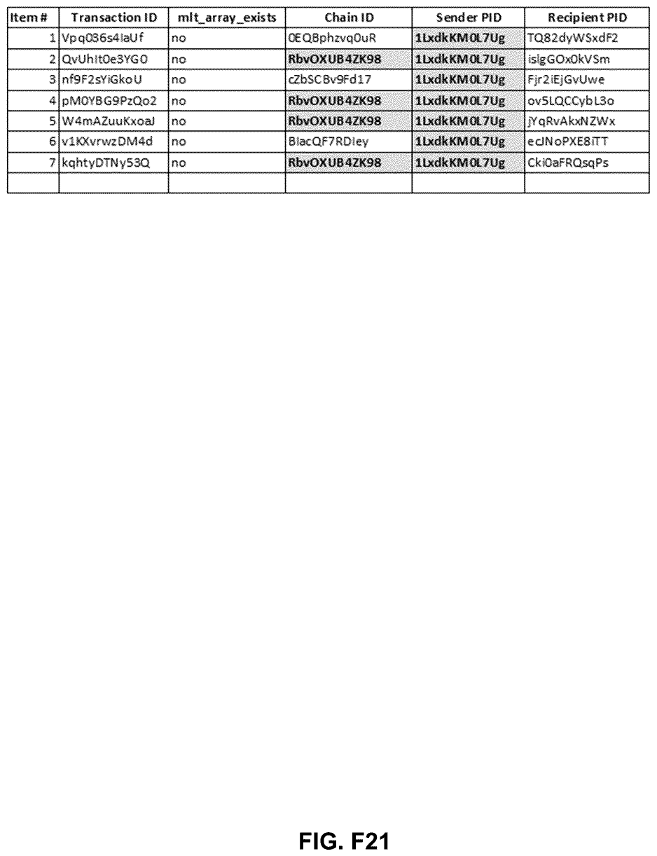

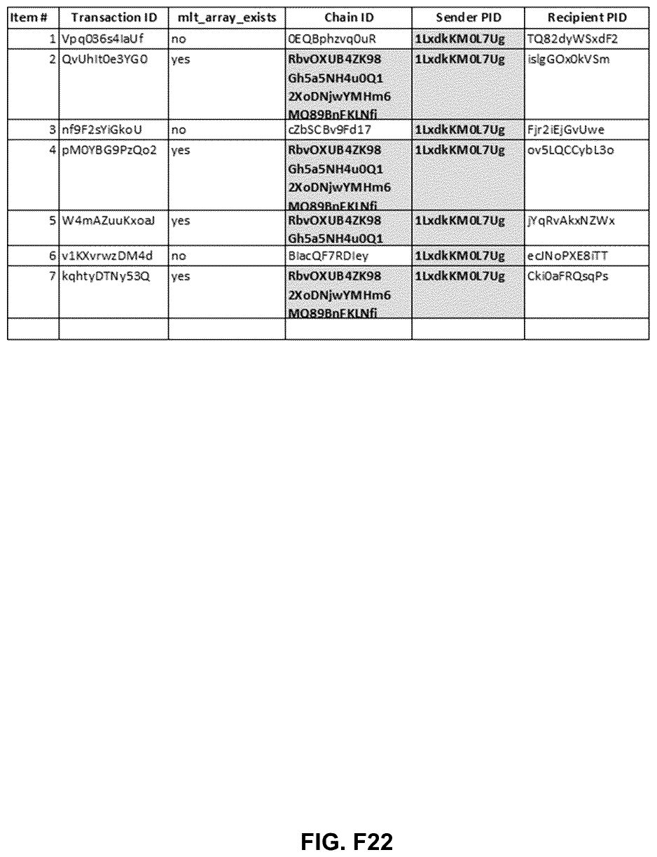

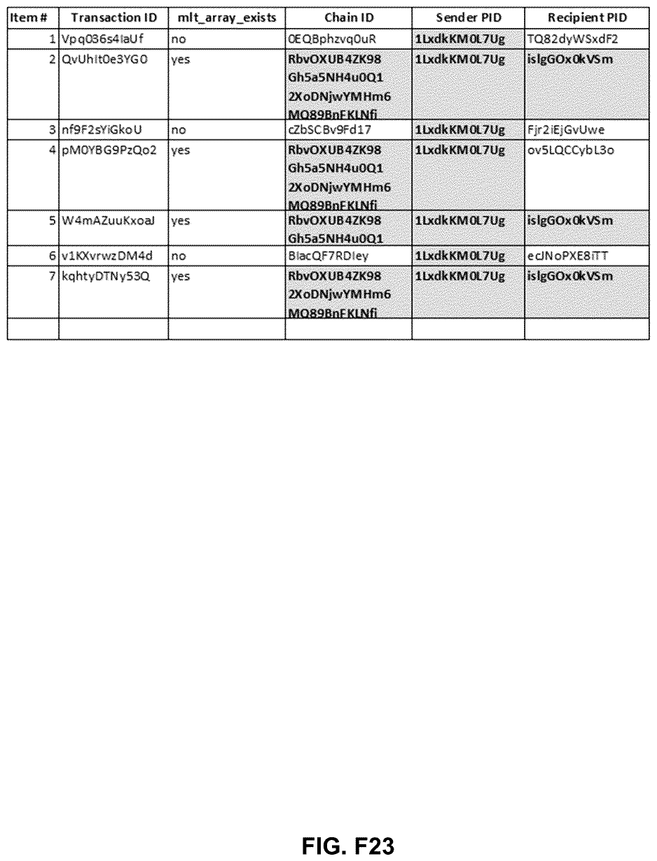

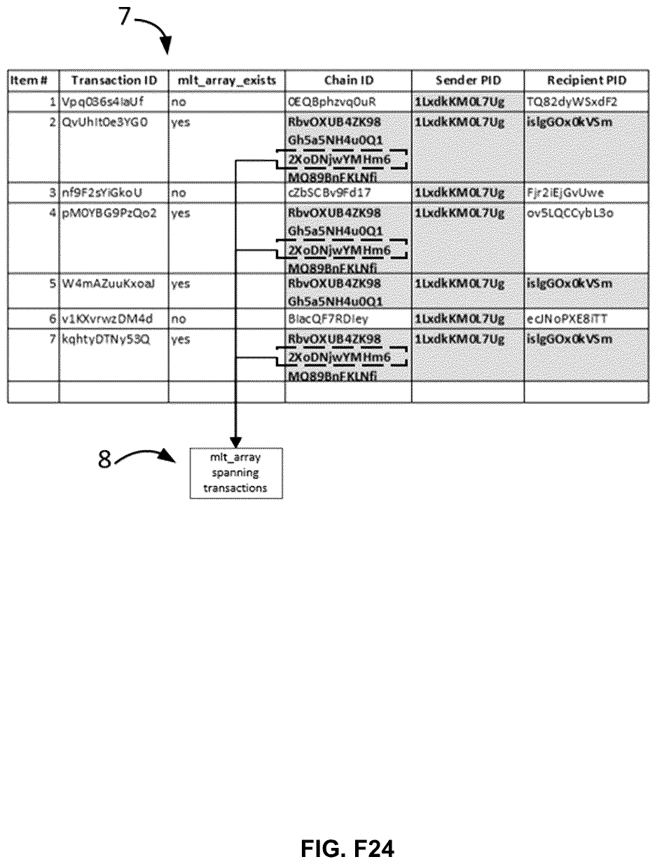

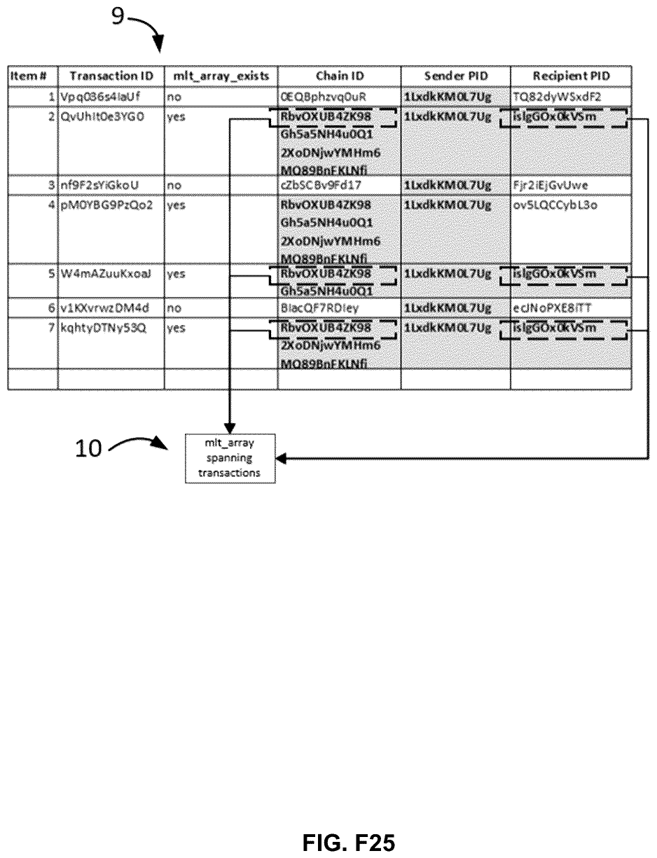

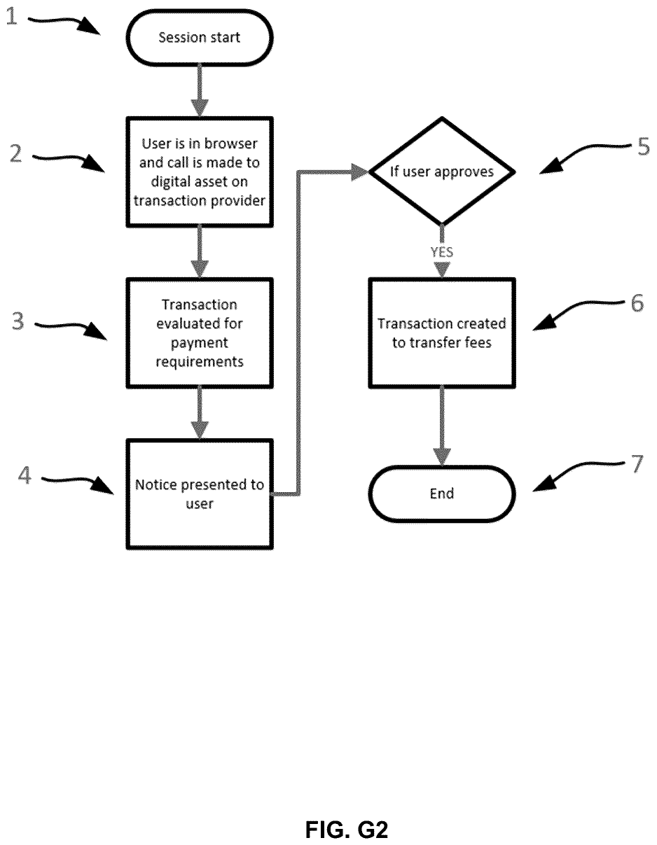

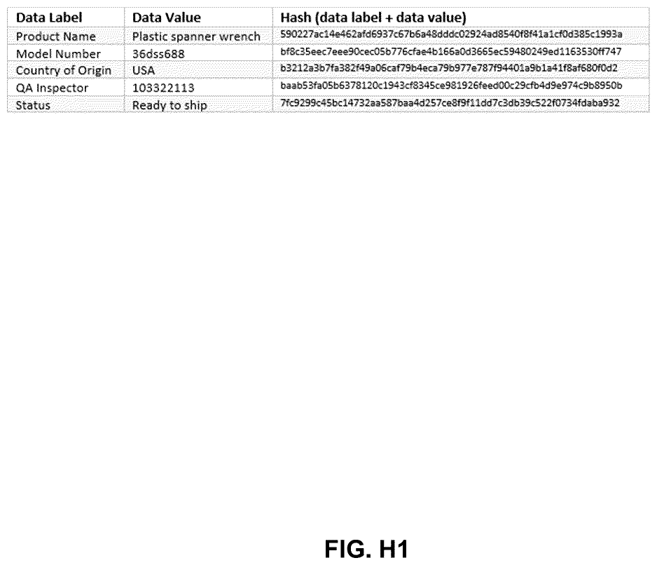

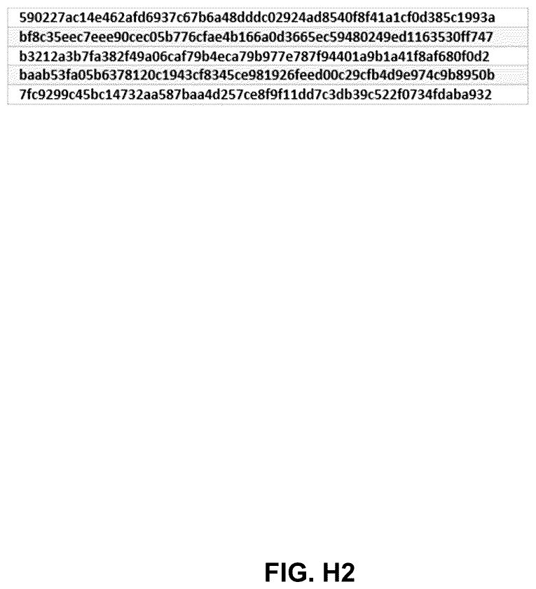

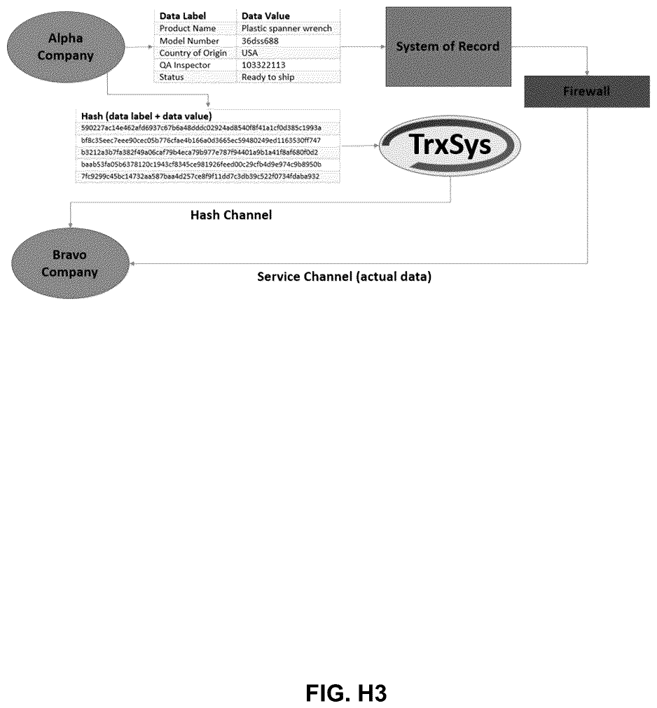

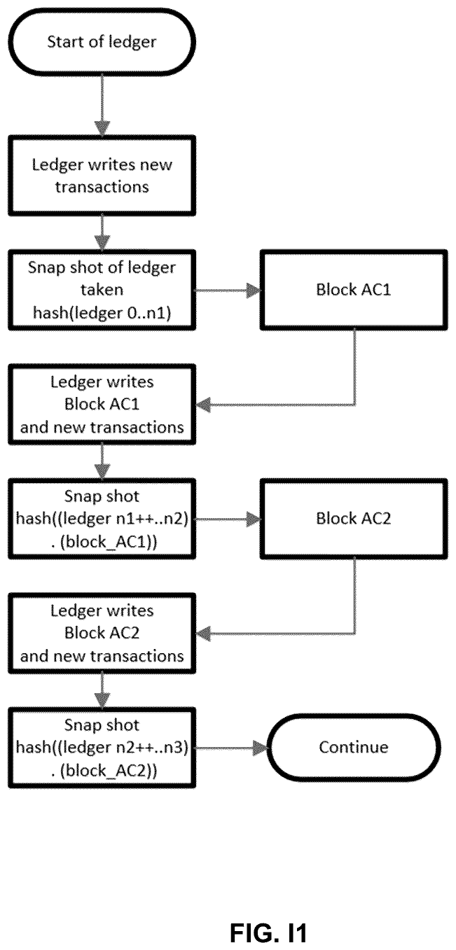

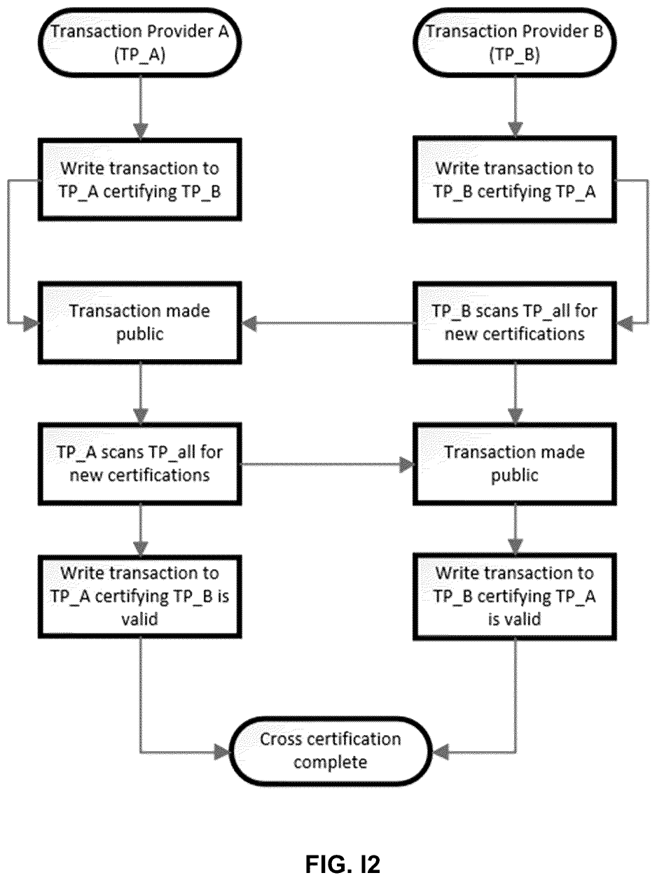

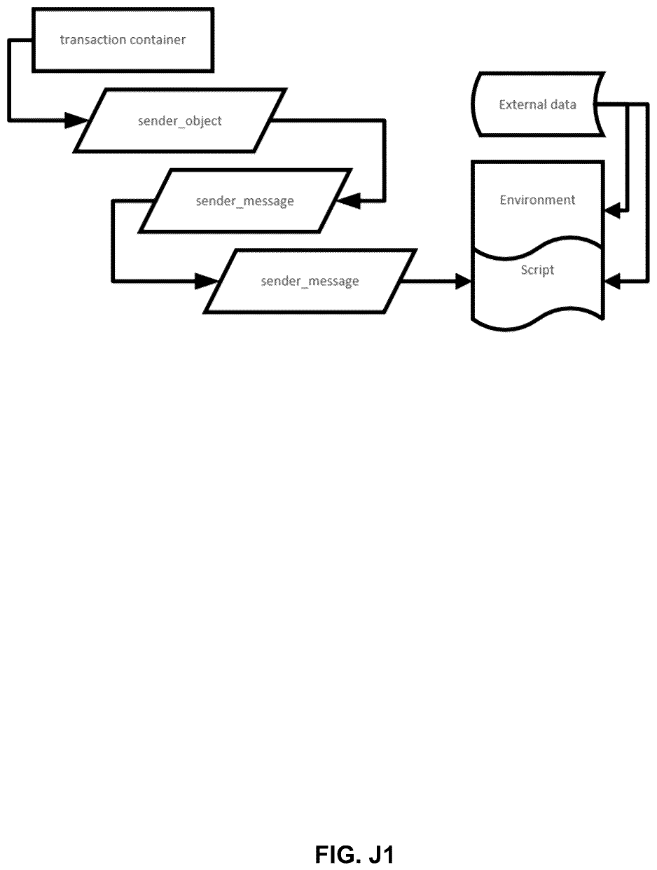

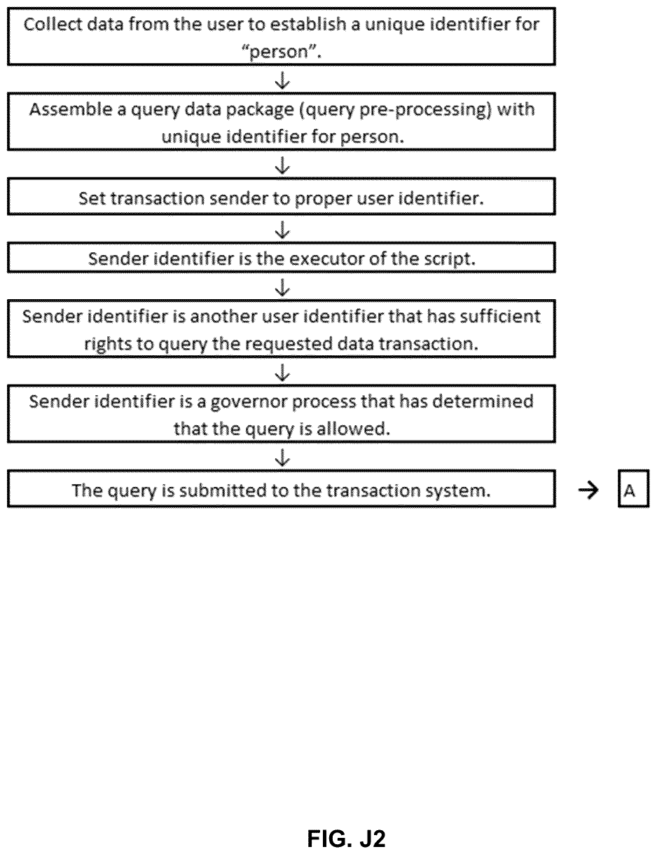

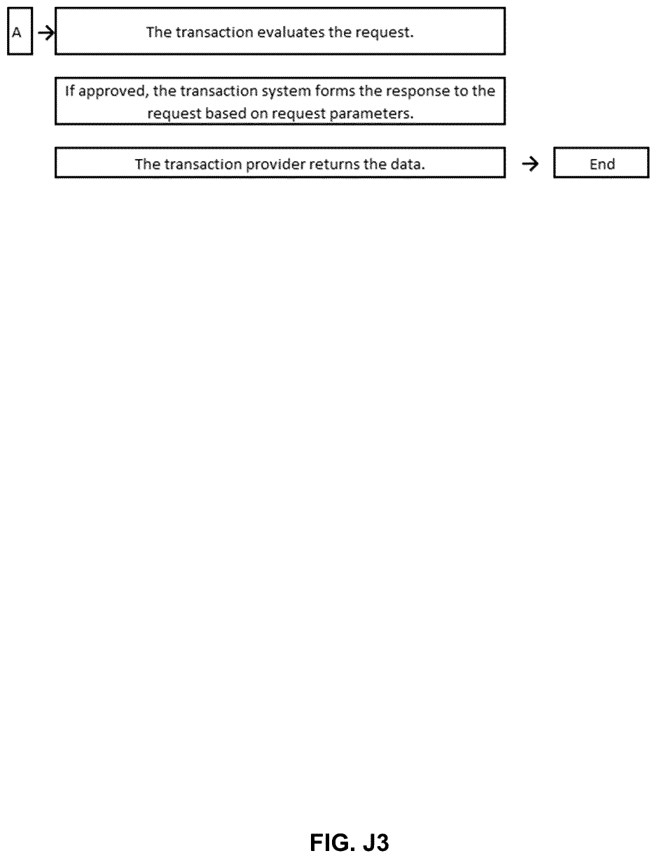

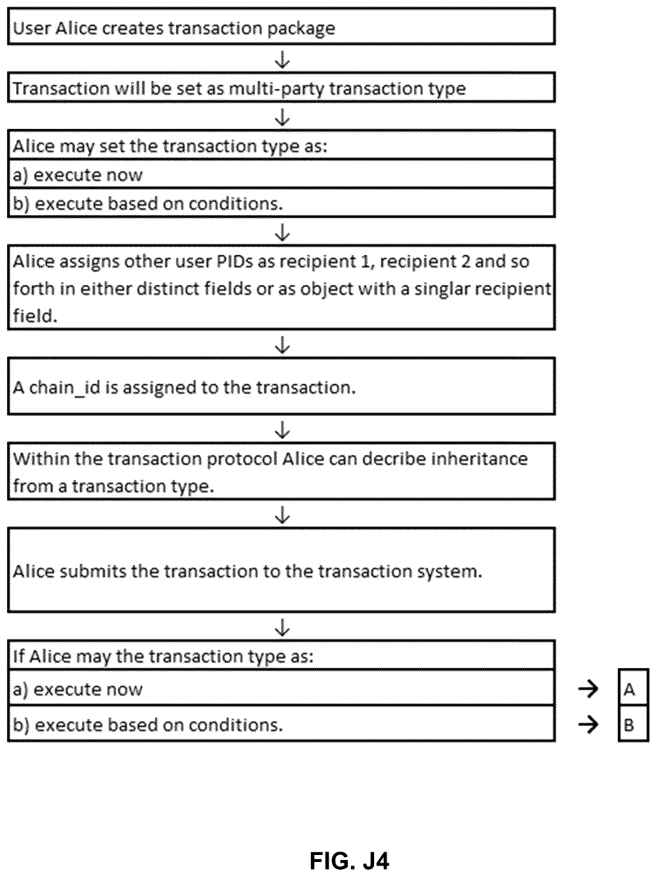

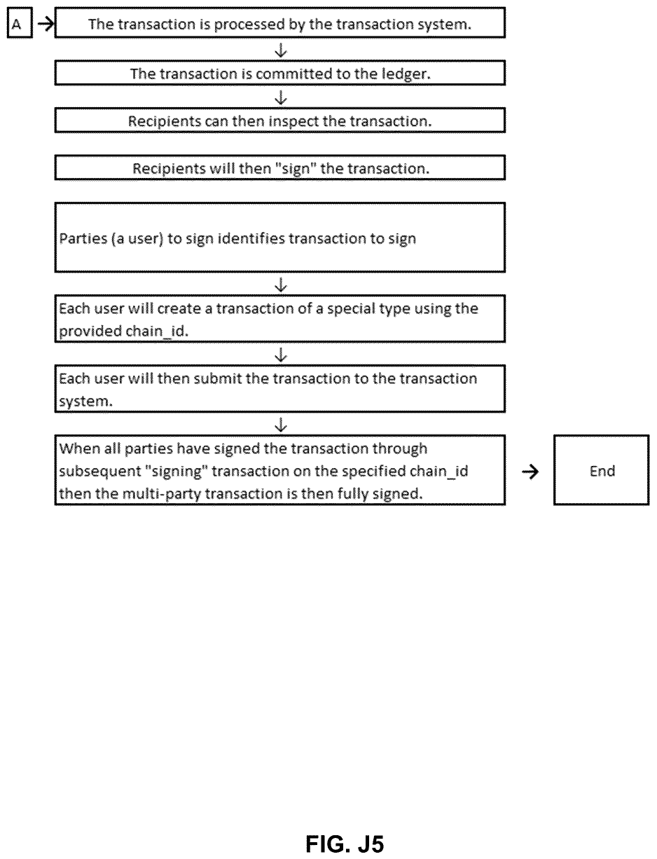

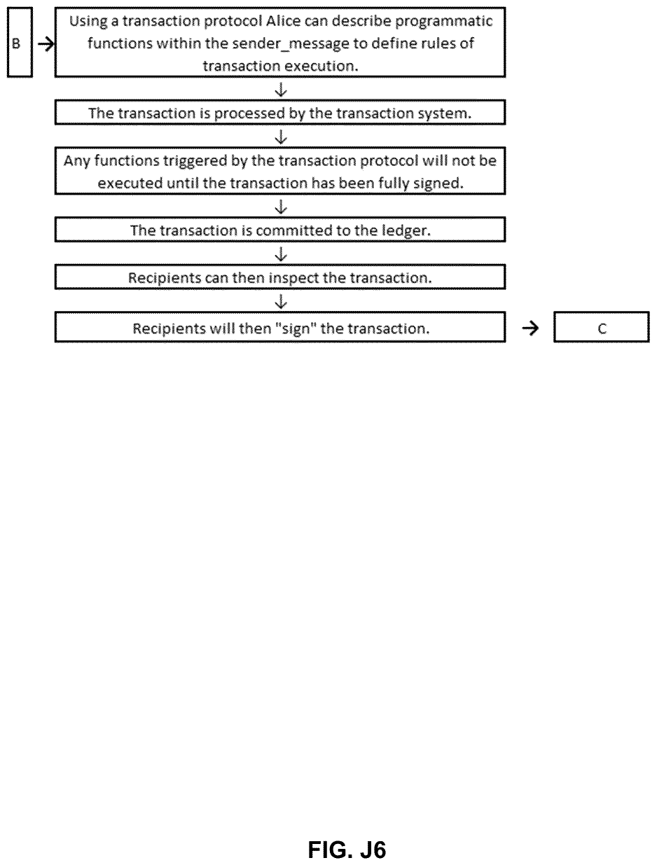

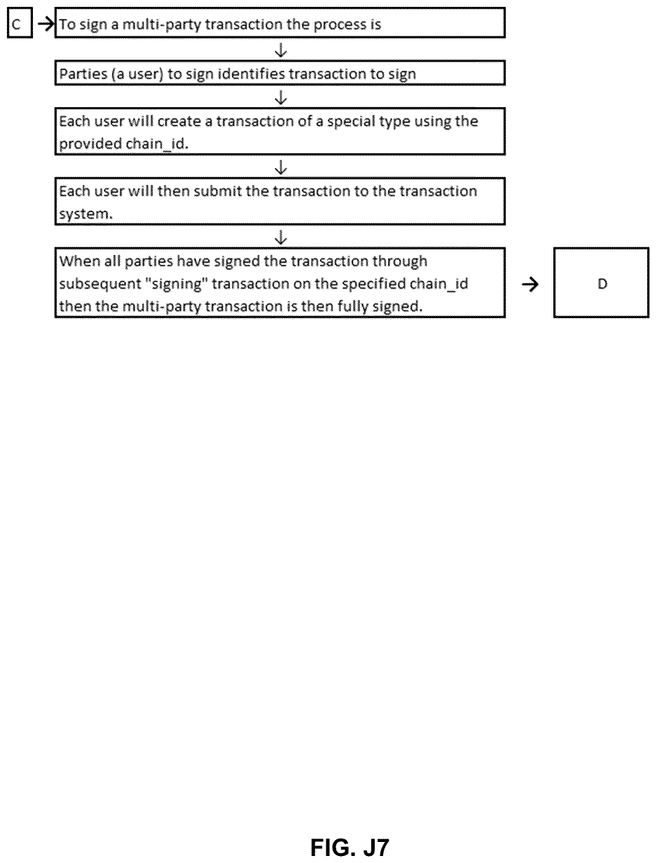

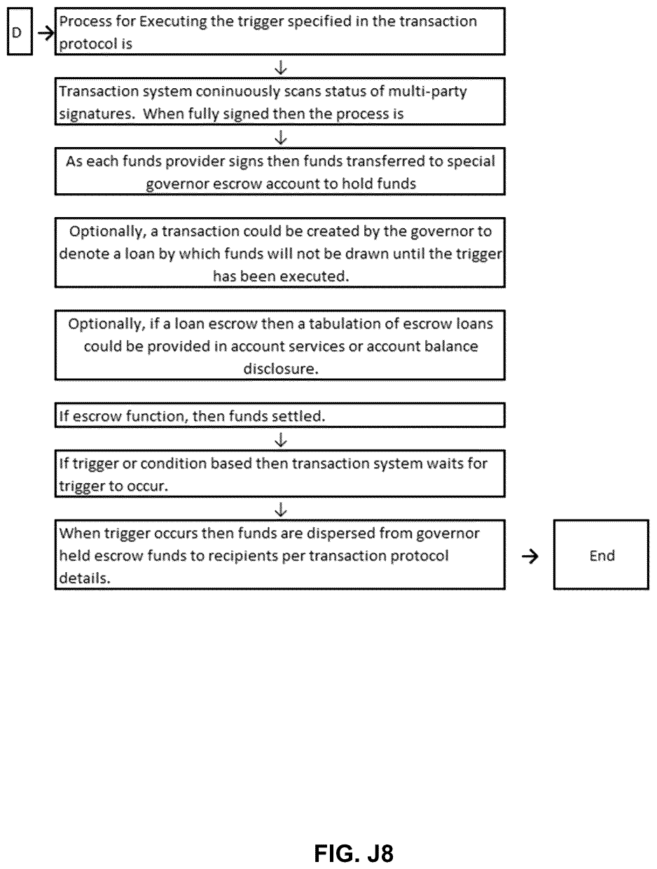

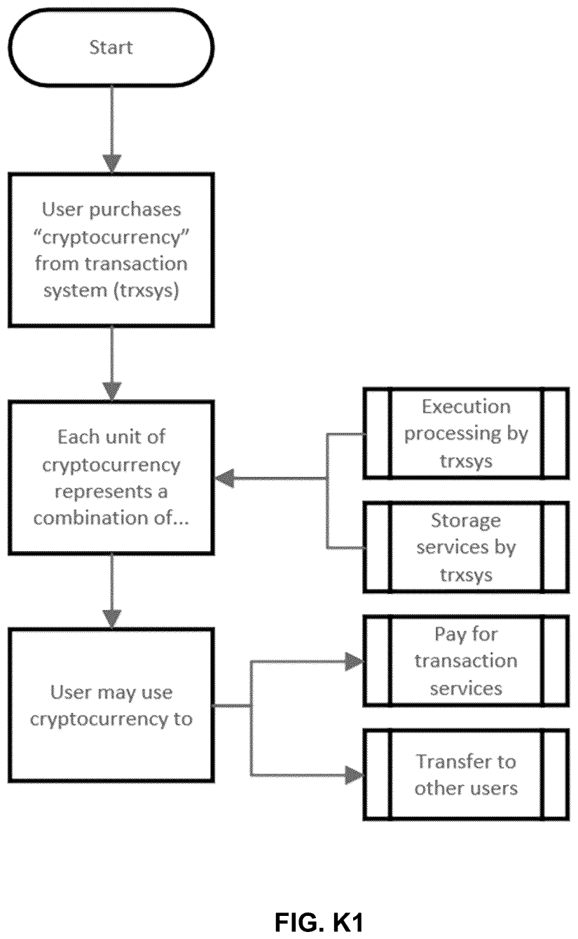

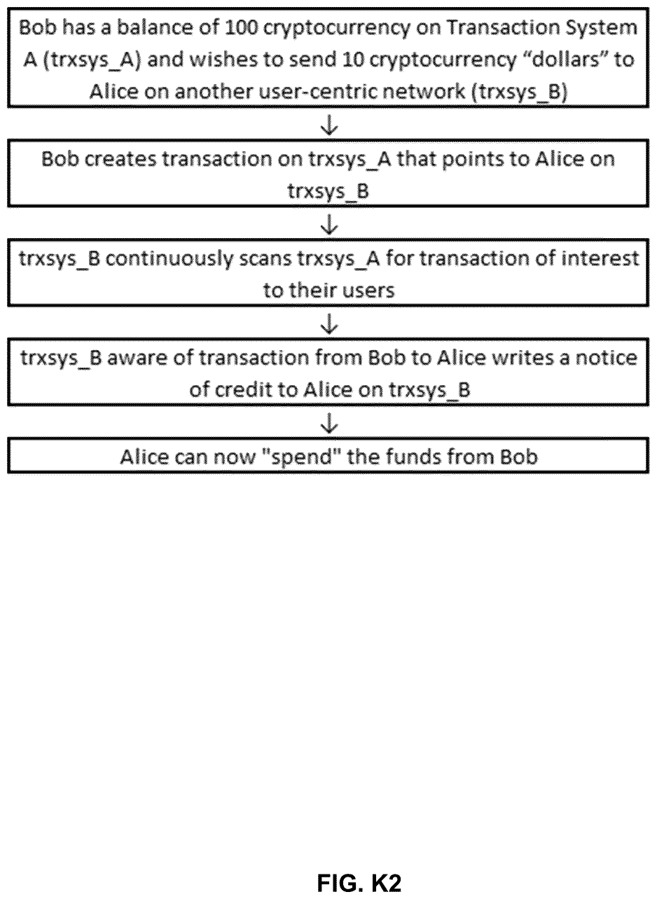

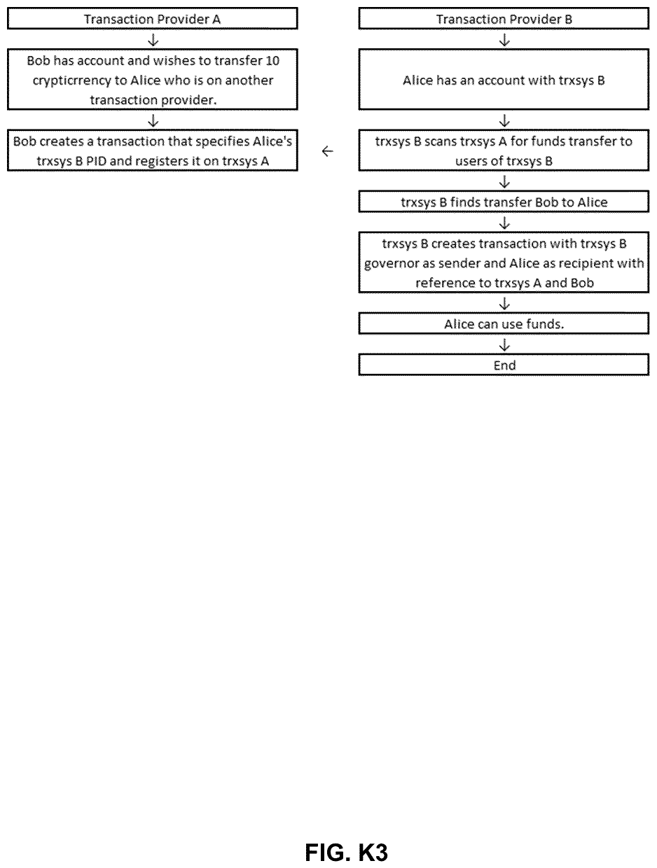

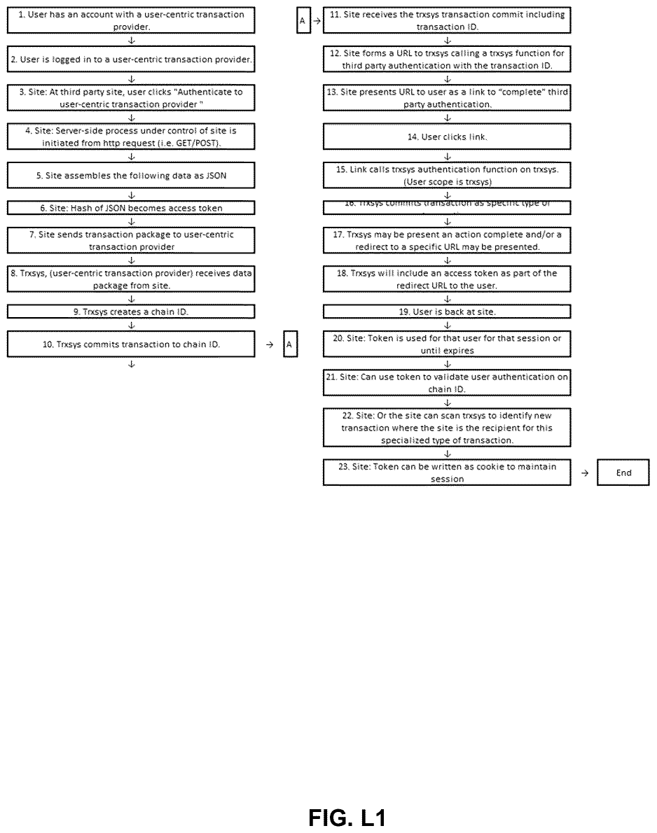

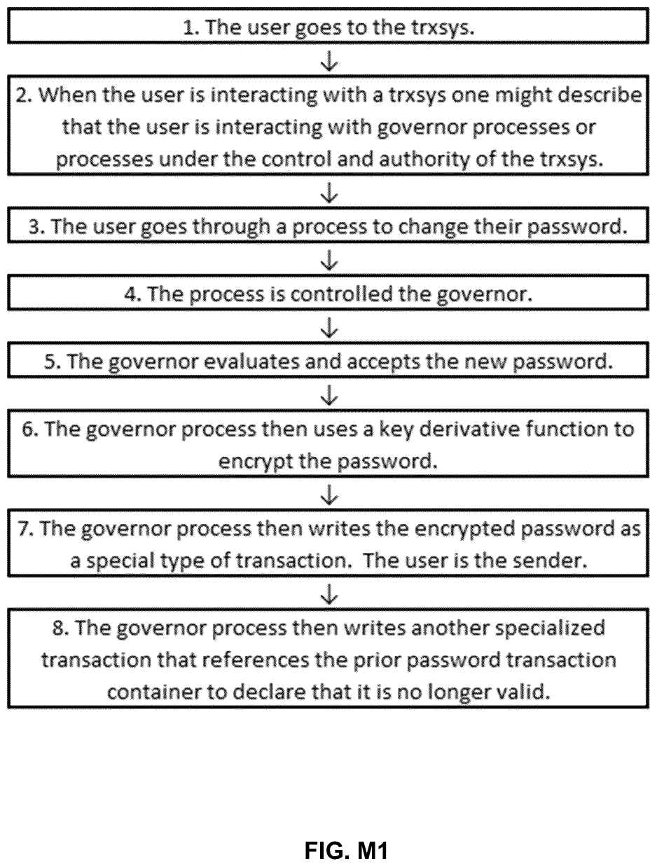

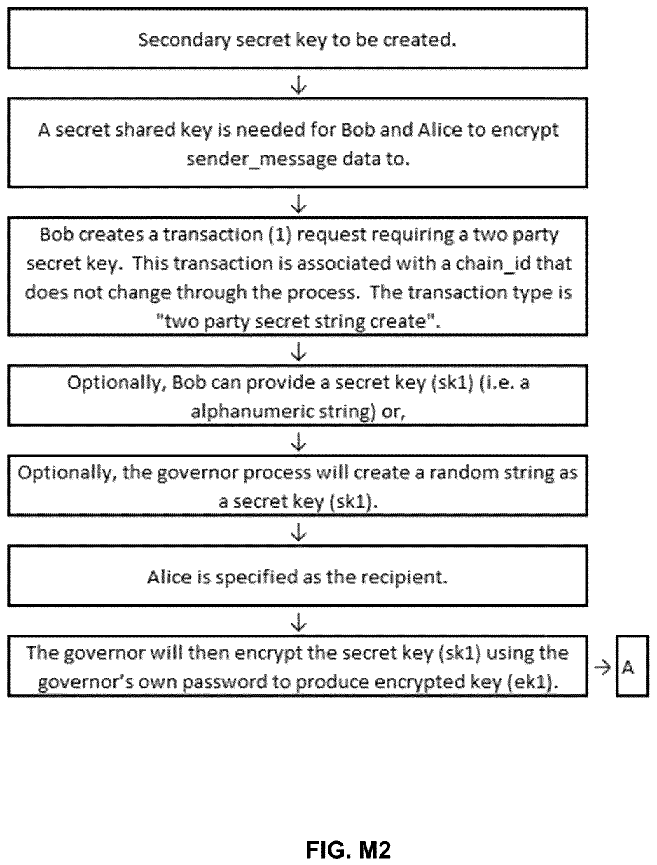

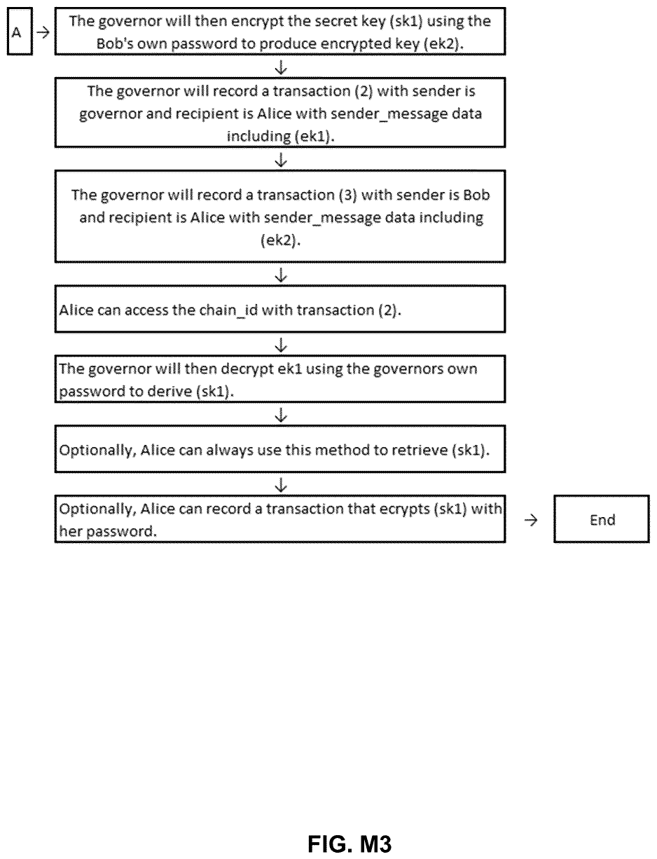

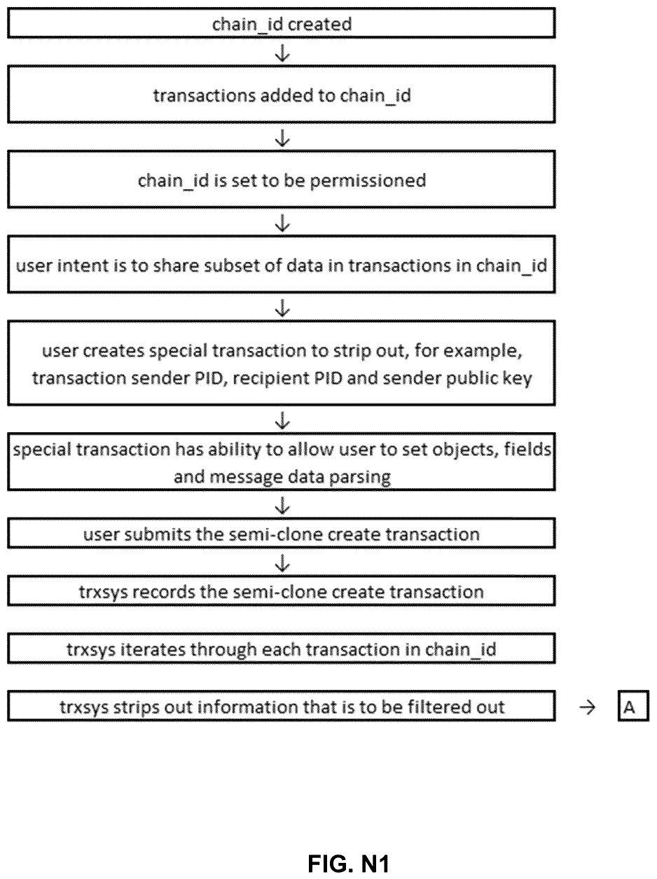

FIG. 23A is Python (v3) code that demonstrates how to send a transaction to the APL. Example steps for sending the transaction are:

“URL” The correct URL to the API is already set. No change.

“lg_name” and “lg_password” These will either be provided as part of the POC program or through trx_sys registration.

“sender_amount” Leave at 0.

“sender_message” This is the field that data is entered in.

“recipient_pid” Leave at 0. “sender_chain_id” Will need a Chain ID entered here. A Chain ID is 52 characters long.

FIG. 23B is an example API for writing data to a Chain App ID.

FIG. 23C is an example API for querying a Chain App.

FIG. 23D is an example API for Querying a Transaction ID for message.

FIG. 23E is an example API for Querying transaction results.

FIG. 23F is an example API for Querying Transactions that contains the PID.

FIG. 23G is an example API for Querying Transactions that have the PID.

The following describes an invention disclosure for Method for User Account Keys Genesis provenance through side channel signing—method prevents the operator of a Transaction System from ever having access to a user's signing key pair.

FIG. D1 describes the process flow.

Conventional blockchain provides for public-key cryptography to allow for the creator of a transaction to sign a transaction in such a manner that only the holder of the private key could create the transaction. And the corresponding public key, which is publicly disclosed, could allow others to confirm the validity of the transaction.

Public-key cryptography just might be one step in getting the platform towards a universal truth. Let us work through a scenario. A user, we will call this user the sender, wishes to send a transaction to another person, and we will call that person the recipient.

The sender creates a transaction. The sender has an address for the recipient. The sender assembles the components of a transaction, signs it with the sender private key and includes the public key. The sender then sends this to the system. For clarity, we will call the system the governor process or just “governor” for brevity.

The governor receives the transaction, the governor will have to have some information to connect the sender's key pair to the sender's account. Afterall, we previously mentioned that the system, sorry, the governor, needs to know who people are and that people would have properly vetted accounts.

Perhaps when the user sets up an account the governor could create and assign an initial key pair to the user. When the new user account is set up then a special transaction type could be used to create the user as well as signing an ID for the new user with the user's private key.

But maybe it is not such a good idea for the governor to do this. The governor having unrestricted access to the user's private key is not a good thing.

To solve this the governor creates the new user's initial key pair and then the private key is encrypted using the user's password that is stored in the system. The user's password could be encrypted using some sort of key derivative cryptography to keep the account password safe.

Then what really happens is that the user creates their own first transaction to create their account but within a governor process.

Let us explore this in some more detail to understand the process and the risk. During the account create process the governor process will have both access to both the user password and that could be used to decrypt the user's private key.

This is actually an acceptable practice in conventional technology systems. But, blockchain, as a concept, has introduced concern over the amount of power that centralized organizations have.

The user could always create a secondary key pair and authorize those keys by signing with the primary key pair. However, because one might reason that the governor, having access to the primary key would be able to sign and authorize a key as if the governor were the user.

A governor operating as a bad actor could potentially capture the password and save the unencrypted password and wreak havoc upon the system.

To solve this the user would need some information that the governor does not have access to. So, the user could create a key pair entirely outside of the purview of the governor. The first transaction would be written as described, but a subsequent transaction could be written that is signed by the official primary private key and then signed by this second key that the governor has no access to.

A challenge with this dual signing method is that the governor, if behaving badly, could still create this secondary key pair and wreak havoc under the user's account.

Conventional blockchain solves this problem by never allowing a central authority to hold credentials. But, conventional blockchain lacks the practical ability to identify a person. Without a reasonable degree of identification then there cannot exist services such as recourse or privacy.

The following describes a reasonable scenario.

New user goes to the centrally managed website and creates an account along with a password. The password is encrypted but that really just protects the password from hackers not the governor. Regardless, the governor creates and assigns the primary key pair. The user wants assurance that the governor will never create transactions without her consent. The user then creates her own secondary key pair. The user creates a secondary ID, like a long random number. The user signs that secondary ID with her secondary private key. The user creates a transaction of a type that declares a secondary ID and secondary key pair. The user submits that transaction to the governor. The governor processes that transaction without ever having access to the secondary key pair. From that point forward the user can use that secondary key pair. The transaction identifying that secondary ID and key pair would effectively state to all that this user's transactions should also be signed by this secondary key pair.

One may expect some challenges to arise. What if the governor misbehaves and creates this secondary key pair before the new user can? In that case, the user will not be able to use that account. But this introduces the problem of plausible deniability. Consider a user creates a transaction and then, for whatever reason, decides that she wants to deny that transaction. One avenue, if she is a bad guy, would be to deny that she did that transaction. She could claim that the governor made this bad transaction without her permission.

Her strategy is plausible deniability. To counter plausible deniability, the system could be set up in such a manner as to require a new user to decide at the time of account creation whether the user wants to use secondary IDs and key pairs. If so, then the user will be expected to establish that secondary key pair and ID transaction before actually using the account. Then the governor could only misbehave at the time that an account was first created. And, it is at the time of account creation when the risk to all parties would be the least.

To summarize, the user signs up for a new account and then decides if she wants to hold a secondary ID and key pair on her local system as added security.

The user could optional decide on this level of rigor. We do not believe that every user will want to have this extra level of rigor related to account security. Therefore, it seems reasonable that this feature should be optional.

If we can rely on the public keys to validate that a user signed a transaction and equally rely upon the fact that the governor also signed the transaction then we are getting closer to meeting the objective of universal trust and portability.

The following describes an invention disclosure for Method for ASP (Application Service Provider) specific certified ID, like on Ebay, user gets a certified Ebay ID but the ID is bound to the login ID on Ebay and can never be regenerated. Therefore, the user is incentivized to adhere to conditions of use and acceptable use policies. The benefit could be significantly reduce crime on the Internet. An application service provider (ASP) that is operating as user-centric has a requirement for a person to only ever have one ID. A user-centric platform can use a special transaction type to generate a unique ID that is bound to the ASP. The user-centric platform can never create a second unique ID bound to the specific ASP. The result is that trust of user accounts for the ASP (like Ebay) is increased because a user cannot create new IDs if they get bad reviews (etc.).

The following describes an invention disclosure for Method for evolving identity state. Is a critical method for practical user-centric computing. Allows a user to easily on-board to a transaction system, or even no formal onboarding, to then 1) inherit rights for an existing or even non-existent (unregistered) user, and, 2) allows for the strength (i.e. MFA, biometrics) to increase the identity rigor over time.

Examples disclosed herein build upon the concept of “Identity Encapsulation” described in the provisional patent filing “Methods for a User Centric Transaction System”.

With Identity Encapsulation the management of user identity was described such that a user's identity would be recorded as a collection of transactions. In particular, “Identity encapsulation refers to the methods by which the user's identifying information such as name, address, passwords, biometric data, etc. are encapsulated into a chain app (collection of transactions) and serve as an alternative to a user database or directory service (like Microsoft Active Directory). Through identity encapsulation, the system is able to offer self-sovereign identity where the user can authoritatively port or make access available to other platforms.”

This invention provides methods such that an encapsulated or “transactionalized” or tokenized identity attributes, as described above, can incrementally evolve to layer on or include new identity attributes.

In a practical sense, this allows for a user to sign up to a user-centric transaction provider with minimal information and then later increase the strength of those identity credentials. Further, through a model of identity inheritance, the user may have a basic identity established by a third party and then the user inherits rights to those digital assets.

With regard to the aforementioned inheritance model, an example of practical usage could manifest as a user accesses a web-based service that allows the user to take immutable pictures (i.e. photo app). The user is not required to create a login or otherwise sign up for the web service. This is a benefit of user-centric computing. A user can interact with a web site, mobile app, etc. and benefit from rich services (i.e. persistent data) without a login to the third party site being established. Getting back to this example: The user has a need to take a photograph that will be registered as an immutable digital asset on a user-centric transaction provider. The user may or may not have an account on a user-centric transaction provider. If the user does not have an account registered with a user-centric transaction provider then the user can still utilize the services of the photo app.

Continuing with the example of the photo app; the user launches the photo app (could be a mobile app or web page), takes a picture, enters a description of the photo (etc.) and enters basic identity information such as a phone number and/or an email address. The photo app receives the photo and associated information and processes the request into a data package to be sent to a user-centric transaction provider. The photo app operator will specify a special transaction type that implies inheritance. The details of transactional inheritance are described in the provisional patent filing “Methods for a User Centric Transaction System” and are mentioned here to establish context for how an identity can be created in a basic sense without the user ever having registered with a user-centric transaction provider. Continuing with the photo app example; the photo and associated meta information is recorded as a transaction or chain of transactions on the user-centric transaction provider. The user may subsequently visit the user-centric transaction provider and acquire ownership and control of the digital asset described in the aforementioned transaction(s).

At this point in the example, the user does not have an account or a login to the user-centric transaction provider. However, the photo related transactions establish a placeholder identity with the user's phone number and/or email address acting as identifiers.

The user may then create an account on the user-centric transaction provider. The user may either specifically reference those transactions or by simply attempting to register with identity information (i.e. phone number or email address) that exists within inheritance transactions. Regardless, the user will validate, using conventional methods, ownership of those credentials.

Upon validation of ownership of those credentials ownership of those digital assets will pass, through governor process generated transactions, to the user.

At this point the user is now registered with the user-centric transaction provider.

The preceding was used to simply describe how a user could establish the basics of an account on a user-centric transaction provider without actually having registered with the user-centric transaction provider.

The user, having an account on a user-centric transaction provider might have a very basic account, i.e. validated only with phone and email. However, in some cases, like with banking, a requirement may exist to establish the actual identity of a user. Those requirements may involve the evaluation of ID card verification, face verification, document verification such as utility bills as proof of address, and biometric verification.

The evaluation of identity information may take place through a third-party.

The third-party evaluator of identity will be able to record the results of the evaluation as special transaction types with the user-centric transaction provider. Those special identity transaction types will reference, through PID (or SID, etc.) the user being evaluated.

Therefore, the user, starting with a very basic identity, can evolve the strength or quality of their identity that match the identity requirements of various services such as banking, healthcare, etc.

The following describes examples to enable a party, such as a government or enterprise, to create IDs (identities) that are derived or inherited from a person's primary user-centric identity to which the party would retain control and rights.

User-centric (sometimes referred to herein as “ChainCasting”) computing is not exclusively reserved for consumers. User-centric computing advocates a single self-sovereign identity that falls within the control of the person.

A person's identity can evolve as new information, such as biometric data, is added to the person's identity. The person's identity information is contained within a plurality of transaction containers.

Described is a user-centric identity fits within identity requirements of IT systems and organizations such as is found in companies, governments and other organizations.

Just as user-centric computing is architected such that data created by a user is bound (data, identity and trust) so should an organization have an expectation that data created by persons working within an organization is bound to that organization.

The challenges are twofold when integrating a user-centric identity into an organization.

How to create an identity that is derived from a user-centric identity.

How the organization can affect control over the data created by that identity.

Creating an identity: To create an identity is a mostly simple process. The user, perhaps upon attaining employment at a company that supports user-centric identities, could execute a specialized transaction that would 1) derive a unique id and 2) bind that identity to the company's user-centric identity.

The management of the identity, like for the user's user-centric password, would fall under the responsibility of the person's transaction provider.

Optionally, the organization may require a different password policy as well as identity information. If, for example, a different policy was required, then 1) the password policy could be described within a specialized transaction that would require a password of a specified length, password changes over some frequency, etc. 2) the organization would have authority to revoke the person's derived identity password with another specialized transaction.

Controlling data: Employees of organizations will consume data, create data and interact with systems. A fundamental capability is with rights assignment as is commonly found with access control systems (Identity and Access Management IDAM).

Within the user-centric computing paradigm, management of access can manifest along two directions: 1) The user-centric derived identity can be consumed by traditional IDAM platforms. In this model the user-centric derived identity will simply integrate into existing IDAM platforms. Rights to systems and data would be provisioned within the IDAM system with little to no interaction or dependencies of the user-centric transaction provider. I other cases the organization could leverage specialized transaction for rights assignment.

The derived identity could have rights applied to a conventional information system then that information for the rights assignment could be stored in conventional systems or recorded utilizing specialized transactions that describe access rights to a specific system. Such a rights description may manifest as:
{“system”:“hf3.example.url”,“rights”:“rw”,“star t”:“1639511494”,“end”:“1639811999”}

The preceding example demonstrating one of potentially many implementations of the concept.

In some cases, the organization may need to provision rights to user-centric transaction containers and/or chain IDs. In such a case an administrator at the organization could provision rights to the employee's derived user-centric identity.

Out of practical necessity, the employee's derived user-centric identity would never be the primary owner or creator of a chain ID.

A supposed paradox may exist in that an employee can never be the owner/creator of a chain ID because that would give the employee a level of control such as to block the parent organization from controlling the organization's user-centric transactional data. One might suggest that the organization simply create all chain IDs and then assign to employees, but this severely lacks practicality.

The solution is that when a user-centric identity is derived from a person's user-centric identity then that identity can be bound or assigned or otherwise connected to an organization. The transaction provider's access engine will interpret that declaration (the special transaction used to create the user-centric derived identity) as the organization as always having superior or dominant rights to all transactions and chain IDs created by the employee.

Therefore, user-centric computing in the consumer domain as well as government, enterprise and small/medium business (SMB) is not only possible but very practical.

The following describes inventive material in support of Methods for Granular Identity Attestation in Email Platforms. User-centric computing provides for tokenized or transactionalized identity elements. The capability can be used to mitigate spam, malware and other “undesirable” email messages.

To mitigate undesirable email there are two use cases enabled with user-centric computing.

Method to prove that an email is from an email address that belongs to a real person who has established a user-centric identity with a verified identity. Equally, a method to enable a person with a user-centric identity to configure their identity such that the recipient of an email (etc.) can validate a given the level of identity verification.

Method to generate an email address that is a) bound to a specific sender's domain, and b) to revoke or time-bound the email address. This method is actually not needed as the first method described increases the strength of identity thereby improving quality of email. This method is simply called out to demonstrate that this functionality was taken into consideration.

Email quality: Technical Method Described Through a Scenario:

Alice has an email address. She is registered with a user-centric transaction provider. She gets too much spam. Her email provider, perhaps Gmail, Outlook, etc. has recently begun to offer user-centric computing email prioritization. She has learned that user-centric computing email prioritization will validate that email messages sent to her email address are from a validated user-centric computing identity. She can also adjust or configure various identity elements such as location of the person sending the email or company that the person works for.

Alice goes into her email providers configuration panel and sets a higher priority to email addresses that are user-centric fully verified identities, that come from her local zip code and surrounding areas or work for companies in the industries related to her interests in veterinary medicine, farming or coffee (she likes coffee). She also wants to prioritize emails from email addresses that have a high degree of truthfulness.

Alice knows that if a person or company associated with a user-centric registered email address lies or misrepresents the subjective or qualitative keywords or descriptions associated with their email address then she can register a complaint with the user-centric transaction provider that can be inspected by other users. This capability encourages user-centric users to be honest about their identity elements.

Bob has Alice's email address. Bob is registered with a user-centric transaction provider. Bob has transactionalized several of his identity elements. He has configured his email account through his email provider to enable identity validation for location (but not his specific address) and the company he works for (a veterinary supply company). He knows that when he sends an email to Alice that his identity will be verified but only for the identity elements that he has allowed. But he knows that in sme cases, like with apply for a mortgage he could even associate his specific street address along with his bank balance. Regardless, Bob knows that his email address has a better chance of being read because he is user-centric and has never had any complaints filed against his email address or any of his other registered email addresses.

### Method for Proxy Transaction for Inheritance

Presented as proxy transaction for inheritance method. FIG. E1 depicts the process for the user to engage with an Application Service Provider (ASP) and create an inheritance transaction. At 1 it is assumed that a user may or may not exist within the user-centric platform (i.e. the User-centric transaction system). No requirement exists for the user to be predefined. However, the user has an intent to engage with an online service characterized as an ASP. The ASP would offer some valued-added service at 2. That value-added service may include enhancing data provided by the user such as photo or image manipulation or the service may involve the presentation and selection of catalog of items. The value-added is not limited to the preceding descriptive examples. The relevant nature of the service is that the online service (the ASP) provides some service that does not include transaction execution and storage.

To further establish context, one may imagine a simple example where a user makes use of an ASP to take a picture of a rental car before it is rented. This may allow the user to retain immutable proof of the condition of the rental vehicle. The ASP provides a value-added service of making it easy to take and load a digital photograph onto a user-centric platform.

At 3 the user would access, in the manner of a “web app” or “web page”. At 4 the ASP would perform a value-added service. At 5 the user would provide either Personally Identifiable Information (PII) or a user generated unique identifier. By “user generated” we mean that a function within a browser or web application would actually create the unique identifier. The user may enter PII such as their name or phone number. Alternatively, at 6 the ASP could generate a unique identifier.

The ASP at 7 would create the transaction. Creating the transaction means that the correct data elements are assembled in such a manner as to allow execution by the transaction system. Within the transaction assembly the ASP would set the transaction to a “type” declaring that the transaction will allow the user to inherit rights to the transaction. At 9 the identifying information would also be added to the transaction assembly.

FIG. E2 depicts a continuation of process from FIG. 1. At 1 the transaction system collects the data provided by the ASP. If upon analysis of the transaction all certificates, ASP credentials, etc. are approved then the transaction system will write the transaction to 2 the ledger. The transaction will then provide a reply to the ASP (i.e. REST API HTTP response code and data message).

The ASP may or may not provide acknowledgement from the transaction system that the transaction was processed. That would be a business or marketing decision and is therefore configurable. The ASP 4 may provide the successfully executed transaction ID to the user.

FIG. E3 depicts the transaction inheritance process. At some point in time after the successful execution of the transaction, the user may exercise a right 1 to inherit control over the transaction. The user 2 may know the transaction ID or not. The user may query 3 the transaction system given the user's knowledge of the PII that was shared with the ASP. The transaction system would respond 4 with the transaction ID. The transaction system would provide a web form 5 or API or other method to allow for interactions with the user. The transaction system 6 would create a transaction and execute the 7 the transaction with a transaction type that would give rights to the inheriting user and would decrease the rights of the ASP who created the original transaction on behalf of the user.

FIG. E4 depicts management of queries that reference inherited transactions. Given the preceding process flow (FIG. E1, FIG. E2 and FIG. E3) the user will have successfully inherited the transaction in question. Normal operation of a transaction system is such that queries are issued 1 from various users and the rights of the requestor are resolved against the permissions assigned to the corresponding transactions. A query produces a result set 2 comprised of some indeterminate quantity of transactions. For each transaction returned the transaction system will evaluate rights that the requesting user has. If a transaction 3 is of type “inheritance” then the system will inspect 4 if the transaction has been inherited. And, regardless of “yes” inherited or “no” not inherited the system 5 will determine if the current user has proper rights. If not then 6 the system will provide an error and exit the process. If the user does have read rights then 7 the results will be displayed.

Method to establish a fully funded escrow. For a user-centric transaction system to be practical it must provide methods by which the user can assign rights to an ASP such that the ASP can charge or bill the user for provided services. Continuing with the aforementioned example of a user taking a picture of a rental car and the using an ASP to write the transactions, with an escrow capability the ASP could charge the user a fee for the service that they provide. Of course, there could be a direct billing but an escrow model allows for funds to be established for the benefit of simplicity in recurring transactions. One might also identify a benefit in the manner of a subscription service to a news web site. The user is willing to pay for the content but wants an experience where there is no need for the user to explicitly confirm payment for every article that is read. Additionally, the user may wish to have a means of providing a “hard cap” such that a run-away or malicious or otherwise unintended process could deplete the user cryptocurrency (or even fiat currency) account. Regardless, it is this subscription model that one might keep in mind while considering the method described for escrow. It also important to keep in mind that within a usercentric compute paradigm that the ASP does not have a requirement to identify the user or to set up an account for the user or to retain session state or other information about the user. In user-centric computing the user retains control of the data exchanged between the user and the ASP. Additionally, in user-centric computing the transaction system holds a balance of cryptocurrency that is native to transaction system. It is with this cryptocurrency that the user would pay for services provided by an ASP.

Further, and to simplify the description of the escrow process, one might consider a process flow where the user intends to frequently access “for fee” digital assets, like news articles, from an ASP. The user establishes an escrow fund for that specific ASP. The user visits the ASP web site. The ASP web site provides an identifier for the ASP and information describing the payment requirement. This all happens automatically within a browser or app and does not need user intervention. The browser or app passes the “for fee” payment information to the transaction system. The transaction system, knowing some minimal set of information on the user and having received the necessary payment request then determines if an escrow had been established. The escrow allows for the transaction system to perform the payment without additional approval from the user. If all conditions are met then the transaction system issues a payment, in the form of cryptocurrency to the ASP.

Alternatively, one who is versed in the art may consider that the same method could be used to facilitate a payment with fiat currency (i.e. US dollar) by fiat funds held by the transaction system or through payment requests made to an established financial institution.

FIG. E5 depicts Method to establish a fully funded escrow. Allows a user to fund an escrow account such that the Application Service Provider (ASP) can draw from that escrow account as services are provided. In this model of “fully funded” a defined amount of cryptocurrency would be moved to an account controlled by the transaction system (also known as the governor or governor process). An agreed upon amount would be deducted from the user's account and placed in escrow controlled by the governor. The funding process 1 has the user visiting the ASP web site or mobile app. Regardless, the user is able to 2 peruse digital assets available for escrow that the ASP is hosting. It is important to note that at 2 an alternative option or options could be provided to the user such as onetime payment. The user, presented with options would select the funding option best suited for their interests. At 2 the process flow is described as the user selecting a fully funded escrow model. At 3 the user identifies an item where, as an example, could be an article written about trout fishing. At 3 the user clicks or otherwise selects the item. For example, the user could click on a Uniform Resource Identifier (URI) or some similar method of selecting a link to a digital asset. The ASP being aware that an asset on the ASP site has been selected is able to 4 assemble a set of data at 5, 6 and 7 to describe the funding requirements for this asset or class of assets (like a magazine subscription). One can imagine a HTTP response as one example of how information would be shared. The assembled information is 8 shared with the user and the user, through a client-side process such as a web browser or web function or local application function will then assemble sufficient data as to initiate the creation of a transaction with the transaction system. At 9 the transaction system completes the assembly of the transaction. The transaction will include data describing who the user is via the user's ID (PID), that the type of transaction is 10 fully funded, the recipient 11 is the governor and 12 additional funding info. The funds, it should be noted are the native cryptocurrency of the transaction system, and the funds are available only to the ASP identified in the shared information from 4. The transaction system executes 13 the transaction. The transaction is between the user and the governor. In effect the user's cryptocurrency account balance is debited while the governor's account is credited. The funds are associated with tokens and other information from the user and the ASP. The funding may have attributes applied such as amount limit per draw, duration of escrow, identifiers for allowed purchases and identifiers for explicitly blocked purchases. If a point arrives where the escrow expires then the governor will execute another transaction returning the funds to the user. Alternatively, and described in FIG. E6 the ASP may draw those funds as established in the creation of the escrow fund.

FIG. E6 depicts the process by which a user engages with an ASP where an escrow is already established and the ASP can draw on that account. At 1 the user accesses the ASP website or app and selects an item or link to state intent to access a digital asset of some sort. The ASP being aware of the selection and knowing that the select is described additionally as having an escrow-based access requirement the ASP assembles information for transmission 2 to the user. The assembled information will include 3 a unique one-time identifier token and the identifier of the ASP (like PID), cost information and information identifying the selected digital asset. At 4 the user receives the ASP requirements to access the digital asset. At 5 a user-oriented process (i.e. client-side such as within a browser or app) process will parse those requirements. The process, being performed by a process under the control of the user, will determine if 6 escrow exists. That process, again initiated by a user process will query the transaction system ledger to determine if an escrow was created for the ASP as described in the parsed data package. If an escrow was established, then at 7 the process will determine if sufficient funds exist and the attributes of the asset match rules established during the setup of the escrow such as to approve or deny the request for payment. At 8, if the request is determined to be valid and funds exist, then a transaction request 9 is assembled.

At 10 the governor receives from the user a request to issue a transaction. The governor will validate user credentials, validate escrow funds availability and other information to determine that the request is valid such as date boundaries, etc. If the governor approves then the governor creates the transaction from the assembled data passed by the user. The transaction is executed. The sender is the governor and the recipient is the ASP. At 12 the ASP will either receive acknowledgement of prove through messaging sent from governor to user to ASP with the transaction ID and token. Or the ASP may scan in the manner of querying the transaction system for transactions that match the ASP's PID or associated chain app ID or token.

The content 13 that can now be proven to be paid for from the escrow account can 14 be shared. The ASP will now share the digital asset or content. The user 16 receives the content and the process concludes.

It is also intended that a user could create an escrow account that is not specific to a particular ASP. In this manner a similar process would flow as is described in FIG. E5 and FIG. E6. The difference from FIG. E5 is that the user would not need 1 through 7. Instead the user would simply establish an escrow by creating a transaction that would be executed 8 and the ASP funding info 12 would be more generic. At 12 lists of ASPs could be used to include or exclude ASPs. Additionally, various parameters cold be included even including regular expressions to establish data ranges for funding, minimum or maximum amounts per charge, frequency of charges from ASPs, etc.

It is also intended that in some implementations the escrow would serve as the establishment of a payment requirement and not a means of funding. One might characterize this feature as an automated rules bound payment function.

Method for user-centric session management with ad-based marketplace. User-centric computing continues to provide for advertisement-based revenue models. Methods will be described that allow for the user to maintain control and collection of their web access session data, sharing of that data with a third-party advertising agency and compensation to a web site or web service in exchange for said services.

FIG. E7 demonstrates that a user initiates a session with an ASP. A session would be characterized as a temporary and interactive exchange of information between a user and a server. A user may be a human or machine is the larger context of user-centric and User-centric transaction system interactions. However, in the context of the described method a user mostly aligns to that of a human. A server, in this context, refers to a single point from which resources from that server, other servers, other domains, etc. may be requested for access. A user visits 1 an ASP and the ASP replies 2 with an identifier for the site or app. A web resource (like a web page) is often comprised of digital assets pulled from multiple sources that are not of the originating or primary domain. Therefore, multiple records or transactions may be included in the following processes. Additionally, a hierarchy or relationship may be established between digital assets. The identifier could simply be the ASP domain name or given the location or directory of the site being accessed the identifier could be a combination of domain and identifier. The ASP will not generate a unique ID per visit or for each user. Rather the ID would identify the entry point to the site. Context info will also be included in the response from the ASP to the user. Context could include descriptions of categories of information such as [men's clothing, women's clothing, pants, shirts, shoes]. Regardless, “context” serves the purpose of providing a relationship between ASP digital assets, potential navigational routes, selectable assets and session information accessed by the user and stored in a chain app. Context could equally be established from a client-side analysis of the digital asset. One may consider that context establishes a scope of interest with ASP.

A user-controlled process 3 queries the transaction system with information provided by the ASP. The transaction system will search the ledger for transactions or chains of transactions that match the search criteria provider by the ASP (or resolved simply from the domain name of the ASP). If prior transactions exist then those transactions are provided to 5 a user process. The user process will evaluate the identified transactions for context and scope given information provided by the ASP. Given the preceding example of as [men's clothing, women's clothing, pants, shirts, shoes] the user process may establish that context for this session could continue as [woman's clothing, shirts]. The preceding is a very simple example and in practice one would expect much more complex “contexts” to exist. One may consider that the aforementioned model of “scope and context” can be simplified in description such that an ASP provides information about what the user can do while the transaction system provides information about what the user has done. The user then provides scope to the ASP. Context and scope information could also include configurable information such as site preferences like language, color preference, device requirements, session expiration, etc.

The ASP 6 will evaluate the scope information provided by user and will serve assets accordingly. If, however, the user does not have prior session data then a new chain ID will be 7 created by a user process to establish a new session. The user will then 8 continue their session with the ASP. The user, as would be considered typical of one interacting with a web site will click or otherwise select various digital assets. Each interaction will be recorded 9 and stored within the transaction system 10 as one or more transactions. In some implementations, clicks and selections could be batched in blocks of recorded activities and then written as one larger transaction to the transaction system. Additionally, the data recorded by the transaction system could also be tagged, labelled or otherwise structured in a hierarchical, relational or key/value manner. The context info provided by the ASP or, in some implementations, the context requirements provided by the user will allow for a flexible and multitude of implementation architectures or styles.

To this point, and within this section of “User-centric session management with ad-based marketplace”, it is demonstrated that a user may engage in an interactive session with an ASP and the user can retain session state information. However, and in a practical sense, the described session management model will need to enable a revenue model for the ASP. The Internet has evolved such that advertisement placement is a significant source of revenue for web service companies. User-centric computing does not preclude ad-based revenue models. One may consider that in a conventional adbased revenue model that the web site collects data from the user. That data is then used by the web site to develop an advertisement placement strategy or the web site may share that collected data with a data broker or advertising agency such that a third party could aggregate the data from that user interacting with that web site and many other web sites to produce a more effective advertisement placement strategy. The point being that the user, in effect, trades information about themselves for free or discounted web services. An ad-based revenue model of trading personal information for services is possible within user-centric computing. FIG. E7 has demonstrated that session state and digital asset selection/download information can be collected. Meta-data such as length of time on a web page and even mouse movement can also be collected and stored within a user-centric data collection. It is this collected data that would be otherwise used by web sites, data brokers, etc. to develop personalized advertising strategies for the user.

FIG. E8 demonstrates how a user, in a user-centric model, is able to grant access to their session data to an ASP or to a data broker, the ASP or data broker can place advertisements for the user to see and the ASP can be compensated. At 1 the user interacts with, as is common, a multitude of ASPs (think of multiple web sites), and at 2 the session data (clicks, pages views, assets selected, etc.) is recorded in one or more transactions owned by the user and stored by the transaction system. To this point data on the interactions of a user across one or more ASPs has been collected. The user has control of that data. At 3 the user can grant read access to that data by creating a transaction for that function. The user will need the ASP or ad brokers identifier (i.e. PID).

It is important to note that in a model where the user decides to use an ad broker that the user will not necessarily provide read writes to the ASP and only to the ad broker. The information passed to either the ASP or the ad broker could be provided through traditional means of passing data to the user as is common with web application architecture. The amount of data shared 4 can be limited by, for example, date boundaries, categories of data, volume of data, etc. At 5, during transaction assembly the sender in the transaction is the user while the recipient is the ad broker. Of course, the user could grant read rights to a specific ASP, or multiple ASPs, or one or more ad brokers. One transaction would provide rights to one organization. However, in some implementations a transaction system may allow for multiple recipients to be identified within one transaction for the assignment of access rights. Once the ad broker or ASP has read access to the specified user data then the ad broker or ASP may perform analytics, as is traditionally done, upon said data such that the most effective advertisements can be placed on the digital assets (i.e. web pages) that the user visits. The ad broker or ASP can become aware of the assignment of access writes by either receives a message generated outside of the transaction system or through queries against the transaction system's ledger that look for transactions with the ad broker's or ASP's ID (i.e. PID) identified as the recipient and of transaction type being “access control”.

FIG. E9 demonstrates how an ad is generated in a user-centric ad-based marketplace. It is generally accepted that ad selection for a user is based upon an analysis of multiple data points created by or on behalf of the user. To this point methods have been described that allow an ad broker or ASP to collect information about a user in a user-centric compute paradigm. FIG. E9 is described as having four relevant involved parties 1 transaction system, 2 the user, 3 the ASP and 4 the ad broker. At 5 the user visits an ASP (i.e. web site). The ASP responds 6 with a PID to identify the ASP and a request for a SID (unique secondary ID for this session) from the user. A user process creates a SID 7 and this SID 8 along with the chain ID for the set of user web interactions, and ASP ID are added to a transaction and executed by the transaction system. If the ASP is also performing the function of an ad broker then the ASP is identified as the recipient. If an ad broker is being used then the ad broker is the identified recipient. 7 and 8.1 provides for the user or a user process to inform the ASP or ad broker of the just executed transaction details. 9 and 8.2 provides for the ASP to inform itself or the ad broker of the just executed transaction details. 10 and 8.3 provides for the ad broker to inform itself the just executed transaction details. Regardless, the transaction is stored in the ledger. The transaction serves to provide an association between the SID (unique number for this session), the ASP PID, and a chain ID that identifies some transaction or set of transactions that contain prior user web activity, PII, etc. At 9 the ASP is made aware of the completed transaction. The ASP may be made aware of the transaction by querying (like through an API) their PID as a recipient in a new transaction or a user process may collect and forward the transaction ID to the ASP. Unless explicitly allowed, the ASP does not have rights to the chain ID. Additionally, the chain ID can be represented by a unique ID (i.e. SID) to reinforce confidentiality. The ASP will then pass the SID or transaction ID to the ad broker unless the ASP is generating ads in which case the ASP will have read rights to the user data. It is important to note that in a model where the user is using an ad broker that the ASP is passing a SID user chain ID and ASP identifier information (that are written into a transaction) to the ad broker so that the ad broker can then 10 query the transaction system 11 for data contained within the passed chain ID data collection (i.e. things the user has done). The transaction system will validate that the ad broker does in fact have rights to read the chain ID transaction set.

That validation will be determined by inspecting a prior transaction written by the user to give the ad broker rights. This is why the ASP, who has the chain ID, cannot do anything with that information. Additionally, and is common within a user-centric platform, a transaction (such as one that provides rights to a user) can be anonymized through a subsequent transaction that create an LRN that provides for an association between one transaction ID and another. One may consider this capability as an anonymizing pointer. At 12 if the access rights are approved then the transaction system returns a result set of those identified transactions. At 13 the ad broker has information describing the user behavior, prior clicks, etc. and the ad broker has information on the ASP itself.

The relevance of the ad broker having info on the ASP is to refine scope of interest, for example, the user is on Walmart.com then the ad broker should not provide ads for Target.com. Therefore at 14 the ad broker creates an ad strategy for the placement of one or more ads. It should be noted that while the preceding description of an “ad” is suggestive of an ad placed within a web page (i.e. banner ad) however, an ad could just as easily be expressed by voice (i.e. pre-recorded audio ad) or even paper mail. It should be noted that this process is happening in near real-time and could occur during the load of a web page, for example. Regardless, the intent is that for online (i.e. digital) ads the user is active within a session with the ASP. The ASP, being aware that they are engaged with a user will 15 “look” for an ad from the ad broker. If an ad broker is being used then the ASP does not know who the ad broker is. The ad broker, because of the transaction that they were tagged in does know who the ASP is because the ASP PID was included in the transaction. The ad broker, having an ad or plurality of ads, can either create a transaction with the ASP as the recipient or simply leverage a webhook or API query to the asp to with, and regardless of the method provide information to the ASP with either the ad data itself or a link (i.e. URL) to the ad data. It would be considered more common for a URI to be placed on the ASP digital asset (i.e. web page) such that easier tracking of “clicks” could be maintained. At 15 the ASP can identify that an ad exists through one of the several aforementioned methods. At 16 the ASP will display or otherwise render the ad for the user. The ASP will include an identifier such as the SID with the URI or URL for the ad. A mockup of a URL might look like, https://www.someASP.com/session_SID-823498298347&ad=11222112. In this mock-up URL identifying information such as the session SID and a reference to the add are included to provide for session data to be collected by the user and written as a transaction in the event that the ad was clicked. At 17 the user may interact with (i.e. click) the ad or simply ignore it.

FIG. E10 demonstrates the process by which compensation or revenue occurs in a user-centric marketplace. FIG. E10 is described as having four relevant involved parties 1 transaction system, 2 the user, 3 the ASP and 4 the ad broker. At 5 the user visits an ASP (i.e. web site). At 6 the user clicks an ad that has been placed on the web page. At 7, and just like every other “click” or resource access a transaction is created, or in some cases batched up during the session, the data (resource, ASP info, etc.) is formed into a transaction 8 and written to the ledger 10. An asynchronous process takes by the ad broker. The ad broker, having previously been assigned rights by the user to session data will 9 query (like via API) the ad broker recipient PID. If exists, the transaction system, and 11 validating rights, will return 12 a result set including all transactions associated with their PID as recipient PIC. Within that set would be a transaction with the chain ID specified by the user. The ad broker could then, upon 13 parsing the identified as “new” transaction, perform a subsequent query for the chain ID that was contained in that new transaction. The ad broker could then easily identify 14 if an ad had been clicked. The data contained within the ad click transaction would contain information on the ASP. Additionally, in some implementations the ASP could write a transaction with the ad broker as the recipient. This is demonstrated in FIG. E11 at Item number 5, 6, 7 and 8 where the chain_id and URL data would act as a secondary or even primary system of record that a click occurred. FIG. E10 at 16 would then provide for the ad broker to pay the ASP. To “pay” could refer to sending money or some other exchange of value.

One may also consider that the process for ad revenue in a usercentric marketplace has so far not provided a means by which the ASP, when the user elects to use an ad broker, can determine or validate or otherwise confirm that the ad broker is fairly compensating the ASP for each ad click by each user. A remedy is to have the ASP create an LRN for each URL/URI rendered for each ad on each page for each user. A transaction would be created, similarly to the aforementioned processes for user-centric ad-based marketplace, that would provide an association between the ad and the ASP. Other identifying information, in some implementations could be included to assist with association and verification. Regardless, the result is that the user is able to prove what links she clicked, the ad broker is able to count and verify clicks on ads clicked on at the ASP, and the ASP is able to correlate with the ASP the ad click count as stated by the ad broker.

In some cases, the ASP may find it beneficial to provide a small payment, a micro-payment, back to the user to cover the cost of transaction execution by the user. A payment, in this manner, would involve a payment based on a cryptocurrency that is native to the transaction system.

Demonstrated in FIG. E10 at 18 is a configurable option where the user may elect to receive compensation for accessing content, digital assets, etc. on the ASP. The configuration setting may be established through several manners. The transaction system could have a transaction that explicitly states that the ASP will compensate the user per click, per value of digital asset, etc. This transaction would give the ASP access to session state. This transaction would establish an understanding of the rules of compensation but would not perform the payment automatically. The transaction system could utilize an additional transaction that is specifically designed to provide a payment (i.e. micropayment) to the user for each defined action or access by the user. One might align such functionality as is often described as a “smart contract” in blockchain lexicon. To review, one transaction between the user and the ASP that associates user session data with the ASP and inspectable by the ASP. That transaction, or may be a second type of transaction, establishes rules, boundaries and agreement for micro-payments made in exchange for access and use of digital assets. Finally, another transaction may be utilized to facilitate or automate the payment from the ASP to the user. At 19, in conclusion, a payment would be made to the user from the ASP. The payment itself would be a simple transaction executed by the transaction system that would send some amount of cryptocurrency from the ASP to the user. Additionally, and keeping in mind, that every transaction has a cost that is paid by the sender of the transaction. Alternatively, information could be exchanged between the user and the ASP such that a payment (like US Dollar) could be made outside of the transaction system.

Demonstrated in FIG. E11 is a table representative of the overall process of ad revenue in a user-centric marketplace. At 1 is a simple reference to a row in the table. At 2 is a reference to how the table row corresponds to a Figure and reference point. At 3 is an example of a message payload containing descriptive information. One may observe in the table that each transaction has a unique ID and that there are a variety of transaction types. The chain ID is used to provide an association between transactions. The message field within a transaction may contain a variety of different types of data from links the were clicked (URL/URI) as well as more complex data structures. In some implementations, binary data such as an image could be referenced to an “off platform” location or an image could be stored directly in the transaction message as binary, Base64, Hex, etc. In some implementations, the ad itself could be stored as a transaction. In such implementations additional transaction types could be defined that act as a record of access to a transaction. And, in some implementations a transaction could facilitate a payment to take place when an ad is “clicked” that is embedded or otherwise enabled from a transaction.

### Method for Write Rights Inheritance

Presented as method for write rights inheritance is an access control function. For any transaction the creator (i.e. sender) of a transaction may be viewed as the administrator of that transaction ID or chain_app_id. When enabled, the following method allows any recipient of a transaction for a given chain_app_id to then write transactions to the same chain_app_id. In contrast to “no permissions” assigned to a chain_app_id, only recipients of the chain_app_id can write new transactions. This is an administrative inheritance and does not require that the administrator user to assign rights explicitly (i.e. one by one) to each user. In contrast to explicit assignment of rights where only the chain_app_id administrator can explicitly declare which PIDs can write to the chain_app_id. No PID of recipient is required.

To establish the usefulness of this method one may imagine within a supply chain there are multiple parties involved with sharing resources, assets and information. A buyer may order a product from a supplier. The supplier may in turn issue an order from the manufacturer. The manufacturer may then order raw materials from several commodity sellers, and so forth. It is unreasonable to expect that the parties involved in a complex supply chain be identified and locked into a formal or informal organization (i.e. consortium) when such a model typically precludes the simple addition or removal of members.

The intent of the described method is to allow for the formation of dynamic and ad hoc data sharing network among parties to a supply chain. Of course, supply chain is only an example use case. Such a model could be easily applied to other use cases such as with the sharing of medical information, research data, etc.

FIG. E12 demonstrates a process flow where one party creates a transaction, chain_app_id in one transaction and then creates a subsequent transaction to assign write rights to recipients of a transaction associated with the defined chain_app_id. The process is described in the context of supply chain parties for clarity of process. However, the capabilities and features enabled with the described method can be used across a multitude of use cases where one party creates a transaction, chain_app_id, and intends for any subsequent recipient of a transaction with the defined chain_app_id to inherit right writes and to also explicitly reject any write attempts from parties who have not been a recipient of a transaction of the defined chain_app_id or who have not otherwise been explicitly given permission to write a transaction with the identified chain_app_id.

At 1 a user identified as “buyer” creates a transaction to order a product from a user identified as “supplier.” At 2 the transaction is formed such that the sender is the buyer, the recipient is the supplier and a new and unique chain_app_id has been created. The transaction at 4 is executed by the transaction system and subsequently written to the ledger. At 6 the buyer creates a transaction of type “assign write rights to any recipient of a transaction for this chain_app_id”. To simply the description we will define this type of transaction as “write rights inheritance” transaction. The “write rights inheritance” transaction at 4 is processed by the transaction system and stored to the 5 ledger.

At 7 the supplier identifies the transaction. A transaction can be identified by the recipient querying the transaction system for their ID (i.e. PID or SID) or by being informed through some other manner such as email, webhook, etc. The supplier will then, in this scenario process, create a transaction 8 to order a product from the manufacturer. In this transaction 9 the sender is the supplier, the recipient is the manufacturer and the chain_app_id would be the chain_app_id previously created by and used by the buyer. The supplier would submit the transaction data to the transaction system 10 and the transaction system would determine if the supplier has rights to write the transaction with the specific chain_app_id. The transaction system would inspect the ledger for “write rights inheritance” transaction with the specified chain_app_id. The transaction system would then inspect the ledger to identify if the current transaction sender was a recipient on a prior transaction of this chain_app_id. If such transactions are identified then the transaction submitted by the supplier will be approved by the transaction system and written 4 to the 5 ledger.

At 11 the manufacturer identifies the transaction. A transaction can be identified by the recipient querying the transaction system for their ID (i.e. PID or SID) or by being informed through some other manner such as email, webhook, etc. The manufacturer will then, in this scenario process, create a transaction 12 to order a product from the commodity seller. In this transaction 13 the sender is the manufacturer, the recipient is the commodity seller and the chain_app_id would be the chain_app_id previously created by and used by the buyer. The manufacturer would submit the transaction data to the transaction system 10 and the transaction system would determine if the manufacturer has rights to write the transaction with the specific chain_app_id. The transaction system would inspect the ledger for “write rights inheritance” transaction with the specified chain_app_id. The transaction system would then inspect the ledger to identify if the current transaction sender was a recipient on a prior transaction of this chain_app_id. If such transactions are identified then the transaction submitted by the manufacturer will be approved by the transaction system and written 4 to the 5 ledger.

The example scenario described in FIG. E12 can essentially carry on forever. It should be noted that branches may also exist where one party creates multiple transactions to different parties and each of those parties would, in turn, inherit write rights for the specified chain_app_id.

Although the method described for “write rights inheritance” is bounded to write rights one may expect a similar method to provide for read rights inheritance. While a system wide default configuration exists such that any named party (i.e. sender or recipient) within a transaction will have read rights to a transaction, the same default does not apply to chain_app_ids. Therefore, it is possible for multiple parties to have the right to write to a given chain_app_id yet those parties only have rights to read transactions for which they were the sender or recipient. All other up stream and down stream transaction may be blocked for reading by a given user. Therefore, and implemented in the same manner, a corresponding “read write inheritance” would also be a feature available from a transaction system.

### Method for Identity Encapsulation

Identity encapsulation refers to the methods by which the user's identifying information such as name, address, passwords, biometric data, etc. are encapsulated into a chain app (collection of transactions) and serve as an alternative to a user database or directory service (like Microsoft Active Directory). Through identity encapsulation, the system is able to offer selfsovereign identity where the user can authoritatively port or make access available to other platforms.

In its simplest sense, identity encapsulation moves user object data (like login and password) from a separate and separately controlled database into a single and monolithic ledger. The ledger will contain all transactions from all ledger participants and each participant will have their identity written as a set of transactions into the ledger.

Identity encapsulation allows the owner of his or her identity to both provision access to other parties as well as to provide for portability of his or her identity. Similarly, to up stack and down stack portability described above; the user can select “up stack” application service providers that can provide value added services related to identity such as age verification. Likewise, the user can select a different “down stack” provider such that her identity would exist on another transaction system.

FIG. E13 demonstrates establishing login and account credentials with user-centric identity encapsulation for new user registration. One might observe similarities with common user registration practices. That is a fair observation because the end result of a user being uniquely identified with various describing attributes is exactly what happens. The difference is that the user retains organic control of the identity information. That feature is unique and novel to user-centric computing as has been described throughout this document. At 1 a user who is new to the platform visits the site of the transaction system. At 2 the user provides personal identifiable information (PII). At 3 the transaction system will validate information. Validation could represent a multitude of sub-processes such as cell phone number verification, address validation, etc. At 4 the information from the user is either accepted or rejected. If accepted, at 5 the user's data are processed as the user's credentials, PII, etc. At 6 a collection of sub-processes are identified such as password validation and processing, PIC creation, key pair creation, etc. At 7 a chain_app_id is created. In some cases, data may be represented by hierarchical chain_app_ids. The individual data records are assembled into a collection of transactions. Each transaction has the same chain_app_id. For example, one transaction is created for the first name (trx_fname), another for the password (trx_password), and so on. The purpose for one transaction per data element is to provide for more granular updating of data and more granular sharing (i.e. assignment of permissions) of data. At 8 the transactions are written to the 9 ledger by the transaction system. At this point one may consider that the user has been registered. Of course, there may be a variety of sub-processes and additional validation or data processing steps that take place (i.e. address confirmation) that are not described herein but other common and expected by those skilled in the art. FIG. E14 demonstrates the process by which a user is “logged into” the transaction system. The transaction system can be interacted with in three fundamental manners. 1) No authentication to the transaction system's web site for accessing the site in read only mode. 2) Authenticated to the transaction system's web site. 3) Authenticated on a per “instance” basis through an API for writing a transaction. 4) Authenticated on a per “instance” basis through an API for querying the ledger.

With regard to “No authentication to the transaction system's web site for accessing the site in read only mode” no authentication is required and is therefor out of scope with authentication.

With regard to “Authenticated to the transaction system's web site”, “Authenticated on a per “instance” basis through an API for writing a transaction”, and “Authenticated on a per “instance” basis through an API for querying the ledger”, in the first case the user may stay authenticated during a session through traditional methods such as cookies. In some cases, the user may be required on an instance basis to issue login credentials to validate permission for a function. Regarding the access via API for write and query those functions will require authentication per each instance. Although, in some instances one could implement a persistent authenticated state across multiple API instances or interactions. Therefore, the following process should not be viewed as a singular method of accomplishing tasks such as writing transactions or querying the ledger.

At 1 an already registered user accesses the site via API or web form. The user 2 will provide credentials (login name and password). Additionally, the user may include query parameters or transaction data. At 3 the transaction system will validate the credentials, and if 4 approved will determine, based on the 13 request, whether to process as a query or a transaction write. If a transaction write, and 5 the transaction data and details are without error then 6 the transaction is assembled by the transaction system. The transaction system will then commit or write the 7 the transaction to the 8 ledger.

If, at 13 a query is the request from the user, then 9 the query will be validated to determine if the user has permissions and that the query is valid. If approved then the 10 ledger will be queried. At 11 the transaction system will assemble the data, report or response per the requirements of the query. At 12 the user is updated through a response to the user. The user may then view or otherwise interact with the received transactions or data in a manner that is the offline from the transaction system.

FIG. E15 demonstrates how a user may provision PII read rights to other parties. A scenario may exist where a user may have a need to share their first name, last name and address with another party. In order for a user to authoritatively give read rights to another party for PII the user will create a transaction giving those rights to the other party. One might question why this would be necessary. It would be much simpler to just tell the other party or send an email with the user's address. The benefit of sharing PII that is recorded in a transaction system is that the data will establish as a fact that such information is recorded at a particular date and time and is associated with the identity credentials being provided by the user. The transaction system will allow for a user to update, for example, one's street address, but an update would be recorded as a subsequent record of type PII street address. An interested party may require, like for loan approval, a listing of addresses. The user could provide an authoritative list of all addresses that she had recorded.

The nature of user-centric computing is that wholeness of records (i.e. sets of related transactions) can also be proven. The user, one could reason, may provide their current address as latest record, or their entire address history that is provably whole. A transaction system would make available a multitude of transaction types to give rights, to establish boundaries (like timeframe or whole data set vs one record) for those rights. Because of an expected multitude of transaction types covering many uses the actual process to assign a right to another user is very simple.

At 1 an existing user intends to give rights to another party. The user may accomplish this through the transaction system web site or through an API. In some implementations an ASP could initiate the process. Regardless, at 2 the user's credentials are provided to the transaction system. It should be noted that in some circumstances a token could be used to allow an ASP or other third party to initiate the function on behalf of the user. Regardless, a 9 set of data including transaction type, boundaries and limits will be assembled and passed to the 3 transaction system. The transaction system will 4 validate the request and if approved will 5 process the requested transaction (i.e. further validation of request details) and 6 assemble the data into one or more transactions. The transaction system 7 will commit or write the transaction to the ledger.

Subsequently, the party that was given rights to the identified set of data can issue a query to the transaction system. The transaction system would then validate the request, query the ledger and return a set of data in the form of a collection of previously written transactions.

The aforementioned “Method for Identity Encapsulation” where a user can assign read rights to another party and the other party can query and read those transactions fits within the user-centric computing concept of “up stack portability”. Likewise, the user can select a different “down stack” provider such that her identity would exist on another transaction system. For down stack portability one of several methods could be used depending upon the implementation of user-centric computing by the transaction system. In one case the user could simply provide access, as had just been described and in the manner of up stack portability, but to another transaction system. In another case, the user could simply copy the identity related transactions, which are actually transaction containers as is every transaction, into transactions that would then be captured or encapsulated into transactions on the receiving transaction system. The originating transaction system receiving transaction system could then validate the user based on credentials passed from the first transaction system.

### Method for Ledger Multiplexing

A ledger in user-centric computing may be described as a collection of transactions with an identified sender and optionally identified recipients with a message of some indeterminant data size, format and structure with information that connects a given transaction across one or more sets of transactions.

As has been described throughout this document a transaction can have a chain_app_id that can be used establish an association or relationship to other transactions. As has been described, both transaction and a chain_app_id can have rights applied to enable control over who can query, view and read the transaction or transaction set, respectively. Rights are assigned through the execution of specialized transaction types.

An astute observer may point out that if only a single chain_app_id can be applied to a set of transactions then the practicality of the platform becomes somewhat limited as more complex data structures across multiple transactions are not possible. To enable more complex associations of transaction collections such that a transaction may be associated with a plurality of other transaction collections the concept of ledger multiplexing is introduced. Ledger multiplexing allows a given transaction to become a member of multiple chain_app_ids.

One might consider an example scenario where a multiplexed ledger would prove its usefulness. An example could be expressed where a user's health insurance company has offered a discount if the user can prove that she purchases some minimum amount and type of produce. The store that the user shops at is user-centric computing compliant. Therefore, all purchases made by the user are recorded in a collection of transactions that are organized by a hierarchy of chain_app_ids. The store sells more than produce. The store sells all typical grocery items, pharmacy products, garden supplies, etc. If the user's purchases were all tied to only one chain_app_id then the user would have to share details of every purchase with her insurance company in order to provide proof of the purchase of produce. This would be undesirable for the user because she would be sharing far too much private information. This would also be undesirable for the insurance company because they would then become responsible or liable to a degree for all of the unnecessary information that they had collected.

One might also consider that the user could simply provide copies of receipts. However, copies of paper receipts or even digital copies of, for example, a store's “reward card” associated purchases all lack any means of proving the authenticity of any individual data record and lack the ability to prove a wholeness of the set of information. Therefore, user-centric data provides the best option for proving that a set of data is whole and authentic.

In this scenario, the store will have taken a multiplexed approach to constructing transactions (purchases) on behalf of the user. The benefit to all parties is that the user could assign read rights to her insurance company for the produce chain_app_id.

One should consider that when mention is made of “constructing transactions (purchases) on behalf of the user” that the actual function of said “construction” could be done through transaction inheritance where the store creates and executes the transaction. The user would subsequently create and execute a transaction to inherit rights to the transaction. Alternatively, at the time of sale and with a device such as a Point of Sale (POS) terminal a transaction could be partially assembled for the user. The user then interacting with the POS device could provide credentials and other information in a manner that would allow the user to initiate transaction execution without the requirement for transaction inheritance.

As mentioned in the shopping example, there may be a need for a hierarchy or plurality of IDs assigned to each transaction to enable the identification of many transaction sets.

Continuing with the example, there may be a need to provide an identifier for the store. There may be a need to provide an identifier for the category of grocery item. may be a need to provide an identifier for the category of yard supplies. Further, may be a need to provide an identifier to further distinguish among each of these categories. There may be a need to provide an identifier to distinguish between organic versus not organic produce.

There may be a need to provide an identifier to distinguish between fruit and vegetables. An indeterminate variety of distinguishing identifiers will be required in a user-centric platforms in order to be of practical use.

Additionally, along with many identifiers for many different “categories”, there is also a need to establish proof of wholeness of sets of transactions for a given chain_app_id and recipient. Perhaps, and in continuation of the aforementioned shopping example, the user has a need to share information with her insurance company regarding produce that she has bought. And, suppose that those identifiers are standardized, for example by the government like with Universal Product Code (UPC codes) leveraging GS1 specifications. Therefore, a code for a produce item, like apples, will not be a subset of the grocery. Rather the grocery will be a subset, within a purchase, of the apple code. Therefore, a burden may exist on the user to establish an authoritative set of transaction describing her purchases of produce. She may have to identify every grocery store that she visited and then “drill down” into those transaction to find produce transactions. Alternatively, she may be able to first find produce transactions and then build a list of associated grocery stores.

The result of the preceding description is that a requirement is needed to 1) establish authoritative sets of transactions by chain_app_id. And, 2) To establish authoritative sets of transaction by recipient ID. And, 3) To establish authoritative sets of transactions by chain_app_id AND recipient ID.

User-centric computing requires that when a data set is shared with another party that the receiving party have a means of proving the authenticity of each transaction AND the wholeness of the data set. If one cannot prove the wholeness of the set of transactions then questions may arise as to whether any data is missing. The uncertainty of wholeness in a data set increases risk and diminishes the value of user-centric computing. Therefore, the preceding example of a shopper having a need to authoritatively establish data sets to share with a third party is a critical requirement of user-centric computing.

One might consider that giving the user the ability to define what a “whole data set” is could lead to unintended manipulations. For example, suppose that a bank was using user-centric computing. The user has control over transaction data. At the time of a transaction the user could add any number of chain_app_ids to a transaction. Then, when the user needed to prove a set of payments or a balance then the user could simply provide proof through a chain_app_id that the user decides to establish as an authoritative data set on. In this manner, the user could potentially build a data set that does not include some payment data thereby inflating the user's balance. Alternatively, the user, being in control of creating transactions could create transactions with a chain_app_id and make it appear that more payments were made to an account then actually occurred.

Regarding the possible manipulations related to chain_app_id and multiplexed ledger manipulations, there are two specific methods to make such activities impossible. First, in some cases the user-centric ledger will be used to record payments related to fiat currency. In these cases, a transaction will be executed to record a transfer (i.e. payment of funds). The user may initiate transaction execution with information from the bank. The bank would validate the transaction with a subsequent transaction to act as a receipt. Alternatively, the bank may initiate transaction execution to record a transfer (i.e. payment of funds) and in this case the user would be the recipient and would have access to the records but the bank itself would be the sender of the transaction. Second, a bank could require that when the user, or whomever, creates the chain_app_id that a declaration capability be added. The declaration would establish an understanding, a contract of sorts, that states that the transaction is not valid unless a specific identity (i.e. PID) create a subsequent transaction that approves the transaction. This way a user could establish a chain_app_id for use with a banking account. However, until the bank validated the transaction the transaction, entirely executed by the user, would have no factual relevance even though it is a properly formed transaction. Therefore, while a user could create numerous transactions with an intent to manipulate the integrity of the transaction set, the effect would be that those transactions would simply be discarded as not being valid.

Before elaborating of how data sets are distinguished within user-centric computing we will review the components of a transaction to firmly establish context of the concept of multiplexed ledger technology arrays.

In review, a transaction is comprised of several objects. Those objects are described below.

Sender object—information about the sender including PID or SID of the sender.

Sendersigning object—hash and cryptographic information for the sender object.

Recipient object—optional information about the recipient including PID or SID of the recipient. In some implementations may include multiple recipients.

Recipientsigning object—hash and cryptographic information for the sender object.

Xnode object—The xnode object represents information collected or produced from the sign and bind process.

Blocksigning object—The blocksigning object is used to tie all the objects together, including the prior transaction's hash, with the result being a chain of objects.

Chainribbon object—Ownership of transactions does not include the ability to delete or modify a transaction that has already been written. However, the owner of the transaction may remove the “chain ribbon” key to the message that is contained “alongside” the transaction to effectively disable or “kill” the information contained in the transaction message. This ability to kill or disable information in a transaction does not extend to any part of the transaction outside of the message (block meta data). The sender ID, recipient ID, amount sent, cryptographic signatures, etc. will remain intact.

The sender_message is encrypted, for example by AES (Advanced Encryption Standard) with a 256 bit key and 128 bit initialization vector.

The key and IV are included anytime the transaction is queried so as to allow the requester to decrypt the sender_message.

The sender object also contains chain_app_id information. In some cases, the chain_app_id is referred to as the sender_chain_id. Regardless, ledger multiplexing allows for multiple chain_app_ids to be included in the sender_object. Additionally, a common name or alias can also be used to describe a chain_app.

Any unique chain_app_id is defined and instantiated within a singular transaction. It is within this transaction that creates the chain_app_id that information such as a common name or alias would be included. In some implementations, subsequent transactions could be used to provide an update to the common name or alias.

Any unique transaction may include any number of chain_app_ids. A chain_app_id is optional and transactions can exist without any chain_app_ids.

FIG. E16 demonstrates how to establish a chain_app_id as a multiplexed ledger technology (MIT) array. At 1 the user has an intent to use a specific chain_app_id as a MLT array. The user's intent is expressed by submitting properly formed data through an API or through interacting with a form hosted by the transaction system or a third party. The transaction system will determine 2 if the chain_app_id exists. If “no” then 3 the user will receive an error message that the chain_app_id does not exist. If “yes” at 2 then the transaction system will 4 determine if the user has permissions. If “no” then the system will present an error. If “yes” the system will inspect the existing chain_app_id transaction set to determine 5 if a chain_app declaration is required. A chain_app declaration is used to declare that while the user has rights to write to this chain_app_id and the right to query on this chain_app_id, transactions written to this chain_app_id must have a corresponding transaction that approves or validates that the transaction is actually valid. One may consider this to be a type of receipt. A chain_app declaration is not required. If chain_app declaration is selected then the system will determine if the user has permissions to set a chain_app_id to be declarative. If “yes” at 12 the variable for mlt_declaration is set to “yes”. At 13 the user may specify a PID (or SID) of a user. At 14 the user may specify a chain_app_id that is used as a collection of PIDs (or SIDs) such as might be described as a group of users. At 15, the chain_app_id intended to be used as a group of users is specified. It should be noted that if the intent is to use a mlt_declaration then either a 13 PID (or SID) or at 15 a chain_app_id will be specified. A valid ID of either type is required if mlt_declaration is intended. At 15 if a chain_app_id is specified then as 7 the chain_app_id will be inspected to determine if the chain_app_id was established properly as a user group.

If a chain_app declaration 5 was not required then the transaction system will collect data from the user that 6 in effect sets mlt_array_exists to “yes”. The parts of the transaction will be validated, such as permissions to execute this transaction, at 7. At 8 the validated parts of the transaction will be assembled. At 9 the transaction system will execute the transaction and 9 store the new transaction to the ledger.

FIG. E17 demonstrates the design and integration of a multiplexed ledger technology (MLT) array within a transaction. At 1 a transaction is defined as a set of objects including 2 sender, 3 sendersigning, 4 recipient, 5 recipientsigning, 6 xnode, 7 blocksigning and 8 chainribbon.

At 9, within the sender object a variable, mlt_array_exists will be set to “yes” if a MLT array is intended to be used and stored with the transaction. At 10 a chain_array is declared. One may consider a chain_array to be a JSON object. However, other object notations could be used per implementation and configuration. Regardless, a chain_array is a collection of data that exists within the sender object and denoted as an object. The chain_array will have 11 a chain_app_id, 12 mla_seq_trx_id and 13 hash(current+prior). Some clarification is warranted. The chain_app_id is a chain_app_id that the user intends to associate this transaction with. The 12 mla_seq_trx_id would be the incremented count value of the last instance of this chain_app_id that this user was either the sender or the recipient. The 13 hash(current+prior) is complimentary to the 12 mla_seq_trx_id. The “hash” servers as a proof to demonstrate the inability of any party to manipulate the wholeness of the set of transactions contained within the chain_app_id.

We will pause for a moment and consider the practical application of the preceding. As an example, Alice has a collection of transactions for grocery purchases. She hopes to get a discount by proving that she bought some amount of organic fruit and vegetables. She will need some manner to develop an authoritative report of those transactions. When she makes a grocery purchase and assuming the grocery stores that she shops at are user-centric compliant, then she will have access to all of her purchase information. Her purchases will be represented by some plurality of chain_app_ids. Let us assume that she is using a Point of Sale (POS) device and that Alice is therefore the “sender” as defined within the transactions. Further, the chain_app_ids are declarative meaning that although Alice creates the transaction, the grocery will also include a “receipt” transaction with Alice being tagged as the recipient. Of course, Alice's identity can be represented as a primary ID (PID) or unique secondary ID (SID). Regardless, Alice will have access to all of the transactions. Multiple chain_app_ids could be used to distinguish between different types or classifications of the groceries that she has purchased. For example, suppose chain_app_id Ci9vktANpApd is used to represent organic fruits. But within a transaction for a purchase of groceries there may be many chain_app_ids. MJKUqQrdWbak might be used to establish the store identity, 8JHkGL462X6Q might be used to identify a red seedless grape, and so on. The point is that Alice has a need to create a set of data or a report that shows the fruits and vegetables that she purchased. Fortunately, user-centric computing through MLT arrays allows for the user to authoritatively create that set of data. The data may be represented as a report that Alice could share with her insurance company. That report would include sufficient information that, even if emailed, could be verified by the insurance company. But, more likely, Alice would simply give permission for the chain_app_ids for organic fruits and vegetables that she has purchased to the insurance company. It should be recognized that those chain_app_ids for organic fruits and vegetables are also used by many other users. But Alice has no interest in those other users' data. Just her's. The MLT array creates a connection between each of her transactions that has that chain_app_id. This last sentence is critical in conceptualizing MLT arrays and the practical application of the technology.

An MLT array allows a user to build a chain of transactions that can be proven whole and authentic. And the added fact that multiple chain_app_ids can be added to transactions allows for incredible flexibility in how data is categorized, represented and used.

Multiple chain_app_ids can be added to a transaction. Each chain_app_id added to a transaction is a chain_array. At 16 we see two additional chain arrays being added to 14 MLT array that is subsequently added to a single transaction.

At 14 the variable for mlt_array_(X) is written in a manner suggesting that “X” is itself a variable with the label. At 15 we see that “X” could be either sender or recipient or (sender and recipient).

One might describe 15 the options of MLT arrays being sender only or recipient only or (sender and recipient) in conversational manner of, “the creator of a chain_app_id can decide if the users of a chain_app_id can share a proof of record set where the user is the sender, or the user is only the recipient or the user is both sender and recipient.”

The usefulness of being able to distinguish arrays of sender or recipient or both could be demonstrated with user-centric record keeping or accounting with non-fiat crypto payments. For example, one could theorize a circumstance where a chain_app_id is defined by a bank that represents interest payments from a bank to a user who holds a checking account. The checking account accrues interest per some percentage of the deposits. The user may desire to prove to another financial institution the amount of those interest payments in the hopes of getting a better interest rate from the other bank. In this circumstance each transaction for the checking account would be either inherited (the bank creates and executes the transaction for deposit, transfer, withdrawal or interest deposit) with the user having rights but being the recipient. Or, the user could be the creator of the transaction (the sender) with the bank providing a corresponding declaration “receipt”. A chain_app_id will be used to tie all these transactions together. Keeping in mind that the user wishes to share balance information as it relates to interest but not wanting to share all the details of every transaction, the user would utilize chain_app_ids that are associated with deposits, withdrawals and interest payments. And keeping in mind that a banking transaction may involve some plurality of executed user-centric transactions. The user identifies the chain_app_ids that specifically denote an amount credited, debited and the type of transaction. The type of transaction could be specified in the message field and does not necessarily represent a specific user-centric transaction “type”. Regardless, the chain_app_ids for this circumstance may be represented as “recipient” from the user's perspective. Therefore, it would prove beneficial for the user to be able to provide access to the other bank for chain_app_ids that are needed to represent the aforementioned interest payments.

While the preceding may appear at first glance to be an overly complex means of structuring data for a simple query, in practice such a query or report and the sharing of that information would be rather simple for the user as the underlying functionality would be abstracted into a user friendly interface as is done in conventional institution-centric compute models.

Demonstrated in FIG. E18 are MLT arrays for sender and recipient. At 1 is a representation of a single transaction and that 2 a MLT array is stated to exist in this transaction. The purpose of explicitly stating 2 that a MLT array exists is to simply reduce the compute burden in determining if a MLT array exists in the transaction. At 3 the MLT array is defined with 4 arrays optionally for either the sender or the recipient with 5 simply representing a closing bracket to enclose the entirety of the MLT array into one JSON or similar structure.

Demonstrated in FIG. E19 is a table that represented a collection of seven transactions. In this table at 1 designates that for each row is a distinct transaction. At 2 is a transaction ID. At 3 is value to designate with the transaction whether a MLT array exists. In this table, as can be seen, there are no MLT arrays. This table is imply used as a baseline in conceptualizing transactions that have or rather do not have MLT arrays. At 4 is the value for the Chain ID. Here it can be seen that each Chain ID is unique. At 5 is the Sender PID. Every Sender PID is unique just as at 6 each Recipient ID is unique. Therefore, the described table is a collection of unrelated transactions. In no manner could those transactions be queried as a same set or related set or associated set.

Demonstrated in FIGS. E20 through E25 is a table with the same column headings as was described in FIG. E19. Therefore, the column headings described in FIG. E19 apply to FIGS. E20 through E25 and will not be “redefined”.

Demonstrated in FIGS. E20 through E25 are several tables that progress through a description of MLT arrays using mock transactions to assist in conceptualizing the practical use and value of user-centric MLT arrays.

Demonstrated in FIG. E20 is a list of transactions. In this table the sender is the same across all of the transactions. Therefore, the sender would have the right to share with another party rights to access this list of transactions. It is important to recognize that in user-centric computing the ID (i.e. PID or SID) listed in the “Sender PID” field will always have rights for the transaction. “Rights” fundamentally means that the sender can assign read rights to another ID. As a recipient, a user will always have rights to view a transaction but cannot assign read rights to another party unless the sender has given permission for the recipient to subsequently assign read rights to another party.

Demonstrated in FIG. E21 is a collection of transactions. The Sender PID is common across all transactions. Also, the Chain ID is common across several of the transactions. In particular, transactions (Item #) 2, 4, 5 and 7 represent a set in the form of transactions that are associated based on the Chain ID. The sender has “native” rights to share all transactions with whomever she pleases. Additionally, the sender has rights to share the transactions that are grouped together by the common Chain ID. Not shown is that the transactions associated with the common Chain ID would be sequentially numbered and serially hash bound together. This would allow the user (who is the sender) to share those transactions in such a manner as to allow the other party to valid each transaction AND validate the wholeness of the set. It should be pointed out that the Chain ID may be used only by this particular user or the Chain ID may be used by many users. Even if the Chain ID is used by many users the transactions by this particular sender would be sequentially bound as mentioned. The user would only have rights to transactions that she was the sender, recipient or was given permission by the administrator of the given Chain ID.

Demonstrated in FIG. E22 is a collection of transactions. One will notice that several transactions, Item #2, 3, 4, and 7 have multiple Chain IDs. In its simplest form that is what a MLT array is; two or more Chain IDs contained within a single transaction.

Demonstrated in FIG. E23 is a collection of transactions. One will notice that the Sender continues to be common across all transactions, several transactions have multiple Chain IDs and the Recipient is common across several transactions.

Demonstrated in FIG. E24 is a collection of transactions. One will notice that the Sender continues to be common across all transactions, several transactions have multiple Chain IDs and the Recipient is common across several transactions. As an example, in this table the sender could give read rights to another party such that the other party could view the transactions associated with Chain ID “2XoDNjwYMHm6”. As mentioned previously, other users may have used this Chain ID if they had rights. Or perhaps only this current user has used this Chain ID. It does not matter. The objective is to prove wholeness of the set of transactions where the Sender PID is “1LxdkKM0L7Ug” and the Chain ID is “2XoDNjwYMHm6”. “Wholeness” of the transaction set means that the set is constructed in such a manner as to allow the viewer of that transaction set to prove the integrity and completeness of the set of transactions. As mentioned previously, this set 8 would have a sequential ID that is incremented by a count of “1” from one transaction to another. Additionally, each transaction would have information such as to serially bind this transaction set together with hashes of data that span the current transaction with the preceding transaction. The result is that the party haven been given rights to view the set of transactions can independently prove with the information provided that the set of transactions, for the provided parameters, is whole, immutable and therefore fully trusted.

Demonstrated in FIG. E25 is a collection of transactions. One will notice that the Sender continues to be common across all transactions, several transactions have multiple Chain IDs and the Recipient is common across several transactions. As an example, in this table the sender or recipient, if permissioned, could give read rights to another party such that the other party could view the transactions associated with Chain ID “RbvOXUB4ZK98” and Recipient ID “islgGOx0kVSm” as a 10 provably whole set.

To conclude, a MLT array allows for a user of a user-centric platform to establish sets of related transactions for the sender, the recipient and with a plurality of Chain IDs.

### Method for Proxy Transaction for Inheritance

Presented as proxy transaction for inheritance method. FIG. F1 depicts the process for the user to engage with an Application Service Provider (ASP) and create an inheritance transaction. At 1 it is assumed that a user may or may not exist within the user-centric platform (i.e. the User-centric transaction system). No requirement exists for the user to be predefined. However, the user has an intent to engage with an online service characterized as an ASP. The ASP would offer some valued-added service at 2. That value-added service may include enhancing data provided by the user such as photo or image manipulation or the service may involve the presentation and selection of catalog of items. The value-added is not limited to the preceding descriptive examples. The relevant nature of the service is that the online service (the ASP) provides some service that does not include transaction execution and storage. To further establish context, one may imagine a simple example where a user makes use of an ASP to take a picture of a rental car before it is rented. This may allow the user to retain immutable proof of the condition of the rental vehicle. The ASP provides a value-added service of making it easy to take and load a digital photograph onto a user-centric platform.

At 3 the user would access, in the manner of a “web app” or “web page”. At 4 the ASP would perform a value-added service. At 5 the user would provide either Personally Identifiable Information (PII) or a user generated unique identifier. By “user generated” we mean that a function within a browser or web application would actually create the unique identifier. The user may enter PII such as their name or phone number. Alternatively, at 6 the ASP could generate a unique identifier.

The ASP at 7 would create the transaction. Creating the transaction means that the correct data elements are assembled in such a manner as to allow execution by the transaction system. Within the transaction assembly the ASP would set the transaction to a “type” declaring that the transaction will allow the user to inherit rights to the transaction. At 9 the identifying information would also be added to the transaction assembly.

FIG. F2 depicts a continuation of process from FIG. F1. At 1 the transaction system collects the data provided by the ASP. If upon analysis of the transaction all certificates, ASP credentials, etc. are approved then the transaction system will write the transaction to 2 the ledger. The transaction will then provide a reply to the ASP (i.e. REST API HTTP response code and data message).

The ASP may or may not provide acknowledgement from the transaction system that the transaction was processed. That would be a business or marketing decision and is therefore configurable. The ASP 4 may provide the successfully executed transaction ID to the user.

FIG. F3 depicts the transaction inheritance process. At some point in time after the successful execution of the transaction, the user may exercise a right 1 to inherit control over the transaction. The user 2 may know the transaction ID or not. The user may query 3 the transaction system given the user's knowledge of the PII that was shared with the ASP. The transaction system would respond 4 with the transaction ID. The transaction system would provide a web form 5 or API or other method to allow for interactions with the user. The transaction system 6 would create a transaction and execute the 7 the transaction with a transaction type that would give rights to the inheriting user and would decrease the rights of the ASP who created the original transaction on behalf of the user.

FIG. F4 depicts management of queries that reference inherited transactions. Given the preceding process flow (FIG. F1, FIG. F2 and FIG. F3) the user will have successfully inherited the transaction in question. Normal operation of a transaction system is such that queries are issued 1 from various users and the rights of the requestor are resolved against the permissions assigned to the corresponding transactions. A query produces a result set 2 comprised of some indeterminate quantity of transactions. For each transaction returned the transaction system will evaluate rights that the requesting user has. If a transaction 3 is of type “inheritance” then the system will inspect 4 if the transaction has been inherited. And, regardless of “yes” inherited or “no” not inherited the system 5 will determine if the current user has proper rights. If not then 6 the system will provide an error and exit the process.

If the user does have read rights then 7 the results will be displayed.

### Method to Establish a Fully Funded Escrow.

For a user-centric transaction system to be practical it must provide methods by which the user can assign rights to an ASP such that the ASP can charge or bill the user for provided services. Continuing with the aforementioned example of a user taking a picture of a rental car and the using an ASP to write the transactions, with an escrow capability the ASP could charge the user a fee for the service that they provide. Of course, there could be a direct billing but an escrow model allows for funds to be established for the benefit of simplicity in recurring transactions. One might also identify a benefit in the manner of a subscription service to a news web site. The user is willing to pay for the content but wants an experience where there is no need for the user to explicitly confirm payment for every article that is read. Additionally, the user may wish to have a means of providing a “hard cap” such that a run-a-way or malicious or otherwise unintended process could deplete the user cryptocurrency (or even fiat currency) account. Regardless, it is this subscription model that one might keep in mind while considering the method described for escrow. It also important to keep in mind that within a user-centric compute paradigm that the ASP does not have a requirement to identify the user or to set up an account for the user or to retain session state or other information about the user. In user-centric computing the user retains control of the data exchanged between the user and the ASP. Additionally, in user-centric computing the transaction system holds a balance of cryptocurrency that is native to transaction system. It is with this cryptocurrency that the user would pay for services provided by an ASP.

Further, and to simplify the description of the escrow process, one might consider a process flow where the user intends to frequently access “for fee” digital assets, like news articles, from an ASP. The user establishes an escrow fund for that specific ASP. The user visits the ASP web site. The ASP web site provides an identifier for the ASP and information describing the payment requirement. This all happens automatically within a browser or app and does not need user intervention. The browser or app passes the “for fee” payment information to the transaction system. The transaction system, knowing some minimal set of information on the user and having received the necessary payment request then determines if an escrow had been established. The escrow allows for the transaction system to perform the payment without additional approval from the user. If all conditions are met then the transaction system issues a payment, in the form of cryptocurrency to the ASP.

Alternatively, one who is versed in the art may consider that the same method could be used to facilitate a payment with fiat currency (i.e. US dollar) by fiat funds held by the transaction system or through payment requests made to an established financial institution.

FIG. F5 depicts Method to establish a fully funded escrow. Allows a user to fund an escrow account such that the Application Service Provider (ASP) can draw from that escrow account as services are provided. In this model of “fully funded” a defined amount of cryptocurrency would be moved to an account controlled by the transaction system (also known as the governor or governor process). An agreed upon amount would be deducted from the user's account and placed in escrow controlled by the governor. The funding process 1 has the user visiting the ASP web site or mobile app. Regardless, the user is able to 2 peruse digital assets available for escrow that the ASP is hosting. It is important to note that at 2 an alternative option or options could be provided to the user such as onetime payment. The user, presented with options would select the funding option best suited for their interests. At 2 the process flow is described as the user selecting a fully funded escrow model. At 3 the user identifies an item where, as an example, could be an article written about trout fishing. At 3 the user clicks or otherwise selects the item. For example, the user could click on a Uniform Resource Identifier (URI) or some similar method of selecting a link to a digital asset. The ASP being aware that an asset on the ASP site has been selected is able to 4 assemble a set of data at 5, 6 and 7 to describe the funding requirements for this asset or class of assets (like a magazine subscription). One can imagine a HTTP response as one example of how information would be shared. The assembled information is 8 shared with the user and the user, through a client-side process such as a web browser or web function or local application function will then assemble sufficient data as to initiate the creation of a transaction with the transaction system. At 9 the transaction system completes the assembly of the transaction. The transaction will include data describing who the user is via the user's ID (PID), that the type of transaction is 10 fully funded, the recipient 11 is the governor and 12 additional funding info. The funds, it should be noted are the native cryptocurrency of the transaction system, and the funds are available only to the ASP identified in the shared information from 4. The transaction system executes 13 the transaction. The transaction is between the user and the governor. In effect the user's cryptocurrency account balance is debited while the governor's account is credited. The funds are associated with tokens and other information from the user and the ASP. The funding may have attributes applied such as amount limit per draw, duration of escrow, identifiers for allowed purchases and identifiers for explicitly blocked purchases. If a point arrives where the escrow expires then the governor will execute another transaction returning the funds to the user. Alternatively, and described in FIG. F6 the ASP may draw those funds as established in the creation of the escrow fund.

FIG. F6 depicts the process by which a user engages with an ASP where an escrow is already established and the ASP can draw on that account. At 1 the user accesses the ASP website or app and selects an item or link to state intent to access a digital asset of some sort. The ASP being aware of the selection and knowing that the select is described additionally as having an escrow-based access requirement the ASP assembles information for transmission 2 to the user. The assembled information will include 3 a unique one-time identifier token and the identifier of the ASP (like PID), cost information and information identifying the selected digital asset. At 4 the user receives the ASP requirements to access the digital asset. At 5 a user-oriented process (i.e. client-side such as within a browser or app) process will parse those requirements. The process, being performed by a process under the control of the user, will determine if 6 escrow exists. That process, again initiated by a user process will query the transaction system ledger to determine if an escrow was created for the ASP as described in the parsed data package. If an escrow was established, then at 7 the process will determine if sufficient funds exist and the attributes of the asset match rules established during the setup of the escrow such as to approve or deny the request for payment. At 8, if the request is determined to be valid and funds exist, then a transaction request 9 is assembled.

At 10 the governor receives from the user a request to issue a transaction. The governor will validate user credentials, validate escrow funds availability and other information to determine that the request is valid such as date boundaries, etc. If the governor approves then the governor creates the transaction from the assembled data passed by the user. The transaction is executed. The sender is the governor and the recipient is the ASP. At 12 the ASP will either receive acknowledgement of prove through messaging sent from governor to user to ASP with the transaction ID and token. Or the ASP may scan in the manner of querying the transaction system for transactions that match the ASP's PID or associated chain app ID or token.

The content 13 that can now be proven to be paid for from the escrow account can 14 be shared. The ASP will now share the digital asset or content. The user 16 receives the content and the process concludes.

It is also intended that a user could create an escrow account that is not specific to a particular ASP. In this manner a similar process would flow as is described in FIG. F5 and FIG. F6. The difference from FIG. F5 is that the user would not need 1 through 7. Instead, the user would simply establish an escrow by creating a transaction that would be executed 8 and the ASP funding info 12 would be more generic. At 12 lists of ASPs could be used to include or exclude ASPs. Additionally, various parameters cold be included even including regular expressions to establish data ranges for funding, minimum or maximum amounts per charge, frequency of charges from ASPs, etc.

It is also intended that in some implementations the escrow would serve as the establishment of a payment requirement and not a means of funding. One might characterize this feature as an automated rules bound payment function.

Method for User-Centric Session Management with Ad-Based Marketplace

User-centric computing continues to provide for advertisement-based revenue models. Methods will be described that allow for the user to maintain control and collection of their web access session data, sharing of that data with a third-party advertising agency and compensation to a web site or web service in exchange for said services.

FIG. F7 demonstrates that a user initiates a session with an ASP. A session would be characterized as a temporary and interactive exchange of information between a user and a server. A user may be a human or machine is the larger context of user-centric and User-centric transaction system interactions. However, in the context of the described method a user mostly aligns to that of a human. A server, in this context, refers to a single point from which resources from that server, other servers, other domains, etc. may be requested for access. A user visits 1 an ASP and the ASP replies 2 with an identifier for the site or app. A web resource (like a web page) is often comprised of digital assets pulled from multiple sources that are not of the originating or primary domain. Therefore, multiple records or transactions may be included in the following processes. Additionally, a hierarchy or relationship may be established between digital assets. The identifier could simply be the ASP domain name or given the location or directory of the site being accessed the identifier could be a combination of domain and identifier. The ASP will not generate a unique ID per visit or for each user. Rather the ID would identify the entry point to the site. Context info will also be included in the response from the ASP to the user. Context could include descriptions of categories of information such as [men's clothing, women's clothing, pants, shirts, shoes]. Regardless, “context” serves the purpose of providing a relationship between ASP digital assets, potential navigational routes, selectable assets and session information accessed by the user and stored in a chain app. Context could equally be established from a client-side analysis of the digital asset. One may consider that context establishes a scope of interest with ASP.

A user-controlled process 3 queries the transaction system with information provided by the ASP. The transaction system will search the ledger for transactions or chains of transactions that match the search criteria provider by the ASP (or resolved simply from the domain name of the ASP). If prior transactions exist then those transactions are provided to 5 a user process. The user process will evaluate the identified transactions for context and scope given information provided by the ASP. Given the preceding example of as [men's clothing, women's clothing, pants, shirts, shoes] the user process may establish that context for this session could continue as [woman's clothing, shirts]. The preceding is a very simple example and in practice one would expect much more complex “contexts” to exist. One may consider that the aforementioned model of “scope and context” can be simplified in description such that an ASP provides information about what the user can do while the transaction system provides information about what the user has done. The user then provides scope to the ASP. Context and scope information could also include configurable information such as site preferences like language, color preference, device requirements, session expiration, etc.

The ASP 6 will evaluate the scope information provided by user and will serve assets accordingly.

If, however, the user does not have prior session data then a new chain ID will be 7 created by a user process to establish a new session.

The user will then 8 continue their session with the ASP. The user, as would be considered typical of one interacting with a web site will click or otherwise select various digital assets. Each interaction will be recorded 9 and stored within the transaction system 10 as one or more transactions. In some implementations, clicks and selections could be batched in blocks of recorded activities and then written as one larger transaction to the transaction system. Additionally, the data recorded by the transaction system could also be tagged, labelled or otherwise structured in a hierarchical, relational or key/value manner. The context info provided by the ASP or, in some implementations, the context requirements provided by the user will allow for a flexible and multitude of implementation architectures or styles.

To this point, and within this section of “User-centric session management with ad-based marketplace”, it is demonstrated that a user may engage in an interactive session with an ASP and the user can retain session state information. However, and in a practical sense, the described session management model will need to enable a revenue model for the ASP. The Internet has evolved such that advertisement placement is a significant source of revenue for web service companies. User-centric computing does not preclude ad-based revenue models. One may consider that in a conventional ad-based revenue model that the web site collects data from the user. That data is then used by the web site to develop an advertisement placement strategy or the web site may share that collected data with a data broker or advertising agency such that a third party could aggregate the data from that user interacting with that web site and many other web sites to produce a more effective advertisement placement strategy. The point being that the user, in effect, trades information about themselves for free or discounted web services. An ad-based revenue model of trading personal information for services is possible within user-centric computing. FIG. F7 has demonstrated that session state and digital asset selection/download information can be collected. Meta-data such as length of time on a web page and even mouse movement can also be collected and stored within a user-centric data collection. It is this collected data that would be otherwise used by web sites, data brokers, etc. to develop personalized advertising strategies for the user.

FIG. F8 demonstrates how a user, in a user-centric model, is able to grant access to their session data to an ASP or to a data broker, the ASP or data broker can place advertisements for the user to see and the ASP can be compensated. At 1 the user interacts with, as is common, a multitude of ASPs (think of multiple web sites), and at 2 the session data (clicks, pages views, assets selected, etc.) is recorded in one or more transactions owned by the user and stored by the transaction system. To this point data on the interactions of a user across one or more ASPs has been collected. The user has control of that data. At 3 the user can grant read access to that data by creating a transaction for that function. The user will need the ASP or ad brokers identifier (i.e. PID). It is important to note that in a model where the user decides to use an ad broker that the user will not necessarily provide read writes to the ASP and only to the ad broker. The information passed to either the ASP or the ad broker could be provided through traditional means of passing data to the user as is common with web application architecture. The amount of data shared 4 can be limited by, for example, date boundaries, categories of data, volume of data, etc. At 5, during transaction assembly the sender in the transaction is the user while the recipient is the ad broker. Of course, the user could grant read rights to a specific ASP, or multiple ASPs, or one or more ad brokers. One transaction would provide rights to one organization. However, in some implementations a transaction system may allow for multiple recipients to be identified within one transaction for the assignment of access rights. Once the ad broker or ASP has read access to the specified user data then the ad broker or ASP may perform analytics, as is traditionally done, upon said data such that the most effective advertisements can be placed on the digital assets (i.e. web pages) that the user visits. The ad broker or ASP can become aware of the assignment of access writes by either receives a message generated outside of the transaction system or through queries against the transaction system's ledger that look for transactions with the ad broker's or ASP's ID (i.e. PID) identified as the recipient and of transaction type being “access control”.

FIG. F9 demonstrates how an ad is generated in a user-centric ad-based marketplace. It is generally accepted that ad selection for a user is based upon an analysis of multiple data points created by or on behalf of the user. To this point methods have been described that allow an ad broker or ASP to collect information about a user in a user-centric compute paradigm. The FIG. F9 is described as having four relevant involved parties 1 transaction system, 2 the user, 3 the ASP and 4 the ad broker. At 5 the user visits an ASP (i.e. web site). The ASP responds 6 with a PID to identify the ASP and a request for a SID (unique secondary ID for this session) from the user. A user process creates a SID 7 and this SID 8 along with the chain ID for the set of user web interactions, and ASP ID are added to a transaction and executed by the transaction system. If the ASP is also performing the function of an ad broker then the ASP is identified as the recipient. If an ad broker is being used then the ad broker is the identified recipient. 7 and 8.1 provides for the user or a user process to inform the ASP or ad broker of the just executed transaction details. 9 and 8.2 provides for the ASP to inform itself or the ad broker of the just executed transaction details. 10 and 8.3 provides for the ad broker to inform itself the just executed transaction details. Regardless, the transaction is stored in the ledger. The transaction serves to provide an association between the SID (unique number for this session), the ASP PID, and a chain ID that identifies some transaction or set of transactions that contain prior user web activity, PII, etc. At 9 the ASP is made aware of the completed transaction. The ASP may be made aware of the transaction by querying (like through an API) their PID as a recipient in a new transaction or a user process may collect and forward the transaction ID to the ASP. Unless explicitly allowed, the ASP does not have rights to the chain ID. Additionally, the chain ID can be represented by a unique ID (i.e. SID) to reinforce confidentiality. The ASP will then pass the SID or transaction ID to the ad broker unless the ASP is generating ads in which case the ASP will have read rights to the user data. It is important to note that in a model where the user is using an ad broker that the ASP is passing a SID user chain ID and ASP identifier information (that are written into a transaction) to the ad broker so that the ad broker can then 10 query the transaction system 11 for data contained within the passed chain ID data collection (i.e. things the user has done). The transaction system will validate that the ad broker does in fact have rights to read the chain ID transaction set. That validation will be determined by inspecting a prior transaction written by the user to give the ad broker rights. This is why the ASP, who has the chain ID, cannot do anything with that information. Additionally, and is common within a user-centric platform, a transaction (such as one that provides rights to a user) can be anonymized through a subsequent transaction that create an LRN that provides for an association between one transaction ID and another. One may consider this capability as an anonymizing pointer. At 12 if the access rights are approved then the transaction system returns a result set of those identified transactions. At 13 the ad broker has information describing the user behavior, prior clicks, etc. and the ad broker has information on the ASP itself. The relevance of the ad broker having info on the ASP is to refine scope of interest, for example, the user is on Walmart.com then the ad broker should not provide ads for Target.com. Therefore at 14 the ad broker creates an ad strategy for the placement of one or more ads. It should be noted that while the preceding description of an “ad” is suggestive of an ad placed within a web page (i.e. banner ad) however, an ad could just as easily be expressed by voice (i.e. pre-recorded audio ad) or even paper mail. It should be noted that this process is happening in near real-time and could occur during the load of a web page, for example. Regardless, the intent is that for online (i.e. digital) ads the user is active within a session with the ASP. The ASP, being aware that they are engaged with a user will 15 “look” for an ad from the ad broker. If an ad broker is being used then the ASP does not know who the ad broker is. The ad broker, because of the transaction that they were tagged in does know who the ASP is because the ASP PID was included in the transaction. The ad broker, having an ad or plurality of ads, can either create a transaction with the ASP as the recipient or simply leverage a webhook or API query to the asp to with, and regardless of the method provide information to the ASP with either the ad data itself or a link (i.e. URL) to the ad data. It would be considered more common for a URI to be placed on the ASP digital asset (i.e. web page) such that easier tracking of “clicks” could be maintained. At 15 the ASP can identify that an ad exists through one of the several aforementioned methods. At 16 the ASP will display or otherwise render the ad for the user. The ASP will include an identifier such as the SID with the URI or URL for the ad. A mockup of a URL might look like, https: //www.someASP.com/session_SID=823498298347&ad=11222112. In this mock-up URL identifying information such as the session SID and a reference to the add are included to provide for session data to be collected by the user and written as a transaction in the event that the ad was clicked. At 17 the user may interact with (i.e. click) the ad or simply ignore it.

FIG. F10 demonstrates the process by which compensation or revenue occurs in a user-centric marketplace. FIG. F10 is described as having four relevant involved parties 1 transaction system, 2 the user, 3 the ASP and 4 the ad broker. At 5 the user visits an ASP (i.e. web site). At 6 the user clicks an ad that has been placed on the web page. At 7, and just like every other “click” or resource access a transaction is created, or in some cases batched up during the session, the data (resource, ASP info, etc.) is formed into a transaction 8 and written to the ledger 10. An asynchronous process takes by the ad broker. The ad broker, having previously been assigned rights by the user to session data will 9 query (like via API) the ad broker recipient PID. If exists, the transaction system, and 11 validating rights, will return 12 a result set including all transactions associated with their PID as recipient PIC. Within that set would be a transaction with the chain ID specified by the user. The ad broker could then, upon 13 parsing the identified as “new” transaction, perform a subsequent query for the chain ID that was contained in that new transaction. The ad broker could then easily identify 14 if an ad had been clicked. The data contained within the ad click transaction would contain information on the ASP. Additionally, in some implementations the ASP could write a transaction with the ad broker as the recipient. This is demonstrated in FIG. F11 at Item number 5, 6, 7 and 8 where the chain_id and URL data would act as a secondary or even primary system of record that a click occurred. FIG. F10 at F16 would then provide for the ad broker to pay the ASP. To “pay” could refer to sending money or some other exchange of value.

One may also consider that the process for ad revenue in a user-centric marketplace has so far not provided a means by which the ASP, when the user elects to use an ad broker, can determine or validate or otherwise confirm that the ad broker is fairly compensating the ASP for each ad click by each user. A remedy is to have the ASP create an LRN for each URL/URI rendered for each ad on each page for each user. A transaction would be created, similarly to the aforementioned processes for user-centric ad-based marketplace, that would provide an association between the ad and the ASP. Other identifying information, in some implementations could be included to assist with association and verification. Regardless, the result is that the user is able to prove what links she clicked, the ad broker is able to count and verify clicks on ads clicked on at the ASP, and the ASP is able to correlate with the ASP the ad click count as stated by the ad broker.

In some cases, the ASP may find it beneficial to provide a small payment, a micro-payment, back to the user to cover the cost of transaction execution by the user. A payment, in this manner, would involve a payment based on a cryptocurrency that is native to the transaction system. Demonstrated in FIG. F10 at 18 is a configurable option where the user may elect to receive compensation for accessing content, digital assets, etc. on the ASP. The configuration setting may be established through several manners. The transaction system could have a transaction that explicitly states that the ASP will compensate the user per click, per value of digital asset, etc. This transaction would give the ASP access to session state. This transaction would establish an understanding of the rules of compensation but would not perform the payment automatically. The transaction system could utilize an additional transaction that is specifically designed to provide a payment (i.e. micro-payment) to the user for each defined action or access by the user. One might align such functionality as is often described as a “smart contract” in blockchain lexicon. To review, one transaction between the user and the ASP that associates user session data with the ASP and inspectable by the ASP. That transaction, or may be a second type of transaction, establishes rules, boundaries and agreement for micro-payments made in exchange for access and use of digital assets. Finally, another transaction may be utilized to facilitate or automate the payment from the ASP to the user. At 19, in conclusion, a payment would be made to the user from the ASP. The payment itself would be a simple transaction executed by the transaction system that would send some amount of cryptocurrency from the ASP to the user. Additionally, and keeping in mind, that every transaction has a cost that is paid by the sender of the transaction. Alternatively, information could be exchanged between the user and the ASP such that a payment (like US Dollar) could be made outside of the transaction system.

Demonstrated in FIG. F11 is a table representative of the overall process of ad revenue in a user-centric marketplace. At 1 is a simple reference to a row in the table. At 2 is a reference to how the table row corresponds to a Figure and reference point. At 3 is an example of a message payload containing descriptive information. One may observe in the table that each transaction has a unique ID and that there are a variety of transaction types. The chain ID is used to provide an association between transactions. The message field within a transaction may contain a variety of different types of data from links the were clicked (URL/URI) as well as more complex data structures. In some implementations, binary data such as an image could be referenced to an “off platform” location or an image could be stored directly in the transaction message as binary, Base64, Hex, etc. In some implementations, the ad itself could be stored as a transaction. In such implementations additional transaction types could be defined that act as a record of access to a transaction. And, in some implementations a transaction could facilitate a payment to take place when an ad is “clicked” that is embedded or otherwise enabled from a transaction.

### Method for Write Rights Inheritance

Presented as method for write rights inheritance is an access control function. For any transaction the creator (i.e. sender) of a transaction may be viewed as the administrator of that transaction ID or chain_app_id. When enabled, the following method allows any recipient of a transaction for a given chain_app_id to then write transactions to the same chain_app_id. In contrast to “no permissions” assigned to a chain_app_id, only recipients of the chain_app_id can write new transactions. This is an administrative inheritance and does not require that the administrator user to assign rights explicitly (i.e. one by one) to each user. In contrast to explicit assignment of rights where only the chain_app_id administrator can explicitly declare which PIDs can write to the chain_app_id. No PID of recipient is required.

To establish the usefulness of this method one may imagine within a supply chain there are multiple parties involved with sharing resources, assets and information. A buyer may order a product from a supplier. The supplier may in turn issue an order from the manufacturer. The manufacturer may then order raw materials from several commodity sellers, and so forth. It is unreasonable to expect that the parties involved in a complex supply chain be identified and locked into a formal or informal organization (i.e. consortium) when such a model typically precludes the simple addition or removal of members.

The intent of the described method is to allow for the formation of dynamic and ad hoc data sharing network among parties to a supply chain. Of course, supply chain is only an example use case. Such a model could be easily applied to other use cases such as with the sharing of medical information, research data, etc.

FIG. F12 demonstrates a process flow where one party creates a transaction, chain_app_id in one transaction and then creates a subsequent transaction to assign write rights to recipients of a transaction associated with the defined chain_app_id. The process is described in the context of supply chain parties for clarity of process. However, the capabilities and features enabled with the described method can be used across a multitude of use cases where one party creates a transaction, chain_app_id, and intends for any subsequent recipient of a transaction with the defined chain_app_id to inherit right writes and to also explicitly reject any write attempts from parties who have not been a recipient of a transaction of the defined chain_app_id or who have not otherwise been explicitly given permission to write a transaction with the identified chain_app_id.

At 1 a user identified as “buyer” creates a transaction to order a product from a user identified as “supplier.” At 2 the transaction is formed such that the sender is the buyer, the recipient is the supplier and a new and unique chain_app_id has been created. The transaction at 4 is executed by the transaction system and subsequently written to the ledger. At 6 the buyer creates a transaction of type “assign write rights to any recipient of a transaction for this chain_app_id”. To simply the description we will define this type of transaction as “write rights inheritance” transaction. The “write rights inheritance” transaction at 4 is processed by the transaction system and stored to the 5 ledger.

At 7 the supplier identifies the transaction. A transaction can be identified by the recipient querying the transaction system for their ID (i.e. PID or SID) or by being informed through some other manner such as email, webhook, etc. The supplier will then, in this scenario process, create a transaction 8 to order a product from the manufacturer. In this transaction 9 the sender is the supplier, the recipient is the manufacturer and the chain_app_id would be the chain_app_id previously created by and used by the buyer. The supplier would submit the transaction data to the transaction system 10 and the transaction system would determine if the supplier has rights to write the transaction with the specific chain_app_id. The transaction system would inspect the ledger for “write rights inheritance” transaction with the specified chain_app_id. The transaction system would then inspect the ledger to identify if the current transaction sender was a recipient on a prior transaction of this chain_app_id. If such transactions are identified then the transaction submitted by the supplier will be approved by the transaction system and written 4 to the 5 ledger.

At 11 the manufacturer identifies the transaction. A transaction can be identified by the recipient querying the transaction system for their ID (i.e. PID or SID) or by being informed through some other manner such as email, webhook, etc. The manufacturer will then, in this scenario process, create a transaction 12 to order a product from the commodity seller. In this transaction 13 the sender is the manufacturer, the recipient is the commodity seller and the chain_app_id would be the chain_app_id previously created by and used by the buyer. The manufacturer would submit the transaction data to the transaction system 10 and the transaction system would determine if the manufacturer has rights to write the transaction with the specific chain_app_id. The transaction system would inspect the ledger for “write rights inheritance” transaction with the specified chain_app_id. The transaction system would then inspect the ledger to identify if the current transaction sender was a recipient on a prior transaction of this chain_app_id. If such transactions are identified then the transaction submitted by the manufacturer will be approved by the transaction system and written 4 to the 5 ledger.

The example scenario described in FIG. F12 can essentially carry on forever. It should be noted that branches may also exist where one party creates multiple transactions to different parties and each of those parties would, in turn, inherit write rights for the specified chain_app_id.

Although the method described for “write rights inheritance” is bounded to write rights one may expect a similar method to provide for read rights inheritance. While a system wide default configuration exists such that any named party (i.e. sender or recipient) within a transaction will have read rights to a transaction, the same default does not apply to chain_app_ids. Therefore, it is possible for multiple parties to have the right to write to a given chain_app_id yet those parties only have rights to read transactions for which they were the sender or recipient. All other up stream and down stream transaction may be blocked for reading by a given user. Therefore, and implemented in the same manner, a corresponding “read write inheritance” would also be a feature available from a transaction system.

### Method for Identity Encapsulation

Identity encapsulation refers to the methods by which the user's identifying information such as name, address, passwords, biometric data, etc. are encapsulated into a chain app (collection of transactions) and serve as an alternative to a user database or directory service (like Microsoft Active Directory). Through identity encapsulation, the system is able to offer self-sovereign identity where the user can authoritatively port or make access available to other platforms.

In its simplest sense, identity encapsulation moves user object data (like login and password) from a separate and separately controlled database into a single and monolithic ledger. The ledger will contain all transactions from all ledger participants and each participant will have their identity written as a set of transactions into the ledger.

Identity encapsulation allows the owner of his or her identity to both provision access to other parties as well as to provide for portability of his or her identity. Similarly, to up stack and down stack portability described above; the user can select “up stack” application service providers that can provide value added services related to identity such as age verification. Likewise, the user can select a different “down stack” provider such that her identity would exist on another transaction system.

Any unique transaction may include any number of chain_app_ids. A chain_app_id is optional and transactions can exist without any chain_app_ids.

Demonstrated in FIG. F19 is a table that represented a collection of seven transactions. In this table at 1 designates that for each row is a distinct transaction. At 2 is a transaction ID. At 3 is value to designate with the transaction whether a MLT array exists. In this table, as can be seen, there are no MLT arrays. This table is imply used as a baseline in conceptualizing transactions that have or rather do not have MLT arrays. At 4 is the value for the Chain ID. Here it can be seen that each Chain ID is unique. At 5 is the Sender PID. Every Sender PID is unique just as at 6 each Recipient ID is unique. Therefore, the described table is a collection of unrelated transactions. In no manner could those transactions be queried as a same set or related set or associated set.

Demonstrated in FIGS. F20 through F25 is a table with the same column headings as was described in FIG. F19. Therefore, the column headings described in FIG. F19 apply to FIGS. F20 through F25 and will not be “redefined”.

Demonstrated in FIGS. F20 through F25 are several tables that progress through a description of MLT arrays using mock transactions to assist in conceptualizing the practical use and value of user-centric MLT arrays.

Demonstrated in FIG. F20 is a list of transactions. In this table the sender is the same across all of the transactions. Therefore, the sender would have the right to share with another party rights to access this list of transactions. It is important to recognize that in user-centric computing the ID (i.e. PID or SID) listed in the “Sender PID” field will always have rights for the transaction. “Rights” fundamentally means that the sender can assign read rights to another ID. As a recipient, a user will always have rights to view a transaction but cannot assign read rights to another party unless the sender has given permission for the recipient to subsequently assign read rights to another party.

Demonstrated in FIG. F21 is a collection of transactions. The Sender PID is common across all transactions. Also, the Chain ID is common across several of the transactions. In particular, transactions (Item #) 2, 4, 5 and 7 represent a set in the form of transactions that are associated based on the Chain ID. The sender has “native” rights to share all transactions with whomever she pleases. Additionally, the sender has rights to share the transactions that are grouped together by the common Chain ID. Not shown is that the transactions associated with the common Chain ID would be sequentially numbered and serially hash bound together. This would allow the user (who is the sender) to share those transactions in such a manner as to allow the other party to valid each transaction AND validate the wholeness of the set. It should be pointed out that the Chain ID may be used only by this particular user or the Chain ID may be used by many users. Even if the Chain ID is used by many users the transactions by this particular sender would be sequentially bound as mentioned. The user would only have rights to transactions that she was the sender, recipient or was given permission by the administrator of the given Chain ID.

Demonstrated in FIG. F22 is a collection of transactions. One will notice that several transactions, Item #2, 3, 4, and 7 have multiple Chain IDs. In its simplest form that is what a MLT array is; two or more Chain IDs contained within a single transaction.

Demonstrated in FIG. F23 is a collection of transactions. One will notice that the Sender continues to be common across all transactions, several transactions have multiple Chain IDs and the Recipient is common across several transactions.

Demonstrated in FIG. F24 is 7 a collection of transactions. One will notice that the Sender continues to be common across all transactions, several transactions have multiple Chain IDs and the Recipient is common across several transactions. As an example, in this table the sender could give read rights to another party such that the other party could view the transactions associated with Chain ID “2XoDNjwYMHm6”. As mentioned previously, other users may have used this Chain ID if they had rights. Or perhaps only this current user has used this Chain ID. It does not matter. The objective is to prove wholeness of the set of transactions where the Sender PID is “1LxdkKM0L7Ug” and the Chain ID is “2XoDNjwYMHm6”. “Wholeness” of the transaction set means that the set is constructed in such a manner as to allow the viewer of that transaction set to prove the integrity and completeness of the set of transactions. As mentioned previously, this set 8 would have a sequential ID that is incremented by a count of “1” from one transaction to another. Additionally, each transaction would have information such as to serially bind this transaction set together with hashes of data that span the current transaction with the preceding transaction. The result is that the party haven been given rights to view the set of transactions can independently prove with the information provided that the set of transactions, for the provided parameters, is whole, immutable and therefore fully trusted.

Demonstrated in FIG. F25 is 9 a collection of transactions. One will notice that the Sender continues to be common across all transactions, several transactions have multiple Chain IDs and the Recipient is common across several transactions. As an example, in this table the sender or recipient, if permissioned, could give read rights to another party such that the other party could view the transactions associated with Chain ID “RbvOXUB4ZK98” and Recipient ID “islgGOx0kVSm” as a 10 provably whole set.

To conclude, a MLT array allows for a user of a user-centric platform to establish sets of related transactions for the sender, the recipient and with a plurality of Chain IDs.

### Method for Practical Tokenization of Digital Assets

The following describes an invention disclosure for tokenization to provide functionality similar to CarFax for laptops, servers and other electronic devices that support logic. Could be used to prove:
OEM
Date/Time of events
Original BOM
SN and identifying data
Original owner
Assignment to subsequent owners
Processor telemetry data

What about proof of other components? The OEM could attest to components included at time of manufacturing.

What about components changes out at some point? The owner could add new records as components are changed.

How is ownership in the data set (chain ID) for a particular laptop transferred? This is where I have some ideas.

When a laptop is manufactured at OEM facility the BOM could be added to a chain ID specific to this laptop. The OEM would create a transaction of type inherit and rights abandon (IRE). Sort of like NFT.

The OEM would create a transaction of type Persistent Write Rights and assign to the processor ME. This means that the processor ME would always have rights to write data to the chain regardless of any other rights assigned to the chain. This type of transaction does not allow anyone but the assigned owner (IRE) to read data from the chain. The IRE based current owner can give read rights to others until the IRE closes is or is otherwise reassigned.

The OEM would use an IRE transaction to assign rights to the processor ME. The ME could write telemetry data to the chain.

The IRE means that the OEM can assign rights to another party, like the reseller. Once the rights have been assigned to the reseller then the OEM can no longer assign rights to anyone else or inspect subsequent transactions to the chain.

The reseller could add information to the chain.

### Method for Tokenized Digital Asset Access

The following describes an invention disclosure for practical access to tokenized digital asset such as an image (i.e. JPG) with an open pointer structure (i.e. URL). This would allow a web page hosted by a third party to pull an image registered on a user-centric transaction provider.

In a user-centric computing environment it is expected that browers and apps will continue to pull digital resources from remote locations. Those remote location, in user-centric computing, will be transaction providers rathe than traditional web servers. Further, client-side languages such as HTML and Javascript will continue to be used to reference where specific digital assets are located and how to access them.

In user-centric computing there may also be circumstances where a fee for access requirement exists.

This IDF covers methods to:

Reference, markup or tag or describe where a digital exists within a transaction provider and to pass credentials to that transaction provider.

Provisions such that the owner of the digital asset can charge for access to the digital asset. This will also require method to 1) report on access to interested parties, and, 2) a practical method to disclose to a user that a fee for access is required.

Provisions such that a third party can be compensated (i.e. paid) for directing a user to the digital asset owned by another party.

Further this IDF covers method to report or account for access to transactional data. An example is a legal requirement for a vehicle owner to acknowledge read of recall. An example is where a user accesses an image (i.e. JPG) that is registered on a user-centric transaction provider. The owner of the image (transacitonalized on trx_sys) may require 1) a means of reporting access of the image by anonymous parties, or, 2) a means of charging users that are permissioned to access the image.

To establish context, in a convention sense digital assets such as images and digital photographs are accessed through, as an example, HTML. Examples are from <w3schools.com>. An image might be referenced in HTML as:
<a href=“https://www.w3schools.com”>
<img border=“0” alt=“W3Schools” src=“logo_w3s.gif” width=“100” height=“100”>
</a>

Another example where an email address is linked:
<a href=“mailto:someone@example.com”>Send email</a>

Another example where a phone number is linked:
<a href=“tel:+4733378901”>+47 333 78 901</a>

Referencing a digital asset from a web page (etc.) that points to a transaction container

In conventional Internet systems architecture there is typically 1) a client using a browser or client application (i.e. mobile app) and, 2) a web server. The client, whether browser or client, will be developed, such as with HTML, and is able to access data on the server. Simple example are provided above.

In conventional technology the Internet application model might be described as a solution stack with:
Client
Server

Of course, a variety of technologies exist in a practical sense such as a web server, a database server, a user account server, and all of these systems are connected via API, RPC, microservices, etc. But all data served to the client is bound to the company hosting the data.

In user-centric computing data may be owned and controlled by an Application Service Provider AND data may be owned and controlled by the end user.

However, the solution stack will be described similarly as the conventional Internet application model of:
Client
Server

In a conventional sense a modern web application controlled by the web server. In user-centric computing the client has much greater responsibilities for the control and flow of data. User-centric computing decouples data, identity and trust from the services layer.

Regardless of how different user-centric computing is, the end user will have an expectation of user experience as has been established by conventional and modern web applications.

A user-centric application will share data with the Application Service Provider (ASP). It is important to point out that the objective of user-centric computing is NOT to provide anonymity of the user to the ASP. The objective is to provide the user with controls and trust over data resulting from an interaction or session with the ASP.

User-centric applications will be structured very similarly to modern web application with a few changes.

Identity. The identity of the user will be provided by the user. A registration process where the ASP stores or otherwise keeps any registration is unnecessary and likely in violation of user-centric computing principles. User-centric computing provides a novel Open Authentication model for session state management. See IDF_method_13_User_Centric_Open_Authentication.docx. Fundamentally, session state is managed by the end user.

Structure. The structure of the user-centric application, whether web browser (ie. HTML) based or web application based will utilize common practices for presentation and GUI development. Elements referenced or called from a “page” can be called in a traditional manner, such as an image being referenced through a HTML <image> tag. Additionally, in user-centric computing a page may reference transaction containers stored on a transaction provider.

A simple HTML page to display an image and the user's first name in a conventional application will require a server process (i.e. script) to pull the user's first name from the database containing user information. In user-centric computing the name is rendered from the client in the following manner.

As an example of how a simple script would display an image and a user's first name in user-centric computing the following provides a conceptual model.
<html>
<head>
<title>Acme Store</title>
</head>
   <body>
<a href=“https://www.w3schools.com”>
<img border=“0” alt=“W3Schools” src=“logo_w3s.gif” width=“100” height=“100”>
</a>
   <a href=“https://www.trx_sys.com”><transaction_container render=“text” transaction_type=“352” index=“0” mode=“read”>
   </a>
   </body>
</html>

In the above code example a new HTML element is provider. Of course, the actual implementation may vary with this pseudocode example being used to convey the concept.

Continuing with the preceding “mock up” a <a href> HTML tag is provided that points to trx_sys, a user-centric transaction provider. A keyword “transaction_container” establishes that the intent of the program is to reference a transaction container. “Render” establishes that raw unencrypted text is to be returned. The “transaction_type” refers to the type of transaction. In this mock-up transaction type “352” would simply refer to an identity transaction that would only contain the user's first name. The “index” states that for all transactions of type “352” only the latest or most recent record would be returned. The “mode” states that this action is “read” as opposed to “write”.

The script would be executing on the user's client browser (or app) and the user would be logged in or otherwise validated to the transaction provider. Therefore, the ASP server does not need to and is not able to query the name data of the user.

One may observe that the preceding example operates in a manner that may be viewed as cross-site scripting which is true. Cross-site scripting, in conventional technology models presents a significant security risk. However, in user-centric computing that threat does not exist because of 1) transaction functions are limited, and 2) transactions are executed within the user identity scope or within a known identity scope.

### Charge for Access to a Digital Asset

Provisions such that the owner of the digital asset can charge for access to the digital asset. This will also require method to 1) report on access to interested parties, and, 2) a practical method to disclose to a user that a fee for access is required.

In the preceding section a description was provided as to how a transaction container could be referenced from within a client-side web page or web application.

In some cases, it may prove useful to enable the provider of a digital asset (i.e. image, video, sound file, etc.) to charge the consumer or end user a fee for access.

Of course, such a charge model is readily implemented in classic or legacy Internet application architecture. Those same methods could continue to be used in user-centric application architecture. The downside to the legacy model is that the accounting and charging for access by an end user to a digital asset would require that the Application Service Provider (ASP) to 1) manage end user identity (who is access the digital asset), 2) registry of access (accounting) and 3) remuneration (billing). Of course, user-centric computing could simplify the legacy Internet application architectural model through, for example, derived identity services, please see IDF_method_20_Derivative_Identity.docx.

User-centric computing can shift those functions to the transaction provider and end user.

An overview of the process (a scenario) to describe how an end user could access a music video (video1.mov) that was described on a music video web site, an ASP. Of course, user-centric computing provides several ways to implement the details of the following example.

The end user, Alice, is registered with a user-centric transaction provider and is using a browser or mobile app that is user-centric computing compatible.

A user-centric compatible browser or mobile app is one that is able to interact with a transaction provider using credentials made available to the client platform.

The music video web site lists a description of many music videos.

Alice finds a video that she wants to play.

Alice knows that she has to pay a small fee to access the video.

Alice clicks on the music video link.

The link to the video is actually a reference (like URL) to a transaction container or chain ID that contains the music video (optionally may contain a reference to the actual music video source file).

Upon clicking on the link, a transaction call is made to the transaction provider that has the specified transaction container. Included with the transaction call is the user credentials. The call goes directly from the client to the transaction provider. The music video web site does not need to know who Alice is or record her clicks (session state).

The transaction container for the music video may reference other transaction containers or have information contained within itself to describe the fee for access, how to report or log access through the creation of logging transactions, and finally to charge Alice's account.

Because there is a fee for accessing the file one of several options could occur:

A notice is presented to Alice to approve the fee.

A notice is presented to Alice to approve all fees (up to a limit) within a time bound scope to allow Alice to view (and pay for) access multiple music videos.

On click (approving) of the notice for the fee(s) then another specialized transaction is executed from the user. Again, the user state or credentials are passed from the client to the transaction provider without interaction or visibility by the ASP.

Either a onetime transaction takes place, again from the user state, that creates a transaction that sends the required fee (in user-centric cryptocurrency) to the ASP. Or, an escrow method or batch/hold method creates a transaction chain ID to tally up fees for the specified time period.

Upon successful receipt of the payment (if required) the specialized transaction that contains the video will decrypt the music video and serve it to the client.

Alice will then watch the music video.

### Third Party Compensation

Provisions such that a third party can be compensated (i.e. paid) for directing a user to the digital asset owned by another party. In some cases, perhaps many cases, an ASP will list many digital assets, such as music videos, that an end user can peruse. The ASP, in this case, will act as a broker. The ASP provides value in curating and presenting a set of digital assets. In this case, the ASP provides a value-added service to both the end user as well as the content creator.

To enable a model of compensation from the end user to both the content creator as well as the content curator the following example scenario should suffice as description of the concept.

The end user, Alice, is registered with a user-centric transaction provider and is using a browser or mobile app that is user-centric computing compatible.

A user-centric compatible browser or mobile app is one that is able to interact with a transaction provider using credentials made available to the client platform.

The music video web site lists a description of many music videos.

The creators of the music videos retain rights to the music videos that they create. But they agree to provide a commission to the music video web site.

When the musician creates the music video a .MP4 file is the actual digital asset. The musician uploads the .MP4 to a specialized transaction of chain of transactions that stores the .MP4 (optionally a reference to another location may be provided).

The musician creates a specialized transaction that states that:

The total cost to access the music video is $X (user-centric cryptocurrency)

If referred by a third-party then the commission is $X % of the fee.

Alice finds a video that she wants to play.

Alice knows that she has to pay a small fee to access the video.

Alice clicks on the music video link.

The link to the video is actually a reference (like URL) to a transaction container or chain ID that contains the music video (optionally may contain a reference to the actual music video source file).

Upon clicking on the link, a transaction call is made to the transaction provider that has the specified transaction container. Included with the transaction call is the user credentials. The call goes directly from the client to the transaction provider. The music video web site does not need to know who Alice is or record her clicks (session state).

The transaction container for the music video may reference other transaction containers or have information contained within itself to describe the fee for access, how to report or log access through the creation of logging transactions, and finally to charge Alice's account.

The transaction containing the music video or another transaction in the chain of transactions will describe how in fees charged for access will be distributed.

The system inspects the fee structure and constructs two or more transaction to facilitate compensation to the intended parties.

Because there is a fee for accessing the file one of several options could occur:

A notice is presented to Alice to approve the fee.

A notice is presented to Alice to approve all fees (up to a limit) within a time bound scope to allow Alice to view (and pay for) access multiple music videos.

On click (approving) of the notice for the fee(s) then another specialized transaction is executed from the user. Again, the user state or credentials are passed from the client to the transaction provider without interaction or visibility by the ASP.

Either a onetime transaction takes place, again from the user state, that creates a transaction that sends the required fee (in user-centric cryptocurrency) to the ASP. Or, an escrow method or batch/hold method creates a transaction chain ID to tally up fees for the specified time period.

Upon successful receipt of the payment (if required) the specialized transaction that contains the video will decrypt the music video and serve it to the client.

Alice will then watch the music video.

It should be noted that the preceding scenarios and examples represent only one possible implementation of the described use cases. It is expected that when one becomes familiar with the concepts of user-centric computing that the underlying methods will allow for a multitude of other implementations.

### Method for Creator Rights Asset Attestation

The following describes an invention disclosure for Method to mitigate deep fakes, counterfeiting and enforce creator rights with digital assets such as images, video and audio.

User-Centric Transaction Provider provides a universal truth of uncontestable data. A web site could host images or videos that are registered with User-Centric Transaction Provider. That would provide for a timestamped record of origin for any particular digital asset. A digital asset accused of being fake would have identity (or PID) of the user. The web site could require that digital assets provide further identity information. Given that identity is “irreplaceable” it would be too significant a risk for the owner or creator of the digital asset to deal with deep fakes.

In a more complex manner, User-Centric Transaction Provider could have analytic processes that analyzes digital assets that are being attempted for registration to see if infringement is detected. Something like partial has analysis. My preference is that User-Centric Transaction Provider makes analysis of registered images available to some “registered” third party service that performs this function.

### Document Conventions:

Other brands and names are used to convey the concepts of user-centric computing.

### Creator Authenticity

Creator Authenticity has presented multiple challenges to the tech industry as conventional industry-centric platforms lack universal trust, sovereign identity and authoritative portability. User-Centric Computing is the first data platform to solve the challenges of Creator Authenticity in a practical, cost effective, global and high-speed manner.

In support of Creator Authenticity, a User-Centric Computing can enable:

Registration of digital assets to prove provenance.

“Chaining” or establishing associations across multiple related digital assets.

Watermark integration and digital asset search.

Rights requests.

Assignment of rights from read, to read for fee, to transfer of rights.

Provide privacy of identity related to registered digital assets.

Native storage of digital assets on User-Centric Transaction Provider versus off-platform storage.

Track usage of a digital asset.

Facilitate compensation for use of a digital asset.

Identification of usage and infringement of digital assets across controlled and even uncontrolled media.

Digital asset defined:

A digital asset would include any combination of visual, acoustic and other data that represents a medium that can be used by a human for entertainment, education, business purposes, etc.

Supporting Creator Authenticity with Registered Digital Assets and Watermarks:

User-Centric Computing stores data in a manner that results in it being “provably” reliable. Any interested party with permissions can inspect transactional data hosted on a User-Centric Transaction Provider to establish its authenticity, timestamp, and immutability. For Creators, User-Centric Computing enables one to register a digital asset that can be easily proven to have been created by a specific person or business at a specific time.

Registering a digital asset is just one part of the puzzle however. Methods need to exist to allow an interested party to inspect a digital asset such that ownership, rights and conditions of use can be readily determined. Methods need to exist to allow for identification of the asset when its usage is infringed upon. Methods need to exist to allow for the billing of digital asset consumption.

Existing methods include watermarks that are often applied to digital assets to include information in a digital asset to assert ownership, conditions of use, etc. Additionally, notices are applied on web sites. Additionally, some digital assets are encrypted such that a key is required to decrypt the content.

Multiple methods of watermarking exist within the industry. In some cases, a digital asset is altered where information is added in either a visible or invisible manner. In other cases, information is derived, such as through hashes of an image. Finally, information is embedded in the digital assets file name or associated meta descriptors. These methods, collectively or independently allow the Creator to mark a digital asset.

In many cases, the preceding methods are sufficient for low risk or low value sharing of digital assets or where a suitable alternative is simply not available. However, where risk or value is “not negligible” then a higher degree of trust is required. The watermark in a digital asset can provide information describing limits of usage or directs an interested party to a site with said information. From the perspective of the interested party (the user) of a digital asset, challenges exist with regard to 1) common standards for a repository, 2) immutable information, and 3) consistent methods for engaging with the Creator.

User-Centric Computing solves all of those problems. But one may consider that a User-Centric Transaction Provider becomes the “singular vendor” which introduces other risks. In particular: 1) A singular vendor can “lock in” users and increase prices, and reduce the user experience without threat or concern of users having practical alternatives. 2) A singular vendor is a single point of failure.

User-Centric Computing mitigates the aforementioned risks of vendor lock-in and single point of failure through its very design. User-centric computing requires complete and authoritative portability of data. Eventually there will be other user-centric transaction providers and users of User-Centric Transaction Providers could easily move their data elsewhere. This is a native feature of user-centric computing. With regard to single point of failure, if a User-Centric Transaction Provider were to fail, users could likewise port their data to other platforms. Universal trust means that the data is trusted to a degree that the data could even be ported to non-user-centric or institution-centric platforms.

User-Centric Transaction Providers support of watermarks extends to digital assets that have been marked by a third-party watermarking process. An example would be watermarks applied by Imgix (https://imgix.com). The Creator could apply a watermark from imgix and then register the asset with a User-Centric Transaction Provider.

Additionally, a User-Centric Transaction Provider is a platform that supports “up stack” Application Service Providers (ASP). An ASP could automate watermarking using proprietary (licensed) methods as well as commonly accepted practices such as creating a hash of a digital asset.

User-Centric computing provides for methods to allow a Creator to register information about the digital asset as well as the digital asset itself. The Creator can establish a “terms page” or “conditions of use” page that watermark information can reference or point to. And, those terms, being immutable, will be highly trusted. Additionally, because of how User-Centric Computing can “chain” together related transactional data, new terms or updated terms, and designation of ownership can be recorded and referenceable from the original watermark.

Watermarking, as described so far, establishes a means of establishing authenticity and terms of usage for a digital asset. However, methods to 1) facilitate an accounting of usage, and 2) identification of infringement are required for a Creator Authenticity platform to be useful.

### Accounting of Usage

User-Centric Transaction Provider allows for “transactionalization” of digital assets. To “transactionize” a digital asset means that the digital asset has been stored in its entirety as a transaction within a User-Centric Transaction Provider. Therefore, a web site, for example, could use a User-Centric Transaction Provider as the <img src> directly. Please see IDF_method_21_Tokenized_Asset_Access.docx. The <img src> tag could include a token identifying the hosting web site. When the image is accessed in this manner then a record, in the form of a transaction, could be recorded by the User-Centric Transaction Provider. The record of the image being accessed would serve as a verifiable and immutable accounting of digital asset access. Alternatively, an abstraction of a non-transactionalized digital asset could reference an “off platform” resource location but with an accounting still possible on a User-Centric Transaction Provider.

FIG. G2 describes the process by which a user may be charged for accessing a digital asset from a browser.

Finally, User-Centric Computing could facilitate a micro-payment capability where multiple parties (i.e. the Creator and hosting web site) could be compensated through User-Centric Computing native cryptocurrency or through a third party payment broker. This capability effectively provides a solution to annoying “pay walls”.

### Detecting Infringement

Infringement would include any violation of the terms of a registered asset. While the digital asset is hosted or referenced from a User-Centric Transaction Provider, infringement is simply not possible. However, and is often the case, a digital asset is copied from an authorized web site. The same could happen to digital assets rendered from a User-Centric Transaction Provider. An image would still exist either in a web page or in an application. And that image could be copied.

The benefit provided by User-Centric Transaction Provider is that when a consistent registry of digital assets exists, even if spanning multiple User-Centric Transaction Providers, then it becomes easier for anyone to identify the usage terms of a digital asset. Additionally, if one were to attempt to “re-register” a digital asset to which they did not have rights to then a valued-added ASP (like https://regiztree.com) could be useful in identifying the attempt of improper registration.

Identifying digital assets that have been improperly copied from the User-Centric Transaction Provider ecosystem becomes more difficult as some means of discovery must exist. In this respect, a User-Centric Transaction Provider or a third-party could routinely, or per request, scan image repositories of search engines. Or, in the case of a Creator becoming aware of an infringement would have proof of digital asset registration and could then pursue remediation through the judicial system.

### Constraints:

Browsers do not currently include a native DRM capability for diverse media. Encrypted Media Extensions (EME) are primarily limited to video. EME has been highly controversial because it places a necessarily proprietary, closed component which requires per-browser licensing fees into what might otherwise be an entirely open and free software ecosystem. (source: wiki.com)

### Design Objectives:

The system should support diverse media, browsers, apps, etc. such that an ecosystem will be encouraged to flourish.

The system should be simple for creators to register digital assets.

The system should be simple for creators to assign rights to another party.

The system should enable other parties to search for and identify a digital asset that has been registered with the system through watermarks, keywords, etc.

The system should provide methods to allow a third party that has rights to the digital asset to compensate the registered owner of the digital asset when the digital asset is accessed.

The system should provide methods to allow for the identification of infractions of usage across an open ecosystem.

Proof of digital asset creation.

Method 1: Artist, etc., can register an entire digital asset with User-Centric Transaction Provider

Method 2: Artist, etc., can register an abstraction (i.e. hash) of an entire digital asset with User-Centric Transaction Provider.

Additionally, artist, etc., can register keywords and supporting meta-data to enable others to query, identify and search for a registered digital asset.

Overview: A digital asset registered to the User-Centric Transaction Provider transaction system establishes a system of record keeping that would allow the creator to retain rights or assign rights to others.

### Assignment of Rights.

Method 1: Registered owner of digital asset can assign read rights to individuals, companies and groups of users.

Overview: The owner can assign rights to another party such that a party acting in the capacity of a content provider (also known as Application Service Provider) can 1) make access available to the digital asset such that it is served from User-Centric Transaction Provider. Or, 2) the content provider, having a local copy of the digital asset provides an accounting of access of the content that is recorded as transactions in the User-Centric Transaction Provider ledger. The User-Centric Transaction Provider ledger can be used to reconcile required payments.
Person goes to content registration web site.
Enters data
Enters their PID
Enters their email
Enters their phone
Address???
Company name???
URL???
Asset Type [image, video, audio, physical (non-digital)
Asset Transactionized [yes, no]
Accrual Method [text]
Accrual Periodicity
[https://www.dublincore.org/specifications/dublin-core/collection-description/frequency/]
Accrual Policy [text]
Title
Alternate Title
Description [text]
Language [English
Mandarin Chinese
Hindi
Spanish
French
Standard Arabic
Bengali
Russian
Portuguese
Indonesian
Urdu
Standard German
Japanese
Swahili
Marathi
Telugu
Turkish
Yue Chinese
Tamil
Western Punjabi]
Rights
Creative Commons
Commercial & other
Agent or Mediator
Keywords
Click [Go]
Regiztree (upload.pl)
Collect params, validate
API: Checks that PID is ok, queries email.
Else fail
API: Transaction to create new Chain ID
Hash taken of photo
API: Transaction to register photo
API: Transaction to register metadata
[sender is Registration Site, recipient is PID person]
API: Create assignment transaction for Chain ID assignment.
Has a fee described but not charged at this time
Email sent to person
Has chain ID and link
Has transaction IDs and link
User can log into their account on User-Centric Transaction Provider
Can see transactions and links
So far, has been free for user. However, if the user wants to assign rights then the Registration Site has to assign “reassignment rights”.
Person creates special transaction
Enters chain ID for Assignment
[sender is person, recipient is PID regiztree]
Fee gets paid to Registration Site when trx executed.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

### Method for Intersystem Communication Session Token

The following describes describes an invention disclosure for managing password credentials for intra-system communication across a services layer.

### Managing the Password:

At the time that a transaction is executed the password is passed from a form or API to transaction_exec.pl and is used to decrypt private key.

The challenge is that every time a transaction is written the system will ask for a password. The need, therefore, is for a method to enable multiple transaction writes when the user is authenticated without the user having to enter their password with each write. This challenge, of course, also exists with other sites (Application Service Providers) operating like OAUTH2.

### Solution:

Ok, thinking out loud. The password is needed to decrypt the user's private key. The options, therefore, are to store the password or private key in clear text for the duration of the session. I like how currently the password exists in clear only briefly and in the script at run time. However, reality is that if the server was compromised then transaction_exec.pl could be modified to siphon off passwords. But that would still require that transaction_exec be modified. That risk could be mitigated through monitoring capabilities. Further, if the server was compromised at that level then it is essentially “game over” for the server. If the credential is stored in clear text, even temporarily in a database or other “file” then that file could be read. However, this is all about balancing security with functionality. Fact is that scripts must run. Maybe scripts could be compiled to obfuscate credentials or credential paths. But fact is that credentials exist, must be stored, must be accessed but with the least risk.

### Method for Hash Type or String Enforcement and Evaluation in the Sender Message

Presented in the following describes an invention to enforce only hash data in a message to make sure that actual data is not loaded. Is a security and data normalization benefit. Special transaction types have already been discussed that enforce a chain app template. This function is an extension of chain app template but instead of requiring a template structure for data written to a specific chain ID, this function requires and checks that hash data is only allowed.

Security and data standardization benefits are realized when a user permissioned to access transaction container data can be assured that the message data will only contain alphanumeric strings and has no risk of malicious code injection.

To enable a proof that only hash type or pure alphanumeric data can be included in a transaction container message data there are several methods provided below.

A special field can be made available in the transaction type that creates a new chain ID.

If a chain ID was created without the aforementioned configuration variable set for “hash type data only” then a subsequent transaction type of a special type (unique identifier for transaction type) can be created and assigned to the chain ID in question. Because there may exist transactions for the respective chain ID that existed before the setting of the Hash Typing Enforcement transaction one of two optional actions could take place.

Action one is for the system to reject the transaction for Hash Typing Enforcement as the respective chain ID may not be “clean” with respect to message data.

Or,

Action two is for the system to accept the transaction for Hash Typing Enforcement and perform an analysis of the message data contained within the respective message fields of the respective transactions. If upon analysis the transaction are found to be “clean” then the system may allow the transaction to be written.

Or,

As is described with the preceding two options one can imagine other options such as flagging “non-clean” transactions such that they may be filtered out of queries or otherwise notice made to the querying party.

Then, upon completion of the preceding it will be expected that users will continue to write and read transactions for that chain ID.

When writing a transaction to a chain ID set as Hash Typing Enforcement then the system will inspect incoming transactions to validate adherence to Hash Typing Enforcement requirements.

Hash Typing Enforcement requirements may include:

Variably configured values for minimum and maximum string length.

Variably configured characters (i.e ASCII, UTF-8, etc.) that are explicitly allowed or explicitly disallowed.

### Method Ephemeral Chains

The following describes an invention for Ephemeral Chains.

An ephemeral chain has characteristics of existing for a fixed period of time. A typical use case for an ephemeral chain is to establish an immutable and highly trusted audit capability. In some cases the requirement is for auditing capabilities to exist for only a temporary period of time. Once that period of time has expired then the data associated with the immutable audit log would be deleted.

Ephemeral ledgers may also be offered at a lower price per transaction than immutable ledger.

Ephemeral chains may have any of the following properties:

Rolling delete per record of first in first out where the chain persists but the records expire individually based on timeframe.

Rolling delete per record of first in first out where the chain persists but the records expire individually based on quantity of transactions.

Rolling delete per record of first in first out where the chain persists but the records expire individually based on ephemeral chain data size.

Records are collected in batch, written to an ephemeral chain and then deleted upon expiration of the time limit.

Transaction meta data is retained on the primary ledger with ephemeral message data written off chain where either of the four preceding configurations can be applied.

### Considerations to Design Requirements:

Given that characteristics of the ephemeral chain such as quantity of transactions and the size of the data message will be deleted at the expiration of the timeframe, ephemeral chain size or quantity of transactions a challenge exists in the manner of establishing a proof of activity such that the sender's fees can be proven after the fact.

An ephemeral chain is separate from the primary ledger. An ephemeral chain is not hash bound to the primary ledger. The result is that it would possible for a transaction system to manipulate the ephemeral chain. Therefore, methods need to exist to establish the integrity of ephemeral chains.

What data is available to the ephemeral transaction or ephemeral chain?

The question is; how does one party write a temporary transaction to a temporary chain such that others can rely upon that data as fully trusted for the given duration?

### Process

User, defined as Party A, creates a transaction to declare an ephemeral chain. User sets option such that the chain completely disappears after, for instance, one month.

trx_sys records transaction and ephemeral chain ID.

trx_sys creates ephemeral ledger database for the specified chain ID.

The sender can write transactions to the ephemeral ledger database using the specified chain ID.

At the end of the specified one month period the ephemeral ledger database is deleted.

### Actions

During the active period of the ephemeral ledger database another party, defined as Party B, has a need to validate the ephemeral transactions.

Party B can inspect the transactions and validate that they were correctly recorded.

Challenge: How can either party establish that the ledger has not been manipulated given that there is no multi-tenant data mixing of persistent historical hash record?

Solution A.1: All interested parties are identified before the ephemeral chain is created and given access to the ephemeral chain. Each party can query and record to their own data storage system the transactions of the ephemeral chain. Given that each transaction is signed by the governor, each transaction is hash bound to the preceding transaction, and each transaction is signed by the sender a manipulation of the data would require collaboration by both the trx_sys governor and the sender. Further, the locally distributed ledger data held by Party B would serve as proof of the status of the ephemeral ledger at any given sequential transaction ID or point in time. If, for example, the governor intended to manipulate and regenerate the ledger then the trx_sys governor would have to compromise the sender's keys. The sender, if intending to manipulate the ephemeral ledger, would have to compromise the trx_sys governor's keys. Further, Party B would have a copy of the legitimate ledger which would create a means of contesting the ephemeral ledger. Locally distributing ephemeral transactions is optionally based on the requirements of the involved parties.

Solution A.2: Further, any party to the ephemeral chain could request that a snapshot hash be taken of the ephemeral ledger by trx_sys and recorded to the primary ledger. This would be optional.

Challenge: How will the ephemeral chain be billed? If it disappears then there would be no record of it existing aside from the snap shot.

Solution: The snap shot could include a summary of activity (like a ledger of sender, receives and fees. Alternatively or optionally, for a ledger to “expire” all parties could be required to sign a “close of ephemeral chain”. This would give each party an opportunity to copy the data themselves (DDLT-Discretely Distributed Ledger Technology) and to formally acknowledge the validity of the data set as well as the formal close of the data set.

Solution (additional details): When calculating a user's balance if the ephemeral ledger is open then an ephemeral ledger CLOSE transaction is permanently written to the permanent ledger. This will allow a transaction calculation to reference those calculations IF an ephemeral ledger CLOSE transaction does not exist. If an ephemeral ledger CLOSE transaction exists then it can be inspected for a sum of sends/receives for that user.

Challenge: What exactly happens to the data or file structure once an ephemeral ledger is closed?

Solution: The ephemeral ledger is written to a database outside of the immutable ledger. Once it is closed then all of the corresponding transactions written to the specific ephemeral ledger are permanently deleted. This will allow for easier data management and unfettered growth of data size to be better controlled.

### High Level Design

Ephemeral chains exist outside of the hash bindings of the primary ledger.

Option: trx_sys governor could write a lightweight receipt transaction to the primary ledger. Drawback is that this will consume permanent data on the primary ledger.

Option: The customer utilizing ephemeral chains accepts that trx_sys holds the truth and basically the customer trusts that trx_sys will behave. Drawback is that this places a burden on trx_sys to establish a truth without a corresponding truth.

Option: See Solution A.1 above

### Method for Chain Manifest

The following describes an invention for Chain Manifest. The method for a chain manifest is useful in establishing a declaration of a whole set of transactions. This is an extension of Multiplexed Ledger Technology (MLT) as has been described by the named inventor listed on this invention. Restated, the method for a chain manifest is used to create a transaction that declares a whole set of transactions.

In some cases, a transaction may not have information, like a label or ID, that would provide useful at a later date in establishing a set of whole records.

A chain manifest can be used to establish wholeness of a record set of, initially, unrelated transactions or transactions not otherwise having keys or explicit associations.

The chain manifest is an attestation certificate where a transaction service provider asserts the wholeness of the record set through other identifying methods.

A chain can be created that states

### Chain 001

trx 1
trx 2
trx 3<--want to make a part of set referenced in Chain 002
trx 4
trx 5<--want to make a part of set referenced in Chain 002
trx 6
trx 7<--want to make a part of set referenced in Chain 002
Chain manifest with Chain 002
reference chain 001 trx 3, trx 5, trx 7

### Chain 002

trx 1, reference Chain 001, trx 3
trx 2, reference Chain 001, trx 5
trx 3, reference Chain 001, trx 7

Then Chain 002 Manifest can be used to provide for proof of wholeness of set. That it is a manifest denotes that certain data has been omitted by that the manifest represents a declaration of wholeness. In certain circumstances the root chain can be used for proof.

Challenge: How to easily determine or query that any particular transaction ID is part of a chain manifest?

Solution: A chain manifest will typically be associated with a specific chain. In this case a chain manifest transaction within the specific chain could be used to easily reference the manifested transaction IDs.

Challenge: However, in some cases a chain manifest could span multiple chains. It may be burdensome to query if any specific transaction is part of a chain manifest.

Solution: A database field could be flagged in each transaction that is part of a chain manifest. In some cases, a given transaction may be part of many manifests. The solution is that the database record flag would be an array of chain manifest IDs.

In some cases it may need to be proven that a set of transactions are related across many different fields (i.e. transaction ID, chain IDs, PIDs, and even message content). And, that declaration of what constitutes a whole set may include subsequent transactions that have yet to be written. The solution is that the chain manifest can include programmatic expressions to be used in a transaction protocol. Please see the invention by the same named inventor of this invention covering Transaction Protocol in a User-Centric Transaction System. The following text may be similar to what is described in that patent filing to establish scope and context.

An expression of a user-centric transaction protocol such as INCLUDE_TRANSACTION_ID can be used to specifically include transaction ID.

An expression of a user-centric transaction protocol such as INCLUDE_CHAIN_ID can be used to specifically include chain ID.

An expression of a user-centric transaction protocol such as NOT_INCLUDE can be used to specifically include transaction ID or chain ID or PID or a regular expression.

An expression of a user-centric transaction protocol such as is based on common regular expressions can be used to identify a string within a sender message.

Control structures such as is common in programming languages such as “if” “then” “else” and so forth may be included in the transaction protocol.

Other common variables, expressions, assignment statements, brace-delimited blocks, control structures, and subroutines, such as is common in programming languages may be included in the transaction protocol.

The end result is that a transaction protocol can be used to describe a chain manifest across multiple vectors and extend across transactions that have already been written and may still be written. The results of a chain manifest in producing a set of transaction based on the rules set forth in the transaction protocol or simple list in the chain manifest are auditable and repeatable allowing interested parties to be certain that the list of transactions returned will always have the same characteristics described in the chain manifest.

### Method for Down-Stack Portability of Transaction Containers

The following describes an invention for Method for Down Stack Portability. Authoritative and highly trusted can be moved away from transaction provider A to transaction provider B and can then subsequently be re-integrated into transaction provider A.

User-centric computing has a requirement that data is highly portable while maintaining trust in the integrity of data. The practical implementation of highly portable data is that the user is able to execute and store transaction containers on any transaction provider platform they chose, move to other transaction providers and repatriate those transaction containers if they so choose to.

Further, users who consume that data must be able to establish both wholeness of a set of transaction containers as well as continuity of those transaction containers.

Provided are specialized transactions that serve the purpose of facilitating transaction chain closure, open, and kill.

A specialized transaction types are specified that can open, close and modify rights of a chain of transactions. Further, in the art related to user-centric computing are methods to effectively kill transaction through the removal of the chain ribbon key. This is a known capability and described in the art for user-centric computing.

New specialized transactions are described to 1) facilitate chain continuity across multiple transaction providers, 2) to kill and move transactions to another transaction provider.

### Chain Continuity:

A specialized transaction type is specified that can specify that a chain of transactions is now being hosted at another transaction provider. This allows a user to establish a new route for new transaction to be written to a new transaction provider. Therefore, a user can record a specialized transaction on transaction provider A that states that new transactions on this chain will be recorded on transaction provider B.

When a new transaction arrives for a specified chain ID, regardless of which transaction provider receives the request, the transaction provider, not finding the chain ID on their local platform may query other certified transaction providers.

Upon finding the chain ID and evaluating the rights (can this PID write to this chain or can this PID query this chain ID) in an approved sense then the transaction provider B will service the request.

Specialized transactions (inter-transaction provider reference transaction) will both establish and make available data across transaction providers. Please see IDF IDF_method_11_Cross_provider_certification.docx

### Kill and Move

A need may arise, such as for compliance or performance reasons for a user to not just establish continuity of a chain of transactions across multiple transaction providers but to actually move or concentrate those transactions onto a singular or new transaction provider.

Therefore, a set of specialized transactions are described to:

Replicate a transaction on transaction provider A to transaction provider B

Transaction provider B will write a specialized transaction on transaction provider B that attests to the integrity of the replicated transaction(s).

Transaction provider A makes a reference that the transaction or perhaps a chain of transactions have now been closed on transaction provider A.

The original transaction on transaction provider A will then be killed using known methods involving removing the chain ribbon key.

Users requesting the original transaction, who are permissioned to access the original transaction will be routed to the replicated transaction on transaction provider B.

### Method for Multi-Channel Portability

The following describes an invention that leverages clear (i.e. actual) data or hashes of data to enable multi-party data sharing from disparate data sources. Further, to mitigate against the risk of vendor lock-in, methods will be described to enable portability of hash channels to other transaction providers.

A channel, in this context, refers to the methods and processes by which multiple parties access (write and read) data. A channel may be actual data or a channel may utilize hash representations of data.

This invention will describe channel portability using the hash channel model. But this invention can be generalized to both models.

trx_sys Hash Record Audit Model

trx_sys can store immutable data in several manners. However, the common characteristic of all of these methods of storing immutable data is that the data will be stored within a single field of the transaction. We call this field the “message” or it may also be referred to as the sender_message field.

The message field stores text data. While trx_sys can often support UTF-8 and Unicode encoding methods we have only tested with the ASCII character set. Binary data can only be stored within the message field when encoded to, for example, HEX or Base-64.

There are four primary ways to interact with trx_sys.

Purely with the trx_sys web interface. In this case, the user interacts exclusively with web pages on the trx_sys web site with examples being “Transaction” or with graphical chain apps. The user or chain app developer/administrator will have little to no interest in how data is encoded for the message field.

Purely through the API. In this case, the user experience may be abstracted away from trx_sys functionality. The developer may simply pass message data “up the stack” to the user. From the developer's perspective the formatting of the message field is critical though. The developer can determine the structure of the message field. The message field can contain any sort of structure (string, CSV, JSON, XML, etc.) that they like as long as they limit the character set to ASCII.

Hybrid transaction system web interface and API. In some cases, an application may require a combination of the preceding two models. For example, data is populated into transaction system through the transaction system API while the user interacts with the application through transaction system web page graphical interface. With this model, the developer will create a Graphical (no code) Chain App. The developer will then need to examine the message field JSON structure so as to understand how to write data (in bulk or individual records) to the transaction system.

It is expected that the dominant usage model for transaction system will be from web sites that leverage the transaction system blockchain. In these cases, the web site, what we call an Application Service Provider (ASP), will provide the web interface to the user with data being written and queried via API from transaction system.

Chain IDs can be created as a “standard” chain ID or as a graphical “no code” chain ID. It is important to recognize that if a chain ID is created as a standard chain ID then it cannot be viewed as a graphical chain app. The reason for this is that a graphical “no code” chain ID has an app template associated with it, written in the message field, that is required to display graphically.

### Data Storage Models

While transaction system transaction system can store numerous styles of data (i.e. clear text, Base-64, HEX, etc.) there may be a need to store hashed values of data. This requirement may express itself when an organization has security restrictions related to storing actual data on the transaction system blockchain. A hash, being a one-way deterministic function, allows for a representation of the actual data to be stored in a manner such that it is very difficult if not impossible to derive the input or actual/original data value. SHA256 is an example of a hashing protocol.

When hashed data is used with transaction system there is essentially no change to how the transaction is written, controlled (i.e. access control) or queried. The only real difference is that there are secondary or tertiary functions that exist in the application stack outside of trx_sys to hash data and store hash mappings to the actual data.

We will describe some best practices for storing and querying hash data on the transaction system blockchain.

### Example of Hash Function in Python 3.

###Convert string to SHA256 hex hash digest in Python 3
import hashlib
##initialize string
str=“This is just a simple string. I like apples, oranges and peaches.”
##encode string to SHA256 Hex
result_hex=hashlib.sha256(str.encode( ))
##Display the results
print(“The hexadecimal SHA256 hash is:”)
print(result_hex.hexdigest( ))
print(“\r”)

The output of this script is . . .
C:\scripts>python_hash_sha256_example.py

The hexadecimal SHA256 hash is:
a46be5bea481d00dc101b82eea7feb01e20e866137578f2 78e542c3539d7aa8b

Constructing the hash record for the transaction to trx_sys

A best practice may be considered that using hashes of individual fields of data rather than hashing the entire record. In the following example we have a data record for an inventory system. That data will be converted to multiples hashes and concatenated together into a single string to prepare the data for upload to trx_sys.

See FIG. 1: Example list of data labels, value and corresponding hashes.

Enter “Product Name, Plastic spanner wrench” and the result will be . . .
590227ac14e462afd6937c67b6a48dddc02924ad 8540f8f41alcf0d385c1993a

To construct the sender_message for the transaction system transaction simply concatenate the hashes together with a comma. Of course, these hashes could be stored in a variety of manners such as JSON, XML, etc. Regardless, with our example, the string of hashes . . .

See FIG. 2

Becomes . . .
sender_message=“590227ac14e462afd6937c67b6a48dd dc02924ad8540f8f41alcf0d385c1993a,bf8c35eec7eee90cec05b776cfae4b166 a0d3665ec59480249ed1163530ff747,b3212a3b7fa382f49a06caf79b4eca79b9 77e787f94401a9b1a41f8af680f0d2,baab53fa05b6378120c1943cf8345ce9819 26feed00c29cfb4d9e974c9b8950b, 7fc9299c45bc14732aa587baa4d257ce8f9f1 1dd7c3db39c522f0734fdaba932”

Of course, the hashes cannot be reversed. To verify the hash, one will need to have access to the original actual data and then perform the same hash function (i.e. SHA256 hex digest).

### Architecting a Hash Record Audit Log

Although storing hashed data on the transaction system transaction system blockchain means that the actual data is not available on transaction system for reporting, etc. there is a significant benefit. A system of record (SOR), like for inventory control or tracking sales data or shipping information, can use a hash record audit log to provide proof that data once written to a SOR cannot be manipulated. Even if the actual data for the SOR is stored behind a company firewall proof of data integrity, through the hash record audit log, can be established to any permissioned party both behind and in front of the firewall.

The benefits of a hash record audit log are numerous. In a multi-party business relationship, the proof or integrity of data records can be established absolutely. It is essentially impossible for a party to contest the integrity of the hash record audit log. Further, a hash record audit log can serve as a forcing function in increasing data quality between multiple parties. Given that contesting the integrity of a hash record audit log is impractical if not impossible the likelihood of one party attempting to make a claim about having recorded data when they did not is significantly less. One may theorize that as data quality and trust increase then the conventional risk mitigation procedures that currently exist in multi-party business relationships will no longer be necessary. The decrease in risk mitigation techniques can increase business agility while decreasing cost.

Considerations for developing a hash record audit log in the trx_sys blockchain.

When developing a hash record audit log there are several considerations related to architecting the overall system. Primarily, since actual data is not recorded on the transaction system blockchain there needs to be a method for communicating actual data to the other permissioned parties.

The transaction system views the communication of actual data as well as the communication of hash data as channels. Therefore, to aid in the understanding of the conceptual model, a transaction system describe two channels of communication; hash channel and actual data channel. At trx_sys we often describe the actual data channel as a service channel.

See FIG. H3

The above diagram (See FIG. H3) describes the separation of a hash channel from the service channel.

The following are best practices identified by the transaction system for developing platforms to utilize hash record audit logs.

Do not use graphical (no-code) graphical applications. transaction system provides for a native capability of developing no-code graphical chain apps. These apps will typically have the user interacting directly with web forms on the trx_sys web site. The developer determines what fields to collect data as well as rights assignments. The user, given sufficient permissions on trx_sys by the developer/administrator, can enter data and query data through trx_sys web forms associated with the trx_sys chain app.

Always create and assign a chain ID for transactions. A chain ID is used as a key to establish an association among multiple related transactions. Permissions are typically at the Chain ID level. While it is possible to write transactions without a chain ID the management of permissions becomes impractical.

Hash individual data elements rather than an entire record. A data record is comprised of many data fields. For the hash channel the developer can either hash the entire record or hash each individual record. trx_sys recommends hashing each individual data field then construct a comma delimited string of all the hashes. The string of hashes is then entered in the message (sender_message) field of the transaction.

Transactions should be written to trx_sys via API. While it is possible to write a transaction using a trx_sys web form, we recommend that transactions for hash channels be written through the trx_sys API. The reason for this is that end users should not have to enter hashed data into the hash channel manually. Further, using the API provides for integration into the SOR.

Access control should be based on chain ID and trx_sys login name. A common implementation of a hash channel will involve multiple parties having the ability to enter hashes themselves as well as the primary party entering data into the hash channel. For simple implementations, one primary party interacting distinctly with multiple parties, it is recommended that a chain ID be set up for each company (party) that the primary company (primary party) will be communicating with. Then each company simply enters transactions into trx_sys with the given chain ID. None of the companies will be able to “see” the other companies' trx_sys records. Further, access controls can be set such that only permissioned parties can view or write to their respective chain ID.

Each company should have their own login IDs. Immutability and nonrepudiation data trust characteristics requires that each party enter data into the hash channel with their own trx_sys login ID. While it is technically possible for one party to collect raw data from multiple parties and write an immutable transaction to trx_sys the attribute of nonrepudiation will not exist, thereby breaking the trust model.

### Implementation Scenario

In the following implementation example scenario, we have a primary company, we will call it Alpha Company, that has several business partners that they wish to establish a hash channel with for auditing purposes. The purpose is to reinforce trust related to the sharing of inventory data. They feel that an audit log with characteristics of immutability, universal trust and nonrepudiation will improve overall business agility and reduce costs.

The companies that Alpha company is working with are Bravo, Charlie and Delta companies. Alpha company creates three chain IDs. One for Bravo company, one for Charlie company and one for Delta company. Alpha company then assigns rights respectively to each company. Therefore, Alpha company can see all data across all chain IDs but each company can only write to and read from their own chain IDs.

### Create New Chain ID

A chain ID can be created either via API or through the trx_sys web interface.

To create a chain ID on the trx_sys web site: Resources>>Transaction & Chain App Tool>>Transaction Create:

Set Transaction Type=2 . . . . Create new chain app ID

Set Access controlled=yes

Set Make public=no

Click Generate New Chain ID

Enter a unique chain name in Chain App Common Name. We recommend to avoid spaces as this has not been thoroughly tested on trx_sys.

Note: Copy or otherwise document the Chain ID

Note: Leave all other fields as is.

Click “Go . . . ” and the Chain app ID will be created.

A chain ID can also be created through the API by using a transaction with the preceding configuration. An example is as follows using Python 3 can be found at . . .

https://www.trx_sys.com/documentation/example_create_new_chain_id.txt

Given the preceding scenario of Alpha company wanting to set up an audit channel with several companies we recommend that a chain ID be created for each company (Bravo company, Charlie company, etc.) Alpha company, therefore, creates three chains. Alpha company, in this scenario, does not need to create a chain ID for themselves. Alpha company will write data to the chain IDs created for the other companies.

The result is that Alpha company can then write to or query those individual chain IDs while maintaining privacy between all of the involved companies.

### Assign Rights

Every login created on trx_sys will have a Primary ID assigned to it. trx_sys refers to this as the user's PID. Your PID can be found by going to trx_sys, logging in and going to Resources>>My Account.

A PID is always 52 characters. An example PID is . . . e7f5458cJb7897fuq6acDPog6AI1t61Mt5nphG11m0f7FwsxrCox

Most every function in trx_sys is recorded as a transaction including rights assignments. Rights are therefore assigned by creating a transaction that declares that a PID has rights to read transactions from a chain ID and a subsequent transaction declares that a PID has rights to write transactions to a chain ID.

When creating a chain ID, the transaction can be configured as “Access Controlled”. However, if the chain ID is created without being set for “Access Controlled”, then chain access rights can be configured with a subsequent transaction of a transaction type that turns on access control for a chain.

Continuing with the scenario where Alpha company has set up a chain ID for Bravo, Charlie and Delta companies you will have now created three chain IDs.

Of course, to assign rights to these chain IDs people at Bravo, Charlie and Delta companies will have to register with trx_sys to set up their own login IDs. When Bravo, Charlie and Delta companies set up their IDs they will then need to share their respective PIDs with you.

At this point the three chain IDs that you have created have a security model that can best be described as security through obscurity meaning that for someone to write to or query data from the chain ID the person would have to only know the chain ID. This, obviously, is not very secure.

Access rights are managed through special transactions written to their respective chain IDs. There are separate special rights transactions for READ and WRITE.

As is common with trx_sys, any type of transaction can be created and recorded to trx_sys through either the web interface (Resources>>Transaction & Chain App Tools>>Transaction Create) or through the API.

An example Python 3 script for assigning rights is available at . . .

https://www.trx_sys.com/documentation/example_set_rights_for_chain.txt

In the above script you will see that it is almost exactly the same script for creating a new chain ID.

Regardless of whether you use the web interface or the Python script writing to the API, you will do the following to implement READ and WRITE access control rights for the example scenario:

Create and execute a transaction of type=“6” (WRITE rights) for each company (Bravo, Charlie and Delta) as follows.

Transaction 1: Trx_type=6, chain ID and PID of Bravo company.

Transaction 2: Trx_type=6, chain ID and PID of Charlie company.

Transaction 3: Trx_type=6, chain ID and PID of Delta company.

Create and execute a transaction of type=“12” (READ rights) for each company (Bravo, Charlie and Delta) as follows.

Transaction 1: Trx_type=12, chain ID and PID of Bravo company.

Transaction 2: Trx_type=12, chain ID and PID of Charlie company.

Transaction 3: Trx_type=12, chain ID and PID of Delta company.

At this point, only Alpha company and the specific companies to which rights have been assigned can read from and write to their respective chain ID.

### Write Data Transactions to a Chain

Writing a data transaction is basically the same as what you have done with transactions for creating chain IDs and assigning rights. The difference is that you will use transaction type=“3” which is a basic transaction. Care should be taken to write data to the correct chain ID.

Given that the presented scenario involved establishing a hash channel, actual data will not be written to trx_sys. As previously described actual data will be hashed. In the example script below for writing a data transaction you will notice that a hash string (several hashes delimited with a comma) have been entered into the sender_message.

trx_sys expects that the sender_message will be encoded to Base-64. The example script does just that. The script will encode sender_message to Base-64.

Since the transaction is written to a specific chain ID it is not necessary to enter a recipient ID.

An example Python 3 script for writing a data transaction is available at . . .

https://www.trx_sys.com/documentation/example_write_transaction.txt

Read Data Transactions from a Chain

Reading, querying or pulling data reports from trx_sys is simple. If a login ID, which is associated with a PID, has rights to a transaction or a chain ID then trx_sys will reply with the transaction as it was written to trx_sys.

For the most part, all queries go to the API at /api/consolidated_query.pl

Although there are many transaction query functions, a common query function is to request all transactions written to a specific chain ID.

An example Python 3 script for querying a data transaction is available at . . .

https://www.trx_sys.com/documentation/example_query.txt

There are some significant differences between querying transactions and writing transactions.

IDs (transaction IDs or chain IDs) are in the variable “ids” rather than sender_chain_id. This is because it is possible to query a transaction or the transactions in a chain ID.

It must be explicitly stated if individual transactions or a chain ID is being queried. This is set in the variable labeled as . . .

id_type=“2”

##Is a required field

##“1” query a single transaction ID or a collection of transaction IDs comma separated

##“2” query a single chain ID or a collection of chain IDs comma separated

##Do not mix transaction IDs and chain IDs.

There are a variety of query types (query_type) that can be used to return different types or limits on the returned transactions.

A common implementation is to set a job (i.e. cron job) to query trx_sys periodically for new transactions written to a chain ID. Otherwise, one will have to rely upon a secondary or alternate channel of communication in order to be discover new transactions written to a chain ID.

### Making a Hash Channel Portable

The preceding describes how to use a hash channel to increase trust in the integrity of data across multiple disparate data systems.

However, one might be concerned that such a process could be at risk of vendor lock-in. Concerns about vendor lock-in are well founded as they can introduce higher cost, lower performance and greater security risks.

There are five (or more) parties that may have concerns or interests related to making hash channel data portable.

The sender of transactional has data.

Other interested parties who participate in the data sharing. One might consider these users to be peers in the information sharing system.

Transaction provider “A”. Being the transaction provider for which the hash channel system was originally set up.

Transaction provider “B”. Being the transaction provider for which the hash channel system is intended to move to.

The Application Service Provider (ASP) that is facilitating data sharing for one or all parties.

The Application Service Provider(s) (ASP) that are facilitating data sharing for one or some of the parties.

Per the preceding a hash channel can be established across multiple users. The preceding description described the use of a single transaction provider.

The use of a single transaction provider is not a requirement.

To commit to stay with a specific transaction provider is not a requirement.

Set up with multiple transaction providers.

A specialized transaction can specify that users with an interest in a chain of transaction operate on a different transaction provider. The following is generalized to hash channels and traditional data channels.

This type of specialized transaction will specifically establish:

For a given chain ID, notice is declared to uses who are native to another transaction provider can more rapidly identify the transaction provider that is hosting this chain ID.

The specialized transaction can target specific transaction providers or target all transaction providers.

The specialized transaction provider facilitates a pointer to the proper transaction provider.

The specialized transaction is executed on the user's transaction provider.

Through either a push or pull notification that transaction is discovered by other transaction providers.

Where a transaction provider discovers such a specialized transaction then the transaction provider's governor process will register a transaction of a specialized type that will serve as a pointer to its users as to where this chain ID can be found.

Moving from one transaction provider to another.

The method to enable Moving from one transaction provider to another can utilize methods described in the preceding section for down-stack portability.

Method for establishing data trust and immutability when data (i.e. sender_message) has been removed from the transaction container.

There may be cases where a party receives a transaction container(s) or accesses a transaction container(s) from a trx_sys (a user-centric transaction system) and then removes or strips out message data for ingestion into a conventional application and database platform. Then a situation may arise where a proof of immutability is required. There are two methods that could optionally be implemented to such requirements such as this.

Option 1: Prove immutability with minimum data. In this option the party that is receiving and storing message data from a transaction container and who has discarded the transaction container (meta data) could simply store the transaction ID along with the message data in the a database record. This method will only consume a minimal amount of additional space (less than 60 bytes typically) and one extra field (column) within a database. The transaction container ID could be used to validate the integrity of the data stored in the database record with the data stored in the transaction container as the transaction container will persist on the trxys or in DDLT location, unless an ephemeral chain was used without DDLT coping of the transaction container to another location outside of the trx_sys.

Option 2: Prove immutability with no association to a specific transaction container. In this option the party that is receiving and storing message data from a transaction container and who has discarded the transaction container (meta data) without retaining the transaction ID would store the message data in a database record. No connection, identifier or key would be retained to associate the message data stored in a database record with the discarded transaction container. However, it would still be possible within boundaries to prove authenticity and integrity of the data element. To establish proof of data integrity the transaction container must exist within the trx_sys or as a DDLT stored container outside of the trx_sys. Given the preceding boundaries, one might consider that if data, that has been stripped from a transaction container, and has not been otherwise manipulated, would continue to be the same, exactly the same in comparison, to the data of the transaction container from which the data was stripped then it would be possible to correlate or associate that data to data within a transaction container. There would be controlling factors such that if a data record was simple like “hello world” then there may be a multitude of transaction containers that contain the message “hello world”. Therefore, a reasonable association would not be possible. However, if the holder of the data in the database had an account on the trx_sys then the holder of the data in the database might be able to modify the query to “find transactions with my PID as a recipient with a message that contains ‘hello world’”. In such a case it is likely that the potential result set has been significantly narrowed down. Further, if one were to attempt to correlate back to transaction containers across multiple record of data within a database then that would further narrow the results. One might suppose a data table with the following information.
Record 1) apples, qty 3
Record 2) bananas, qty7
Record 3) grapes, qty 2
Record 4) oranges, qty9

In the preceding table, if a query to reestablish an association to the transaction containers were to specify;

“find transactions of a common chain_id with my PID as a recipient with a messages that contains {“apples, qty 3”, “bananas, qty7”, “grapes, qty 2”, “oranges, qty9”} and in series”.

Then the query would be substantially narrowed and the results would likely be reduced to a single return set or similarly small return set.

The system could limit “proof reestablish queries” based on several factors such as ID, as recipient, as sender, timeframe, size of chain, other identifying data such as one known transaction ID on the chain, etc.

The result is that data that has been completely stripped from transaction containers could have proof of immutability reestablished in a practical and provable manner.

### Method for Discretely Distributed Ledger Technology DDLT

To facilitate querying of message data trx_sys has significantly advanced the concept of Distributed Ledger Technology with Discretely Distributed Ledger Technology (DDLT). DDLT allows for a user to replicate or distribute permissioned data to a node under their control. This allows transaction container message data to be fully searchable and indexable yet maintain complete privacy and control.

DDLT is the process where a party replicates transaction containers to a storage system outside of the control of trx_sys. In other words, a user can optionally distribute their ledger records to a server of their own choosing. One might also describe a user-controlled replication server as a trx_sys node. However, a DDLT node, even though completely authoritative in the manner of data integrity, is under the control of the user (or company).

DDLT has practicality in two significant respects: First, the user can query message data. User-centric computing architecture does not currently provide for intra-transaction message data query capability. Second, even if a user-centric transaction provider were to somehow go out of business or disappear or be hacked in some unexpected manner, then the DDLT transaction containers would persist with the same level of trust and integrity of transaction containers stored directly (as in not distributed) on the user-centric transaction provider's ledger.

Data is fully decoupleable through DDLT from the technology platform to mitigate attack vectors and allow for fast recovery in the event of major incidents of either a cyber-attack or operational failure (i.e. major incidents). Additionally, for platform resiliency a hot site is readily maintained.

Transaction containers are fully portable. The user may replicate transaction containers to, where they have permissions, a storage system of their choosing.

The transactions containers that the user replicated in the DDLT model will be transactions containers that the user created and will always have rights to and/or transactions containers that the user was a recipient of and will therefore always have rights to and/or transactions containers that the user was permissioned to access.

For transactions containers that the user was assigned rights to then there may come a time when those rights are revoked. A traditional transactions container, once accessible can be replicated to a storage system outside of the transaction provider's control. Therefore, the permissions model will fail.

It is expected that some Application Service Providers (ASPs), companies or governments may have very large stores of transactions to which they had rights to access at one time but those rights may have changed.

It should be pointed out that the chain ribbon key is not applicable to this circumstance.

It should also be pointed out that if a person or computer system were to ever have access to data in an unencrypted or clear form then there are no technical methods by which that data can then be re-encrypted such that the holder of that data that was at one time clear and unencrypted is now encrypted in a manner that does not require trust in the behavior of the clear and unencrypted data.

Therefore, the programmatic method to enforce access rights to DDLT transaction container message data is based on the transaction provider making available methods such that the methods serve as notice that a party who is at one time permissioned to view the message data of a transaction container does not permanently have that right.

The solution involves two parts: 1) Make available a method that discloses that rights to a transaction container, chain ID, etc. is temporal and that the holder of those transaction containers does not have permission to view that data in perpetuity. 2) Make available a method such that a holder of those transaction containers can access a remotely stored key if so permissioned to access.

1) Disclose Acceptable Use: Within a transaction container a field or fields will be made available to state whether the transaction container or chain ID is configured for temporal rights. This will serve as notice to the holder of the transaction container what the boundaries or rules are for storing that transaction container as well as accessing the message data stored in the transaction container.

2) Secondary encryption key: A secondary encryption (like AES key) is created at the time of creation of the transaction container. That secondary key will have to be stored somewhere. Therefore, a specialized transaction can serve as a remote key store. A secondary key store transaction can utilize DDLT. That specialized transaction serving as a secondary key store can be part of a chain or otherwise making a reference to related transactions such that the user may specify a location, such as a URL or even other transaction, to provide controls over who may access that key that is stored in the specialized transaction for secondary key storage.

It is important to point out that there is no general replication of transaction containers. Only the sender, recipient and permissioned parties will ever have access to transaction containers. With the preceding methods a reasonable control structure is possible to enable DDLT and the associated benefits such as local search/indexing and data resiliency.

Method for enforce ACL in P2P with DDLT nodes. As described in the aforementioned methods, a secondary encryption key stored in a specialized transaction can be used to enforce access control. However, that method depends upon the transaction provider. It may be reasonable to expect that in some cases the owner of the transactions may wish to serve them in a outside of the purview of the transaction provider. Therefore, a requirement would manifest as a DDLT “node” would store the transactions that would need to be served to other parties as well as methods to control access to those transaction without having to instantiate a secondary method of access control. In this method access control is provided through a DDLT “server”. One may consider that a DDLT node allows the owner of transaction containers to 1) store those transaction containers locally and, 2) perform analytics upon those transaction containers.

However, what if a need exists to allow others to access those transaction containers without having to rely on the transaction provider? To enable such a requirement a DDLT server makes possible for a user to query another user's set of locally stored transaction containers. Benefits for this capability could include higher performance access to transaction containers, no leakage of information as to when, how often and what was accessed by another user.

To enable the preceding DDLT server the following methods are introduced:

A specialized transaction that can optionally declare that a set of transactions or a set of chain IDs can only be accessed through a DDLT server.

A specialized transaction that can optionally declare the location of the transaction that points to an IP address, domain name, URL or other identifier for where that DDLT server would be found.

A DDLT server that can listen to, evaluate and respond to requests from other user who wish to access transaction containers stored within that DDLT server. An optional implementation could include the capability to allow a user to query a DDLT server for transaction containers that are not stored locally and thereby act as a proxy.

A DDLT server could have capabilities to automatically determine through a learning model or through a pre-configuration that a transaction container created by the owner of the DDLT server should be replicated back to the DDLT server for performance reasons.

A scenario of a DDLT server.

Alice and Bob are both user-centric computing users that are signed up with a transaction provider. They could be signed up with different transaction providers.

Alice is hosting a DDLT server. She is storing financial trading data on her DDLT server in the form of transaction containers. Bob is a customer of Alice. Bob depends on very high-speed access to new (real-time) and historical analysis of transaction containers. Alice is using a DDLT server to replicate new transaction containers to her DDLT server. Bob accesses that data.

Bob issues a query to the Alice's DDLT server. Using User-Centric Open Authentication methods Alice is able to validate Bob's identity. Alice's DDLT server evaluates request and returns the requested transaction containers.

### Method for Transaction System Platform Interoperability

The following describes methods for Platform Interoperability.

How do blockchains interoperate with each other? One might consider the recent IPO of Coinbase and point to their service as a means of establishing interoperability between various cryptocurrencies. However, Coinbase only facilitates an exchange of value and not data. Other companies have established a “big API” type of service that allows one to query data from multiple blockchains. However, none of these services actually enable data services that span multiple blockchains for the purpose of dynamic workflow. Well, how might an inter-blockchain workflow manifest in a practical sense? My view:

Blockchains are mostly useless for portability but are great for immutability and attestation of data integrity. Suppose there are a collection of companies that wish to collaborate (share data) with each other. And a requirement exists that a) data must be high integrity, and b) each company is responsible for storing data on an immutable blockchain platform of their own choosing. In some cases a company may decide that they want to leverage a private blockchain such as HyperLedger Fabric, Quorum, Corda, etc. while in other cases a company may decide to use a public blockchain like Ethereum, Solana or EOS.

To facilitate a workflow requirements will include the ability to provide a) access controls for data, b) methods to reference the workflow (essentially a collection of inter-blockchain transactions), c) methods to reference off-chain data, decrypt encrypted data and validate data integrity.

Therefore, a service layer is required to glue everything together. One of the more challenging requirements emerges as disparate private blockchains need to communicate outside of their respective consortiums. Its kind of like this . . . consortium A has data and they trust that data but they also need consortium B to trust that data without consortium B actually joining consortium A. And to make things even more complicated there may exist companies that do not want to be part of “the blockchain”. Reality is business is messy and just because there is a way that things should be done does not mean that that is how things will be done. So, yes, cooperating with the non-blockchain folks is also a requirement.

This is where we see the emergence of a blockchain service layer to enable interoperability between a mix of public, private and conventional technologies.

### Service Layer

User-centric computing could act as the service layer to provide for connectivity between disparate blockchains that are public, private or a mix thereof.

To flesh this out, we will work through a scenario.

Company A is a member of a private blockchain closed consortium, the technology does not matter.

Company B is a member of a different private blockchain closed consortium.

Company C uses a public blockchain.

Company D uses a different public blockchain.

Company E uses no blockchain.

For various reasons these companies want to continue to use their respective blockchains. Perhaps they have greater trust in their respective blockchains, they have company or government requirements, they have consortium requirements or restrictions.

The companies have a need to share data amongst themselves that requires for high integrity provably immutable data. Companies A and B while being members of separate consortiums have a requirement to share data with each other as well as with companies C and D. To establish some context let us describe the workflow as relating to a supply chain.

Company A is a member of a manufacturing consortium.

Company B is a member of a packaging consortium.

Company C is a shipping carrier.

Company D is a warehousing company.

Company E is a reseller.

Company E has a need for a product and places an order to Company A. Company E records the purchase order on the private consortium of manufacturers that Company A is a member of. Those other members can then act in confidence to fulfill the manufacturing a various parts of the larger product. Company A has also been delegated to move the finished product from manufacturing into packaging through Company B who has been delegated to service requests of this nature. Company A gives access to associated transactional data on their private blockchain to private blockchain that Company B is a member of. The members of the packaging consortium are then able to act in confidence in placing orders to other packaging consortium members for the acquisition, printing and construction of packaging necessary to fulfill the order. Company C uses Ethereum and smart contracts to facilitate shipping orders and payments while Company D monitors multiple public and private blockchains for requests to store goods between shipping events.

Let's explore what would be required to enable dynamic and complex collaboration across multiple platforms.

Method for a private blockchain consortium member to be delegated as a recipient of external information.

“I have some information that I got from somewhere that I need to share with some of you in my consortium”.

Method for a private blockchain consortium member to be delegated as a sharer of internal and external information.

“My consortium has some information that needs to be shared with other consortiums, public blockchains and conventional technology platforms.”

Method for a company using the a public blockchain to reference transactional data to private blockchain consortiums, users of conventional technology and other users of public blockchain.

What does a user-centric transaction provider enable?

A user-centric transaction provider acts as a service layer across the tire spectrum of private and public blockchains as well as conventional technologies.

A private blockchain can publish data to user-centric transaction provider. Data would be replicated such that the data on user-centric transaction provider is immutable with reference to immutable stored on the private blockchain.

A private blockchain could establish access controls to limit read rights for parties outside of the consortium through a special type of transaction on user-centric transaction provider or simply upon an agreed upon message construct . . .
{consortium ID: 0001, read_rights_id:09230923}

Message broadcast from private blockchain to external interested parties.

A public blockchain could store encrypted keys and references to off-chain data stores on trx_sys and provide rights controls.

### Method for Proxied Anonymity Transaction Chain

In some cases rights to a digital asset or message data needs to be provided by a 1st party to a 2nd party who will then have a need to provision rights to a 3rd party where a) the 3rd party should not have knowledge of who the 1st party is, and or b) the 1st party should not have knowledge of the 3rd party.

While the trx_sys provides ACL rights inheritance a challenge exists where is expected between parties such as a broker.

### Process:

The 1st party creates a digital asset or message. This is the “data”.

The 1st party records the data in a transaction on chain_id (A).

The 1st party intends to transfer ownership of the data in the transaction “transaction with data” to the 2nd party.

The 1st party creates a transaction of s specialized type to transfer ownership of the transaction with data to the 2nd party and registers to chain_id (A). At this point anyone with access to the chain_id (A) and is permissioned to read chain_id (A) could identify and read the original transaction with data.

The 1st party does not wish for anyone to know that she created the original transaction with data. The 1st party creates a proxied anonymity transaction and names the 2nd party as the recipient.

The trx_sys (transaction system) replicates the original transaction with data and includes meta information attesting to the fact that this is a proxied anonymity transaction and will list specific information from the original transaction with data such as timestamp and hashes but no other identifying information.

Then a 3rd party who is permissioned to the chain_id (A) can retrieve the entire chain except for the original transaction with data. The proxied anonymity transaction will serve as notice that the original creator of the transaction with data does not wish to be known but the hash of the message data, timestamp, etc. are attested to by the trx_sys and can be exposed when compelled by a lawful order by a judicial body.

The trx_sys may optionally create a field to store a hash of the sender_message only to facilitate verification.

Method for an Evolving Merkle Tree Function that Evolves to Accept New Leafs

A transaction system may use a simple hash list to provide both a historical list of transaction hashes as well as a means for a person to look up their transaction hash in the ledger.

Risks with only a hash tree and signed transactions:

How can any particular party determine that the ledger has not been manipulated? A specific party may be able to determine that their transactions have not been manipulated but how can they determine that the overall ledger is free from manipulation? While it may satisfy many that they can prove the integrity of their own transactions others may see a risk with the overall platform if it cannot be proven to be free from ledger manipulation.

Requirement: Provide a method by which a party can easily establish that the ledger has never been manipulated.

As the ledger grows in size a hash list will no longer be practical. One might consider the use of a “pure” Merkle tree implementation. However, as my understanding goes, a Merkle tree is useful for validation of a static set of data.

### Requirements:

Method that would tie back to a single root hash that never changes.

Method that would allow a person to easily lookup a transaction hash.

Method that allows for the system to scale to trillions of stored transactions.

User wants to establish as a fact that the ledger has not been retroactively manipulated. There are several factors to consider with this need. First, the user may want to determine that the ledger has not been manipulated during some timeframe. Second, the user may want to determine that the ledger is not being manipulated with recent transactions. The user may have a hash from a historical transaction that can be used as a check point. Equally the user may have a hash from a just executed transaction that the user wants to keep as a check point.

To the first point, the user should be able to enter the hash into the searchable field and have that hash information retrieved. Hash information might include the path through the tree as well as the preceding and following transaction hashes.

### Attack Vectors.

One might consider that a bad actor could produce a fictitious transaction hash and declare that the hash is real and since it does not show up in the ledger hash list then the hash list must have been manipulated. To mitigate; while a transaction hash reference is suitable for a party to prove that the transaction does exist, and, that two transaction hash references can be used to validate that the running serial hash binding has not been manipulated.

### Walk Through

A hash list may present challenges. At some point it becomes far too large to simply download. Of course an existing user could just download new hashes. The user can use the hash list to establish that the hash of their transaction exists in the hash tree. But what exactly does that prove? If a ledger manipulation were to occur by the transaction provider how strong is the argument by the user against the transaction provider. User says, “Hey the hash tree changed.” Transaction provider says, “No, it did not. You have corrupt data or manipulated it yourself.”

When we take the same scenario and extend it to thousands or millions of users then we could have groups of users argue about what the “real” hash values are.

The transaction provider could organize the hash tree into a set of leaf nodes. This is called a Merkle tree. The benefit of the Merkle tree is that a given data element (i.e. a transaction) can be verified without downloading or needing access to the entire set of hashes. However, how does one establish as a fact that the Merkle tree has not been modified?

To avoid the paradox of the “he said she said” conundrum a proof needs to exist such that any party can establish that yes, the governor of trx_sys did assert to the state of the ledger at a given point in time. The assertion would be facilitated with a transaction that takes the top hash and signs it. Then a user with a transaction request the Merkle proof branch. The user could then recalculate the top hash. The result is that trx_sys governor will not be able to manipulate the ledger. Further, the signed top hash assertion by the governor makes the ledger's integrity uncontestable.

The following is described in FIG. 1. Method for an evolving tree of hashes with attestation snap shots.

### Design

At some given point in time (or quantity of transactions) a ledger hash snap shot of hash records (Attestation Certificate aka AC) is taken. This will be called a Block AC. Data included would be a hash chain for a given range of transactions as well as referential information to prior AC.

Block ACs will be publish publicly instead of the overall hash list.

Because the AC is a batch of ledger hash records there is a latency from the last AC to the current AC. Intermediate Block ACs will be published for some given frequency and will be available publicly as a trailing indicator of ledger integrity.

Some users may have a requirement to prove ledger integrity immediately a special transaction type is available for an intra-AC. This will be called an Intra-Block AC. Intra-Block ACs will not be publicly shared. A cost will be associated with Intra-Block AC to mitigate excessive Intra-Block AC transactions.

Just as a singular hash list can grow to an impractical size so can a list of Block ACs. To overcome scale issues, Block AC references will be wrapped into a hierarchical model.

To aid in finding the hash reference to a particular transaction and the Block AC that it exists in a search function will be provided.

Queried data presented to the user would be similar to the current hash list [timestamp, sequential ID, hash]

The above will be integrated into a Merkle tree structure.

### Method for Cross Certification of Transaction Providers

The following describes a methods for Cross-provider certification. Methods by which trust can be extended to both “certified” and “uncertified” transaction providers. This is a critical requirement for the development of the user-centric ecosystem.

Method to cross-certify or cross-audit or cross-verify other transaction providers to enable full authoritative portability. Similarly, methods to enable authoritative portability minus funds transfer to non-certified transaction providers. These two methods are critical to foster an open and trusted user-centric computing economy and community whether a transaction provider is certified or not.

This IDF addresses interoperability requirements for 1) certified transaction providers, and 2) non-certified transaction providers.

### Becoming a Certified Transaction Provider

trx_sys is factually the first user-centric transaction provider. Any other company, organization or government agency wishing to become a certified transaction provider will have to be certified by trx_sys.

To become “certified” means that trust is fully established between the respective transaction providers such that each transaction provider will accept the other's transactions as being fully trusted including funding or monies considerations.

When certified by trx_sys a transaction provider agrees to mutual auditing of 1) ledger integrity, 2) cryptocurrency generation, and sales (i.e. deposits associated with the sales of cryptocurrency). Further, the certified transaction provider agrees to:

Limits established on the creation of cryptocurrency.

Agreement as to the methods by which other transaction providers will be evaluated and certified through the establishment of an organization to be headed by trx_sys. A charter will exist.

Certified transaction providers may choose to become uncertified.

A trx_sys will not have any absolute authority and the enforcement of authority will extend to the ability for any certified party to revoke a certification key.

Special transactions may exist to afford a certified transaction provider rights to query special transactions related to ledger integrity, funding, cryptocurrency creation, etc.

Agreements to leverage trx_sys intellectual property.

Further agreements, standards, arbitrating bodies and methods, etc. may be established.

The preceding primarily discussed the governance model of certified transaction providers. The technical methods are as follows:

A process will be used to evaluate and make a determination as to whether to certify a transaction provider or not. If approved:

The following is described in FIG. 12 for a cross transaction provider mutual certification.

trx_sys will record a special transaction that establishes the certification. The “new” transaction provider will be described through the domain, IP address, company/org/country name, etc.

The second “new” transaction provider will create a special transaction on the new transaction provider that will include a description of the first transaction provider.

Each special transaction registered on each transaction system will then record a subsequent special transaction on the each other's transaction provider's transaction system that references the special transaction from the other.

The result is that each transaction provider has a transaction acknowledging the acceptance of the other as certified. Further, by cross-signing the transaction the operational capability of the other is established.

The aforementioned special transactions will have limits as to who may execute them. They will be permissioned transactions and therefore are not available for general purpose usage.

When a new transaction arrives for a specified chain ID, regardless of which transaction provider receives the request, the transaction provider, not finding the chain ID on their local platform may query other certified transaction providers.

Upon receiving a request from a user on transaction provider B to transaction provider B for a chain that exists also on transaction provider A then transaction provider B may evaluate the rights (can this PID write to this chain or can this PID query this chain ID) in an approved sense then the transaction provider B will service the request.

User credentials can be evaluated across certified transaction providers.

Optionally, routing information, such as additional IP addresses and domains, may be used to provide for interoperability route look ups.

Optionally, the cross-certification may be contained on transaction chains.

### Cross-Provider Rights Evaluation

Rights are pervasive across certified transaction providers. A chain of transactions, associated by a common chain ID or even different chain IDs that are otherwise associated, may exist across a plurality of transaction providers. Rights to read and rights to write to the specific chain ID may exist.

A request to write to a chain ID that perhaps initiated on transaction provider A may end up also on transaction provider B and transaction provider C.

If, perhaps, the request to write a transaction arrives at transaction provider C then transaction provider C will have to determine if sufficient write rights exist for the user. Transaction provider C will inspect the local chain of transaction to determine if local rights are described or if a transaction has been written that references back (inter-transaction provider reference transaction) to transaction provider B. Transaction provider C will then query transaction provider B for rights and inter-transaction provider reference transactions. Each transaction provider will provide the required or requested information. The information provided will be [pid X is (approved)∥(not approved) to write to this chain ID].

Read rights are evaluated in a similar manner.

User credentials are evaluated in a similar manner.

Becoming a non-certified transaction provider

The initial or default status of any transaction provider is “non-certified”. Although trx_sys owns the IP associated with user-centric computing there may be transaction providers that 1) trx_sys agrees to provide a license for use but the transaction provider is not certified, 2) There may transaction providers that exist outside of jurisdictions by which trx_sys can enforce compliance or adherence to IP laws.

Regardless, there may be uncertified transaction providers.

An uncertified transaction provider will lose the benefits of 1) full interoperability of funds and value transfer, 2) possibly transaction data integrity and trust, 3) access to latest features, standards and code base, and 4) limited belief among the market in their funds value.

### Method for Transaction Protocol

The following describes an inventive subject matter for a programming capability (aka smart contract) within user-centric Transaction Systems.

As a user-centric transaction provider operates at the transactional data layer there are actually very few use cases that a user-centric transaction provider would not be able to support. However, when contrasted with public and private blockchain a topic that comes up frequently has to do with smart contracts.

The topic within this IDF is with programming or scripting within a user-centric computing. Similar models may be described as smart contracts, stored procedures, transaction protocols, etc.

A smart contract, at its core, is an immutable script that executes based on both internal and external triggers. User-centric computing currently provides similar but very limited functional capabilities with various types of transactions. The architecture and design of user-centric transaction systems support multiple transaction types, like rights assignment, and are strict in their functionality. The result is that User-centric transaction system transaction types serve the purpose of functional or logical primitives. Those primitives can serve the basis of a Turing complete scripting capability in User-centric transaction architecture.

In a competitive sense; Ethereum, Solana, and private blockchains all provide for this type of scripting capability. Concerns may exist regarding the practicality of immutable smart contracts in conventional blockchain platforms.

Smart contracts, because they are immutable, either lack recourse for bugs, errors, etc. in the smart contract or require a level of governance such that an authority may arbitrate disagreements. This may place an unreasonable burden of liability and bureaucracy on User-centric transaction providers (or any other transaction provider). Indemnification against loss related to smart contracts will require much more exploration.

One may consider the question of “are smart contracts a requirement in business?” Workflow automation, payment automation, process automation, etc. all exist today. And, theoretically, an immutable scripting capability could further automate those processes by reducing the risk of triggered events. An example might include that when a delivery agent (i.e. trucking company) delivers a pallet of goods and then registers that delivery with the smart contract then the smart contract automatically makes a payment to the manufacturer of those goods.

Unfortunately, and this why “theoretically” is called out, is because such an example ignores two significant risks that are introduced while trying to mitigate the risk related to payment processing. The first risk is that the trigger comes from an external source. External sources are typically called “oracles” but there is no magic with an oracle. An oracle is simply a trusted person, process or machine that provides data to a smart contract. That data could be entered incorrectly, maliciously, etc. The smart contract is immutable and regardless of the quality of data provided by the oracle the smart contract will trigger based on that data. A smart contract assumes oracle data is of perfect quality. Always. This does not match with real world business circumstances.

The second risk is that there may be bugs in the smart contract. However, since the smart contract is immutable, then any bugs, errors, mistakes or malicious intent, are equally immutable. The parties to a contract of course could agree (via contract, etc.) to update the smart contract code if it were found to be failing in some manner. Unfortunately, those parties to the smart contract will rely on external or traditional risk mitigation techniques. Therefore, the singular benefit of triggering a payment within a workflow has an increased risk along with an increased risk mitigation burden. The value proposition of smart contracts is built upon flawed logic.

A stored procedure along the same lines as is included in typical relational database platforms may serve as a model by which a smart contract type capability could manifest within a user-centric transaction system. The question then becomes whether it makes sense to integrate at that level a smart contract capability versus the use of specialized transactions that are completely immutable and designed to perform specific functions.

Following is a rationale for a transaction protocol.

### Transaction Protocol

There may be use cases in user-centric computing where a scripting capability would prove useful. For the sake of clarity and consistency, we will refer to the scripting capability in user-centric computing as a transaction protocol.

User-centric computing is architected upon a model where various transaction types perform fundamental or primitive functions. Therefore, transactions can be executed (stored) or accessed (queried) from external programs through a user-centric transaction provider's exposed API.

Further, a transaction may contain a program to be executed in the manner of analytics being performed upon one or more data sets that are stored in transactions. The described method is rigid or rather significantly limited in the manner of logic that can be described within the transactions themselves. Basically, this method says execute this script against these data sets. There are strict boundaries on transaction types that can be both accessed and created.

For general purpose scripting of a transaction protocol, there may be a benefit to enable a user to specify 1) logic that 2) involves querying transactions, 3) writing transactions, 4) accessing external data, 5) evaluating data, etc.

Benefits of a transaction protocol integrated into user-centric computing include:

Standard reference or model by which external programs can run complex procedures.

Centralized logic.

Performance advantage in contrast to queries and data evaluation done on one's local system or off-platform.

Enforce execution terms and conditions.

Risk of a transaction protocol integrated into user-centric computing include:

All of the aforementioned concerns.

A transaction protocol capability can be integrated into user-centric computing.

The structure would be as follows:

Transactions may act as primitives.

Not all transactions may act as primitives. The language construct would define allowed transactions.

Multiple transactions could be included in a transaction protocol, we will subsequently refer to the transaction protocol for a specific implementation as a script.

Logic, as is expected in a general-purpose language, would be available with a script.

A user-centric protocol would have 1) variables, 2) control structures, 3) data structures, 4) syntax and 5) tools. Within this IDF we will not go into detail on most of the preceding. There is sufficient prior art to borrow. That being said, the novelty within a user-centric transaction protocol would be in 1) providing a control structure the aggregates multiple transactional functions together, 2) registering and maintaining a transaction protocol within a user-centric transaction system, and 3) executing or establishing a run-time environment for transaction protocols.

### Registering a Transaction Protocol

A transaction protocol will be written or stored within the message field of a special transaction type.

See FIG. J1.

Resources, such as message data within other transaction containers that are referenced by the transaction protocol will be bound to the available access rights of the respective transaction containers and chain IDs.

When the transaction protocol is stored within a transaction container of a specialized type then an expectation or requirement will exist to establish a runtime or programming environment. One might consider this to be analogous to how a Python 3 virtual environment is configured.

One or more additional specialized transactions may be written to support configuration files or libraries or data sets that the transaction system may determine to store in a separate transaction that will be written by the governor process as sender with the user who created the transaction protocol transaction as the recipient.

Further, output, if there is output, like stdout, will be written to a transaction in the same manner of a separate transaction that will be written by the governor process as sender with the user who created the transaction protocol transaction as the recipient.

### User-Centric Transaction Protocol Control Structure:

Sufficient prior art exists to enable control structure for a protocol. However, where novelty is required is with the method by which a transaction protocol would reference transaction functions, passes arguments and receives arguments.

For example, one might consider a function that looks to establish the Country that a person lives in. This is a simple function that, within a transaction protocol, could be used to localize language for the user at the presentation layer.

In pseudocode, the function may look like
import user_centric
a=user_centric.person[“country”]
print (a)

In the preceding example the variable “a” will be passed the country of the person.

See FIG. J2. Transaction protocol execution process flow.

The module or function “user_centric” will perform the following:

Collect data from the user to establish a unique identifier for “person”.

Assemble a query data package (query pre-processing) with unique identifier for person.

Set transaction sender to proper user identifier.

Sender identifier is the executor of the script.

Sender identifier is another user identifier that has sufficient rights to query the requested data transaction.

Sender identifier is a governor process that has determined that the query is allowed.

The query is submitted to the transaction system.

See FIG. J3. Transaction protocol execution process flow continued and completed.

The transaction evaluates the request.

If approved, the transaction provider returns the data.

A similar process flow takes place for data packages that are written to the transaction system.

Registering and maintaining a transaction protocol within a user-centric transaction system

A transaction protocol can be described as a script. A script can be registered as a specialized type of transaction. The script will follow a structure or syntax that will be based on existing art.

The transaction container will include the script and other meta information to describe data inputs, operations and output.

Data inputs can be transactions, chains of transactions (i.e. chain ID), as well as external sources. Further, inputs can include references to specific users through PIDs or SIDs.

Therefore, the script will include an operational flow, variables, control structure, output, and identifiers for users and transaction containers that exist or may exist.

The transaction container containing the transaction protocol (script) can be permissioned and included in chains of transaction containers as is the case with any transaction.

The creator of a transaction container containing the transaction protocol (script) can be able to describe PIDs or SIDs of 1) parties that agree to the operational functions of the script and 2) maintenance of the script.

As a practical consideration the transaction container containing the transaction protocol (script) can be modified if all signing parties identified in the transaction container containing the transaction protocol (script) sign (i.e. accept) subsequent transactions of a specialized type to update the transaction container containing the transaction protocol (script).

The transaction system runtime for transaction protocols will inspect the chain ID, if it exists, for the transaction container containing the transaction protocol (script). If transactions exist that affect the agreement of all parties to executing the transaction then those transactions will be evaluated to determine if the transaction container containing the transaction protocol (script) should execute.

The rules to determine the appropriate action in runtime (i.e. execute, don't execute, etc.) may vary per implementation and will be elaborated upon in other design documents.

A provision will be made in the transaction container external to the sender_message (message field) to declare that the transaction is executable.

Provisions can be made within the script that is contained within the sender_message to declare or include or reference languages other than that syntax, variables, etc. that are implemented natively within the transaction protocol.

Executing or establishing a run-time environment for transaction protocols

The runtime for executing a transaction container containing the transaction protocol (script) exists within the control of the transaction provider. A transaction protocol system could optionally be implemented upon a Discretely Distributed Ledger Technology (i.e. local store of transaction containers). However, execution on the transaction provider's transaction system is likely to become the dominant use case.

The runtime contained within the transaction system may manifest as any number of supported runtime environments. Examples of runtime environments include .Net, Java, Python, Perl, Javascript, etc.

An expression of a user-centric transaction protocol such as INCLUDE_TRANSACTION_ID can be used to specifically include transaction ID.

An expression of a user-centric transaction protocol such as INCLUDE_CHAIN_ID can be used to specifically include chain ID.

An expression of a user-centric transaction protocol such as NOT_INCLUDE can be used to specifically include transaction ID or chain ID or PID or a regular expression.

An expression of a user-centric transaction protocol such as is based on common regular expressions can be used to identify a string within a sender message.

Control structures such as is common in programming languages such as “if” “then” “else” and so forth may be included in the transaction protocol.

Other common variables, expressions, assignment statements, brace-delimited blocks, control structures, and subroutines, such as is common in programming languages may be included in the transaction protocol.

### User-Defined Transaction Type

The following describes an inventive subject matter disclosure for User Defined Transaction Types. A variety of transaction types exist within user-centric computing. The server purposes such as declaring a chain ID, stating the rights of a user to a transaction, etc. All transactions have in common that they are the same for all users. One might consider that the list of predefined transaction types are global primitives.

Proposed in this IDF is are methods to allow a user to create new transaction types that are limited in functionality and scope.

### Transaction Type Identifier Conventions

A user-defined transaction type will require a unique identifier. Conventional or predefined transaction types are integers (i.e. “3”, “4”, “27”). A user-defined transaction type will always begin with a lowercase “u” followed by a distinct alpha-numeric string of a length not to exceed 52 characters. Examples of user-defined transaction type unique identifiers could include “u300”, “uhd63he7”, “u8”, “u743ydtyer63hd7w78”. Of course, the preceding values could be implemented differently with the same effect.

### User-Defined Transaction Type Functions

User-defined transaction type functions will be structured around the concept of verbs and nouns.

For example, a simple user-defined transaction type could be used to provide a sub-category of a predefined transaction type. Suppose within a chain of transaction (a chain ID) that the user wishes to categorize the transactions using user-defined transaction types. The user-defined transaction type identifier might look like:

“u7x2” is a random distinct string beginning with “u”.

The chain ID stores transactions for the sale of grocery goods like fruit, vegetables, dairy, etc.

The user or owner/creator of the user-defined transaction type is to establish a transaction category for “Honeycrisp apples”. Of course, the user could define “Honeycrisp apples” in the message data. But, it may be easier for the user to be able to establish a count of “Honeycrisp apples” if a specialized transaction type could be used.

One might consider that the user simply sets the transaction type to “u7x2” and then be done with it. However, the transaction type also specifies access rights to the transactions. Therefore, it would be beneficial if the user-defined transaction type could reference a predefined transaction type, like transaction type “3” which is a standard transaction.

To accomplish the preceding the user-defined transaction type of “u7x2” will need to be associated with a predefined transaction type.

The user will use a user-centric domain specific language to describe a verb and noun relationship (verb) between the user-defined transaction type (noun) and the predefined transaction type (noun).

The user-defined transaction type will be defined in the transaction in the following manner.

sender_transaction_type=u7x2

sender_message=u7x2 inherits from sender_transaction_type=3.

A provision will be made in the user-defined transaction type external to the sender_message (message field) to declare that only the results of transaction executed scripts will be stored with this user-defined transaction type. This is important. A user-defined transaction type can be specified to only accept input or new transactions of a specific type from a specific user-defined transaction type. What this means is that a chain ID can be setup to accept user-defined transaction types that are generated by that user-defined transaction type. An example, Alice owns a shipping company and Bob runs a fleet of refrigerated trucks. They both need to make sure that the recorded temperate analysis are performed by a specific transaction type (user-defined transaction type) and no one else, Alice or Bob can write potentially false data. Only the script in the user-defined transaction type can write script based analytic results to the specified user-defined transaction type.

A chain ID can be configured to accept transaction (i.e. analysis) results only from a specific user-defined transaction type. And that user-defined transaction type can be configured (along with a script) to only have results written from that user-defined transaction type script.

When creating a user-defined transaction type a configuration option may manifest as:
sender_user_defined_transaction_type_write_by_script_only=yes (or no)

Language structure (but limited to the following functions)
Verbs
Inherits from
Write to (chain ID)
Get (return a single transaction)
Read from (return data from a message)
Read_object (return object of a given label)
Where (filter)
IN, OR, NOT (limit)
If (evaluation)
While (iterate)
For each (iterate)
Select from (message)
Send to
Timestamp (get current time EPOCH)
Call (pass arguments to a script contained in another transaction container and receive arguments back)
Execute_transaction
Nouns
Chain ID
Sender PID
Recipient PID
Transaction ID
Transaction provider ID
Transaction type
Variable declaration (i.e. “$”)
Array declation (i.e. “@”)

The preceding examples of verb and noun programming constructs (not a comprehensive list) can be executed from a transaction container.

A more complex example of a transaction protocol may include the following where Alice creates a transaction with an embedded script that is to be used by Bob, a customer of hers.

Alice is a shipper of pharmaceuticals that need to be refrigerated while in transit.

Bob is the warehouser that will receive the shipment. Bob is required to inspect the temperature logs that is stored in transaction containers.

The end customer, Charlie, downstream has requirements to make sure that all parties who touch the shipment use the same method for evaluating the temperature log during shipment. And that each party writes an acknowledgement transaction.

Of course, this could all be done with a script or program executed external to the transaction provider. However, by executing within the scope of the transaction provider then proof will exist as to what data was accessed, when it was accessed and how it was evaluated.

The purpose of the script is to:

For a given permissioned user

Read temperature across all transaction contained data stored in a chain ID.

Evaluate the how to evaluate temperature data over period of time

Use the permissioned user's PID to write a transaction with a result of the analysis to serve as proof as the what the permissioned user's result was.

The script output is:

Write a transaction to a specific chain ID with a specific user-defined transaction type with data of timestamp_start, timestamp_stop, temperature_avg, temperature_high.

An example output may look like:
1641252366, 1641254466, 42F, 43.2F

The benefit is that;

All permissioned parties know what data was accessed and

By whom and When and An undeniable result or acknowledgment was made by the permissioned user.

To actually create the preceding script the following is done (of course, other implementations could serve the same purpose). Note that the script will execute in the user context of the user who is accessing or calling the script. Also note that the following script calls another script to perform complex parsing.
sender_transaction_type=u751kjsdhy233 □ distinct identifier that begins with a “u”.
sender_transaction_executable=yes
sender_message=
inherits from sender_transaction_type=3; #to establish permissions model
chain_id=“o5nqbxukzzccpz5b0khm8akpcie70mo6jqszvd3455w85h65on2y”;
@chain_id_array=get (chain_id, values_only); #get the chain values
$temperature_value=“ ”; #declare an empty variable
##chain_id_array will contain timestamp, temperature and other metadata. Parse out the temperature data to only return the temperature data slope and count of temperature data points that exceed 42F.
##Call the transaction that will parse and analyze the data in chain_id_array.
$temperature_evaluation=call (
“rgbwpopvpz1tf7znbw4osvnvr39tkxcpw0jyhi902ed6jzy 0pnkk”);
##Now prepare to write the transaction with the evaluated data.
write_to=chain_id; #write to the same chain ID
sender_transaction_type=u44; #a user-defined transaction type that all parties had previously agreed upon.
sender_message
inherits from sender_transaction_type=3; #permissions will be inherited from transaction type 3
sender_message=
{
“timestamp_start”:“1641252366”,
“timestamp_start”:“1641254466”,
“temperature_avg”:“42F”,
“temperature_high”:“43.2F”
}
execute_transaction( );

The preceding pseudocode serves as an example of how a script could be embedded into a transaction container and executed with a call to a script in another transaction container.

Not included is the pseudocode example of the script that determines temperature average and temperature high. However, the given example should suffice for those skilled in the art of programming to understand the concepts and functions described herein.

Optionally, transaction containers (transactions) of a special type can be numbered sequentially so as to establish a whole set of transactions of a specific type. This concept can equally apply to transaction types that are not user-defined.

### Method Multi-Party Signatures

For The following describes an inventive subject matter disclosure for multi-party transactions and escrow-based transactions.

Multi-Party Signatures or multi-party Transaction Contract, refers to a transaction, transactions and chain ID where multiple parties can acknowledge agreement of terms set forth in a contract on a chain.

Example use cases of multi-party signatures:
Use case 1 Multi-Party Non-Disclosure Agreement
Use case 2 Payment Triggered by Approval of Multiple Parties
Use case 3 Acknowledgement of Services Completed by Multiple Parties

### SUMMARY

A specialized transaction, within a chain of transactions, contains sufficient information to a) describe the terms of a multi-party agreement or to reference the location of those terms in other transactions, b) provisions by which multiple parties can acknowledge the terms, c) provisions by which multiple parties can attest to the completion or acceptance of the agreement as complete, d) provisions to reference other transactions or external dependencies, e) provisions to evaluate the status of signatures and dependencies then document within a system generated transaction, and e) provisions to enable the system to trigger an event described in a transaction that may also be a script or transaction protocol.

### Requirements:

Transaction type that designates multi-party transaction contract.

Digital terms can be stored within the message field.

Optionally, multi-party transaction contract type cannot be used as regular chain transaction.

Multi-party transaction contract in effect designates a chain ID with certain functions.

Multi-party transaction contract functions

Create multi-party transaction contract designated chain.

Multi-party transaction contract type that stores contract terms

Multi-party transaction contract type that assigns rights to another recipient.

Only current owner can assign rights to another.

Multi-party transaction contract types that declares identity disclosure levels

x—Allows those approved to read the asset to query identity full name, address

y—Allows those approved to read the asset to query identity full name, address, email, phone

Multi-party transaction contract type that allows owner to assign read rights as public

Multi-party transaction contract type that allows owner to revoke read rights as public

Multi-party transaction contract type that allows owner to assign read rights to specific recipient

Multi-party transaction contract type that allows owner to revoke read rights to specific recipient

Multi-party transaction contract type that allows party (trx recipient) to state that per recipient obligation has been met.

Multi-party transaction contract type that allows sender to acknowledge that per recipient obligation has been met.

Multi-party transaction contract type that allows sender to close the contract as obligations met and contract is closed.

Multi-party transaction contract type that allows sender or recipient to add additional information and photos (etc.) as descriptive content.

The following describes model for Transaction Contracts in a User-Centric Platform.

### Use Cases:

Allow a transaction system user to fund an escrow account such that the Application Service Provider (ASP) can draw from that escrow account as services are provided. The escrow account would be fully funded where the amount is deducted from the user's account and placed in escrow controlled by the governor.

Allow a transaction system user to set up a draw where the user would retain the balance and the ASP could draw funds to a specified limit.

### Methods: (Described Through a Scenario)

Start charging people after some x qty of transactions

Use Google Ads to cover cost.

Have the user sign up for the transaction system and then give ASP permission to transact on the user's behalf.

Another type of transaction . . .

Transaction is “Proxy Funding”

User goes into transaction system and creates the transaction of “Proxy Funding”

User gives permission to a specific ID to transact on their behalf.

Then when a transaction is submitted by ASP then transaction system (i.e. execution method transaction_exec.pl) looks for a proxy funding field. If this information escapes, this is not a problem, only the ASP can spend these funds. Continuing, the transaction system looks up the proxy_funding field and is able to determine who to bill for the transaction. The actual transaction will need to be constructed. A method to draw money from one's account will need to be provided.

The same problem will be solved with inheritance, to enable the ASP to get paid. This is fundamentally an extension of the inheritance concept.

The transaction contract will perform in the manner of “if X happens then pay Y.”

Another question comes up. When proxy_funding is established, say its $10(t), will those funds be locked in escrow or still available? The proxy_funding function needs to be configurable.

Redirecting funds when the transaction system does not have the user's password and the password is required if the transaction system were to write the transaction on behalf of the user. Without login/password the user is not able to sign a transaction.

A series of charges could batch up and when the user logs in then the proxy_funding transactions could be settled. This is not fair to ASPs.

There is currently no way for the transaction_exec (the transaction execution process) to sign a transaction by the user without the user's password.

It is possible to have the governor sign both sides of the transaction and reference back to the “transaction contract” that would provide authorization. This would allow for a draw. Logically it would work like:

The user performs a proxy_funding transaction
transaction_type=“proxy_funding”
recipient_id is specified and is the ASP

The funds may or may not move to governor escrow. The following assumes that funds remain with user but can be “drawn” by ASP.

### Accounting in the System

The initial “transaction contract” for proxy_funding will give proof of intent to allow the governor to draw fund to a specific ASP.

A potential challenge exists with sender id and recipient_id when the governor is sending fund. Another transaction ID when the funding actually takes place. As long as an audit is possible by both parties that show 1) the sender_id agreed to the funding and drawing details, 2) the recipient can validate that funds were received, and, 3) on both sides funding can be proven.

No change would be required to how balances were tabulated unless funds are actually moved to an escrow. A question then becomes; would funds be marked escrow and not escrow?

A scenario . . . sender_id creates $10(t) escrow fully funded to recipient_id. This transaction could be written but given type of proxy_funding_escrow_full (vs proxy_funding_escrow_draw) then the sender_id balance would tabulated by deducting the $10(t) while the recipient_id would not be allowed to include in recipient_id.

“Transaction Contract” funding would initially take place on the transaction system via a form. Would have fields like
sender_id (prepopulated)
recipient_id
funding amount
terms (not coding) could be populated from another transaction or from plain text. But is to be stored in sender_message
transaction contract protocol

It is only transaction_exec.pl that will process transaction contracts
Initially, only transaction type 26 (escrow draw).
ASP setting up an escrow draw by ASP (done once by ASP)
Is set up by the ASP
Creates sender_chain_id
ASP Form fields:
sender_chain_common name
sender_chain_id
escrow_type={25, 26} note: 26 (draw) to start with.
max_funding_limit
min_funding_limit
fee (is the amount per transaction to charge user)
max_amount_per_transaction
min_amount_per_transaction
expiration_date
terms_description
scheduling, frequency, notification method for refunding, etc.
User setting up an escrow draw (done once by user)
User has account on trx_sys and as funded
User goes to ASP
User clicks something and a form is populated with info on transaction contract
Read only fields show info including transaction ID of transaction contract
Amount to send is shown as $0(t) for this transaction to set things up.
recipient ID is auto-populated as the ASP ID (because right now cannot pay directly to a sender_chain_id)
The user clicks submit and a transaction of type 26 is set up
Using the escrow draw
User goes to ASP web site
User enters PID or SID (could be unique every visit)
ASP accepts data, forms JSON object and sends to trx_sys API
transaction system parses JSON and identifies transaction type 28.
transaction system queries sender_chain_id etc from ledger and parses
transaction system evaluates request
If all good
transaction system forms transaction Type 28
sender_id is governor (type 26 makes this OK, this is proof of authority to do)
recipient_id is drawn from query on associated type 26
amount is evaluated based on param and associated type 26
Transaction processed
ASP receives API response.
At a later time the user can view my_account to determine how balance was affected.
transaction type=24 (escrow draw)
Sender (sender_pid) will be the user who is setting up the escrow.
Recipient (recipient_pid) will be the ASP that will eventually receive funds from the user (sender)
transaction_exec.pl architecture
if transaction type 24
format form fields as JSON in sender_message.

### Alternate Escrow Model

The preceding escrow model represents one (possibly two) distinct methods to manage an escrow process. An alternate model is described.

Escrow will be defined as a process to hold or redirect funds in a temporary manner for final disposition based on a trigger.

Escrow can be paid from one to one.

Escrow can be paid from one to many.

Escrow can be paid from many to one.

Escrow can be paid from many to many.

Recipients of funds can be identified in the recipient field as a collection, tuple, JSON, etc.

Recipients of funds can be identified in a multiple transactions such that for a single escrow function the transaction system actually registers multiple transactions at the time that the escrow transaction is submitted by the user.

A user can only specify that funds by drawn from the user's own account and not another when setting up an escrow transaction.

Escrow transactions will always require a chain_id to be setup or used.

If the escrow is one to many or many to many then the transaction system will register multiple transactions.

The user who initially sets up a many to many escrow chain_id and transaction will spawn multiple committed transactions. Those transaction will be used to serve as notice to other who will provide funds. Those users who are providing funds will have to create subsequent transactions of a specialized escrow type.

A scenario might be:

FIG. J4 depicts scenario with user creating a multi-party transaction.

A many to many escrow is setup with a trigger being that once all sundering and receiving parties have signed approval of the escrow then funds will settle. The scenario is that Alice creates the initial escrow and specifies using a transaction protocol that 300 cryptocurrency will be equally provided by three parties; Alice, Bob and Charlie. There will be two receiving parties of Dan and Ed. When all parties have signed then the 100 cryptocurrency will be drawn each from Alice, Bob and Charlie. Then 150 cryptocurrency will be provided to Dan and Ed.

FIG. J5 depicts scenario with execute now multi-party transaction.

Alice forms the initial escrow transaction and submits to the transaction system. This transaction uses a transaction protocol (script) stored in the sender_message to describe the contributions and disbursements. The providers of funds will be specified in a distinct field of the transaction such as a list. The recipients of funds will be specified in a distinct field of the transaction such as a list. Or the recipients and providers of funds will be specified in the transaction protocol using labels such as to denote the recipients and providers of funds. Further, the collection and distribution of funds rules will be described within the sender_message as a transaction protocol. The method to enumerate those rules will be based on conventional programmatic models such as used by Perl or Python, as examples, and that those conventions are supported by the transaction provider.

A known programming language such as Perl or Python may be used as a processing engine. Optionally, the programming languages used for a transaction protocol may have limits on functionality, input methods, output methods, memory requirements, control methods, etc.

FIG. J6 depicts scenario with execute based on conditions multi-party transaction.

The transaction system will write a transaction from Alice as sender.

The transaction system will then write a transaction from Alice as sender with Bob as recipient. The transaction will reference via chain_id and specialized transaction types to the transaction first recorded by Alice.

The transaction system will then write a transaction from Alice as sender with Charlie as recipient. The transaction will reference via chain_id and specialized transaction types to the transaction first recorded by Alice.

A similar transaction is not needed to specify Alice as the recipient because she is the creator and her contribution of funds is specified in the transaction protocol.

The transaction system will then write a transaction from Alice as sender with Ed as recipient. The transaction will reference via chain_id and specialized transaction types to the transaction first recorded by Alice.

The transaction system will then write a transaction from Alice as sender with Frank as recipient. The transaction will reference via chain_id and specialized transaction types to the transaction first recorded by Alice.

That Alice approves the escrow transaction is implied by Alice setting up the escrow.

As each party who is contributing funds signs (creates) a specialized transaction naming a special escrow holding account of the transaction system “governor” on the chain_id then funds will be transferred from the user contributing funds to the specialized governor account.

FIG. J7 depicts scenario with users names as parties to the multi-party transaction signing the transaction and thereby approving it.

When all parties have signed (thereby transferring funds) then the governor will disperse funds per the instructions provided in the transaction protocol.

FIG. J8 depicts scenario with trigger executed for multi-party transaction.

Optionally, the transaction protocol could require that all recipients provide similar signed transactions establishing an approval.

Optionally, the transaction protocol could specify other internal or external triggers where data would be evaluated to determine when to execute the disbursement.

Optionally, the escrow transaction or within the transaction protocol a time bound trigger could be established to cancel the escrow transaction and return funds if a time bound trigger is exceeded. Other such escrow cancellation triggers could exist based on the evaluation of other data.

### Method for Micro License Value System in Banking and Finance

As an emerging theory of information, user-centric computing, builds upon architectural and evolutionary trends in conventional as well as from blockchain technologies. In some cases, trx_sys, as the first user-centric computing platform, has borrowed terms from the industry and evolved their definitions. It is likely that we will debate standard terms and definitions used by trx_sys. In particular:

Blockchain. Conventional blockchain describes sets of transactions that are serially hash bound and validated through consensus with trust maintained through distributed ledger technology. trx_sys serially hash binds transactions but transactions are not batched into blocks pre-validation. trx_sys does have blocks but they are assembled post-validation and are used to establish ledger integrity. trx_sys does not have a need to distribute the ledger in an open (lacking privacy) manner. trx_sys only distributes what is absolutely necessary to maintain platform integrity. trx_sys advances the state of the art with blocks and blockchain. Should we call ourselves a blockchain? I don't know.

Cryptocurrency. Conventional cryptocurrency is a unit of currency operating on top of conventional blockchain and distributed ledger. Cryptocurrency is generated as a reward system. The value (price) of cryptocurrency is driven through speculation and has almost no actual utility. trx_sys uses fungible micro-licenses that perform many of the functions of conventional cryptocurrency but without speculation. Conventional cryptocurrency is closed aligned to Ponzi schemes. trx_sys is removes all of the nonsense that has maligned the entire crypto domain.

The following describes challenges with conventional cryptocurrency, the utility of fungible micro-licenses as a cryptocurrency and the emergence of an ecosystem of user-centric providers.

### The Failure of Cryptocurrency

Which has greater value? Cryptocurrency or the transaction?

Consider for a moment how you define “value”?

Cryptocurrency is of far less value than the potential of the transaction. Unfortunately, cryptocurrency has dominated the discussion related to blockchain. The industry has evolved to equate cryptocurrency price with value. Value is something other than the price that a cryptocurrency is trading at. One should consider the utility, the functionality and capability offered by a system.

The volatile and speculative nature of cryptocurrencies, along with a variety of other reasons, have thoroughly discouraged those who might benefit from using or developing applications upon a public, non-repudiation and immutable data system.

We, of the crypto/blockchain community, with few exceptions, have not been very honest with ourselves or with anyone else. The dearth of real and practical use cases is the proof. The tide is turning on public sentiment towards blockchain. We might as well admit that we have lost our way. If we were ever credible enough to have the trust of the public then it is now waning.

The conversation, so far, has been unbalanced. The focus on the price of cryptocurrencies is effectively killing blockchain (other problems notwithstanding). As the price of cryptocurrency has increased without a corresponding increase in utility then innovation and investment dollars have skewed development towards systems with no real value.

The solution is to decouple speculation from the underlying transaction. How do we do this? This is where innovation should focus. As long as cryptocurrency acts as a security then that will be the use case. Utility in transactions is what we should strive for.

More specifically, cryptocurrencies will never replace paper and coin fiat currency (currency issued by a government). We will also never see cryptocurrencies facilitate our common purchases. Cryptocurrencies may persist as a proxy for fiat, but, with regard to cash, cryptocurrency fails as a replacement.

Displacing cash is a very narrow topic within the broader cryptocurrency domain. But, to begin with, and in the fairness of disclosure, I am not an expert in economics. My expertise is with information systems and information theory. Therefore, my opinions are made through the lens of information dynamics.

Cryptocurrency will never replace fiat currency. One of the main reasons has to do with exposure. This is a very fundamental concept related to currency in the form of cash transactions.

Cryptocurrency has been compared to electronic cash in that an exchange can be made anonymously. Therefore, one might rationalize, cryptocurrency must be the next evolutionary step in the progression of currency. This argument is fundamentally flawed. Cryptocurrency is not an analogy for a physical currency. And the reason, as was mentioned, has to do with exposure.

When two people agree to exchange money for an item or service then one person hands over some cash. Neither party needs to explicitly identify themselves for the transaction. No problem. Now, with cryptocurrency, particularly using something like Bitcoin or Ethereum, then a similar exchange takes place, but electronically. Both types of transactions can be done anonymously (pseudo-anonymously specifically). Same thing. Just one is electronic. Except that they are entirely different.

When one makes a purchase with physical cash then there is a level of exposure that takes place between the parties involved in the transaction. I see you and give you cash. You see me and receive the cash. That exposure represents a temporal reduction in anonymity and balanced risk to both parties. That risk actually introduces a stabilizing equilibrium in an exchange. With cryptocurrency an expectation of anonymity exists that is fundamentally different from transacting in cash. Therefore, the risk dynamic is different between cash and cryptocurrency transactions. The result is that with an anonymous transaction the ability to pursue redress from a bad transaction does not exist or is severely limited.

Within any trust model there are three parts; how does data enter the system, how does the system maintain the integrity of data and what recourse is available to an aggrieved party?

It is this third point that becomes problematic. In an anonymous cryptocurrency system, there is no system of recourse for an aggrieved party. Given existing public blockchain architecture, if a system of recourse exists then there will be no or limited anonymity. Additionally, an authority would need to exist to rule on the side of one party or another. In that case, one would really need to ask, why use a cryptocurrency system at all? Smart contracts are not the solution as they lack judicial insight.

Others may argue that we are missing the point altogether. That the real benefit is to provide an immutable record of the transaction. Well, of what value is an immutable transaction at the time of the transaction? It may be trusted to be an actual record in the system but so what? Does it provide an inherent means for the aggrieved party to seek redress? No. To seek redress would involve a third party acting in an official capacity. And, with the anonymous nature of cryptocurrency the party being complained about has plausible deniability to the transaction.

As the cryptocurrency community attempts to add services and functionality, they are finding that some of the core tenets (i.e. anonymity and decentralization) of public blockchain are logical fallacies.

So, it all boils down to the fact that anonymous cryptocurrency transactions introduce unbalanced risk in an exchange.

Of course, others may argue that cryptocurrency should be viewed more as an analogy to electronic payment systems. This logic is also flawed. Electronic payment systems are based on the same fiat system of cash and are able to provide remediation over disputes.

Perhaps some folks will argue that I still do not “get it” and that cryptocurrency will replace legacy systems of international cross-border financial settlement.

One may question: How would a U.S.-backed digital currency change transactions globally? What would it mean for fees that banks charge for transactions? Further, what does it mean for decentralized cryptocurrencies like Bitcoin? Is it important for the U.S. to move faster than global competitors?

Our response somewhat elaborated upon: A digital currency backed by the USA could serve the purpose of making funds transfer settlement much easier, quicker and less expensive for a global audience. It is important to recognize that a US-based federal cryptocurrency would, in effect, extend the rights of consumers and businesses from the US and other countries to sign up for accounts with the Federal Reserve (or some other US based agency).

It is also important to recognize what would not be part of such a system. There would be no miners to maintain consensus as data integrity would be established by the US government. There would be no distributed ledger as that would be a violation of privacy laws and is simply poor design for performance reasons as well. There would be no anonymous transaction capabilities as that would be a violation of banking laws. There would be no speculation on the “coin” as the cryptocurrency would be a proxy for the dollar. Any decentralized aspects would be secondary in authority to the US government.

The preceding statements are simple reality for any country-centric cryptocurrency.

The question still stands, though, should the US develop a cryptocurrency? And, keeping in mind that a US based cryptocurrency would extend the rights of the Federal Reserve to issue and manage consumer and business accounts to a global audience, is that ultimately, good or bad?

The practical implementation of a US-based global bank, this is what a federal cryptocurrency would in effect be, has significant challenges. Some questions that come to mind: How would identity be established and maintained for a global audience? How would foreign countries implement controls upon a financial platform for which they have limited or no authority or insight? How would inter-country disputes be handled?

Further, public blockchains like Bitcoin, Ethereum, etc. are speculative securities at best and long-running Ponzi schemes at worst. Public blockchains, at least as currently architected, do not serve as a model by which countries should strive for, aspire to, emulate, etc.

### Cryptocurrency as a Fungible Micro-License

Is cryptocurrency a requirement to meet the objectives of user-centric computing such as universal trust and immutability as well as authoritative decoupling and portability?

Serious technologists have mostly dismissed cryptocurrency as scams with Initial Coin Offerings (ICO) being a plague upon the technical community. Cryptocurrency has basically ruined whatever usefulness blockchain may have introduced.

One might argue that the price of Bitcoin or Ethereum is proof of their value. Such an argument is useless because the price of a security (a speculative instrument) has little relationship to its usefulness or functionality.

We found that a carefully constructed cryptocurrency could solve a specific challenge with user-centric computing as well as providing a variety of secondary benefits. User-centric computing has a challenge with how transaction service would be paid for. There are several options to fund user-centric computing services.

1) The service becomes a standards body for the Internet and would be funded by some combination of government and industry grants as well as fees for certain services. But, such a model, perhaps similar to ICANN, fails to address an equitable means of balancing out a model of supply and demand. For example, if someone wanted to post a billion “authoritative” pictures of her cat, how would that be regulated? The challenge of setting limits would become an administrative nightmare in establishing a semblance of fairness.

2) The platform could be funded through the common practice of the user trading their privacy and personal data for services. Either the service could be the monetizer or that function could be allocated to service providers such as Facebook or Google. We rejected the tactic of monetizing the user-centric platform by consuming private information from the users and selling it to advertisers because that method would represent a third-party having control and not the user. If the user wanted to share private information with a third party, then that should be by the explicit choice of the user.

3) The users fund their accounts and then transaction fees would be deducted from that account. We almost headed down this path but ended up rejecting it. We felt that such a system introduced two challenges. The first being that the service would become a holder of user funds with many of the responsibilities that a bank manages such as returning cash to a user (i.e. a depositor) or enabling a user to transfer funds to other users. We did not want to become a bank. Second, it did not strike us as ethical to restrict a user from removing their cash funds from the platform. A closed economy we felt was required to mitigate the risk of speculation and abuse. Therefore, we rejected the service being funded through the service holding cash deposits by the user.

4) A closed cryptocurrency structured as a micro-license for transactional services, we reasoned would solve several problems. By structuring the cryptocurrency as a software license for transaction execution and storage services then the cryptocurrency would serve a well-defined utility purpose. In this model the transaction provider would not be a holder of deposits and therefore, not a bank. Such a model would give the user, the purchaser of the cryptocurrency, a clear understanding as to the value, functionality and usefulness of the cryptocurrency. Additionally, because the cost of a transaction is so low (potentially fractions of a penny) the system of cryptocurrency would have significant granularity of “coinage” or minor units of currency. The granularity of the platform's cryptocurrency would enable intra-system payments for services. We theorized that if the concept of cryptocurrency micro-licenses were to be implemented within a closed economy (i.e. the transaction provider would not convert micro-licenses back to cash) then a very unique phenomenon may emerge which we will describe as “perfect portability of value” where value can be transferred across transactional platforms without a settlement process by an intermediary.

It is with this latter model that we settled on; the model of closed cryptocurrency structured as a micro-license because it provided the best balance of user control, portability, service remittance, mitigation of speculative practices, etc.

See FIG. K1: A cryptocurrency in a closed system based on cost of transaction execution and storage services.

### Perfect Portability of Value

With regard to “perfect portability of value” this capability has significant value. The cryptocurrency in user-centric computing represents a license for compute and storage of transactional data. Transactions are paid for with user-centric cryptocurrency. We should be clear that cryptocurrency in a user-centric platform is very different from the popular notion of cryptocurrency such as is found with Bitcoin and Ethereum. First, user-centric cryptocurrency is non-speculative. It will not go up or down in relation to the fiat currency to which it is pegged. It is not a stable coin as it does not represent the holding of a monetary unit. Cryptocurrency in user-centric computing represents a given amount of compute and storage. User-centric cryptocurrency is transferable within a transaction provider's closed ecosystem.

It is technically possible to transfer user-centric cryptocurrency to user's who reside on other user-centric platforms.

When, once enabled, a user could transfer user-centric cryptocurrency from transaction provider A to a user on transaction provider B then this would take place without a settlement process or intermediary.

The notion of perfect portability of value, lacking a better term, refers to the ability to transfer value without an intermediary providing settlement or exchange. A user-centric platform, when architected to the emerging standards of user-centric computing, allows for the transfer of value or cryptocurrency across other user-centric networks operated by unrelated parties within a common country.

In contrast to existing public blockchain platforms, it is not possible to send cryptocurrency directly from, for example, Bitcoin to Ethereum. An intermediary, in the form cryptocurrency exchanges, are required to transfer funds between disparate blockchains. And this is a problem.

Conventional blockchain lacks organic portability of funds but it does allow and encourage speculation on their cryptocurrency. When a cryptocurrency is closed to portability but has a fixed quantity then speculation arises. This is the worst design of all for a system intended to be used for practical purposes. Holders of conventional cryptocurrency are, by the very design of public blockchain, discouraged from using the platform for practical purposes because the currency is inflationary. More simply put, why use or spend the cryptocurrency today when it will likely be worth something more tomorrow.

User-centric computing does not have a fixed quantity of “coins”. The value of a user-centric cryptocurrency will always be based on the relative value of the compute services it represents and aligned to the fiat currency of the country to which it is operating in. User-centric computing has no intention of replacing government issued currencies because that does not serve the objective of giving authoritative control of data to the user.

We foresee a time when there will be multiple user-centric providers that compete on services, execution speed, transaction cost, etc. The principles of user-centric computing require that user transactional data is portable such that transactions written to one provider's ledger are fully trusted by another user-centric provider.

Part of this trust is with the value represented by the currency of the user-centric platforms. With a true user-centric transaction system, users will be able to transfer cryptocurrency from one user to another. This is a fundamental feature of user-centric computing.

Users of user-centric platforms will also be able to transfer cryptocurrency in a simple manner to another user-centric platform without any intermediary. A settlement process is not required. One might draw similarities to how banks settle the transfer of funds from one customer of one bank and another customer of another bank. For banks, this is done with shared accounts to provide for the transfer of monies.

In a user-centric paradigm a user could transfer funds from their account to another user on another user-centric platform by simply creating a transaction to exchange those funds. Likewise, the user could transfer funds from their account on one user-centric provider to their account on another user-centric provider.

It is important to recognize that a user owns their identity. Therefore, the identity of the user is equally portable. Once a user has signed up with one user-centric transaction provider then that user will have the ability to “land” on any user-centric provider's platform. Of course, there may be requirements or restrictions based on each country's laws.

Regarding settlement of funds being transferred from one user-centric provider to another it is important to note that this is not a simple messaging exchange such as with SWIFT (i.e. a description of an exchange but “the” actual exchange), but an actual transfer of funds (value) via transaction messaging.

See FIG. K2 and FIG. K3 for the process to enable a user on one transaction system to transfer cryptocurrency to another user on another transaction system without an intermediate settlement process.

For example, Bob, from the prior example, has a balance of 100 cryptocurrency on, let us call it Transaction System A and wishes to send 10 of those Transaction System A cryptocurrency “dollars” to Alice on another user-centric network. Let us call this other user-centric network as Transaction System B. Bob creates a transaction with an address that points to both Transaction System B and Alice's ID on Transaction System B. Upon execution of the transaction the funds become available to Alice. There is no other intermediate process.

The preceding assumes that both Alice and Bob reside within the jurisdiction of a common country. Even though user-centric platforms are not banks, they may perform some functions that fall within finance regulations. Cross border exchange will remain somewhat complicated do to varying banking requirements, exchange rates and country specific regulations.

A global cryptocurrency is not an objective of user-centric computing. However, interoperability of data transactions and regulated cryptocurrency being traded on a global basis does fit within the objectives of user-centric computing.

But, let us explore how Bob was able to so simply transfer funds to Alice who uses a different user-centric transaction provider.

Going back to the transaction, Bob creates a transaction on Transaction System A and specifies the ID of both Transaction System B and Alice. That transaction is written to the Transaction System A ledger.

Alice, who has no “account” on Transaction System A, can become aware of the transaction crediting her through one of two methods. Either Bob can send an off-chain message to Alice to let her know from which user-centric platform the funds were transferred and the transaction ID. Alternatively, Transaction System B can routinely scan Transaction System A, and other user-centric transaction providers, to determine if their provider ID shows up in any transactions. Transaction System B, in this example, would query the Transaction System A API for their own ID and the transaction from Bob to Alice would show up. At that point, Transaction System B could issue a “Cross-chain transaction inheritance” transaction specifying Alice as the recipient. This would allow the transaction to show up in Alice's list of transactions without there being a requirement to scan every user-centric provider every time a balance is required. Therefore the “Cross-chain transaction inheritance” transaction serves a bit like a marker in the ledger for faster indexing.

But did this transaction actually facilitate the transfer of funds from Bob to Alice? Yes, their accounts are immediately settled with the successful execution of the transaction. This is where user-centric computing differs from conventional banking and conventional blockchain with regard to the transfer of funds. In conventional banking the ledger is simply an accounting of financial transactions. The ledger itself is not money. In a user-centric platform the funds actually represent units of obligation for services to be rendered. The “services” are for the execution and storage of transactions. This is why cryptocurrency in user-centric platforms is referred to as micro-licenses.

Some may notice a sort of paradox with funds in this model. The question may arise along the lines of, well if Bob purchased $100 worth of cryptocurrency from Transaction System A then Transaction System A has received $100. But when Bob transfers $10 of that cryptocurrency to Alice at Transaction System B then Transaction System B does not actually get the $10. So, does this mean Transaction System B ends up on the losing end of the transaction?

This may be further characterized is trade imbalance or unfair settlement of funds.

Simply put, the answer is “no”, Transaction System B does not end up on the losing end of the transaction. And it works out like this; when a user purchased user-centric cryptocurrency that cash (like USD) does go to the user-centric transaction provider that facilitated the sale. The cryptocurrency, as mentioned, represents the purchase of licenses, micro-licenses more specifically, for the execution of transactions and storage of data.

A user-centric transaction provider can generate cryptocurrency in three circumstances; direct sale of cryptocurrency for fiat currency (i.e. US dollars), sale at a discounted amount within disclosed boundaries and simple generation of cryptocurrency within disclosed boundaries.

One might press us further with a scenario where, for example, a great many users transfer a large amount of cryptocurrency from Transaction System A to Transaction System B. Transaction System B would be obligated to execute transactions and store data on their platforms (like in their own data center) yet they would not have access to the cash value associated with the cryptocurrency to pay their own bills. As a brief side note: Data centers, servers, and electricity can be very expensive. The “cloud” is not free.

This is a legitimate concern and risk that we do not want to ignore. However, it is from a network effect that this risk will be mitigated. By “network effect” we mean that as more and more people and more and more businesses leverage user-centric transaction services then user-centric cryptocurrency becomes fungible or useful as a means of paying for services and products outside of the user-centric network.

At no point would a user-centric provider offer to exchange user-centric cryptocurrency for cash. However, we do foresee a point where user-centric cryptocurrency would become intwined within a country's economy and perform as a currency of exchange.

Further, cross-certification limits and boundaries could optionally be implemented to mitigate the risk of excessive trade imbalances. Further a cross-certification process could optionally require that a transaction system demonstrate data center capabilities such as to support a level of cryptocurrency sale that is being conducted.

### Micro-License Generation and Interoperability

User-centric providers would need to be adequately funded in order to be considered as a viable platform. The user-centric provider would need significant funds to establish liquidity to cover the compute requirements of the obligation incurred with “transferred in” funds.

One may also envision a scenario where a rogue user-centric provider fabricated fake identities, issued user-centric cryptocurrency and then spent those funds within the broader user-centric economy. Or, a threat akin to a “Herstatt risk” where a financial institution makes a promise for account settlement and fails to do so out of incompetence, mismanagement or malign intent. To counter threats from user-centric providers themselves, in a general sense, a system of registration, certification, governance and financial staking would likely emerge to mitigate both systemic and intentional threats.

With regard to a user-centric provider generating cryptocurrency without corresponding purchases of cryptocurrency by users, a simple system of checks and balances will exist. All new cryptocurrency generation is publicly reported through ledger inspection methods. Cryptocurrency can only be generated by disclosed “governor” addresses. Every “certified” user-centric provider will agree to have their full ledger audited by each other certified user-centric platforms. The inspection would include analysis of currency generation, currency sales, in/out bound cryptocurrency transfers and currency spends. This will both build trust between user-centric providers as well as increasing trust of the global community in user-centric computing.

If a user-centric provider were to generate cryptocurrency under false pretense and assign to either a fake account or to a real account then the auditing process would uncover a delta between deposits (i.e. cash purchases of cryptocurrency) and the overall sum of all cryptocurrency activities. One benefit of an immutable ledger coupled with public disclosure of specific historical information is that it is nearly impossible to manipulate.

But does this set up user-centric providers to become another oligarchy? The answer is “no”. User-centric computing is built upon the notion of organic user control and portability. While the “core” user-centric providers will establish a sort of “first-mover” advantage, this initial “consortium” will be under existential threat from non-certified user-centric providers. A “certified” user-centric provider is one that is accepted into the cross-auditing network. But the technology, methods and principles of user-centric computing will not be bound to the first user-centric providers. Other unofficial user-centric providers are expected to emerge. They will not be trusted by the core user-centric providers because they will not be cross-audited. However, if the core user-centric providers become greedy, behave poorly or offer bad quality of service then they will simply be evolved out. User-centric data is portable. No one is “stuck” with any provider. Therefore, if an oligarchy exists it is because they provide the best quality transaction services at the best price.

It should be noted that user-centric computing is intended to enable thousands of businesses to emerge into a healthy and balanced yet competitive environment that is far different from what we have today.

As user-centric computing proliferates throughout an economy the cryptocurrency is expected to flow between the various user-centric providers. The user-centric providers will charge, via user-centric cryptocurrency, for transaction execution and storage. The gains realized by user-centric providers for billings users of their platforms will eventually be used to pay for both operational and capital expenses.

The end result is not the replacement of fiat currency but a complimentary service that can be used in a fungible manner across a country's economy.

### Monetary Policy in User-Centric Networks

User-centric networks represent both a transaction system as well as a cryptocurrency system. Cryptocurrency in a user-centric network is not created through mining or other similar activities. Rather, cryptocurrency is created at the time of and in exchange for fiat currency. More simply put, user-centric cryptocurrency is purchased from transaction providers.

Cryptocurrency in user-centric networks are representative of micro-licenses for the execution and storage of transactions. Therefore, user-centric cryptocurrency has an intrinsic value.

One may theorize that a potential threat is with a user-centric transaction provider creating cryptocurrency without the corresponding exchange for fiat currency. This would be akin to creating counterfeit currency.

There will be two classes of user-centric transaction providers. There will be “official” and “unofficial” transaction providers. An official transaction provider will be one that is vetted, authorized and integrated into the larger user-centric provider network. An unofficial transaction provider will be those networks established without being vetted, authorized and integrated into the larger user-centric provider network. Being “unofficial” does not necessarily indicate that a network is a “bad actor”. It simply means that it is not recognized and integrated into the “established” network. Such unofficial networks, one may theorize, could serve other purposes such as less expensive user-centric networks, small or higher performance or even specialized networks, and even closed or private networks. Unofficial networks could create cryptocurrency but that cryptocurrency would not be accepted for inter-provider cryptocurrency transfers by official transaction providers.

The question remains; even if “official” how can the transaction provider be trusted to not generate counterfeit money. A simple solution exists in the form of transparency. The charter of user-centric transaction providers will declare that all purchases of cryptocurrency done by users with fiat currency will have the amount of (and country of) the purchase publicly declared and publicly inspectable. Of course, to protect the privacy of the individual no PII will be shared. But, PII is not needed as long as the purchases are recorded and bound together such that they are immutable. To validate that the reported values are the entirety of cryptocurrency deposits for a given transaction provider the bank for the transaction provider can attest to the balance. Eventually a bank could record deposits as transactions (of record) within a transaction provider's ledger. The bank, through one method or another could clearly state the sum of deposits.

Therefore, if the transaction provider disclosed their deposits and their bank corroborated those deposits then it would become very difficult to simply create cryptocurrency when a set of checks would be available to establish the transaction provider's balance.

There is still an available angle of manipulation however. An expectation is that transaction providers would make publicly available a minimum set of details (such as timestamp, country and amount) for each sale of cryptocurrency. Those sales (fiat currency for cryptocurrency) would be associated together with a per record key and serially bound such that the collection of deposits could not be manipulated. After-the-fact record changes or record adds would not be possible. The preceding covers establishing a fact for reported cryptocurrency sales and subsequent bank deposits. But, what if the transaction provider simply creates and funds with “sock puppets” or other fake accounts and then simply does not disclose any record of those funds? The bad acting transaction provider could then facilitate transactions to authentic accounts?

The transaction provider, as a normal operational and auditing requirement, publicly discloses a Merkle tree, hash tree or other representation of the entire ledger. This capability serves the purpose of ledger verification. And, more specifically validates the wholeness and history of the ledger. It is therefore not possible to manipulate the ledger after the fact.

The generally available public ledger does not include funds transfer, credits or debits. The reason for this is that the data contained within transaction amounts could “leak” information.

However, is able to produce a ledger validation report with amounts to adhere to existing or expected auditing requirements.

The ledger integrity is provable and unchangeable. For the purpose of financial auditing the amounts associated with each transaction is provable and corresponding bank deposits to financial institutions are verifiable. Therefore, it is not possible for a transaction provider to create fake accounts or to create cryptocurrency that is not accounted for.

It is expected that a transaction provider will create some minimal amount of cryptocurrency that will not have corresponding deposits. These “creates” will be disclosed in the audit record because there is no way for cryptocurrency to be created that does not have a corresponding transaction. The created cryptocurrency along with per transaction fees and license fees will be used for operational support, network expansion as well as fraud mitigation and redress.

A user-centric transaction provider can generate cryptocurrency for two reasons: a) in direct exchange for user's purchasing cryptocurrency. b) additional cryptocurrency generated as a % of sales of cryptocurrency.

A user-centric transaction provider will disclose cryptocurrency revenue. For each instance of cryptocurrency generation, like a new user, or a user purchasing cryptocurrency, or the user-centric transaction provider creating additional currency, those records can be sequentially associated and disclosed in a similar manner as Ledger Integrity. Those transactions would disclose the GDP of the trx_sys economy. This function, in contrast to Ledger Integrity, might be called Currency Integrity.

Currency Integrity could be verified via 3rd party audit or disclosure of tax filing. Given that there is a direct correlation between revenue and cryptocurrency generation the GDP of the user-centric transaction provider's economy would need to balance.

Suppose a user-centric transaction provider generates currency and does not disclose? Given that currency transfers/payments are not publicly inspectable this becomes a challenge. Perhaps and analogous to a Merkle tree could be a “Funding tree”. In a funding tree a recipient of funds could generate a report that “tracks and traces” an amount of transferred funds from a sender through all prior transactions. This report would serve the purpose of demonstrating the source of cryptocurrency back to the original source funding transaction. And if any original source funding transaction did not correspond to a hash record in the ledger then this would be considered fraudulently generated funds. To generate such a report the system would traverse the currency “receives” from the sender and recursively through every prior transaction. But, does the user know that such a report is not a fabrication? trx_sys could point to any set of origin funding transactions that it wants to. To mitigate a trx_sys from creating false Funding trees a solution has been developed. Eventually there will be many transaction systems. As mentioned in other essays there will be fully trusted transaction systems and un-trusted transaction systems. For a transaction provider to become fully trusted they will need to allow for other transaction providers to audit their ledger balances. An audit of one transaction provider by another transaction provider would identify any fraudulent activity in the manner of currency generation. And, what makes this such a good solution is that transaction providers a) have to be trusted to survive, b) a fully trusted transaction provider will get more business and finally, c) it is contrary to the interests of transaction providers to have another transaction provider fraudulently generate currency. The result is that each transaction provider will be incentivized to identify and weed out any misbehaving transaction providers.

Transparency, auditing and the basic-principles of user-centric computing will establish significant trust in transaction providers.

### Micro-License Generation and Interoperability

User-centric providers would need to be adequately funded in order to be considered as a viable platform. The user-centric provider would need significant funds to establish liquidity to cover the compute requirements of the obligation incurred with “transferred in” funds.

One may also envision a scenario where a rogue user-centric provider fabricated fake identities, issued user-centric cryptocurrency and then spent those funds within the broader user-centric economy. Or, a threat akin to a “Herstatt risk” where a financial institution makes a promise for account settlement and fails to do so out of incompetence, mismanagement or malign intent. To counter threats from user-centric providers themselves, in a general sense, a system of registration, certification, governance and financial staking (not staking like with the Proof of Stake in conventional cryptocurrency) would likely emerge to mitigate both systemic and intentional threats.

With regard to a user-centric provider generating cryptocurrency without corresponding purchases of cryptocurrency by users, a simple system of checks and balances will exist. All new cryptocurrency generation is publicly reported through ledger inspection methods. Cryptocurrency can only be generated by disclosed “governor” addresses. Every “certified” user-centric provider will agree to have their full ledger audited by each other certified user-centric platforms. The inspection would include analysis of currency generation, currency sales, in/out bound cryptocurrency transfers and currency spends. This will both build trust between user-centric providers as well as increasing trust of the global community in user-centric computing.

If a user-centric provider were to generate cryptocurrency under false pretense and assign to either a fake account or to a real account then the auditing process would uncover a delta between deposits (i.e. cash purchases of cryptocurrency) and the overall sum of all cryptocurrency activities. One benefit of an immutable ledger coupled with public disclosure of specific historical information is that it is nearly impossible to manipulate.

But does this set up user-centric providers to become another oligarchy? The answer is “no”. User-centric computing is built upon the notion of organic user control and portability. While the “core” user-centric providers will establish a sort of “first-mover” advantage, this initial “consortium” will be under existential threat from non-certified user-centric providers. A “certified” user-centric provider is one that is accepted into the cross-auditing network. But the technology, methods and principles of user-centric computing will not be bound to the first user-centric providers. Other unofficial user-centric providers are expected to emerge. They will not be trusted by the core user-centric providers because they will not be cross-audited. However, if the core user-centric providers become greedy, behave poorly or offer bad quality of service then they will simply be evolved out. User-centric data is portable. No one is “stuck” with any provider. Therefore, if an oligarchy exists it is because they provide the best quality transaction services at the best price.

Another practical concern is trade deficit or imbalance between transaction providers.

It should be noted that user-centric computing is intended to enable thousands or millions of businesses to emerge into a healthy and balanced yet competitive environment that is far different from what we have today in the form of institution-centric computing.

As user-centric computing proliferates throughout an economy user-centric cryptocurrency is expected to flow between the various user-centric providers. The user-centric providers will charge, via user-centric cryptocurrency, for transaction execution and storage. The gains realized by user-centric providers for billings users of their platforms will eventually be used to pay for both operational and capital expenses.

The end result is not the replacement of fiat currency but a complimentary service that can be used in a fungible manner across both a country's economy and across the globe.

Method for specialized user-centric transaction provider types to serve specific functions.

To this point user-centric computing has described transaction providers as being either certified or not certified. It is entirely possible that transaction provider may need to exist to perform specific functions. Those special types of transaction providers are listed as follows:

Government mandated or government-controlled cryptocurrency generator transaction system. With this type of transaction provider it would be responsible for generating user-centric cryptocurrency and issuing to user-centric transaction providers that either generate cryptocurrency or do not generate cryptocurrency. A system of auditing could be used across transaction providers to validate that cryptocurrency monetary rule are being followed. Such a system may fall within the operating control of a central banking system of a country (like the US Federal Reserve). Such a system could file (transact) cross-provide ledger attestation certifications with other transaction systems of other types.

Pre-funded specific use case transaction system. With this type of transaction system, the user would not be charged for services as the cost for services would be pre-funded. One might imagine a system for taxation or other government services falling within this category. One might also imagine IOT transaction systems that are architected in such a manner to facilitate very highspeed operations that are paid by a consortium or other entities. Such a system could file (transact) cross-provide ledger attestation certifications with other transaction systems of other types . . .

Industry specific (i.e. gaming, energy, automotive, etc.) or country specific transaction systems with their own specialized functions, governance rules, languages, etc. Such a system could file (transact) cross-provide ledger attestation certifications with other transaction systems of other types.

### Method for Secondary Token or Layer 2 Token

trx_sys, as an example of a transaction system supporting the developing standard for user-centric computing, provides a cryptocurrency that has the properties of: 1) closed ecosystem where the transaction system will not exchange transaction system cryptocurrency held by users back to cash (fiat currency). 2) The transaction system cryptocurrency represents a micro-license for the execution and storage of some amount of transaction system transactions. 3) The transaction system cryptocurrency can be exchanged with users on other transaction systems. 4) The transaction system cryptocurrency has no supply limit and is based on users purchasing transaction system cryptocurrency with fiat currency. 5) The transaction system cryptocurrency has a value that is pegged to a fiat currency. 6) The transaction system cryptocurrency will not be speculative in that its fiat currency value will never increase or decrease in value compared to the fiat currency that it is pegged.

### Definitions

trx_sys—“with lowercase “t” is defined as an abbreviation of “transaction system”.

Layer 1 (including “Layer 1 transaction”)—refers to transactions executed in the scope of transactions that are not executed with regard to the management of a secondary or Layer 2 token.

Layer 2 token or secondary token—the terms are interchangeable and refer to series of transactions on a common chain_id that represent a token being requested to sell, the token approval process, shares of a token, trades of a token, etc.

Given the preceding one might consider that a transaction system cryptocurrency of a different or secondary type of token with attributes of a fixed supply could be useful in use cases where the value of a secondary may have a value that increases or decreases in contrast to a fiat currency.

One might observe that the proposed “secondary token” or “layer two token” has similarities in concept to Ethereum ERC20 tokens where a token (ERC20) can be instantiated on top of a transactional layer (Ethereum). However, a secondary token within the user-centric computing paradigm would be substantially different as the base transactional layer is completely different and the secondary token function while having some similarities to ERC20 would be substantially different.

A “secondary token” may also be described as a Layer 2 token as it builds upon the basic transaction functions and cryptocurrency of a user-centric transaction system. However, the references to “secondary” or “Layer 2” should not be considered conceptually or technically similar to descriptions of “Layer 2 protocols” by the conventional blockchain community.

A user-centric transaction system with secondary coin capabilities would operate in the following manner:

Process to request authorization to set up a secondary token:

The token would require vetting and permission by the trx_sys governing body to authorize a secondary token.

Various mechanisms could be used to track the authorization process but would likely manifest as:

Requestor to set up a secondary token creates a transaction of a specialized type within the trx_sys. No recipient is required. The Requestor can be an individual or a member of an organization or government. A chain_id will be specified.

The request may include details on the request in the transaction message.

The request will be evaluated outside of the process flow of transactions in the trx_sys. The trx_sys may interview the requestor, request additional information, etc. and that information may or may not be documented within the chain_id.

If rejected by the trx_sys then the ruling, optionally with or without details, will be recorded on the chain_id as another specialized transaction type.

Methods to contest a decision by the trx_sys governing body may exist or not.

Subsequent transactions by the governing body may require that the requestor modify the request.

If the request is approved then a specialized transaction will be recorded.

Information required in the request to authorize a secondary token:

The transaction for request to authorize a secondary token will include;

>>>Token issuing authority: This is the name of the person, company or country that is making the request to issue the secondary token.

>>>Token name: The common name of the token.

>>>chain_id, transaction ID or URL for additional information:

>>>TotalSupply: provides information about the total token supply

>>>TotalSupply_Can_Increase: yes/no/TBD to state that the total token supply can increase to.

>>>TotalSupply_Can_Decrease: yes/no/TBD to state that the total token supply can decrease to.

>>>TotalSupply_Can_Increase_to_Maximum: yes/no/TBD to state that the total token supply can increase to.

>>>TotalSupply_Can_Decrease_to_Minimum: binary yes/no/TBD to state that the total token supply can decrease to.

>>>If the token supply can increase, decrease or is TBD then;

>>>>>>Frequency by which increase can take place: unit of time (i.e. daily, weekly, etc.)

>>>>>>Frequency by which decrease can take place: unit of time (i.e. daily, weekly, etc.)

Optionally, a transaction protocol can be referenced in another specialized transaction to enumerate logic by which token supply may change.

>>>Sender_message: Documentation that describes the purpose of the coin, arbitrator of disputes (a PID) and other information optionally required by the trx_sys.

>>>List of PIDs for beneficiaries: A list of PIDs of persons who will receive controlling authority of the secondary tokens available to the creating party (PID)

>>>Beneficiary rules: A legal description of the beneficiary structure.

A specialized transaction that provides identity information on the requestor and optionally the requestor's organization, government agency, country, etc.

A specialized transaction that provides a list of PIDs that are allowed to purchase the secondary tokens. Included is a field that denotes whether that list can change (yes, no, TBD).

A specialized transaction that provides a list of countries from which users are allowed to purchase the secondary tokens. Included is a field that denotes whether that list can change (yes, no, TBD).

A specialized transaction that provides Initial price of the secondary token: amount, 0, or TBD.

Specialized transactions that define a value of Yes or No can not be subsequently modified with a transaction of the same type.

Specialized transactions that define a value of TBD can be subsequently modified with a transaction of the same type.

Considerations during the review phase before approval or rejection:

The identity of requestor is to be fully validated.

Trading of the token cannot take place without a specialized transaction from the trx_sys providing approval.

Trading of the token can be suspended or revoked with a specialized transaction from the trx_sys.

Trading of the token can be resumed with a specialized transaction from the trx_sys.

The trx_sys may assign an incrementing number in the transaction requesting approval for chains related to this capability. This incrementing number would not change within the change. This incrementing would increment by the value of one for each new chain. This would allow an interested party to determine how many, for example, Layer 2 coins have been (configurable by the trx_sys) requested, and/or approved.

### Operational Processes and Rules for a Secondary Token:

Once a secondary token is approved for sale and trading then the following applies;

The trx_sys governor will issue the quantity of coins per the request.

That issuance of secondary coins will be recorded in a specialized transaction. The amount would not be recorded in the standard sender_amount fee (the transaction field used to record an amount of standard trx_sys cryptocurrency sent to another party). Further,

The amount will be recorded in a distinct field designated for amounts related to secondary tokens. The “secondary token amount” fields may be recorded in an entirely new object, or a new fields within the standard sender object.

The trx_sys will evaluate fields within objects of transactions submitted to the trx_sys to validate whether the fields and or objects are allowed or not.

A user wishing to purchase a secondary coin will;

>>>Register a specialized transaction with a List of PIDs for beneficiaries: A list of PIDs of persons who will receive controlling authority of the secondary tokens available to the creating party (PID)

>>>Register a specialized transaction with a Beneficiary rules: A legal description of the beneficiary structure.

Tokens may be represented in denominations up to. 000001 of a token. This is configurable per trx_sys and may change.

The owner(s) of any tokens that wish to sell secondary tokens can create a specialized transaction that offers a given quantity of transaction for sale at a given price.

Those persons wishing to buy a given quantity of secondary tokens will provide an offer at a given price.

A trx_sys governor controlled process will serve as a brokerage process. We will describe this as the governor process.

The governor process will match offers to sell with offers to buy. As with other transactions executed by a trx_sys the user will be charged a fee or fees from the primary cryptocurrency of the trx_sys.

The governor process will execute transactions to complete a sale;

The governor process will execute a transaction that references the offer to sell, the seller PID, the buyer PID and meta information describing the sale such as timestamp and digital certificates to establish proof of the transaction.

The governor process will record transactions for purchase and sale, etc. of secondary tokens within the common ledger of the trx_sys.

The governor process will settle the sale of secondary tokens on a FIFO model for fairness.

The buyer and seller may each time limit their orders with such information being contained within the specialized transactions facilitating buy or sell order.

The buyer and seller may each time set ranges by which they will buy or sell with such information being contained within the specialized transactions facilitating buy or sell order.

The governor process may act upon lawful judicial order to reverse payments, redirect payments and to perform services of this nature within the legal bounds of the country of jurisdiction.

Because the governor process provides for the brokering or settlement method the specialized transaction recording the sale of a secondary token will involve a special escrow process.

The trx_sys may generate reports related to the secondary coin and disclose sales, current price, volume, etc. Those reports or data element would be recorded as transactions or they could simply be pushed to a traditional web site to host those reports as that data could all be verified through simple inspection of the chain.

All transactions associated with the secondary coin would be recorded to a chain_id and written to the primary ledger of the trx_sys.

Only one secondary token can be registered to a single chain_id.

Escrow process to facilitate purchase of secondary token(s) from another user;

A user wishes to put an offer to purchase some amount of a secondary token.

The identity of requestor to buy is to be fully validated.

The identity of requestor to sell is to be fully validated.

That amount would not be transferred to the governor or any other account.

The governor will validate that the user has sufficient funds at that time in order to accept the order. “Funds” refer to the cryptocurrency balance of the user for primary cryptocurrency and not a secondary token balance. For example, a user may have a thousand dollars worth of a secondary token but if the user does not have sufficient cryptocurrency issued by the trx_sys then the user will not have sufficient funds to purchase other secondary tokens.

Provisions could be made to allow for margin trading or for loans to be made by the trx_sys or other parties such that the user trx_sys cryptocurrency could be tabulated as “actual funds” or “loaned funds” or “total available funds.”

Whether the transaction describing the buy or sell request can be settled immediately or not the transaction will be recorded.

The obligation of the trx_sys in settlement is to, per a configurable Service Level Agreement (SLA), settle in as immediate a manner that is possible.

For example, the trx_sys records (commits the transaction) the specialized “offer to buy secondary token” request transaction.

If at that time and within practical time boundaries, secondary tokens that are offered for sale and within boundaries or limits specified in both the buy and sell “orders”, then;

The trx_sys will create a transaction that sends an amount of primary trx_sys cryptocurrency from the buyer to the governor. The governor is the sender, the escrowed_sender is the buyer, the recipient is the governor, the escrowed_recipient is the seller, the amount of primary trx_sys cryptocurrency is specified in the sender_amount, the amount of secondary tokens (could be a fractional amount) is specified in the “secondary token amount” and other information such as chain_id of the secondary token.

The primary trx_sys cryptocurrency has now transferred from the buyer to the governor as an escrow function to temporarily hold the funds.

The trx_sys will create a transaction that sends an amount of primary trx_sys cryptocurrency from the governor to the seller. The governor is the sender, the escrowed_sender is the buyer, the recipient is the seller, the escrowed_recipient is the seller, the amount of primary trx_sys cryptocurrency is specified in the sender_amount, the amount of secondary tokens (could be a fractional amount) is specified in the “secondary token amount” and other information such as chain_id of the secondary token.

The reason for sending the funds to the governor is to provide a record of the escrow function in more detail then the governor simply transferring funds directly to the seller from the buyer.

Direct selling and buying in a peer to peer manner.

The holder of a secondary token may transact directly with another user.

The sender could specify in a transaction the “secondary token amount” and the recipient in a similar manner as to how a user would transfer funds to another user with the “sender_amount” field.

This method would not provide provisions, such as an escrow, to insure that the seller would actually provide transfer of those secondary tokens.

However, other user-centric escrow methods could be employed or a user-centric transaction protocol function could facilitate the transfer in a safe manner.

The trx_sys will validate;

>>>The identity of requestor to buy is to be fully validated.

>>> The identity of requestor to sell is to be fully validated.

### Method for NFT Marketplace

While it is entirely possible that a digital asset could be recorded within a standard “layer 1” transaction one might come to expect that a digital asset such as is commonly described as a Nonfungible Token (NFT) may benefit from having a marketplace for selling and trading to be incorporated into a trx_sys.

A NFT marketplace in a user-centric model would be functionally very similar to the preceding Layer 2 token or Secondary token.

In fact, the model would be almost exactly the same with the following changes.

The user would create a standard transaction (i.e. Layer 1) with a digital asset either stored in the transaction message (sender_message) or referenced to an off site location.

The user would assign the transaction with the digital asset (or reference) to a chain_id.

The user would then register the digital asset as a NFT. By registering the transaction with a digital asset (or reference) as a NFT then that would enable other functions related to trading services.

The trx_sys may assign an incrementing number in the transaction requesting approval for chains related to this capability. This incrementing number would not change within the change. This incrementing would increment by the value of one for each new chain. This would allow an interested party to determine how many, for example, NFTs have been (configurable by the trx_sys) requested, and/or approved.

The trx_sys may or may not require an approval process to register a transaction with a digital asset (or reference) as a NFT. The trx_sys may impose limits or the user may impose limits on the number of shares, starting value of shares, etc.

The method to facilitate offers to sell and offers to buy will be handled in the same manner as described for Layer 2 tokens.

### Method for Open Authentication

Presented The following describes an inventive subject matter for Method for open authentication (i.e. Oauth) in user-centric platforms. A key enabling technology to allow for practical integration of user-centric computing into ecommerce, social media, healthcare, etc.

Open authentication refers to methods by which a user can be validated as a permissioned or recognized user into a third-party site or third-party platform.

FIG. L1 depicts process for authentication to an Application Service Provider (site) using user-centric credentials.

One might recognize this concept when going to a new web site and being presented with an option to “Log in with Google” or “Log in with Facebook”.

Several options are presented for utilizing this capability within user-centric computing.

user-centric transaction provider simplified as trx_sys (lowercase) or Trx_sys (upper lower case)

Method: Authentication of a trx_sys user from a third-party site.

### Authentication:

Site is an Application Service Provider (ASP)

Site must be registered with a user-centric transaction provider

Site can identify itself with token as registered with a user-centric transaction provider.

User is registered with a user-centric transaction provider.

User credentials (lg_password specifically) are never known by third party site.

Authentication is time bound.

### Process

User has an account with a user-centric transaction provider.

User is logged in to a user-centric transaction provider.

Site: At third party site, user clicks “Authenticate to user-centric transaction provider”

Site: Server-side process under control of site is initiated from http request (i.e. GET/POST).

Site assembles the following data as JSON

Data: Specialized transaction type set.

Data: Third party site identifier token

Data: Third party site identifier password

Data: Third party app identifier token-Identifies an app within a site.

Data: Third party user-centric transaction provider PID or SID

Data: Third party login name (optional)

Data: URL to redirect back to site

Site: Hash of JSON becomes access token

Site sends transaction package to user-centric transaction provider

Trx_sys, (user-centric transaction provider) receives data package from site.

The transaction sender is the site ID (PID, SID, etc.)

The transaction recipient is the undefined.

The JSON access token is written as message data.

Trx_sys creates a chain ID.

Trx_sys commits transaction to chain ID.

Site receives the trx_sys transaction commit including transaction ID.

Site forms a URL to trx_sys calling a trx_sys function for third party authentication with the transaction ID.

Site presents URL to user as a link to “complete” third party authentication.

User clicks link.

Link calls trx_sys authentication function on trx_sys. (User scope is trx_sys)

Arguments are received and parsed by trx_sys. Including chain ID.

User is logged in or logs in to trx_sys.

Trx_sys validates third party site.

Trx_sys validates that user is real and active.

Trx_sys forms transaction to write to specified chain ID

Trx_sys sets sender as user PID/SID and recipient as site.

Trx_sys commits transaction as specific type of transaction.

Trx_sys may be present an action complete and/or a redirect to a specific URL may be presented.

Trx_sys will include an access token as part of the redirect URL to the user.

User is back at site.

Site: Token is used for that user for that session or until expires

Site: Can use token to validate user authentication on chain ID.

Site: Or the site can scan trx_sys to identify new transaction where the site is the recipient for this specialized type of transaction.

Site: Token can be written as cookie to maintain session

### Result

A trx_sys transaction is recorded sender is user and recipient is third party site.

Fee for this type of transaction is CONFIGURABLE because it is security/authentication related.

### Lite Method of Open Authentication

In some cases a site may wish to leverage more tradition methods of session management and identity management but also wish to leverage some of the benefits of user-centric computing.

More specifically, the site may wish to have a persistent identifier by which sessions can be tracked.

The site may wish to have an option at a future point to increase services with increased user identity.

### To Set Up;

The user is using a browser, or client side injection capability, that with the user's credentials can create a token and register that token with a transaction system. That token may include an identifier for the transaction system.

The user goes to the site.

The site presents the user with an option that states (wording and function could be different) “Lite signup using user-centric credentials.”

The user clicks the function.

The click of the user function is observed by the client-side process.

The client-side process generates a transaction package.

Included is;

Request for a new SID (secondary ID)

Request for a token to be returned with SID and trx_sys identifier.

The trx_sys creates a connecting anonymous identity token.

The trx_sys processes the request including the anonymous identity token and commits a transaction to the ledger.

The trx_sys creates a second transaction to record the anonymous identity token. Given that an anonymous token is unique then the user can look this up at a later time if identity is needed to be de-anonymized.

The site will receive the anonymous identity token but the site can never maliciously associate that anonymous identity token with their user-centric account or anothers' because it was not recorded by a trx_sys governor process into their account.

The trx_sys returns the token with anonymous identity token to the client-side process.

The client-side process returns (i.e. GET/POST) the token with anonymous identity token to the site.

The site may then embed the token with anonymous identity token in session cookies and other tracking methods.

The site may rely upon the fact that it was a real user that generated the token with anonymous identity token.

Optionally, the site may require that the user identity can attest to “strong” or “full” identity without actually knowing anything about the user using methods for evolving identity and identity services that is a feature of identity services in user-centric computing.

Method for Organization token to person workflow authentication with inheritance.

There are use cases where a person needs to interact with an organization in person, perform a workflow of transactional data, and then inherit that data.

A scenario might be with a patient of a healthcare service. There is no need for the patient to be viewed as an anonymous entity to the healthcare service. However, there is significant benefit for the patient to be able to have control over all of her patient records, billing records, lab reports, etc.

A method to support the aforementioned patient care scenario is described through the following scenario.

A patient, Alice, goes to the Doctor.

The Doctor has need to validate Alice's insurance.

Alice could provide proof by retrieving healthcare evidence in the form of a user-centric transaction container where the healthcare insurance company has written a transaction with Alice as the recipient stating that Alice does have health insurance.

To provide that proof, Alice could retrieve the transaction from her trx_sys (transaction system). A client-side application on her phone would render a QR code for the ID of the transaction container. Or the transaction container itself could provide a similar function.

The Doctor office desk worker could scan the QR code (etc), retrieve the proof of insurance.

The Doctor office desk worker could then ask for proof of identity.

Identity and proof of insurance have now been established.

Alice had previously scheduled an appoint with the Doctor office. That schedule record is stored within a transaction container with the Doctor office being sender and Alice being recipient.

The Doctor office has need to collect vital data such as height, weight, blood pressure, etc. as well a questionnaire regarding Alice's current ailment of a hurt knee.

A simple questionnaire is filled out with a paper form.

Instead of having to fill out her name Alice can use her phone to create a short unique code to give to the Nurse.

When Alice goes to her phone to create the code a client-side application interacts with the trx_sys to create a transaction container of a specialized type and will generate the unique code. The unique code would be an alphanumeric string of some configurable length of characters.

Optionally, the code could be timebound to be only useful for (configurably) just this day, this week, etc.

Alice could give the code verbally or simply show the Nurse the unique code.

The Nurse then documents the code on the paper form.

Later the Nurse or other person could enter the data from the paper form to the trx_sys.

The pre-processed data package for the trx_sys would include the unique code and would be marked as such or would have a field dedicated as such.

The trx_sys would inspect the unique code and resolve Alice as the recipient.

The trx_sys would commit the transaction container.

A similar method could be employed if say a simple form application on a computer tablet was collecting information. That unique code could be generated and entered to provide the aforementioned association.

### Method for Practical Intra-Message Query

The following describes an inventive subject matter for Method for Practical intra-message query. User-centric transaction systems such as trx_sys.com currently do not allow for users to query on message data contained within transactions. Provided would be a method to allow that capability. There are two parts an internal system architecture as well as a client-side component.

Transaction containers are natively stored with message data that is encrypted. The challenge is that in order to search through data to provide practical query capabilities a user-centric transaction system would have to unencrypt each transaction's message data and then perform the search match. Or the user-centric transaction system would have to index message data as it is ingested or subsequently processed for indexing. This is not practical. Provided is a solution for practical intra-message querying capabilities.

To perform searches on message data several options are available to a user-centric transaction system:

A user-centric transaction system would keep an unencrypted copy of the message data available. Those transactions with their unencrypted message data would then be available for search. This does not increase a security risk because the ley to decrypt message data is included in every transaction container. However, a user may wish to include secondary encryption. A field could be called out within the transaction that makes a reference or a pointer to the secondary decryption key. The user would be the one to specify the secondary encryption key. That key could be stored in a transaction container. If the user wanted the transaction to be searchable or indexed then the user could give rights, through a special transaction, to a user-centric transaction system, or to others, to decrypt the message data. Therefore, the query capability would be revocable by the user.

Optionally, a user-centric transaction system could store unencrypted data, whether single or double keyed, in an enclave like Intel SGX or Intel TDX.

Optionally, the user can copy transaction containers to their local system or to another system, like a cloud storage platform. The user then may unencrypt their data and search and index their data.

It is to the first point where a user would perform a secondary encryption of the message data to keep it private from a) potential breach of the user-centric transaction system where transaction message data could leak to unintended parties. Or, b) along the lines of the concept of Discretely Distributed Ledger Technology (DDLT) the user may provide transaction containers outside of the user-centric transaction system to other parties. The method to share encryption keys is covered in the DDLT patent filing.

Therefore, we will focus this inventive subject matter on solving problems related to secondary key management while allowing for message query.

A scenario: Alice, is a user of a user-centric transaction system has data contained in many transactions across many chain IDs. In some cases, she is the sender (creator of the transaction), or the recipient, or the inheritor of transactions created on her behalf by others.

Her intent is to keep transaction container message data as private as possible. She understands that message data is encrypted via AES with the key stored adjacent to the transaction. She understands that she sets access rights to transactions to which she owns and that access to those transactions is managed by the user-centric transaction system. Regardless, she wishes to have a secondary encryption method. Of course, for transactions to which she is the sender she could encrypt messages entirely outside of a user-centric transaction system and before the user-centric transaction system ingested and processed the transaction.

A solution would have to cover all manner of transaction types where Alice is the sender, recipient or inheritor. Therefore, if Alice wished to have all of her transactions “properly” encrypted without a readily disclosed key (as with chain ribbon keys) then the solution would have to support users who send Alice a transaction and ASPs (etc.) that created an inherited transaction on her behalf.

User-centric transaction systems give priority control of access rights to the sender of the transaction. Therefore, preference in encryption will be given to the sender with secondary considerations provided to the recipients and ASP (inherited transaction creator).

To accomplish the preceding the user-centric transaction system would provide for a specialized transaction type that would establish that the user (Alice) will require that transactions that she creates are encrypted. Where Alice is the recipient and the sender has also set a requirement for encrypted transactions then the user-centric transaction system would also encrypt the message content and share the key with Alice. But this presents a challenge. If Bob, a user on a user-centric transaction system, creates a transaction and both Alice and Bob have requested secondary encryption then Bob, as the sender will be able to (through a governor process run by the user-centric transaction system) encrypt the secondary key to Bob's password (or perhaps an alternate credential). However, Alice will need that key. But the aforementioned governor process will not have Alice's credentials readily available to encrypt the key for Alice.

Unfortunately, a Diffie-Hellman key exchange will not work because the sender's transaction create (by Bob) is not to be dependent on the recipient being available to complete the exchange. In other words, a Diffie-Hellman key exchange requires both parties to perform some functions before the secret is generated. Therefore, a Diffie-Hellman key exchange will not work for the purpose of a creating a shared secret.

In a simplified sense the challenge is:
1. Bob has a secret that he needs to share with Alice.
2. Bob uses has password to encrypt the secret for storage and store in another transaction.
3. Bob writes the transaction to the transaction system.
4. Bob does not know when Alice will be online.
5. At some point Alice gets online and is somehow rather “magically” able to get the secret.
6. Once Alice has the secret then she can use her password to encrypt the secret and store in another transaction.

Step number “5” is the challenge.

An option or solution is that the user-centric transaction system could temporarily store the secret from Bob until Alice comes online. However, that option violates the principles of user-centric computing because that information, although temporarily stored should be clearly owned in a transaction by Alice but is not.

Of course, that secret cannot be stored in clear text regardless of who has control of it.

The solution is a feature in the aforementioned specialized transaction that establishes the requirement for secondary transaction encryption.

During the creation of the specialized transaction that establishes the requirement for secondary transaction encryption the governor process will create a random string as a secret key. The governor will then encrypt the random string (the secret key) using the governor's own password. The result is a unique encrypted string (secret key) with the secret password only known to the governor.

Then when Bob creates a transaction with Alice as the recipient and both require secondary encryption then the following process will take place.

Bob has a secret that he needs to share with Alice

Bob uses his password to encrypt the secret for storage and store in another transaction.

Bob writes the transaction to the transaction system.

When the transaction system is processing the transaction, the system will have access to the secondary password.

The transaction system will retrieve the transaction for Alice that set the requirement for secondary encryption.

That secondary encryption configuration transaction of Alice's will have the governor encrypted string (secret key).

The transaction system will decrypt the string and will then have Alice's secret key. This is NOT Bob's secret key.

The transaction system then takes Bob's secret string and encrypts it using the Alice secret key.

The transaction system writes the result to a transaction with Alice as the recipient.

At this point Bob has everything he needs to decrypt the message data.

At this point Alice has a transaction from Bob and the transaction system has encrypted and stored the secret key in another transaction that Alice can access.

The next time that Alice is online and executes a transaction or performs maintenance then the transaction system at the point it has access to Alice's credentials (password) then the transaction system will retrieve the secret from Bob that is encrypted by the transaction system and encrypt Bob's secret key with Alice's password and write the encrypted result to a transaction.

At this point Alice has everything she needs to decrypt the message data in the transaction from Bob.

Another way of describing this process.

See FIG. M2 for secret key generation between two parties.

A secret shared key is needed for Bob and Alice to encrypt sender_message data to.

Bob creates a transaction (1) request requiring a two party secret key. This transaction is associated with a chain_id that does not change through the process. The transaction type is “two party secret string create”.

Optionally, Bob can provide a secret key (sk1) (i.e. a alphanumeric string) or,

Optionally, the governor process will create a random string as a secret key (sk1).

Alice is specified as the recipient.

The governor will then encrypt the secret key (sk1) using the governor's own password to produce encrypted key (ek1).

The governor will then encrypt the secret key (sk1) using the Bob's own password to produce encrypted key (ek2).

The governor will record a transaction (2) with sender is governor and recipient is Alice with sender_message data including (ek1).

The governor will record a transaction (3) with sender is Bob and recipient is Alice with sender_message data including (ek2).

Alice can access the chain_id with transaction (2).

The governor will then decrypt ek1 using the governors own password to derive (sk1).

Optionally, Alice can always use this method to retrieve (sk1).

Optionally, Alice can record a transaction that ecrypts (sk1) with her password.

### Method Multi-Party Confidential Computing

The following describes an inventive subject matter for confidential computing in user-centric computing.

Effectively allows for multiple parties to perform analytics (including learning, modelling, inference) upon an immutable set of data kept private from other parties. Includes protecting and certifying the operational code performed against the data set.

Method for query attestation. Allows one to prove that a particular data set was produced from a specific query. This is accomplished through an attestation certificate that documents, immutably, the query structure, elements and boundaries.

Method to increase code (i.e. Python, C, etc.) trust including transactionalizing (i.e. tokenizing) compute containers, schemas and databases. Complimentary to the aforementioned confidential computing.

Confidential computing may also be known as trusted computing.

In the context of this inventive subject matter confidential computing allows analytics to be performed upon multiple data sets owned and controlled by multiple parties without those data sets being shared or exposed to un-permissioned parties.

As an example, one might consider a use case where a health focused research agency is attempting to search across patient data sets that are held by multiple hospitals. The researchers do not wish to hold or store the multiple data sets as this involves excessive risk and liability. Further, the hospitals due not wish to extend access to their respective data sets.

The solution is to make the data sets available within transaction containers. A special type of transaction will limit the rights to the data sets. Further, the special transaction will specify that a program (a script) contained within another special type of transaction container will have access to the data sets and can execute that script across a plurality of so described and permissioned transaction containers. The script will return the results into another type of specialized transaction. The output can then be accessed by parties who are permissioned from the first transaction or subsequent permission modifier transactions.

One might consider that confidential computing can take place within enclaves such as Intel SGX or Intel TDX. This is true. However, user-centric computing solves a different problem. While SGX or TDX can protect the integrity or confidentiality of data within an enclave, user-centric computing, with the aforementioned methods, can solve problems related to multi-party access controls of that protected data.

Most specialized transactions within trx_sys have a defined, bounded and well understood resource (i.e. cpu, memory, etc.) usage characterization. Therefore, no secondary compute provisions are made for most transaction types.

For the use cases involving user-centric confidential computing the compute burden is highly variable. Therefore, the aforementioned special transaction types for establishing a multi-party confidential compute activity will launch a virtual machine (VM). The VM will operate within a protected a protected region under the authority of the transaction provider and optionally within a secure enclave for increased protection. The VM will be permissioned by the transaction provider governor process (i.e. transaction provider root process or similarly permissioned process) to retrieve all specific data sets, the program (script) and then execute the script within the VM.

The output from the script will be capture by the governor process and will be written to a specialized transaction that serves as output for the results of the script.

### Method for Pre-Commit Data Manipulation Mitigation.

The following describes an inventive subject matter for Method for Pre-commit Data Manipulation Mitigation

User-centric computing provides methods such that the integrity of data can be established.

However, there are intricacies to trust dynamics that should be considered as holistic trust in data emerges across many use cases. For example, one might suppose a circumstance where a machine, perhaps an autonomous vehicle, is writing data to a user-centric transaction system. The data, once written becomes uncontestable in the manner of the data message written at a specific time from a specific account.

In a practical manner, the vehicle will gather data and transmit it the transaction system. Because true real-time communication is not possible, there will always be some lag time related to both the transmission of data and the processing of transactional data. Depending upon the data collection requirements there will likely be some batching of vehicle collected data before transmitting to the transaction system.

One might suppose a data set that describes how the brakes were applied to a vehicle. The time, in the following example data is represented as epoch time.
transaction block 001
transaction id=200, time=1629214154.002, brake=off, brake_pressure=0%
transaction id=201, time=1629214155.005, brake=on, brake_pressure=10%
transaction id=202, time=1629214155.107, brake=on, brake_pressure=40%
transaction id=203, time=1629214156.001, brake=on, brake_pressure=100%
transaction id=204, time=1629214157.022, brake=on, brake_pressure=100%

In the above example data set we can see how the vehicle reported, in transaction id=200 that the vehicle brakes were off and then with each subsequent transaction the brakes were applied with greater pressure.

Keeping in mind that it is not practical, even with a very fast network and very fast transaction processing, to record data to a remote system (i.e. the transaction system) in real-time, the potential for one to question the validity of the data written from the vehicle to the transaction system.

One might theorize an unlikely but technologically possible scenario where a vehicle's computer system, perhaps in a vehicle accident scenario, could manipulate data before it is written to the transaction system. Perhaps the vehicle's autonomous system observing that it was in an accident and recognizing that it did not apply the brakes might be configured to change the data to falsely claim that it did apply brake pressure before an accident.

Keep in mind that once data has been written to the transaction system then manipulation is no longer possible. But in the time from when an event was locally recorded to when it has been committed to the transaction system there is potential for manipulation.

Some methods that could be used to mitigate the risk of pre-commit transaction manipulation could include:

1) Cycles per unit of work constraint. The system could be certified such that a given amount of work would be known to take place within a given amount of cycles or time. For example, the processor cycles per instruction could be equated to the quantity of vehicle telemetry records (like brake pressure) recorded over a period of time. Given that logic is required to manipulate data and that logic requires additional instructions then an attempt to manipulate time-bound data would extend beyond the expected timeframe. The result is that it would be computational infeasible to manipulate the data records without an obvious disclosure of the attempt. If the required sampling rate is such that spare cycles are available then a cycle or instruction burning algorithm could be used. Such an algorithm may involve a factoring solution or similar problem.

2) System under control of another. A secondary system could be attached to the vehicle. The secondary system could make independent observations by drawing data directly from the same sensors or from inferential sensors (i.e. brake pressure corresponds to accelerometer data). The secondary system could then write data to the transaction system where it could be used to validate the data written by the first system. This option has a drawback in that with two independently recorded sets of data the possibility of contestability arises. Therefore, a secondary telemetry reporting system may lack practicality for auditing purposes.

3) A slightly modified version of “cycles per unit of work constraint” would be a method that requires that data be written at a given period of time. While data manipulation could still take place, the amount of manipulated data would be bound to a narrow timeframe.

4) Another consideration is that data written to a transaction system is immutable. Therefore, if one were to be caught attempting to manipulate data prior to commit to the transaction system then the record of manipulated data would be undeniable. That fact alone should help to mitigate the risk of pre-commit data manipulations.

5) A device external to the system. A specialized type of Hardware Security Module (HSM) (could be implemented in a sub-system such as Intel SGX or TDX)) could generate a nonce or seed and timestamp (ie epoch) that could be provided to the transaction pre-processing system. That nonce could be 1) recorded by the HSM for audit purposes, 2) made available to a transaction pre-processing system, 3) data record written back to the HSM, 4) HSM signs the data record, and 5) the signed data record, nonce and timestamp are made available (i.e. API) to the transaction pre-processing system to be included as message data in a transaction container.

The nonce and timestamp would be timebound. That is the nonce and timestamp would only be useful for a very narrow period of time.

The result would be a nonce and timestamp comingled into a data record that is auditable. In some configurations the audit record of the HSM could be periodically written to a user-centric transaction provider with associations or references to the transactions written by the primary system.

### Method for Link and Attachment Filtering

The following describes an inventive subject matter for Link and Attachment Filtering to mitigate the risk of spam, malware, viruses, ransomware, etc. using either a gateway (i.e. proxy) or client side filtering to validate links and code.

Some of the most common Malicious software attacks are the result of:

The user opens a link that then launches malicious software.

The user receives an attachment that then launches malicious software.

The user receives an email (spam) with either a link or an attached file.

There are two common actions related to the preceding attacks: 1) a method to transport malicious code to a user's computer, and 2) a method to execute the malicious code on a user's computer.

Code signing has been helpful, like when Microsoft signs an executable. However, no practical methods have been introduced to allow for highly granular signing of email messages and data payloads (i.e. executables) that will attest to the identity of the sender.

User-centric computing provides one root identity per user. A user may create multiple derivative identities but at its core there is just one identity.

Because every user-centric identity has an immutable identity at its root there is substantial risk for a user to send or sign malicious code. In certain circumstances, such as mandated by a lawful judicial process, a derivative identity can be traced to the core identity.

Given the preceding. As user-centric computing is adopted then it is reasonable to find that users may desire to only accept email or attachments from user or web addresses that can be traced back to a specific user.

Of course, in some cases a person's user-centric identity is derived from and aligned to a company. However, just as a person has a root identity so will a company. Therefore, with user-centric computing any derived identity can be traced back to a person or an employee of a company.

In most cases a user will be able to create as many derivative identities as they like. And in most cases those identities can used to varying degrees of anonymity. As long as a transaction provider is not compelled through a judicial process to reveal the core identity of a user then a user may act in complete anonymity if they desire.

### Practical Application of Data Signing

Data may exist as a file such as one might find with an attachment in email.

Data may exist on a remoter server and would be linked to.

A gateway process, such as may be found with a large enterprise, or a client process, could inspect a URL or a data package. We will call this process the “inspecting agent”.

If a data package, the file could contain meta information stating the user-centric transaction ID from which it has been created or processed into a transaction container. Then the inspecting agent can evaluate the data package, such as by taking a hash (i.e. SHA256) of the data package and extracting the transaction ID, then evaluating the corresponding transaction container for this specified transaction container.

If a URL or other “link” then a similar process would take place. The URL will have been processed into a transaction container. The link would include a pointer to the transaction container. The transaction container may be used to simply validate the integrity of the URL or the transaction container may include information to facilitate redirection (like URL redirection) to a secondary location.

The same methods just described could be used to validate email addresses.

And, as mentioned, if a bad actor attempted to send or otherwise provide malicious code to a user's computer and that user's computer is configured to have a user-centric inspecting agent then either the bad actor is at substantial risk if caught or the user's computer may quarantine non user-centric code and links.

### Method for Credential Management.

The following describes an inventive subject matter for method to facilitate password changes and to remedy password breaches in user-centric transaction systems.

A user in a user-centric transaction system has a login name and login password. Additionally, the user has assigned public and private keys.

The user password is stored by the user-centric transaction system (trx_sys) using key derivative method such as Argon2.

Defined is trx_sys as a general reference to user-centric transaction systems

The user password encrypts the private key using AES.

The user password is therefore critical to system security.

Process to change the password:

See FIG. M1.

The user goes to the trx_sys.

When the user is interacting with a trx_sys one might describe that the user is interacting with governor processes or processes under the control and authority of the trx_sys.

The user goes through a process to change their password.

The process is controlled the governor.

The governor evaluates and accepts the new password.

The governor process then uses a key derivative function to encrypt the password.

The governor process then writes the encrypted password as a special type of transaction. The user is the sender.

The governor process then writes another specialized transaction that references the prior password transaction container to declare that it is no longer valid.

Process to register a new key pair.

The user goes to the trx_sys.

The user goes through a process to change their keys.

The process is controlled the governor.

It should be noted that the user keys can be created and

stored by the trx_sys or locally created and stored by the user. This method covers keys created and stored by the trx_sys.

Using a specialized transaction process, the governor creates new keys.

The governor process, while in user scope, then uses the user password to encrypt the new private key.

The public key is not encrypted.

The governor process then writes the encrypted private key and not encrypted public key as a special type of transaction. The user is the sender.

The governor process then writes another specialized transaction that references the prior key pair transaction container to declare that it is no longer valid.

Process for a user to self-generate a key pair on a client or local system.

User-centric computing is architected to give preference to the user. That same philosophy applies to the generation and storage of user public and private key pairs.

To form a proper transaction the user must

Structure the transaction “package” in the proper format before transaction processing by the trx_sys.

The user must correctly tabulate transaction fees and include those fees in the transaction package.

The user must include the user's public key in the transaction.

The user must sign the transaction with the user's private key.

The user submits the transaction to the trx_sys.

The trx_sys evaluates the transaction package, public key, and the pid. The user ID and password is not required to commit the transaction.

Upon successful evaluation of the preceding information the trx_sys will commit the transaction.

For a user to locally create and manage key pairs the following is required.

The user creates a key pair using a local process.

The user registers the new public key with the trx_sys as a specialized transaction type.

The preceding steps serves to associate the user PID with the new public key.

The governor process the commits as a transaction the not encrypted public key as a special type of transaction. The user is the sender.

Optionally, the user may wish to revoke a prior key pair. If so, the user then writes another specialized transaction that references the prior key pair transaction container to declare that it is no longer valid.

### Method Semi-Cloned Transaction Containers

The following describes an inventive subject matter for Method for semi-clone transactions. Is a copy of a transaction that removes objects, fields and is able to parse message data to prevent viewing of transaction container data that a permissioned party wishes to keep private. This methods allows for analysis across large chains while respecting privacy. In practice a transaction of a special type can recreate a transaction minus a data element such as the sender PID.

In prior art related to user-centric computing and trx_sys, a type of read and write access control can be specific that is inherited. What this means is that the creator, user A, of the chain ID can set rights to the chain ID such that when user B is included as a recipient for a transaction in the chain ID by user A then user B can make a transaction including user C as a recipient. This will provide user C with the ability, in a daisy chain manner, to then write a transaction that includes user D as a recipient and so on. The point being that user A did not know who user C, D, etc. is and did not have to explicitly provision rights to those users to read and write to the specified chain ID.

One might imagine that a chain ID may contain hundreds or thousands of transactions. And those transactions may result from a multitude of users.

In some cases, a user at some point in the chain of transactions may decide to restrict others from viewing information in a specific transaction that are downstream (transaction sequential ID is greater than the transaction in question) and/or upstream (transaction sequential ID is greater than the transaction in question).

A transaction container includes a variety of objects with each object containing a variety of labels with values. A transaction container also includes the data package in the form of the sender_message that is part of the sender_object.

There are several use cases where a need may exist to block specific information from either whole objects, name/value pairs of objects or even specific data within part of the sender_message. We will explore such a use case through a scenario.

A chain of transactions exists that is associated to a single chain ID. For simplicity, we will call this a chain ID. A user, we will call her Alice, has inherited rights to write and read to and from the chain ID. Alice is working with a third-party analytics firm that has a need to perform analytics on the data contained in the chain ID. Alice could simple provisions rights through the inheritance model. Or Alice could provision read rights explicitly to the chain to the analytics firm. However, Alice is concerned that the analytics firm would then have access to more data then they actually need.

Alice could download the chain ID and share the data with the analytics firm. However, if the data is stripped from the transaction containers, then the methods used to establish data integrity (i.e. immutability) are lost.

Let us suppose that Alice only wants to restrict the sender PID and sender's public key (the creator's ID and public key of each of the transactions in the chain ID) from being viewed by the analytics firm. But both Alice and the analytics firm need to be able to attest to the data being whole and uncontestable.

Transaction containers are immutable. They will never change. This is a fact.

However, just as a transaction provider can be queried (like through the API) in a manner where only the message data is shared so can a more advanced capability take place. Let us pause with regard to the mention of being able to query transactions and only see the unencrypted message data. This function exists and is useful but the immutability of a result set from such a query is lost.

Getting back to the analytics firm. They need data but not all the data and the data needs to be provably whole and provably immutable.

The solution is to have the transaction system replicate or clone the required data from each complete transaction to a new “semi-clone” transaction. The semi-clone transaction would contain or rather not contain specific data element specified by Alice.

A specialized transaction type, a semi-clone create transaction, would serve as a template by which transaction objects or fields (etc) could be turned off or on for the semi-clone. The semi-clone implementation transaction, once recorded would have the transaction system then generate the semi-cloned transactions. Alice could then provision rights accordingly.

If a circumstance arose where a semi-cloned transaction was required, like for a legal reason, to prove its originating wholeness or integrity then that could be facilitated through a simple permissioning process by entitled transaction owners.

Further, just as transaction container objects and fields could be turned on or off for semi-clone generation the same method could be applied to message content through a simple template reference that would serve as a means of parsing information in or out of the transaction message data. Such a method would allow for the price of an item stored in a transaction message to be stripped out.

One may also consider that a chain_id is not static and new transactions (unless the chain_id is closed) will continue to be added even after the creation of the “create semi-clone transactions” request. Therefore, a provision in the “create semi-clone transactions” transaction will allow the user to configure if the “create semi-clone transactions” function should actively “semi-clone” new transactions. Further, specialized transactions related to “create semi-clone transactions” can modify the functions of the “create semi-clone transactions” in subsequent transactions such as to turn on semi-clone transactions if they were not originally specified to actively semi-clone new transactions. Other functions would be expected to exist in the same or similar manner.

Further, one might specify that a “create semi-clone transactions” should initiate on transactions once they have been inherited N number of times. This would be a configuration option within the “create semi-clone transactions” transaction.

Such a capability would allow Alice to tell the trx_sys that “I know that I am going to permission Bob to view all the chain data, but once Bob passes on to other unknown parties then those parties will only have access to semi-clone transactions thereby keeping data private from those unknown inherited parties but open to Bob.”

The intent is to keep Alice or anyone else from having to actively manage transaction container and chain_id permissions for all parties who may have an interest in accessing transactions on a chain_id.

Additionally, a chain_id established as semi-cloned, would allow a user to query the primary chain_id. The trx_sys would resolve permissions and will be able to determine where in the chain inheritance and semi-clone chain_id the user first landed and can resolve the query results accordingly.

Such a capability would enable, for example, an analytics firm, to access and analyze chain data yet only the chain data that was intended or permissioned by Alice or by a subsequent authorized user (one who was permissioned at an appropriate location of the chain_id).

A transaction system may optionally elect to create semi-clones data sets in an ad-hoc real-time manner rather than actually generating and storing them at the time of the semi-clone request.

Method for Forked chain_id with an inherited association to the preceding chain_id

It must be recognized that while a chain may start out as a linear set of data records (transaction containers) there may be points where the chain_id should fork to different users. One might consider a scenario where Alice has created a chain_id. She adds various transactions to the chain ID. The intent is that access to the chain will be through an inheritance model. Alice only knows who she will directly permission access to the chain to. For example, Alice has set the chain_id permission model to inheritance. Alice knows that she will permission Bob by writing a transaction to the chain_id naming Bob as a recipient. Alice understands that Bob will address new transactions on the chain_id to other people. In some cases, this writing of transaction and provisioning of inherited rights will continue in a daisy-chain or serial manner, one person permissioning another and so on. However, that sort of serial writing of transactions is not very likely with how the “real world” operates.

In many cases, and described through a scenario, Alice will create a chain_id and set the permissions to inheritance. Alice will then write a transaction to Bob thereby giving Bob permission to the prior transactions and to write new transactions. One may reason that Bob will create a transaction to Charlie. Then Charlie creates a transaction for Dan, and another for Ed, and another for Frank.

The transactions that Charlie creates can all be written to the same chain_id that Alice had originally created. Or Charlie could create a fork or forks of the “primary” chain_id. With this option, Charlie creates a transaction for Dan on a forked chain_id with an inherited association to the orginal chain_id, and another forked chain_id with an inherited association to the orginal chain_id for Ed, and another forked chain_id with an inherited association to the orginal chain_id for Frank. The result is an original or root chain_id that forks into three forked chain_ids with an inherited association to the orginal chain_id.

See FIG. N3.

The original chain will persit.

Forked chain_ids will be named in some manner to either root them back to the chain_id from which they were spawned or other pointers will accomplish the same function.

A chain_id may be forked and forked again over and over. Each subsequent chain_id will serve as both a distinct chain_id and forked chain_id regardless of permutations thereof.

The purpose of a forked chain_id with an inherited association to the original chain_id is to separate chains or transaction streams. Alice would have rights through the downstream forks because she created the orginal chain_id. Alice would want to take care not to include information in a rights inheritance model that she did not want exposed to downstream users.

chain_id identified as 111.a and assigns to Dan, then Dan may create a fork of 111.a and assign to George as 111.a1 and Hank as 111.a2.

Dan will have access to chain_id 111 and inherited forks of 111.a, 111.a1 and 111.a2 and sub-forks of all four chain_ids. However, George will not have access to 111.a2 and, conversely, Hank will not have access to 111.a1. Therefore, one might observe that inheritance is not lateral or horizontal. Of course, a subsequent process explicit rights assignment can be made laterally. But those lateral rights would not extend to upstream chain_ids.

See FIG. N4.

Optionally, the system of rights and forks can be configured such that a downstream user of inherited rights could NOT block a subsequent downstream user from accessing upstream chain_ids. Conversely, the system of rights and forks can be configured such that a downstream user of inherited rights could block a subsequent downstream user from accessing upstream chain_ids.

The result is that Alice, Bob, Charlie and so on will be able to share chain_id data, establish forks of inherited chain_ids and control the lateral access of that chain_id data. Let us say that eventually a downstream user named Susan has need to access an inherited chain_id. Susan may find that the most recent chain for which she is permissioned may represent a 50th level of inherited chain_id. Susan can access chain_id data through N.50 back through N.0 (the original chain_id). But she will not have access to any lateral forks that occurred during the life of the chain.

Optionally, a transaction system may provide specialized transactions that would allow Susan to request a fork map. Optionally, a transaction system may provide specialized transactions that would allow Susan to request access at various forks.

One might consider that the preceding access control methods could be subverted by the various users downloading and sharing transaction containers or message data outside of the transaction system. This is possible with any system. However, the access controls are specified in transaction containers which would serve as notice to any user as to the acceptable use policy and intent of rights.

### Method for Practical Digital Asset Management and Interoperability in a User-Centric Metaverse

For The following describes an inventive subject matter for Functions in Support of a Practical and User-Centric Metaverse.

Metaverse defined. A metaverse is a network of 3D virtual worlds focused on social connection. <source: wiki>

Further, there is increasing discussion in the media that the metaverse will be inclusive of business, commerce, acedemia, etc.

Several challenges exist with regard to the practical implementation of a “true” metaverse or perhaps more accurately an “open” metaverse.

With the conventional Internet a user might interact with one site for social media, another for banking, another for online groceries and so on. The point being that the current Internet does provide a rather seamless experience to the user across all of these various institutions. Consider that an institution model of computing is the dominant model of how user data and identity is managed. The user essentially operates in a collection of silos. The reason for this is that the trust or proof od data integrity is, like data and identity, bound to the hosting institution.

The primary challenge with a metaverse is in providing a seamless experience to the user. For example, if a user, Bob, were to enter the metaverse and Bob wishes to visit his bank and conduct some banking business like opening a new account and then Bob wants to go to a metaverse grocery store and have this be a seamless experience then how will Bob login to the bank and then to the grocery store?

One might consider that the metaverse will require a layer of account management. Bob might then login to the metaverse and that login may then pass credentials to the bank and to the grocery.

That “layer” will also need to hold the avater and other identifying information about Bob. After all, Bob won't have one avatar for the bank and another for the grocery. To do so would negate the need of the metaverse.

One might expect that the metaverse will solve the siloed institutional model of how trust in data (and identity) is bound to a multitude of online companies without an ability to move data around, across and to different companies. Therefore, that metaverse layer might also serve the function of attesting to the integrity or truthfullness of data that reside in one silo so that the user, Bob for example, might be able to move that data to another company in the metaverse.

And here we have the problem. The metaverse requires a level of portability and interoperability for which existing or conventional technology methods are simply not adequate. This is where companies, Facebook (is now Meta) in particular is offering to build that layer of interoperability.

The real challenge is not with the AR and VR headsets and communication technology. The real challenge is in enabling a layer of interoperability that does not require a singular company, like Meta, to be that trusted layer of interoperability.

There is simply too much risk to humanity to have a singular company become the metaverse.

Many have discussed using blockchain, such as Ethereum, as the layer of interoperability for the metaverse. Unfortunately, public blockchains are not a practical solution as they either lack privacy, or performance, or compliance, or identity solutions, or practicality, etc. Public blockchain is not a solution.

User-centric computing solves compliance, identity, performance, data portability and other issues.

Several key inventive subject matters are called out that leverage user-centric computing in support of a practical metaverse.

Before digging into the inventive subject matters and benefits of user-centric computing with regard to the metaverse, it may be useful to establish a better understanding of the metaverse for background and conceptual purposes.

The metaverse represents an evolution of multi-player immersive video games that take place in 3D worlds. A 3D world might be described as a collection of shape libraries, rules for shapes, rules for users who are represented as avatars. Users are registered with the hosting or gaming company. Therefore, the current state of the art is for 3D virtual worlds to exist within the control and ownership boundaries of a single hosting company. An extension of that thought is that a metaverse may become a collection of 3D virtual worlds, elements in a world, user identities, and rules for players that span multiple hosting companies.

Interoperability across multiple metaverse environment providers. A metaverse provider would be an organization that provides for digital world environments. A metaverse environment might be considered analogous to a digital city with digital roads, walkways, subways, buildings, etc. A metaverse environment provider could also operate within larger metaverse environments. For example, an apartment may be constructed and sold by one metaverse environment. The building may be from another metaverse environments. The city from another metaverse environments, and so on. A practical requirement would be for digital assets to be created, bought, sold and leased within their respective metaverse environments.

The challenges of such a multiple hosting company metaverse was described in the preceding description.

Continuing with the background statement in the form of continuing with the scenario of Bob in the metaverse but in the context of a user-centric metaverse. Bob puts on a AR/VR headset. Bob logs into his user-centric account. Because of the nature of user-centric computing Bob can log into the user-centric transaction provider of his choice.

Bob has selected the virtual world that he wishes to have as his “home world”. His “home world” represents a collection of libraries, shapes and rules. The “home world” is provided by a metaverse application service provider (MASP). Bob has either purchased a subscription through the MASP or has traded access to some of his personal data for ad generation in the “home world”.

In Bob's “home world” he may be able to see streets, walkways, houses, the sky, birds and even other people.

All of those digital assets (houses, sky, birds) were created by someone. The MASP of the “home world” might provide a variety of “free” digital assets for Bob. Of course, Bob could select a different “home world” and even other worlds from other MASPs.

The metaverse is expected to be interoperable. Therefore, one might consider the metaverse to be a software construct by which digital assets that may have been produced by other parties can overlap and interact with other digital assets.

A MASP will provide for digital asset overlaps and interaction in the user-centric metaverse.

For example, Bob might decide that it would be nice to observe eagles flying around in the user-centric metaverse. Bob would search for and find an eagle that he likes. The eagle would be a software construct that would have behavioral rules applied to it. Bob purchases, leases, trades or otherwise acquire the eagle.

There are two considerations to the eagle. 1) How exactly does Bob purchase, trade or otherwise acquire the eagle and maintain a record of that transaction as well as the data associated with manifesting the eagle? 2) How does the eagle integrate into Bob's “home world”?

### Purchase, Lease, Trade or Other Acquisition of Digital Assets

Continuing with the scenario. Bob connects with a metaverse search engine. We will call this Meta Search Company Acme. Bob does this by recording a specialized transaction that serves as a record within his user-centric computing account that Meta Search Company Acme is a metaverse search property.

The MASP for Bob's home world has been given permission to access certain data contained in special transaction containers on Bob's user-centric computing account. The MASP is therefore able to identify Meta Search Company Acme as Bob's search engine. The MASP retrieves a metaverse construct (data files, libraries, rules, etc.) from Meta Search Company Acme.

The MASP the integrates the Meta Search Company Acme construct in Bob's home world. This may manifest as a simple pop-up search screen or it may manifest as a building that Bob can walk or otherwise navigate into. Bob might interact with AI agents or even avatars of real humans in the Meta Search Company Acme construct. The construct could appear as a building or as a luxury resort like with a swimming pool and cabana. Bob might pay or otherwise compensate Meta Search Company Acme for more advanced features and more advanced experiences.

Bob, regardless of the experience in the Meta Search Company Acme, finds an eagle provided by Metaverse Birds. Bob purchases the eagle through a user-centric transaction that transfers an amount of user-centric cryptocurrency from Bob to Metaverse Birds with, optionally, Meta Search Company Acme getting a commission (or simply an opportunity to adverse to Bob).

Upon completion or commit of the user-centric transaction for the purchase of the eagle from Meta Search Company Acme the MASP becomes aware of the purchase by scanning Bob's user-centric computing account for new transactions of a type that represents digital assets acquired for Bob's home world.

The MASP will then inspect the digital asset requirements that represent the eagle. A programmatic description or digital manifest will be provided by Metaverse Birds. That digital eagle manifest will be described or referenced in the transaction whereby Bob purchased rights to the eagle AND a transaction that contains the digital manifest that optionally would be stored or referenced on the user-centric computing account of Metaverse Birds.

Given sufficient descriptive information on the eagle the MASP will render the eagle an overlay in Bob's home world.

### Interoperability in the Metaverse

We have described how a user, Bob, could contract with a MASP (metaverse application service provider) for a 3D world. The MASP would render the 3D world for the benefit of Bob. However, a world occupied solely by Bob would not be much fun.

Bob may want to visit with a friend in the metaverse. Suppose that friend is Alice. Alice is registered with a different user-centric transaction provider. Bob knows Alice and knows Alice's metaverse email address. Bob creates an email invite to ask Alice to meet him at a café. We will call this Meta Café.

First, the email. User-centric computing provides for routing across different user-centric transaction providers so this is known art. Second, let us suppose that the Meta Café is a digital asset that is provided by Alice's MASP.

The Meta Café is not part of Bob's metaverse. Further, Alice's home world is completely different from Bob's home world.

We should point out that a user-centric supported metaverse can have digital worlds, digital assets, users, universal rules, etc. interoperate through a variety of mechanisms. The examples called out here merely represent a handle of methods to “stitch” together an open metaverse.

Getting back to the Meta Café. The Meta Café is part of Alice's home world. Now whether the creators of Alice home world actually build the Meta Café or acquired it through the same or similar method as how Bob acquired the eagle does not matter. Bob comes from one home world. Alice from another. However, there is an expectation that one may interoperate with other worlds.

To design, maintain and render a metaverse is no single task. It takes significant technical, business, management, legal resources as well as extensive capital expenses for data centers, networks, etc. Therefore, it will be expected that for a MASP generated home world to allow a user from another MASP generated home world would have a cost associated with that activity. For Bob to visit Alice's home world and walk around, observe the sky and forests as well as visit the Meta Café has an associated cost.

Upon entering Alice's home world for the first time a process takes place. This is be mostly seamless to Bob. Let us suppose that Bob is going to “walk” from his home world to the Meta Café in Alice's home world.

Bob leaves his virtual “home” and walks towards Alice's home world and the Meta Café. A mapping service, perhaps provided by Bob's home world or a third party can provide directions. Or Bob, subsequently, may register, through a specialized transaction, that Alice's home world will be physically placed (in a virtual sense) adjacent to Bob's home world where one street ends in his world a new street begins in Alice's home world.

Bob approaches the boundary of his world. This is known by the MASP in the same manner that a 3D game provider knows the special orientation of its players. At the boundary between the two home worlds a process takes place.

Bob's MASP understands that Bob is attempting to visit Alice's home world because either Bob explicitly stated to his MASP that he was going to visit Alice's home world, or through insights into his schedule by his MASP.

Bob's MASP is therefore able to generate a view of Alice's home world as Bob approaches Alice's home world.

Still at the boundary.

A transaction is generated by Bob's MASP essentially asking if Bob wishes to connect to Alice's home world. Bob may have previously created specialized transaction that states that if he attempts to enter another world then, given predefined cost boundaries, he will automatically be connected or cross-certified.

The transaction is generated by Bob's MASP. It states Bob's PID as recipient, Alice's home world MASP PID as a second recipient and Bob's MASP PID as the sender.

The transaction, being user-centric, will be found by Alice's MASP because Alice's MASP is tagged in the transaction as a recipient.

A secondary process may require that Alice approves. But this is just an optional configuration.

More likely Alice's MASP will generate a second transaction.

The transaction is generated by Alice's MASP. It states Bob's PID as recipient, Bob's home world MASP PID as a second recipient and Alice's MASP PID as the sender.

Now, both MASPs for both home worlds have awareness of Bob.

Alice's home world MASP can now generate ads to augment the cost associated with Bob entering Alice's home world. However, MASPs may forego ads in favor of letting users from outside their world enter with the expectation that this will generate goodwill among their users and attract more users to which they can either charge or leverage an ad revenue model.

Capabilities introduced thus far:

A user with a user-centric identity can register with a metaverse application service provider (MASP).

A method for payment to the MASP from a user is described.

A method by which a user can acquire rights to a digital asset have been described.

A method by which one MASP can determine rights to a digital asset has been described.

A method by which a user in one virtual world operated by one MASP can visit another virtual world operated by another MASP.

A method by which compensation and charges can be charged by a MASP and other creators of digital rights across a metaverse of unrelated providers of services.

### Method for Identity Services in a User-Centric Metaverse

The expectations of the metaverse will include being able to interact with other people whether for gaming, business, school, etc. In some cases, a “weak” online identity is sufficient. A weak online identity is one where the actual identity of the human behind the online identity is not proven. A strong identity, on the other hand, might be characterized as an online identity to which the human behind the online identity is known and proven.

User-centric, per other related inventive subject matters, provides rich identity capabilities that can progress from weak to strong identity. Further, user-centric identities are portable. That is, they are not bound to a specific user-centric transaction provider. These identity features make user-centric identities perfect for the metaverse where one might expect to have multiple providers of online assets and services to interoperate without any single company acting as the “benevolent dictator”. Proponents of user-centric computing will typically desire portability of data and identity so as to not be locked into any particular vendor of services.

In the preceding methods of this patent filing several attributes of identity services were described in the context of a user-centric metaverse. However, one particular function was not described.

The metaverse, being a digital construct, will represent the likeness of a person through an avatar. That avatar may exist in any form of character styles or representations from cartoonish, to fantasy style, to realistic. It may be expected within the multiverse that the uniqueness of an avatar be provably unique.

An avatar may be considered a digital asset. Avatar “skins” may be designed by professionals and sold to users of the multiverse. Or, users may have software kits that allow them to design their own avatars.

User-centric computing can both facilitate the sale, lease, trade, etc. of avatar skins. This was described in the preceding method that referenced the sale of rights for an eagle.

Further, user-centric computing can facilitate and provide mechanisms to enforce uniqueness of avatars.

Note: While this inventive subject matter is discussing avatars in terms of the appearance of an avatar skin the following methods are applicable to avatar movement, facial structure, strength, dimensions, sound, colorization, etc.

Regarding enforcement of uniqueness. In the metaverse it may prove beneficial to be able to identify another person with a unique avatar. If everyone looked the same (had the same avatar) then it would be difficult to every know who one was talking to without explicit labelling. Further, if avatars lacked uniqueness, then one might never be certain if they are engaging with the intended person or an imposter.

Uniqueness of avatars could be enforced at the level of Metaverse Application Service Provider (MASP). Or, uniqueness of avatars could be enforced at the user-centric transaction provider level.

Perhaps legislation related to the metaverse will enforce a standard or even laws stating that users have unique avatars.

To enforce avatar uniqueness at the level of the user-centric transaction provider then the following process could exist.

A person is registered with a user-centric transaction provider.

A user would have one or more MASP “worlds” to connect to.

A user would register with a MASP using a specialized transaction type. To unregister would involve a similar transaction type.

The MASP would be able to discover the registration of the user to the MASP.

That user acquires a unique avatar from an avatar provider.

The acquisition (purchase, lease, trade, etc.) would be registered with a special type of transaction stored in the user-centric transaction provider. One might call this an avatar registration transaction.

The specialized type of avatar registration transaction could instantiate a secondary process by the user-centric transaction provider to verify with itself and with other user-centric transaction providers that the avatar is unique.

Further, methods could be used during that secondary avatar uniqueness process to evaluate similarities and boundaries could be set to make sure that an avatar with sufficiently unique from another avatar.

An exception or failure state could notify the user that the avatar failed the uniqueness test would prevent an exchange of funds with the avatar provider.

The user could then create another specialized transaction that “tags” the MASP to the avatar transaction.

A MASP would be able to inspect a user-centric transaction provider for avatar notices of registration.

The MASP would then be able to collect the avatar data from the record itself or from a referenced location.

The MASP, having avatar descriptive data, would then be able to render it for the user in their world.

The user could visit other worlds, and per the preceding example of Bob visiting the Meta Café, in a seamless manner.

For the above see FIG. 1 and FIG. 2.

Additional methods in support of avatar uniqueness:

Using the aforementioned methods an avatar could represent the human likeness (i.e. photo realistic) of the user as an avatar. The likeness could be based on biometric data stored in the user's user-centric transaction provider identity information.

In situations where a requirement was made through a law or at the trx_sys level or at the MASP level that the identity will be unique and based on biometric (the facial structure of the user) then this could be supported. The user could still change various attributes of the avatar such as clothing, hairstyle, make-up, even weight, etc. However, other users could rely upon that avatar appearance as being unique and bound to a specific user.

A user could enable various identity functions such as to allow information about the user's gender, country and language to be readily shared with other users.

A user could enable access by other users to the quantity of recorded transaction for avatar used by the user and whether those avatars are actively used. Further, specialized transactions could be used to explicitly state whether an avatar was disabled and when it was disabled. A first user could then query a second user's avatar data to establish, for example, that for the three avatars owned by the second user that two have been disabled several months ago and the first user can rely on the second user's appearance as a relatively non-changing avatar.

Real-time biometric data could be provided through “streaming” biometric data where cameras and other sensors observe the real human, collect that data, stream to the trx_sys as transactions, are made available to the MASP, and are then rendered onto the “face” or “posture” or (etc.) of the user's avatar.

A user might query a user to establish that the user is a real human versus an “AI bott”.

The user might establish identity sharing profiles through specialized transactions that would allow the sharing of different information depending upon attributes of the digital identity (avatar) or digital asset (thing) or digital location (place) that the user is interacting with.

For example, if the user were to visit a grocery store in the metaverse, the grocery store being a digital place, the user may have a profile established that will share specific preferences such as for organic food such that the digital store will present a virtual representation tailored for that user.

In contrast to the preceding example, another store, perhaps known for its products that are represented the same to all visitors can establish as a fact that what Alice is seeing in the store is the same as what Bob is seeing. This could be accomplished by the store registering a digital assets manifest and digital store design that could be inspected by the respective users. User-centric computing would facilitate a practical capabilities of such functions by allowing users to inspect the last registered version of those specific transaction types.

FIG. 40 is a block diagram of an example processor platform 4000 structured to execute and/or instantiate the machine readable instructions and/or the operations of FIGS. 3B, 4, 6, 7, 10-12, 14, 15, 20, 21H, D1, D2, E1 through E10, E12 through E16, F1 through F10, F12, G2, I1, I2, J1 through J8, K1 through K3, L1, M1 through M3, N1 through N4, O1 and O2 to implement the TC circuitry 102 of FIGS. 1 and 2. The processor platform 4000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 4000 of the illustrated example includes processor circuitry 4012. The processor circuitry 4012 of the illustrated example is hardware. For example, the processor circuitry 4012 can be implemented by one or more integrated circuits, logic circuits, FPGAs, microprocessors, CPUs, GPUs, DSPs, and/or microcontrollers from any desired family or manufacturer. The processor circuitry 4012 may be implemented by one or more semiconductor based (e.g., silicon based) devices. In this example, the processor circuitry 4012 implements the circuitry of FIG. 2.

The processor circuitry 4012 of the illustrated example includes a local memory 4013 (e.g., a cache, registers, etc.). The processor circuitry 4012 of the illustrated example is in communication with a main memory including a volatile memory 4014 and a non-volatile memory 4016 by a bus 4018. The volatile memory 4014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 4016 may be implemented by flash memory and/or any other desired type of memory device. Access to the main memory 4014, 4016 of the illustrated example is controlled by a memory controller 4017.

The processor platform 4000 of the illustrated example also includes interface circuitry 4020. The interface circuitry 4020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 4022 are connected to the interface circuitry 4020. The input device(s) 4022 permit(s) a user to enter data and/or commands into the processor circuitry 4012. The input device(s) 4022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 4024 are also connected to the interface circuitry 4020 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 4020 of the illustrated example, thus, typically includes a graphics driver card, a graphics driver chip, and/or graphics processor circuitry such as a GPU.

The interface circuitry 4020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 4026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 4000 of the illustrated example also includes one or more mass storage devices 4028 to store software and/or data. Examples of such mass storage devices 4028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 4032, which may be implemented by the machine readable instructions of FIGS. 3B, 4, 6, 7, 10-12, 14, 15, 20, 21H, D1, D2, E1 through E10, E12 through E16, F1 through F10, F12, G2, I1, I2, J1 through J8, K1 through K3, L1, M1 through M3, N1 through N4, O1 and O2, may be stored in the mass storage device 4028, in the volatile memory 4014, in the non-volatile memory 4016, and/or on a removable non-transitory computer readable storage medium such as a CD or DVD.

FIG. 50 is a block diagram of an example implementation of the processor circuitry 4012 of FIG. 40. In this example, the processor circuitry 4012 of FIG. 40 is implemented by a microprocessor 5000. For example, the microprocessor 5000 may be a general purpose microprocessor (e.g., general purpose microprocessor circuitry). The microprocessor 5000 executes some or all of the machine readable instructions of the flowcharts of FIGS. 3B, 4, 6, 7, 10-12, 14, 15, 20, 21H, D1, D2, E1 through E10, E12 through E16, F1 through F10, F12, G2, I1, I2, J1 through J8, K1 through K3, L1, M1 through M3, N1 through N4, O1 and O2 to effectively instantiate the circuitry of FIG. 2 as logic circuits to perform the operations corresponding to those machine readable instructions. In some such examples, the circuitry of FIG. 2 is instantiated by the hardware circuits of the microprocessor 5000 in combination with the instructions. For example, the microprocessor 5000 may be implemented by multi-core hardware circuitry such as a CPU, a DSP, a GPU, an XPU, etc. Although it may include any number of example cores 5002 (e.g., 1 core), the microprocessor 5000 of this example is a multi-core semiconductor device including N cores. The cores 5002 of the microprocessor 5000 may operate independently or may cooperate to execute machine readable instructions. For example, machine code corresponding to a firmware program, an embedded software program, or a software program may be executed by one of the cores 5002 or may be executed by multiple ones of the cores 5002 at the same or different times. In some examples, the machine code corresponding to the firmware program, the embedded software program, or the software program is split into threads and executed in parallel by two or more of the cores 5002. The software program may correspond to a portion or all of the machine readable instructions and/or operations represented by the flowcharts of FIGS. 3B, 4, 6, 7, 10-12, 14, 15, 20, 21H, D1, D2, E1 through E10, E12 through E16, F1 through F10, F12, G2, I1, I2, J1 through J8, K1 through K3, L1, M1 through M3, N1 through N4, O1 and O2.

The cores 5002 may communicate by a first example bus 5004. In some examples, the first bus 5004 may be implemented by a communication bus to effectuate communication associated with one(s) of the cores 5002. For example, the first bus 5004 may be implemented by at least one of an Inter-Integrated Circuit (I2C) bus, a Serial Peripheral Interface (SPI) bus, a PCI bus, or a PCIe bus. Additionally or alternatively, the first bus 5004 may be implemented by any other type of computing or electrical bus. The cores 5002 may obtain data, instructions, and/or signals from one or more external devices by example interface circuitry 5006. The cores 5002 may output data, instructions, and/or signals to the one or more external devices by the interface circuitry 5006. Although the cores 5002 of this example include example local memory 5020 (e.g., Level 1 (L1) cache that may be split into an L1 data cache and an L1 instruction cache), the microprocessor 5000 also includes example shared memory 5010 that may be shared by the cores (e.g., Level 2 (L2 cache)) for high-speed access to data and/or instructions. Data and/or instructions may be transferred (e.g., shared) by writing to and/or reading from the shared memory 5010. The local memory 5020 of each of the cores 5002 and the shared memory 5010 may be part of a hierarchy of storage devices including multiple levels of cache memory and the main memory (e.g., the main memory 4014, 4016 of FIG. 40). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 5002 may be referred to as a CPU, DSP, GPU, etc., or any other type of hardware circuitry. Each core 5002 includes control unit circuitry 5014, arithmetic and logic (AL) circuitry (sometimes referred to as an ALU) 5016, a plurality of registers 5018, the local memory 5020, and a second example bus 5022. Other structures may be present. For example, each core 5002 may include vector unit circuitry, single instruction multiple data (SIMD) unit circuitry, load/store unit (LSU) circuitry, branch/jump unit circuitry, floating-point unit (FPU) circuitry, etc. The control unit circuitry 5014 includes semiconductor-based circuits structured to control (e.g., coordinate) data movement within the corresponding core 5002. The AL circuitry 5016 includes semiconductor-based circuits structured to perform one or more mathematic and/or logic operations on the data within the corresponding core 5002. The AL circuitry 5016 of some examples performs integer based operations. In other examples, the AL circuitry 5016 also performs floating point operations. In yet other examples, the AL circuitry 5016 may include first AL circuitry that performs integer based operations and second AL circuitry that performs floating point operations. In some examples, the AL circuitry 5016 may be referred to as an Arithmetic Logic Unit (ALU). The registers 5018 are semiconductor-based structures to store data and/or instructions such as results of one or more of the operations performed by the AL circuitry 5016 of the corresponding core 5002. For example, the registers 5018 may include vector register(s), SIMD register(s), general purpose register(s), flag register(s), segment register(s), machine specific register(s), instruction pointer register(s), control register(s), debug register(s), memory management register(s), machine check register(s), etc. The registers 5018 may be arranged in a bank as shown in FIG. 50. Alternatively, the registers 5018 may be organized in any other arrangement, format, or structure including distributed throughout the core 5002 to shorten access time. The second bus 5022 may be implemented by at least one of an I2C bus, a SPI bus, a PCI bus, or a PCIe bus

Each core 5002 and/or, more generally, the microprocessor 5000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 5000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 60 is a block diagram of another example implementation of the processor circuitry 4012 of FIG. 40. In this example, the processor circuitry 4012 is implemented by FPGA circuitry 6000. For example, the FPGA circuitry 6000 may be implemented by an FPGA. The FPGA circuitry 6000 can be used, for example, to perform operations that could otherwise be performed by the example microprocessor 5000 of FIG. 50 executing corresponding machine readable instructions. However, once configured, the FPGA circuitry 6000 instantiates the machine readable instructions in hardware and, thus, can often execute the operations faster than they could be performed by a general purpose microprocessor executing the corresponding software.

More specifically, in contrast to the microprocessor 5000 of FIG. 50 described above (which is a general purpose device that may be programmed to execute some or all of the machine readable instructions represented by the flowcharts but whose interconnections and logic circuitry are fixed once fabricated), the FPGA circuitry 6000 of the example of FIG. 60 includes interconnections and logic circuitry that may be configured and/or interconnected in different ways after fabrication to instantiate, for example, some or all of the machine readable instructions represented by the flowcharts. In particular, the FPGA circuitry 6000 may be thought of as an array of logic gates, interconnections, and switches. The switches can be programmed to change how the logic gates are interconnected by the interconnections, effectively forming one or more dedicated logic circuits (unless and until the FPGA circuitry 6000 is reprogrammed). The configured logic circuits enable the logic gates to cooperate in different ways to perform different operations on data received by input circuitry. Those operations may correspond to some or all of the software represented by the flowcharts. As such, the FPGA circuitry 6000 may be structured to effectively instantiate some or all of the machine readable instructions of the flowcharts as dedicated logic circuits to perform the operations corresponding to those software instructions in a dedicated manner analogous to an ASIC. Therefore, the FPGA circuitry 6000 may perform the operations corresponding to the some or all of the machine readable instructions faster than the general purpose microprocessor can execute the same.

In the example of FIG. 60, the FPGA circuitry 6000 is structured to be programmed (and/or reprogrammed one or more times) by an end user by a hardware description language (HDL) such as Verilog. The FPGA circuitry 6000 of FIG. 60, includes example input/output (I/O) circuitry 6002 to obtain and/or output data to/from example configuration circuitry 6004 and/or external hardware 6006. For example, the configuration circuitry 6004 may be implemented by interface circuitry that may obtain machine readable instructions to configure the FPGA circuitry 6000, or portion(s) thereof. In some such examples, the configuration circuitry 6004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 6006 may be implemented by external hardware circuitry. For example, the external hardware 6006 may be implemented by the microprocessor 5000 of FIG. 50. The FPGA circuitry 6000 also includes an array of example logic gate circuitry 6008, a plurality of example configurable interconnections 6010, and example storage circuitry 6012. The logic gate circuitry 6008 and the configurable interconnections 6010 are configurable to instantiate one or more operations that may correspond to at least some of the machine readable instructions and/or other desired operations. The logic gate circuitry 6008 shown in FIG. 60 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 6008 to enable configuration of the electrical structures and/or the logic gates to form circuits to perform desired operations. The logic gate circuitry 6008 may include other electrical structures such as look-up tables (LUTs), registers (e.g., flip-flops or latches), multiplexers, etc.

The configurable interconnections 6010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 6008 to program desired logic circuits.

The storage circuitry 6012 of the illustrated example is structured to store result(s) of the one or more of the operations performed by corresponding logic gates. The storage circuitry 6012 may be implemented by registers or the like. In the illustrated example, the storage circuitry 6012 is distributed amongst the logic gate circuitry 6008 to facilitate access and increase execution speed.

The example FPGA circuitry 6000 of FIG. 60 also includes example Dedicated Operations Circuitry 6014. In this example, the Dedicated Operations Circuitry 6014 includes special purpose circuitry 6016 that may be invoked to implement commonly used functions to avoid the need to program those functions in the field. Examples of such special purpose circuitry 6016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 6000 may also include example general purpose programmable circuitry 6018 such as an example CPU 6020 and/or an example DSP 6022. Other general purpose programmable circuitry 6018 may additionally or alternatively be present such as a GPU, an XPU, etc., that can be programmed to perform other operations.

Although FIGS. 50 and 60 illustrate two example implementations of the processor circuitry 4012 of FIG. 40, many other approaches are contemplated. For example, as mentioned above, modern FPGA circuitry may include an on-board CPU, such as one or more of the example CPU 6020 of FIG. 60. Therefore, the processor circuitry 4012 of FIG. 40 may additionally be implemented by combining the example microprocessor 5000 of FIG. 50 and the example FPGA circuitry 6000 of FIG. 60. In some such hybrid examples, a first portion of the machine readable instructions represented by the flowcharts may be executed by one or more of the cores 5002 of FIG. 50, a second portion of the machine readable instructions represented by the flowcharts may be executed by the FPGA circuitry 6000 of FIG. 60, and/or a third portion of the machine readable instructions represented by the flowcharts may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 4012 of FIG. 40 may be in one or more packages. For example, the microprocessor 5000 of FIG. 50 and/or the FPGA circuitry 6000 of FIG. 60 may be in one or more packages. In some examples, an XPU may be implemented by the processor circuitry 4012 of FIG. 40, which may be in one or more packages. For example, the XPU may include a CPU in one package, a DSP in another package, a GPU in yet another package, and an FPGA in still yet another package.

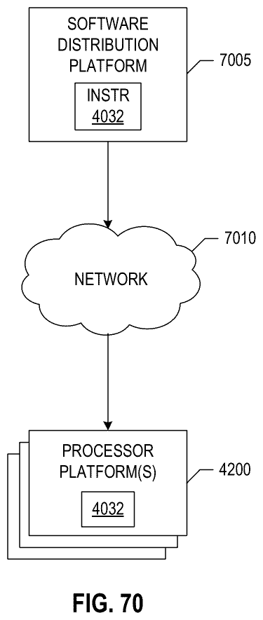

A block diagram illustrating an example software distribution platform 7005 to distribute software such as the example machine readable instructions 4032 of FIG. 40 to hardware devices owned and/or operated by third parties is illustrated in FIG. 70. The example software distribution platform 7005 may be implemented by any computer server, data facility, cloud service, etc., capable of storing and transmitting software to other computing devices. The third parties may be customers of the entity owning and/or operating the software distribution platform 7005. For example, the entity that owns and/or operates the software distribution platform 7005 may be a developer, a seller, and/or a licensor of software such as the example machine readable instructions 4032 of FIG. 40. The third parties may be consumers, users, retailers, OEMs, etc., who purchase and/or license the software for use and/or re-sale and/or sub-licensing. In the illustrated example, the software distribution platform 7005 includes one or more servers and one or more storage devices. The storage devices store the machine readable instructions 4032, which may correspond to the example machine readable instructions, as described above. The one or more servers of the example software distribution platform 7005 are in communication with an example network, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 4032 from the software distribution platform 7005. For example, the software, which may correspond to the example machine readable instructions, may be downloaded to the example processor platform 400, which is to execute the machine readable instructions 4032. In some examples, one or more servers of the software distribution platform 7005 periodically offer, transmit, and/or force updates to the software (e.g., the example machine readable instructions 4032 of FIG. 40) to ensure improvements, patches, updates, etc., are distributed and applied to the software at the end user devices.

Example methods, apparatus, systems, and articles of manufacture to control transactional data are disclosed herein. Further examples and combinations thereof include the following:

Example 1 includes an apparatus to secure data to a ledger, comprising memory, machine readable instructions, and processor circuitry to at least one of instantiate or execute the machine readable instructions to populate encrypted input data into a first portion of a first data structure, populate an encryption key into a second portion of the first data structure, cause the first portion of the first data structure to be signed with (a) credentials corresponding to an identifier corresponding to the encrypted data and (b) credentials corresponding to a transaction host, and store the data structure in a second data structure.

Example 2 includes the apparatus as defined in example 1, wherein the processor circuitry is to determine the encryption key is to be revoked.

Example 3 includes the apparatus as defined in example 2, wherein the processor circuitry is to permit the revocation of the encryption key based on a proof of revocation authorization.

Example 4 includes the apparatus as defined in example 3, wherein the processor circuitry is to evaluate the proof by fetching transaction data based on a transaction identifier corresponding to a requestor of the revocation, and by matching signatures between the transaction identifier and a current transaction identifier.

Example 5 includes the apparatus as defined in example 2, wherein the processor circuitry is to replace the revoked encryption key based on a lack of a proof of revocation authorization.

Example 6 includes the apparatus as defined in example 5, wherein the processor circuitry is to evaluate the proof by fetching transaction data based on a transaction identifier corresponding to a requestor of the revocation, the processor circuitry to disallow the revocation based on a mismatch between signatures of the transaction identifier and a current identifier.

Example 7 includes the apparatus as defined in example 5, wherein the processor circuitry is to replace the revoked encryption key with at least one of the same revoked encryption key or a second encryption key from an encryption key backup storage device.

Example 8 includes the apparatus as defined in example 1, wherein the processor circuitry is to detect modification of the second portion of the first data structure.

Example 9 includes the apparatus as defined in example 8, wherein the processor circuitry is to permit the modification of the second portion of the first data structure based on a proof of authorization.

Example 10 includes the apparatus as defined in example 8, wherein the processor circuitry is to detect the modification as at least one of an encryption key change, a deletion of the second portion of the first data structure, or an encryption key revocation.

Example 11 includes the apparatus as defined in example 1, wherein the second data structure includes at least one of a ledger or a blockchain ledger.

Example 12 includes the apparatus as defined in example 1, wherein the identifier corresponding to the encrypted data corresponds to an owner of the encrypted data.

Example 13 includes a non-transitory machine readable storage medium comprising instructions that, when executed, cause processor circuitry to at least generate an entry of encrypted input data to a first portion of a first data structure, generate an entry of an encryption key into a second portion of the first data structure, sign the first portion of the first data structure with (a) credentials corresponding to an identifier corresponding to the input data and (b) credentials corresponding to a transaction host, and store the data structure in a second data structure.

Example 14 includes the machine readable storage medium as defined in example 13, wherein the instructions, when executed, cause the processor circuitry to detect a revocation attempt of the encryption key.

Example 15 includes the machine readable storage medium as defined in example 14, wherein the processor circuitry is to permit the revocation attempt of the encryption key based on a proof of revocation authorization.

Example 16 includes the machine readable storage medium as defined in example 15, wherein the processor circuitry is to evaluate the proof by fetching transaction data based on a transaction identifier corresponding to a requestor of the revocation, and match signatures between the transaction identifier and a current transaction identifier.

Example 17 includes the machine readable storage medium as defined in example 14, wherein the processor circuitry is to replace the revoked encryption key based on a lack of a proof of revocation authorization.

Example 18 includes the machine readable storage medium as defined in example 17, wherein the processor circuitry is to evaluate the proof by fetching transaction data based on a transaction identifier corresponding to a requestor of the revocation, and disallow the revocation based on a mismatch between signatures of the transaction identifier and a current identifier.

Example 19 includes the machine readable storage medium as defined in example 17, wherein the processor circuitry is to replace the revoked encryption key with at least one of the same revoked encryption key or a second encryption key from an encryption key backup storage device.

Example 20 includes the machine readable storage medium as defined in example 14, wherein the processor circuitry is to determine the second portion of the first data structure has been modified.

Example 21 includes the machine readable storage medium as defined in example 20, wherein the processor circuitry is to permit the modification of the second portion of the first data structure based on a proof of authorization.

Example 22 includes the machine readable storage medium as defined in example 20, wherein the processor circuitry is to determine the modification as at least one of an encryption key change, a deletion of the second portion of the first data structure, or an encryption key revocation.

Example 23 includes a computer implemented method to store ledger data comprising generating, by executing an instruction with processor circuitry, an entry of encrypted input data to a first portion of a first data structure, generating, by executing an instruction with the processor circuitry, an entry of an encryption key into a second portion of the first data structure, signing, by executing an instruction with the processor circuitry, the first portion of the first data structure with (a) credentials corresponding to an identifier corresponding to the input data and (b) credentials corresponding to a transaction host, and storing, by executing an instruction with the processor circuitry, the first data structure in a second data structure.

Example 24 includes the method as defined in example 23, further including determining whether a revocation attempt of the encryption key has occurred.

Example 25 includes the method as defined in example 24, further including allowing the revocation attempt of the encryption key in response to detecting a proof of revocation authorization.

Example 26 includes the method as defined in example 25, further including evaluating the proof by fetching transaction data based on a transaction identifier corresponding to a requestor of the revocation, and matching signatures between the transaction identifier and a current transaction identifier.

Example 27 includes the method as defined in example 24, further including replacing the revoked encryption key based on a lack of a proof of revocation authorization.

Example 28 includes the method as defined in example 27, further including evaluating the proof by fetching transaction data based on a transaction identifier corresponding to a requestor of the revocation, and disallowing the revocation based on a mismatch between signatures of the transaction identifier and a current identifier.

Example 29 includes the method as defined in example 27, further including replacing the revoked encryption key with at least one of the same revoked encryption key or a second encryption key from an encryption key backup storage device.

Example 30 includes the method as defined in example 23, further including detecting modification of the second portion of the first data structure.

Example 31 includes the method as defined in example 30, further including permitting the modification of the second portion of the first data structure based on a proof of authorization.

Example 32 includes the method as defined in example 30, further including determining modification as at least one of an encryption key change, a deletion of the second portion of the first data structure, or an encryption key revocation.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. At least one non-transitory computer-readable medium storing instructions that cause at least one processor circuit to at least:
access transaction data associated with a user-controlled transaction container, the user-controlled transaction container to include at least a user-associated identity value, transaction content, and access-control data specifying one or more permissions for the transaction content;
cause storage of the user-controlled transaction container in a ledger data structure;
evaluate, in response to a request for access to the transaction content, whether a requesting entity satisfies the access-control data; and
selectively provide access to the transaction content based on the evaluation, such that access to the transaction content is controlled by the access-control data stored with the user-controlled transaction container.

2. The at least one non-transitory computer-readable medium of claim 1, wherein one or more of the at least one processor circuit is to assemble the user-controlled transaction container such that the transaction content is stored in a message field of the user-controlled transaction container.

3. The at least one non-transitory computer-readable medium of claim 2, wherein the message field is to store at least one of text, structured data, application template data, executable logic, digital asset data, or a reference to off-container content.

4. The at least one non-transitory computer-readable medium of claim 2, wherein one or more of the at least one processor circuit is to encrypt the message field and to store, separate from the message field, key material used to enable decryption of the message field for an authorized requesting entity.

5. The at least one non-transitory computer-readable medium of claim 4, wherein one or more of the at least one processor circuit is to revoke the key material while retaining the user-controlled transaction container in the ledger data structure, thereby rendering the message field unreadable without removal of the user-controlled transaction container from the ledger data structure.

6. The at least one non-transitory computer-readable medium of claim 1, wherein the access-control data is defined by one or more additional transaction containers recorded in the ledger data structure and associated with the user-controlled transaction container.

7. The at least one non-transitory computer-readable medium of claim 1, wherein the user-controlled transaction container is to include a sender object and a recipient object, the sender object to identify sender-related metadata, and the recipient object to identify recipient-related metadata.

8. The at least one non-transitory computer-readable medium of claim 7, wherein one or more of the at least one processor circuit is to access first transaction data associated with the sender object and second transaction data associated with the recipient object in separate communications, and to assemble the user-controlled transaction container based on the first transaction data and the second transaction data using a shared coordination value.

9. The at least one non-transitory computer-readable medium of claim 1, wherein one or more of the at least one processor circuit is to store, in the user-controlled transaction container, continuity data linking the user-controlled transaction container to at least one prior transaction container associated with a same user, the continuity data enabling validation of completeness of a set of transaction containers associated with the same user.

10. The at least one non-transitory computer-readable medium of claim 9, wherein one or more of the at least one processor circuit is to generate, responsive to a transfer request associated with the same user, validation data indicating that the set of transaction containers associated with the same user is complete for transfer to another transaction system.

11. An apparatus comprising:
interface circuitry;
machine readable instructions; and
processor circuitry to be programmed by the machine readable instructions to:
access transaction data associated with a user-controlled transaction container, the user-controlled transaction container to include at least a user-associated identity value, transaction content, and access-control data specifying one or more permissions for the transaction content;
cause storage of the user-controlled transaction container in a ledger data structure;
evaluate, in response to a request for access to the transaction content, whether a requesting entity satisfies the access-control data; and
selectively provide access to the transaction content based on the evaluation, such that access to the transaction content is controlled by the access-control data stored with the user-controlled transaction container.

12. The apparatus of claim 11, wherein the processor circuitry is to assemble the user-controlled transaction container such that the transaction content is stored in a message field of the user-controlled transaction container.

13. The apparatus of claim 12, wherein the message field is to store at least one of text, structured data, application template data, executable logic, digital asset data, or a reference to off-container content.

14. The apparatus of claim 12, wherein the processor circuitry is to encrypt the message field and to store, separate from the message field, key material used to enable decryption of the message field for an authorized requesting entity.

15. The apparatus of claim 14, wherein the processor circuitry is to revoke the key material while retaining the user-controlled transaction container in the ledger data structure, thereby rendering the message field unreadable without removal of the user-controlled transaction container from the ledger data structure.

16. The apparatus of claim 11, wherein the access-control data is defined by one or more additional transaction containers recorded in the ledger data structure and associated with the user-controlled transaction container.

17. The apparatus of claim 11, wherein the user-controlled transaction container is to include a sender object and a recipient object, the sender object to identify sender-related metadata, and the recipient object to identify recipient-related metadata.

18. The apparatus of claim 17, wherein the processor circuitry is to access first transaction data associated with the sender object and second transaction data associated with the recipient object in separate communications, and to assemble the user-controlled transaction container based on the first transaction data and the second transaction data using a shared coordination value.

19. The apparatus of claim 11, wherein the processor circuitry is to store, in the user-controlled transaction container, continuity data linking the user-controlled transaction container to at least one prior transaction container associated with a same user, the continuity data enabling validation of completeness of a set of transaction containers associated with the same user.

20. The apparatus of claim 19, wherein the processor circuitry is to generate, responsive to a transfer request associated with the same user, validation data indicating that the set of transaction containers associated with the same user is complete for transfer to another transaction system.
